(19) United States
(12) Patent Application Publication
(10) Pub. No.: US 2025/0263236 A1
(43) Pub. Date: Aug. 21, 2025

(54) SYSTEM AND METHOD FOR PRODUCTION AND FULFILLMENT

(71) Applicant: LIGHTS-OUT FULFILLMENT SYSTEMS INC., Brampton (CA)

(72) Inventor: H. J. Paul LANGEN, Brampton (CA)

(21) Appl. No.: 19/204,166

(22) Filed: May 9, 2025

Related U.S. Application Data
(63) Continuation-in-part of application No. PCT/CA2023/051504, filed on Nov. 10, 2023.
(63) Continuation-in-part of application No. PCT/CA2024/050151, filed on Feb. 7, 2024.
Application No. PCT/CA2024/050151 is a continuation-in-part of application No. PCT/CA2023/051504, filed on Nov. 10, 2023.
(60) Provisional application No. 63/540,187, filed on Sep. 25, 2023.
(60) Provisional application No. 63/530,851, filed on Aug. 4, 2023.
(60) Provisional application No. 63/523,847, filed on Jun. 28, 2023.
(60) Provisional application No. 63/440,645, filed on Jan. 23, 2023.
(60) Provisional application No. 63/424,676, filed on Nov. 11, 2022.
(60) Provisional application No. 63/540,187, filed on Sep. 25, 2023.
(60) Provisional application No. 63/530,851, filed on Aug. 4, 2023.
(60) Provisional application No. 63/523,847, filed on Jun. 28, 2023.

(51) Int. Cl. B65G 1/137; B66F 9/06; B66F 9/18; G05D 1/244

(52) U.S. Cl. CPC B65G 1/1375; B66F 9/063; B66F 9/181; B65G 2203/0216; G05D 1/2446

(57) ABSTRACT

Aspects of the present application relate to an order fulfillment system that may include one or more product induction regions. A given product induction region may include a plurality of product storage apparatuses, each holding a plurality of products, and a product transfer apparatus operable to transfer a product, among the plurality of products, into a shipping container. The order fulfillment system may include autonomous mobile robots (AMRs). An AMR may move to a shipping container delivery system to receive a shipping container and then move the shipping container to the product transfer apparatus to receive the product. The AMR may then move to a further location for further processing of the shipping container. The order fulfillment system may be combined with a production system. The product storage apparatuses may be universal crates, which may be returned to production system when empty to be refilled with products.

### RELATED APPLICATIONS

This application is a continuation-in-part of PCT application no. PCT/CA2023/051504, filed Nov. 10, 2023, which claims priority from U.S. provisional patent application No. 63/424,676 filed Nov. 11, 2022, U.S. provisional patent application No. 63/440,645, filed Jan. 23, 2023, U.S. provisional patent application No. 63/523,847, filed Jun. 28, 2023; U.S. provisional patent application No. 63/530,851, filed Aug. 4, 2023; U.S. provisional patent application No. 63/540,187, filed Sep. 25, 2023, and this application is also a continuation-in-part of PCT application no. PCT/CA2024/050151, filed Feb. 7, 2024, which is a continuation-in-part of PCT application no. PCT/CA2023/051504, filed Nov. 10, 2023, and which claims priority from U.S. provisional patent application No. 63/523,847, filed Jun. 28, 2023; U.S. provisional patent application No. 63/530,851, filed Aug. 4, 2023; U.S. provisional patent application No. 63/540,187, filed Sep. 25, 2023.

### FIELD OF THE INVENTION

The present disclosure relates, generally, to systems and methods for production and fulfillment.

### BACKGROUND

Containers are used to package many different kinds of products. One form of container used in the packaging industry is what is known generically as a “box” and it can be used to hold various products and sometimes other boxes containing products. Some in the packaging industry refer to boxes used to package one or more products as “cartons.” Also in the industry, there are containers/boxes that are known by some as “cases.” In this patent document, including the claims, the words “case,” “cases,” “carton,” “cartons,” “container” and “containers” are used interchangeably to refer to boxes, cartons, trays, envelopes and/or cases and the like that can be used to package any type of items including products and other cartons.

Cases come in many different configurations and are made from a wide variety of materials. However, many cases are foldable and are formed from a flattened state (commonly called a carton blank). Cases may be made from an assortment of foldable materials, including, but not limited to, cardboard, chipboard, paperboard, corrugated fiberboard, other types of corrugated materials, plastic materials, composite materials and the like and possibly even combinations thereof.

Cases can be used to fulfil an order initiated by a customer for one or more products by obtaining each product from one or more locations in a storage facility such as a warehouse, loading the product(s) into a case, sealing the loaded case and then shipping the loaded case to a customer.

However, there are many obstacles to providing efficient methods and systems to fulfil customer orders, particularly where it is desirable to be able to fulfil orders for a large number of customers that may each have orders for a wide range of different kinds and/or numbers of products.

### SUMMARY

According to an aspect of the present invention there is provided an order fulfillment system. The order fulfillment system includes a first product induction region including a plurality of product storage apparatuses, each product storage apparatus, among the plurality of product storage apparatuses, holding a plurality of products and a first product transfer apparatus operable to transfer a first product, among a first plurality of products held by a first product storage apparatus among the plurality of storage apparatuses, into a shipping container. The order fulfillment system also includes a shipping container autonomous mobile robot (AMR) and a shipping container delivery system operable to deliver the shipping container to the shipping container AMR. The shipping container AMR is operable to travel, according to shipping container AMR instructions, to the shipping container delivery system, wait, at the shipping container delivery system, to receive the shipping container, travel, while holding the shipping container and according to the shipping container AMR instructions, to the first product transfer apparatus, wait, at the first product transfer apparatus and according to shipping container AMR instructions, for the first product to be transferred, by the first product transfer apparatus, from the product storage apparatus into the shipping container and travel, while holding the shipping container with the first product inside and according to the shipping container AMR instructions, to at least one location for further processing of the shipping container.

According to an aspect of the present invention there is provided a method of operating a fulfilment system. The system includes a first product induction region comprising a plurality of product storage apparatuses, each product storage apparatuses among the plurality of product storage apparatuses, holding a plurality of products, a first product transfer apparatus operable to transfer a first product among a first plurality of products held by a first product storage apparatus among the plurality storage apparatuses, into a shipping container, a shipping container autonomous mobile robot (AMR) and a shipping container delivery system operable to deliver the shipping container to the shipping container AMR. The method includes the shipping container AMR travelling to the shipping container delivery system, waiting to receive, from the shipping container delivery system, the shipping container, travelling, while holding the shipping container, to the first product transfer apparatus in the first product induction region, waiting to receive, at the first product transfer apparatus, the first product from the product storage apparatus, into the shipping container and travelling, while holding the shipping container with the first product inside, to at least one location for further processing of the shipping container.

According to an aspect of the present invention there is provided an order fulfillment system. The order fulfillment system includes a first product induction region comprising a plurality of pallets, each of the plurality of pallets holding a plurality of products, a product transfer apparatus operable to transfer a first product from a selected pallet of the plurality of pallets, a shipping container autonomous mobile robot (AMR) and a shipping container delivery system operable to deliver a selected shipping container to the shipping container AMR. The shipping container AMR is operable to travel to the shipping container delivery system, wait, at the shipping container delivery system, to receive the selected shipping container, travel, while holding the selected shipping container, to the product transfer apparatus in the product induction region, wait, at the first product transfer location, to receive a first product from the selected pallet into the selected shipping container and travel, while holding the selected shipping container with the first product inside, to at least one location for further processing of the selected shipping container.

According to an aspect of the present invention there is provided a method of operating a fulfilment system. The fulfillment system includes a first product induction region comprising a plurality of pallets, each pallet among the plurality of pallets holding a plurality of products, a product transfer apparatus operable to transfer a first product from a selected pallet, the selected pallet selected from among the plurality of pallets, a shipping container autonomous mobile robot (AMR) and a shipping container delivery system operable to deliver a selected shipping container to the shipping container AMR. The method includes the shipping container AMR travelling to the shipping container delivery system, waiting, at the shipping container delivery system, to receive the selected shipping container, travelling, while holding the selected shipping container, to the product transfer apparatus in the product induction region, waiting, at the first product transfer location, to receive a first product from the selected pallet into the selected shipping container and travelling, while holding the selected shipping container with the first product inside, to at least one location for further processing of the selected shipping container.

According to an aspect of the present invention there is provided an order fulfillment system. The order fulfillment system includes a processor operable to generate pallet autonomous mobile robot (AMR) instructions, a pallet AMR configured to receive, from the processor, the pallet AMR instructions. The pallet AMR is configured to, according to the pallet AMR instructions travel to a pallet receiving location, receive, at the pallet receiving location, a selected pallet, travel, while holding the selected pallet, to a product storage region and release the selected pallet. The pallet holds at least one product, the at least one product corresponding with at least one stock keeping unit.

According to an aspect of the present invention there is provided a method of operating a fulfilment system. The fulfillment system includes a processor operable to generate pallet autonomous mobile robot (AMR) instructions, a pallet AMR. The method includes the pallet AMR receiving, from the processor, the pallet AMR instructions, according to the pallet AMR instructions, travelling to a pallet receiving location, receiving, at the pallet receiving location, a selected pallet, travelling, while holding the selected pallet, to a product storage region and releasing the selected pallet, wherein the selected pallet holds at least one product, the at least one product corresponding with at least one stock keeping unit.

According to an aspect of the present invention there is provided a system. The system includes a moving apparatus operable to move one or more of a plurality of crates of a plurality of stacked crates that are vertically stacked on a pallet in a crate stack positioned at a crate moving position, wherein at least some of the plurality of crates contain at least one product in a crate and the crate stack is supported on a pallet, and a processor operable to generate moving apparatus instructions. The moving apparatus is operable to receive the moving apparatus instructions from the processor, engage a selected crate of the plurality of crates in the crate stack and move the selected crate and any crates stacked above the selected crate.

According to an aspect of the present invention there is provided a method. The method includes moving one or more of a plurality of crates of a plurality of stacked crates that are vertically stacked on a pallet in a crate stack positioned at a crate moving position, wherein at least some of the plurality of crates contain at least one product in a crate, and the crate stack is supported on a pallet and engaging a selected crate of the plurality of crates in the crate stack and moving, optionally by lifting, the selected crate and any crates stacked above the selected crate.

According to an aspect of the present invention there is provided a system for delivering products. The system includes a transport trailer configured to receive and store at least one pallet, a pallet autonomous mobile robot (AMR), operable to transport a pallet and a processor operable to transmit instructions to the pallet AMR. The instructions cause the pallet AMR to navigate to a pallet receiving position outside of the transport trailer and engage a pallet, navigate to a storage position in the transport trailer and release the pallet in the storage position and navigate away from the transport trailer without the pallet. The transport trailer includes an interior storage space defined by a ceiling surface, a side wall surface and a floor surface and the floor surface implements a configuration to facilitate navigation in the transport trailer by the pallet AMR.

According to an aspect of the present invention there is provided a method for delivering products using a pallet autonomous mobile robot (AMR) to load a transport trailer with a pallet, the transport trailer configured to receive and store the pallet. The method includes the pallet AMR navigating to a pallet receiving position outside of the transport trailer and engaging the pallet, navigating to the storage position in the transport trailer and releasing the pallet in the storage position and navigating away from the transport trailer without the pallet.

According to an aspect of the present invention there is provided a system for delivering products. The system includes a transport trailer configured to receive and store at least one pallet, a pallet autonomous mobile robot (AMR) operable to transport a pallet and a processor operable to transmit instructions to the pallet AMR. The instructions cause the pallet AMR to navigate to a pallet receiving position inside the transport trailer and engage a given pallet, navigate to a storage position outside of the transport trailer and release the given pallet in the storage position and navigate away from the given pallet.

According to an aspect of the present invention there is provided a method for delivering products using a pallet autonomous mobile robot (AMR) to unload a transport trailer, the transport trailer capable of receiving and storing the pallet. The method including the pallet AMR navigating to a pallet receiving position inside the transport trailer and engaging a given pallet, navigating to a storage position outside of the transport trailer and releasing the given pallet in the storage position and navigating away from the given pallet.

According to an aspect of the present invention there is provided a system for loading and transporting products. The system includes a source of a plurality of products, wherein the system is operable to transfer the plurality of products onto a pallet located at a pallet loading position, a transport trailer configured to receive and store at least one pallet, a pallet autonomous mobile robot (AMR), operable to move a pallet and a processor operable to transmit instructions to the pallet AMR. The instructions cause the pallet AMR to navigate to a pallet receiving position and engage a given pallet holding a plurality of products, navigate to a storage position in the transport trailer and release the given pallet in the storage position and navigate away from the transport trailer without the given pallet.

According to an aspect of the present invention there is provided a system for loading products onto pallets. The system includes a source of products, a product transfer apparatus operable to load at least one product provided by the source of products into each crate among a plurality of crates at a loading station to, thereby, form a plurality of loaded crates, a loaded crate stack forming apparatus operable to form a loaded crate stack from the plurality of loaded crates, an apparatus operable to load the loaded crate stack onto a pallet to form a loaded pallet, a pallet autonomous mobile robot (AMR), the pallet AMR operable to engage with and move the loaded pallet while supporting the loaded crate stack and a processor operable to transmit instructions to the pallet AMR. The instructions causing the pallet AMR to navigate to a pallet receiving position, engage, at the pallet receiving position, a non-loaded pallet, navigate to a crate stack receiving position with the non-loaded pallet, receive the crate stack to, thereby, form the loaded pallet, navigate away from the crate stack receiving position with the loaded pallet and travel, while engaging the loaded pallet, to a location for further processing.

According to an aspect of the present invention there is provided a method for loading products onto pallets. The method including loading at least one product provided by a source of products into each crate among a plurality of empty crates to form a plurality of loaded crates, forming a loaded crate stack from the plurality of loaded crates, loading the loaded crate stack onto a pallet to form a loaded pallet, engaging, with a pallet autonomous mobile robot (AMR), with the loaded pallet and moving the loaded pallet while supporting the loaded crate stack.

According to an aspect of the present invention there is provided a system for delivering products to a fulfillment operation. The system includes a production operation including a source of products, a product transfer apparatus, at the production operation, operable to transfer a plurality of products, provided by the source of products, onto a pallet located at a pallet loading position, a first transport trailer operable to receive and store at least one pallet, the first transport trailer enabling navigation of autonomous mobile robots (AMRs) therein and a first production pallet AMR at the production operation. The first production pallet AMR is operable to navigate to a pallet receiving position, engage, at the pallet receiving position, a loaded pallet holding a plurality of products, navigate to a storage position in the transport trailer, release, at the storage position, the loaded pallet and navigate away from the transport trailer without the loaded pallet. The system further includes a fulfillment operation including a first fulfilment pallet AMR operable to navigate to the storage position on the first transport trailer, engage, at the storage position, the loaded pallet, navigate to a pallet storage position within the fulfillment operation, release, at the pallet storage position, the loaded pallet, navigate away from the pallet storage position without the loaded pallet. When the first transport trailer is loaded with the loaded pallet, the first transport trailer is operable to transport the loaded pallet from the production operation to the fulfillment operation.

According to an aspect of the present invention there is provided a method for delivering products to a fulfillment operation. The method including, at a production operation, transferring a plurality of products provided by a source of products onto a pallet to, thereby, form a loaded pallet, navigating, by a first production pallet autonomous mobile robot (AMR), to the loaded pallet, engaging, by the first production pallet AMR, the loaded pallet, navigating, by the first production pallet AMR, to a storage position in a transport trailer, releasing, by the first production pallet AMR, the loaded pallet in the pallet storage position while the transport trailer located at the production operation and navigating, by the first production pallet AMR, away from the transport trailer without the loaded pallet.

According to an aspect of the present invention there is provided a method of operating a fulfillment operation. The method including navigating, by a first autonomous mobile robot (AMR) at the fulfillment operation, to a pallet storage position on a first transport trailer located at the fulfillment operation, engaging, by the first AMR, a loaded pallet, the loaded pallet holding a plurality of products, moving, by the first AMR, the loaded pallet to a location with the fulfillment operation, emptying, by components of the fulfillment operation, the loaded pallet of most or all of the plurality products to, thereby, form a returning pallet, navigating, by a second AMR at the fulfillment operation, to the returning pallet and moving, by the second AMR, the returning pallet to a pallet storage position on a second transport trailer located at the fulfillment operation.

According to an aspect of the present invention there is provided a method of operating a production operation. The method includes loading a pallet with a plurality of products to, thereby, form a loaded pallet, navigating, by a first autonomous mobile robot (AMR) at the production operation, to the loaded pallet, moving, by the first AMR, the loaded pallet onto a first transport trailer, navigating, by a second AMR at the production operation, to a returning pallet on a second transport trailer located at the production operation and removing, by the second AMR, the returning pallet from the second transport trailer.

According to an aspect of the present invention there is provided a transport trailer. The transport trailer includes an interior storage space defined by a ceiling surface, a side wall surface and a floor surface. The floor surface includes a first configuration to facilitate navigation in the transport trailer by an autonomous mobile robot (AMR).

According to an aspect of the present invention there is provided a transport trailer. The transport trailer includes an interior storage space defined by a ceiling surface, a side wall surface and a floor surface. The transport trailer further includes a plurality of air bags positioned on the side wall surface. The plurality of air bags have a first state, in which the air bags are inflated with pressurized air to engage a side surface of a crate supported on a pallet stored in the interior space and a second state, in which the air bags are depressurized and disengage from the side surface of the crate.

According to an aspect of the present invention there is provided a shipping container blank delivery system for delivering shipping container blanks to an erected shipping container delivery system. The shipping container blank delivery system includes a shipping container blank pallet holding a plurality of shipping container blanks and a shipping container blank autonomous mobile robot (AMR). The shipping container blank AMR is configured to travel to a shipping container blank pallet receiving location, engage, at the shipping container blank pallet receiving location, the shipping container blank pallet and travel to a blank transfer location, wherein the blank transfer location is proximate the erected shipping container delivery system. The shipping container blank delivery system further includes a blank transfer apparatus proximate the blank transfer location and the erected shipping container delivery system, the blank transfer apparatus operable to transfer the plurality of shipping container blanks from the shipping container blank pallet to the erected shipping container delivery system.

According to an aspect of the present invention there is provided a method of operating a fulfillment system that includes a shipping container blank autonomous mobile robot (AMR). The method includes travelling, by the shipping container blank AMR, to a shipping container blank pallet receiving location, engaging, by the shipping container blank AMR at the shipping container blank pallet receiving location, a shipping container blank pallet, the shipping container blank pallet holding a plurality of shipping container blanks and travelling, by the shipping container blank AMR, to a blank transfer location proximate a shipping container delivery system.

According to an aspect of the present invention there is provided a system for delivering shipping container blanks to a fulfillment operation. The system includes a production operation operable to provide a source of shipping container blanks, a product transfer apparatus, at the production operation, operable to transfer a plurality of shipping container blanks, provided by the source of shipping container blanks, onto a shipping container blank pallet located at a pallet loading position, a first transport trailer configured to receive and store the shipping container blank pallet, a production pallet autonomous mobile robot (AMR), at the production operation, operable to move the shipping container blank pallet and a processing system operable to transmit production pallet AMR instructions to the production pallet AMR. The production pallet AMR instructions causes the production pallet AMR to navigate to a pallet receiving position, engage the shipping container blank pallet holding the plurality of shipping container blanks, navigate to a storage position in the transport trailer, release, in the storage position, the shipping container blank pallet and navigate away from the transport trailer without the shipping container blank pallet. When the first transport trailer is loaded with the shipping container blank pallet, the first transport trailer is operable to transport the shipping container blank pallet from the production operation to the fulfillment operation.

According to an aspect of the present invention there is provided a method for delivering shipping container blanks to a fulfillment operation. The method includes transferring a plurality of shipping container onto a shipping container blank pallet, navigating, by a pallet autonomous mobile robot (AMR), to the shipping container blank pallet, engaging, by the pallet AMR, the shipping container blank pallet holding the plurality of shipping container blanks, navigating, by the pallet AMR, to a storage position on a transport trailer, releasing, by the pallet AMR, the shipping container blank pallet in the storage position and navigating away from the transport trailer without the shipping container blank pallet.

According to one aspect of the present invention there is provided an order fulfillment system. The order fulfillment system includes a processor operable to generate carton forming instructions and generate autonomous mobile robot (AMR) instructions. The order fulfillment system further includes a carton forming system configured to receive, from the processor, the carton forming instructions, according to the carton forming instructions, select, from a plurality of magazines, a carton blank and form the carton blank into an erected carton. The order fulfillment system further includes an AMR configured to receive, from the processor, the AMR instructions, according to the AMR instructions, travel to the carton forming system and receive, from the carton forming system, the erected carton, according to the AMR instructions, travel, while holding the erected carton, to a station in a product induction region, receive, at the station, a product into the erected carton and, according to the AMR instructions, travel, while holding the erected carton with the product inside, to a location for further processing of the erected carton.

According to another aspect of the present invention there is provided an order fulfillment system. The order fulfillment system includes a processor operable to generate shipping container selection instructions and generate autonomous mobile robot (AMR) instructions. The order fulfillment system further includes a shipping container delivery system configured to receive, from the processor, the shipping container selection instructions and, according to the shipping container selection instructions, select, from a plurality of shipping containers, a selected shipping container. The order fulfillment system further includes an AMR configured to receive, from the processor, the AMR instructions, according to the AMR instructions, travel to the shipping container delivery system and receive, from the shipping container delivery system, the selected shipping container, according to the AMR instructions, travel, while holding the selected shipping container, to a station in a product induction region, receive, at the station, a product into the selected shipping container and, according to the AMR instructions, travel, while holding the selected shipping container with the product inside, to a location for further processing of the selected shipping container.

According to a further aspect of the present invention there is provided a carton closing and sealing system. The carton closing and sealing system includes an autonomous mobile robot (AMR), a processor operable to generate AMR instructions, a shipping container delivery system configured and operable to deliver, to the AMR, a shipping container and a sealing apparatus operable such that when the AMR moves through the sealing apparatus with the shipping container thereon the shipping container is sealed. The AMR may be configured and operable to receive, from the processor, the AMR instructions and, according to the AMR instructions, travel to the sealing apparatus and move through the sealing apparatus to seal the shipping container.

According to a still further aspect of the present invention there is provided an autonomous mobile robot (AMR) for transporting a receptacle. The AMR includes a mobile cart, a control system for controlling operation of the autonomous mobile robot, a first belt having an upper surface, a first lug fastened to the upper surface of the first belt, a second belt having an upper surface and a second lug fastened to the upper surface of the second belt. The control system is operable to control and adjust a position of the first lug relative to the second lug to move between a first position wherein a spacing between the first lug and the second lug is suitable to allow a receptacle to be positioned between, or removed from between, the first lug and the second lug and a second position wherein the spacing between the first lug and the second lug provides for the first lug and the second lug to engage side surfaces of the receptacle to secure the receptacle between the first lug and the second lug.

According to an even further aspect of the present invention there is provided an autonomous mobile robot (AMR) for transporting a receptacle. The AMR includes a mobile cart, a control system for controlling operation of the autonomous mobile robot and a receptacle securement mechanism operable to releasably secure a receptacle to the mobile cart during movement in a warehouse, when the receptacle carries at least one product in a product order and when the receptacle is empty of any products. The control system is operable to control and adjust the operation of the receptacle securement mechanism between a first state in which the shipping container is secured to the mobile cart and can be moved within the warehouse when the receptacle is both carrying at least one product in a product order and when the receptacle is empty of any products and a second state wherein the receptacle can be removed from the mobile cart.

According to an even further aspect of the present invention there is provided a product unloading system. The product unloading system includes a product rack for storing products. The product rack includes a plurality of storage levels for storing the products thereon, the plurality of storage levels spaced apart from each other and arranged vertically within the product rack. The product rack further includes a plurality of raised platforms configured for travel of an autonomous mobile robot (AMR) thereon, each one of the plurality of raised platforms positioned proximate to a respective one of the plurality of storage levels. The product unloading system further includes an elevator system comprising an elevating platform for lifting the AMR between a ground level and the plurality of raised platforms. The product unloading system further includes a product retrieval robot for retrieving a product from a storage level of the plurality of storage levels and unloading the product onto a receptacle held by the AMR at a corresponding one of the plurality of storage levels.

According to an even further aspect of the present invention there is provided an fulfilment system. The order fulfillment system includes a processor operable to generate carton forming instructions, generate product retrieval instructions, and generate autonomous mobile robot (AMR) instructions. The order fulfillment system further includes a carton forming system configured to receive, from the processor, the carton forming instructions, according to the carton forming instructions, select, from a plurality of magazines, a carton blank and form the carton blank into an erected carton. The order fulfillment system further includes a product retrieval robot configured to receive, from the processor, the product retrieval instructions, and retrieve, according to the product retrieval instructions, a product from a product rack in a product storage location. The order fulfillment system further includes an AMR configured to receive, from the processor, the AMR instructions, according to the AMR instructions, travel to the carton forming system and receive, from the carton forming system, the erected carton, according to the AMR instructions, travel, while holding the erected carton, to the product rack, receive, at the product rack, the product from the product retrieval robot into the erected carton, and according to the AMR instructions, travel, while holding the erected carton with the product inside, to a location for further processing of the erected carton.

According to an even further aspect of the present invention there is provided a fulfillment system. The fulfillment system includes a processor operable to generate receptacle delivery instructions and generate autonomous mobile robot (AMR) instructions. The fulfillment system also includes a carton delivery system configured to receive, from the processor, the receptacle delivery instructions and, according to the receptacle delivery instructions, select, from a selection of receptacles a chosen receptacle for delivery. The fulfillment system includes an AMR configured to receive, from the processor, the AMR instructions, according to the AMR instructions, travel to a receptacle delivery system and receive, from the receptacle delivery system, said chosen receptacle, according to the AMR instructions, travel, while holding the chosen receptacle, to a station in a product induction region, receive, at the station, a product into the chosen receptacle and according to the AMR instructions, travel, while holding the chosen receptacle with the product inside, to a location for further processing of the chosen receptacle.

According to an even further aspect of the present invention there is provided a fulfillment system. The fulfillment system includes a processor operable to generate shipping container selection instructions and generate autonomous mobile robot (AMR) instructions. The fulfillment system also includes a shipping container delivery system configured to receive, from the processor, the shipping container selection instructions and, according to the shipping container selection instructions, select, from a plurality of shipping containers, a selected shipping container. The fulfillment system further includes an AMR configured to receive, from the processor, the AMR instructions, according to the AMR instructions, travel to the shipping container delivery system and receive, from the shipping container delivery system, the selected shipping container, according to the AMR instructions, travel, while holding the selected shipping container, to a station in a product induction region, wherein the product induction region includes a product tower, the product tower including a plurality of compartments for storing products, and wherein at least one of the plurality of compartments includes one or more products, the one or more products corresponding with at least one stock keeping unit, receive, at the station, a first product into the selected shipping container, according to the AMR instructions, travel, while holding the selected shipping container, to a given product storage rack in a storage region, wherein the storage region includes a plurality of product storage racks that store products in pallets, receive, at the given product storage rack, a second product into the selected shipping container and according to the AMR instructions, travel, while holding the selected shipping container with the first product and the second product inside, to a location for further processing of the selected shipping container.

According to an even further aspect of the present invention there is provided a fulfillment system. The fulfillment system includes a processor operable to generate carton forming instructions, generate product retrieval instructions and generate autonomous mobile robot (AMR) instructions. The fulfillment system also includes a carton forming system configured to receive, from the processor, the carton forming instructions, according to the carton forming instructions, select, from a plurality of available carton blanks, a carton blank and form the carton blank into an erected carton. The fulfillment system also includes a product retrieval robot configured to receive, from the processor, the product retrieval instructions and retrieve, according to the product retrieval instructions, a product in a product storage location. The fulfillment system further includes a reusable container, the reusable container including a plurality of products used to fulfil a plurality of orders, the reusable container becoming an empty reusable container upon the plurality of products being removed from the reusable container to fulfil the plurality of orders and an AMR configured to receive, from the processor, the AMR instructions, according to the AMR instructions, travel to the carton forming system and receive, from the carton forming system, the erected carton, according to the AMR instructions, travel, while holding the erected carton, to a product loading station, receive, at the product loading station, the product into the erected carton, according to the AMR instructions, travel, while holding the erected carton with the product inside, to a location for further processing of the erected carton, wherein the further processing of the erected carton includes removal of the erected carton from the AMR, thereafter, according to the AMR instructions, travel and receive, the empty reusable container and according to the AMR instructions, travel, while holding the empty reusable container, to a location for further processing of the empty reusable container.

According to an even further aspect of the present invention there is provided a fulfillment system. The fulfillment system includes a processor operable to generate shipment container delivery instructions, generate product retrieval instructions and generate autonomous mobile robot (AMR) instructions. The fulfillment system also includes a shipment container delivery system configured to receive, from the processor, the shipment container delivery instructions and according to the shipment container delivery instructions, select, from a plurality of available shipment containers, a shipment container. The fulfillment system also includes a product retrieval robot configured to receive, from the processor, the product retrieval instructions and retrieve, according to the product retrieval instructions, a product in a product storage location. The fulfillment system also includes a reusable container, the reusable container including a plurality of products used to fulfil a plurality of orders, the reusable container becoming an empty reusable container upon the plurality of products being removed from the reusable container to fulfil the plurality of orders. The fulfillment system further includes an AMR configured to receive, from the processor, the AMR instructions, according to the AMR instructions, travel to the shipment container delivery system and receive the shipment container, according to the AMR instructions, travel, while holding the shipment container, to a product loading station, receive, at the product loading station, the product into the shipment container, according to the AMR instructions, travel, while holding the shipment container with the product inside, to a location for further processing of the shipment container, wherein the further processing of the shipment container includes removal of the shipment container from the AMR, thereafter, according to the AMR instructions, travel and receive, the empty reusable container on the AMR and according to the AMR instructions, travel, while holding the empty reusable container, to a location for further processing of the empty reusable container.

According to an even further aspect of the present invention there is provided a method of receiving products into a fulfillment center. The method includes transmitting instructions to a first autonomous mobile robot (AMR), the instructions causing the first AMR to navigate to a crate retention structure in a first transport trailer, the crate retention structure retaining a crate in which is stored a plurality of a product and transport the crate retention structure to a product induction region at which individual products among the plurality of products may be removed from the crate. The method further includes transmitting instructions to a second AMR, the instructions causing the second AMR to navigate to the crate retention structure in the product induction region, the crate no longer storing the product, transport the crate retention structure to a second transport trailer and navigate away from the second transport trailer without the crate retention structure.

According to an aspect of the present invention, there is provided an order fulfilment system, comprising: a plurality of reusable pallets; a production operation; a shipping container operation; a fulfillment operation; the production operation comprising: a source of products; a product transfer apparatus, operable to transfer a plurality of products, provided by the source of products, onto a pallet at a production pallet loading position; and a plurality of production AMRs, each operable to move first loaded ones of the pallets from the product transfer apparatus to first transport trailers for transport to the fulfillment operation, and to receive unloaded ones of the pallets from second transport trailers and move the unloaded ones of the pallets to the production pallet loading position; the shipping container operation comprising: a source of shipping container blanks; a shipping container blank transfer apparatus, at the shipping container operation, operable to transfer a plurality of shipping container blanks, provided by the source of shipping container blanks, onto a shipping container blank pallet located at a shipping container pallet loading position; and a plurality of shipping container AMRs, each operable to move second loaded ones of the pallets from the product transfer apparatus to third transport trailers for transport to the fulfillment operation, and to receive unloaded ones of the pallets from fourth transport trailers and move the unloaded ones of the pallets to the shipping container pallet loading position; and the fulfillment operation comprising: a shipping container erector operable to form shipping containers from the shipping container blanks for shipping fulfilled product orders to customers; and a plurality of fulfillment AMRs, each operable to: receive the first loaded ones of the pallets and move the first loaded ones from the first transport trailers to storage locations in the fulfillment operation; receive the second loaded ones of the pallets and move the second loaded ones of the pallets from the third transport trailers to the shipping container erector; and move unloaded ones of the pallets to the second transport trailers for transportation to the production operation and to the fourth transport trailers for transportation to the shipping container operation.

According to another aspect of the present invention, there is provided an autonomous mobile robot (AMR) for transporting a receptacle, the AMR comprising: a mobile cart; a first belt on the mobile cart having an upper surface, and a first lug on the upper surface; a second lug mounted to the mobile cart; first lug movable relative to the second lug to selectively retain the receptacle between the first and second lugs by squeezing the receptacle.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1A illustrates, in a top right front perspective view, part of a carton forming system, in accordance with an example embodiment of the present application;

FIG. 1B illustrates, in a schematic flow chart, a power and control sub-system of the part of the carton forming system of FIG. 1A, in accordance with aspects of the present application;

FIG. 2 illustrates, in a top right rear perspective view, the carton forming system of FIG. 1A;

FIG. 3 illustrates, in a top right side perspective view, the carton forming system of FIG. 1A;

FIG. 4 illustrates, in a front schematic elevation view, the carton forming system of FIG. 1A, but with several components omitted;

FIG. 5 illustrates, in a rear schematic elevation view, the carton forming system of FIG. 1A, but with several components omitted;

FIG. 6A illustrates, in a top right perspective view, a magazine sub-system, in accordance with aspects of the present application;

FIG. 6B illustrates, in a top right perspective view, the magazine sub-system of FIG. 6A, but with several components omitted;

FIG. 6C illustrates, in a right side elevation view, the magazine sub-system of FIG. 6A, but with several components omitted;

FIG. 6D illustrates, in a top plan view, the magazine sub-system of FIG. 6A;

FIG. 7 illustrates, in a right side perspective view, the carton forming system of FIG. 1A, but with several components omitted to show a blank intake system, two erector heads with movement apparatuses and a folding and sealing apparatus;

FIG. 8 illustrates, in a top right rear perspective view, components of FIG. 7;

FIG. 9 illustrates, in a top right front perspective view, components of FIG. 7;

FIG. 10A illustrates, in a plan view, a blank for a regular slotted case in a generally flattened tubular configuration;

FIG. 10B illustrates, in front elevation view, the blank for a regular slotted case of FIG. 10A;

FIG. 10C illustrates, in a side elevation view, the blank for a regular slotted case of FIG. 10A;

FIG. 10D illustrates, in a perspective view, the blank for a regular slotted case of FIG. 10A;

FIG. 10E illustrates, in another perspective view, the blank for a regular slotted case of FIG. 10A;

FIG. 11 illustrates, in a schematic right perspective view, the blank of FIG. 10A configured in an open configuration;

FIG. 12 illustrates, in a schematic right perspective view, the blank of FIG. 11 after a step in a sequentially process of turning the blank into an erected carton;

FIG. 13 illustrates, in a schematic right perspective view, the blank of FIG. 12 after a step in a sequential process of turning the blank into an erected carton;

FIG. 14 illustrates, in a schematic right perspective view, the blank of FIG. 13 after a step in a sequential process of turning the blank into an erected carton;

FIG. 15 illustrates, in a schematic right perspective view, the blank of FIG. 14 after a step in a sequential process of turning the blank into an erected carton;

FIG. 16 illustrates, in a schematic right perspective view, the blank of FIG. 15 after a step in a sequential process of turning the blank into an erected carton;

FIG. 17 illustrates, in a schematic right perspective view, the carton forming system of FIG. 1A, but showing only a single movement apparatus, erector head and some parts of the folding and sealing apparatus, in a sequential stage of processing the blank of FIG. 10A into an erected carton, in accordance with aspects of the present application;

FIG. 18 illustrates, in a schematic right perspective view, the carton forming system of FIG. 17 in a sequential stage of processing the blank of FIG. 10A into an erected carton, in accordance with aspects of the present application;

FIG. 19 illustrates, in a schematic right perspective view, the carton forming system of FIG. 17 in a sequential stage of processing the blank of FIG. 10A into an erected carton, in accordance with aspects of the present application;

FIG. 20 illustrates, in a schematic right perspective view, the carton forming system of FIG. 17 in a sequential stage of processing the blank of FIG. 10A into an erected carton, in accordance with aspects of the present application;

FIG. 21 illustrates, in a schematic right perspective view, the carton forming system of FIG. 17 in a sequential stage of processing the blank of FIG. 10A into an erected carton, in accordance with aspects of the present application;

FIG. 22 illustrates, in a schematic right perspective view, the carton forming system of FIG. 17 in a sequential stage of processing the blank of FIG. 10A into an erected carton, in accordance with aspects of the present application;

FIG. 23 illustrates, in a schematic right perspective view, the carton forming system of FIG. 17 in a sequential stage of processing the blank of FIG. 10A into an erected carton, in accordance with aspects of the present application;

FIG. 24 illustrates, in a schematic right perspective view, the carton forming system of FIG. 17 in a sequential stage of processing the blank of FIG. 10A into an erected carton, in accordance with aspects of the present application;

FIG. 25 illustrates, in a schematic right perspective view, the carton forming system of FIG. 17 in a sequential stage of processing the blank of FIG. 10A into an erected carton, in accordance with aspects of the present application;

FIG. 26 illustrates, in a rear elevation view, components of the carton forming system of FIG. 17;

FIG. 26A illustrates, in a schematic perspective view, part of a folding and sealing apparatus of the carton forming system of FIG. 1A;

FIG. 27 illustrates, in a schematic right perspective view, the carton forming system of FIG. 17 in a sequential stage of processing the blank of FIG. 10A into an erected carton, in accordance with aspects of the present application;

FIG. 28 illustrates, in a schematic right perspective view, the carton forming system of FIG. 17 in a sequential stage of processing the blank of FIG. 10A into an erected carton, in accordance with aspects of the present application;

FIG. 29 illustrates, in a schematic right perspective view, the carton forming system of FIG. 17 in a sequential stage of processing the blank of FIG. 10A into an erected carton, in accordance with aspects of the present application;

FIG. 30 shows a top right perspective view of a first embodiment of an erector head, in accordance with aspects of the present application;

FIG. 31 is a side elevation view of the erector head of FIG. 30;

FIG. 32 is a bottom right perspective view of the erector head of FIG. 30;

FIG. 33 is a bottom plan view of the erector head of FIG. 30;

FIG. 34A is a top right perspective view of a second embodiment of an erector head, in accordance with aspects of the present application;

FIG. 34B is a right side elevation view of the erector head of FIG. 34A;

FIG. 35A illustrates the erector head of FIG. 34A in a stage of opening a carton blank, in accordance with aspects of the present application;

FIG. 35B illustrates the erector head of FIG. 34A in another stage of opening a carton blank, in accordance with aspects of the present application;

FIG. 35C illustrates the erector head of FIG. 34A in a further stage of opening a carton blank, in accordance with aspects of the present application;

FIG. 36 illustrates the erector head of FIG. 34A and a sealing apparatus in a stage of erecting a carton blank to, thereby, form an erected carton, in accordance with aspects of the present application;

FIG. 37 illustrates the erector head of FIG. 34A and a sealing apparatus in a stage of erecting a carton blank to, thereby, form an erected carton, in accordance with aspects of the present application;

FIG. 38 illustrates the erector head of FIG. 34A and a sealing apparatus in a stage of erecting a carton blank to, thereby, form an erected carton, in accordance with aspects of the present application;

FIG. 39 illustrates the erector head of FIG. 34A and a sealing apparatus in a stage of erecting a carton blank to, thereby, form an erected carton, in accordance with aspects of the present application;

FIG. 40 illustrates the erector head of FIG. 34A and a sealing apparatus in a stage of erecting a carton blank to, thereby, form an erected carton, in accordance with aspects of the present application;

FIG. 41 illustrates the erector head of FIG. 34A and a sealing apparatus in a stage of erecting a carton blank to, thereby, form an erected carton, in accordance with aspects of the present application;

FIG. 42 illustrates the erector head of FIG. 34A and a sealing apparatus in a stage of erecting a carton blank to, thereby, form an erected carton, in accordance with aspects of the present application;

FIG. 43 illustrates the erector head of FIG. 34A and a sealing apparatus in a stage of erecting a carton blank to, thereby, form an erected carton, in accordance with aspects of the present application;

FIG. 44 illustrates the erector head of FIG. 34A and a sealing apparatus in a stage of erecting a carton blank to, thereby, form an erected carton, in accordance with aspects of the present application;

FIG. 45 illustrates, in a schematic perspective view, an alternative embodiment of a carton forming system, in accordance with aspects of the present application;

FIG. 46 illustrates, in a plan view, a carton blank for a tray that may be processed in accordance with aspects of the present application;

FIG. 47 illustrates, in a perspective view, a carton blank for an over-wrapping regular slotted case (RSC) that may be processed in accordance with aspects of the present application;

FIG. 48 illustrates, in a perspective view, a carton blank for an over-wrapping regular slotted case (RSC) that may be processed in accordance with aspects of the present application;

FIG. 49 illustrates, in a perspective view, an HSC case that may be formed in accordance with aspects of the present application;

FIG. 50 illustrates a carton forming system, which is presented as an alternative to the carton forming system of FIG. 1A, according to an aspect of the present application;

FIG. 51 illustrates, in a plan view, a carton forming system, which is presented as an alternative to the carton forming system of FIG. 50, according to an aspect of the present application;

FIG. 52 illustrates, in a schematic plan view, an order fulfillment location, in accordance with aspects of the present application;

FIG. 53 illustrates, in a top-right perspective view, an example autonomous mobile robot having a cart carrying an outer case, in accordance with aspects of the present application;

FIG. 53A illustrates, in a top-right perspective view, the example autonomous mobile robot of FIG. 53 with the addition of a shipping container;

FIG. 54 illustrates, in a sectional perspective view, the autonomous mobile robot of FIG. 53, in accordance with aspects of the present application;

FIG. 55A illustrates, in section view, a portion of the outer case of the autonomous mobile robot of FIG. 53, in accordance with aspects of the present application;

FIG. 55B illustrates, in section view, a portion of the outer case of the autonomous mobile robot of FIG. 53, in accordance with aspects of the present application;

FIG. 56 illustrates, in a schematic plan view, a portion of a fulfillment center;

FIG. 56A illustrates, in a schematic plan view, an embodiment of an order fulfillment center;

FIG. 57 illustrates example steps in a method of fulfilling an order, in accordance with aspects of the present application;

FIGS. 58A and 58B illustrate further example autonomous mobile robots, in accordance with aspects of the present application;

FIG. 59 illustrates, in a schematic plan view, a carton forming system with a plurality of magazines, the carton forming system of FIG. 59 being an alternate embodiment to the carton forming system of FIGS. 1 to 44 with some components of magazines omitted for clarity, in accordance with aspects of the present application;

FIG. 60 illustrates, in a rear right side perspective view, the carton forming system of FIG. 59, in accordance with aspects of the present application;

FIG. 60A illustrates, in an enlarged view, a portion of the carton forming system of FIG. 60 with additional components illustrated, in accordance with aspects of the present application;

FIG. 61 illustrates, in a rear left side perspective view, the carton forming system of FIG. 59, in accordance with aspects of the present application;

FIG. 62 illustrates, in a rear perspective view, the carton forming system of FIG. 59, in accordance with aspects of the present application;

FIG. 63 illustrates, in a rear perspective view, part of the carton forming system of FIG. 59, in accordance with aspects of the present application;

FIG. 64 illustrates, as a schematic diagram, an order fulfillment system, in accordance with aspects of the present application;

FIG. 65 illustrates a sample label that may be generated and used in the system of FIG. 64, in accordance with aspects of the present application;

FIG. 66 illustrates another sample label that may be generated and used in the system of FIG. 64, in accordance with aspects of the present application;

FIG. 67 illustrates a sample of a case packing diagram that may be generated and used in the system of FIG. 64;

FIG. 68 illustrates, in a front left perspective view, an example arrangement for a case top sealer, in accordance with aspects of the present application;

FIG. 69 illustrates a schematic plan view of an order fulfilment location, in accordance with an example embodiment of the present application;

FIG. 70 illustrates a perspective view of part of a product unloading system of the order fulfilment center of FIG. 69, in accordance with an example embodiment of the present application;

FIG. 71 illustrates a plan schematic view of an embodiment of the order fulfillment center of FIG. 69, in accordance with an example embodiment of the present application;

FIG. 72 illustrates a perspective view of a plurality of case induction stations of the order fulfilment center FIG. 69;

FIG. 73 illustrates a perspective view of an order verification, case sealing and labelling station of the order fulfilment center of FIG. 69;

FIGS. 74A and 74B illustrate perspective views of example routing staging stations of the order fulfilment center of FIG. 69;

FIG. 75 illustrates a perspective view of a tower that may be used to store products, in accordance with an example embodiment of the present application;

FIG. 76 illustrates, in a schematic plan view, an order fulfilment location that may be seen as a hybrid of the order fulfilment center of FIG. 52 and the order fulfilment center of FIG. 69, in accordance with an example embodiment of the present application;

FIG. 76A illustrates, in a schematic plan view, the order fulfilment location of FIG. 76 with additional reference to a plurality of partitions, in accordance with an example embodiment of the present application;

FIG. 77 illustrates a robotic picker arm which may be used in depalletization processes involving a pallet, in accordance with an example embodiment of the present application;

FIG. 78A illustrates, in a side view, a destrapper-debander end effector, which may be engaged by the robotic picker arm of FIG. 77 for depalletization processes, in accordance with an example embodiment of the present application;

FIG. 78B illustrates, in a top view, the destrapper-debander end effector of FIG. 78A;

FIG. 79 illustrates, in a perspective view, a standardized storage case, in accordance with an example embodiment of the present application;

FIG. 80 illustrates, in a perspective view, a pallet, the pallet constructed with the standardized storage case of FIG. 79 and a standardized pallet base, in accordance with an example embodiment of the present application;

FIG. 81 illustrates, in a perspective view, a plurality of crates stacked on the autonomous mobile robot of FIG. 53, in accordance with an example embodiment of the present application;

FIG. 82A illustrates, in a schematic plan view, an order fulfilment location as an alternative to the order fulfilment center of FIG. 76, in accordance with an example embodiment of the present application;

FIG. 82B illustrates, in a schematic plan view, an order fulfilment location as an alternative to the order fulfilment center of FIG. 82A, in accordance with an example embodiment of the present application;

FIG. 83 illustrates, in a perspective view, a plurality of crates maintained in a structure on the autonomous mobile robot of FIG. 53, in accordance with an example embodiment of the present application;

FIG. 84 illustrates, in a perspective view, a plurality of crates maintained in a further structure on an autonomous mobile robot, in accordance with an example embodiment of the present application;

FIG. 85 illustrates a layout for a transport trailer, in accordance with an example embodiment of the present application;

FIG. 86 illustrates a customer order processing matrix, in accordance with an example embodiment of the present application;

FIG. 87 illustrates, as a schematic diagram, an order fulfilment center at the center of a network of suppliers of products to be stored at the order fulfilment center, in accordance with an example embodiment of the present application;

FIG. 88 illustrates, in a top-right perspective view, a universal pallet, in accordance with an example embodiment of the present application;

FIG. 89 illustrates, in a top-right perspective view, a stack of universal crates loaded upon the universal pallet of FIG. 88, in accordance with an example embodiment of the present application.

FIG. 90 illustrates, in a plan view, a configuration of a plurality of universal pallets loaded with stacks of universal crates, the stacks of universal crates arranged in a cell, in accordance with an example embodiment of the present application;

FIG. 91 illustrates, in an elevation view, the cell of FIG. 90 including the plurality of universal pallets loaded with stacks of universal crates, in accordance with an example embodiment of the present application;

FIG. 91A illustrates, in an elevation view, another cell including a plurality of universal pallets loaded with stacks of universal crates, in accordance with an example embodiment of the present application;

FIG. 92 illustrates, in a plan view, a configuration of 20 cells, in accordance with an example embodiment of the present application;

FIGS. 93A-93H illustrate a sequence of steps, in an elevation view, of a product being extracted from a universal crate in a cell and loaded into a shipping container or receptacle, in accordance with an example embodiment of the present application;

FIG. 94A illustrates, in a schematic plan view, a second level of an order fulfilment center as an alternative to the order fulfilment center of FIG. 82B, in accordance with an example embodiment of the present application;

FIG. 94B illustrates, in a schematic plan view, a first level of the order fulfilment center whose second level is illustrated in FIG. 94A, in accordance with an example embodiment of the present application;

FIG. 94C illustrates a schematic view of a robotic product induction station;

FIG. 95 illustrates a transport trailer, which is partially full of universal pallets, in the middle of a process of being unloaded into a first order induction zone of the order fulfilment center whose levels are illustrated in FIG. 94A and FIG. 94B, in accordance with an example embodiment of the present application;

FIG. 96 illustrates, in a cut-away plan view, the transport trailer of FIG. 95 configured to carry a plurality of the universal pallets, in accordance with an example embodiment of the present application;

FIG. 97 illustrates, in a cut-away elevation view, a transport trailer equipped with inflatable air bags and configured to carry a plurality of the universal pallets, in accordance with an example embodiment of the present application;

FIG. 98 illustrates, in a cut-away rear view, the transport trailer of FIG. 97, in accordance with an example embodiment of the present application;

FIG. 99 illustrates, in a plan view, a process of automated product loading and palletization at a production facility, in accordance with an example embodiment of the present application;

FIG. 100 illustrates, in an elevation view, the process of FIG. 99, in accordance with an example embodiment of the present application;

FIG. 101 illustrates, in an elevation view, a shipping container induction station, in accordance with an example embodiment of the present application;

FIG. 102 illustrates, as a schematic diagram, a first closed loop system whereby a plurality of filled universal crates and a plurality of empty universal crates are continually delivered between an order fulfilment center and a production facility and a second closed loop system whereby a plurality of filled universal crates and a plurality of empty universal crates are continually delivered between the order fulfilment center and a container blank manufacturing facility, in accordance with an example embodiment of the present application;

FIG. 103A illustrates control components of an example control system at a fulfilment center, the control components are illustrated as including a central control unit, a plurality of AMR modules, a plurality of cell modules and a plurality of product identification modules, in accordance with an example embodiment of the present application;

FIG. 103B illustrates example components of an AMR module in the example control system of FIG. 103A, in accordance with an example embodiment of the present application;

FIG. 103C illustrates example components of an example one of the cell modules in the example control system of FIG. 103A, in accordance with an example embodiment of the present application;

FIG. 103D illustrates an example of components for the central control unit in the example control system of FIG. 103A, the central control unit is illustrated as including a processing device, a memory, a network interface and a data store, in accordance with an example embodiment of the present application;

FIG. 103E illustrates data structures of the data store illustrated in FIG. 103D, in accordance with an example embodiment of the present application;

FIG. 103F illustrates applications of the data store illustrated in FIG. 103D, in accordance with an example embodiment of the present application;

FIG. 104 illustrates, in a plan view, a process of automated shipping container blank loading and palletization at a production facility, in accordance with an example embodiment of the present application; and

FIG. 105 illustrates, in an elevation view, the process of FIG. 104, in accordance with an example embodiment of the present application.

### DETAILED DESCRIPTION

The adage “garbage in, garbage out” (often abbreviated as GIGO) is a common phrase used in the field of computer science and information technology. It conveys a simple but important principle: the quality of output or results is determined by the quality of input data.

In essence, if you feed a computer system or algorithm with inaccurate, incomplete, or low-quality data, you should expect the output or results to be similarly flawed or unreliable. Regardless of how sophisticated the processing capabilities of a system may be, if the input data is flawed, the output will likely be flawed as well.

This principle holds true for various systems, not just computers. It is also applicable in areas such as decision-making, problem-solving, general information processing and automation. Therefore, it highlights the importance of ensuring that all inputs are accurate, well-structured, and relevant to the problem at hand in order to obtain meaningful and reliable results. Chaos refers to a state of extreme disorder or unpredictability in a system. The automation industry knows from experience that chaos cannot be fully automated. Chaos theory describes complex systems that are highly sensitive to initial conditions, meaning that small changes in the starting state can lead to vastly different outcomes over time. These systems are nonlinear, and their behavior is difficult to predict with precision.

Automation involves the use of machines, computers, and/or algorithms to perform tasks without human intervention. Automation relies on established rules, algorithms, or processes to execute tasks efficiently and consistently. The inherent unpredictability and sensitivity to initial conditions in chaotic systems make them challenging to automate effectively. Since automation relies on predictability and well-defined processes, it may be seen as difficult to create algorithms or machines that can handle chaotic situations accurately.

In order fulfilment, and more particularly, order fulfilment based on collecting items for an order from a plurality of types of product storage regions, there may be various challenges to providing efficient methods and systems to fulfil orders. There may be challenges in automating the consolidation of products required to fulfil an order, particularly given the number of different products a fulfilment center may store and manage. For example, some fulfilment centers may store and manage millions of different products for order fulfilment. Additionally, there may be little no control as to how products to be stored in the fulfilment center arrive to the fulfilment center.

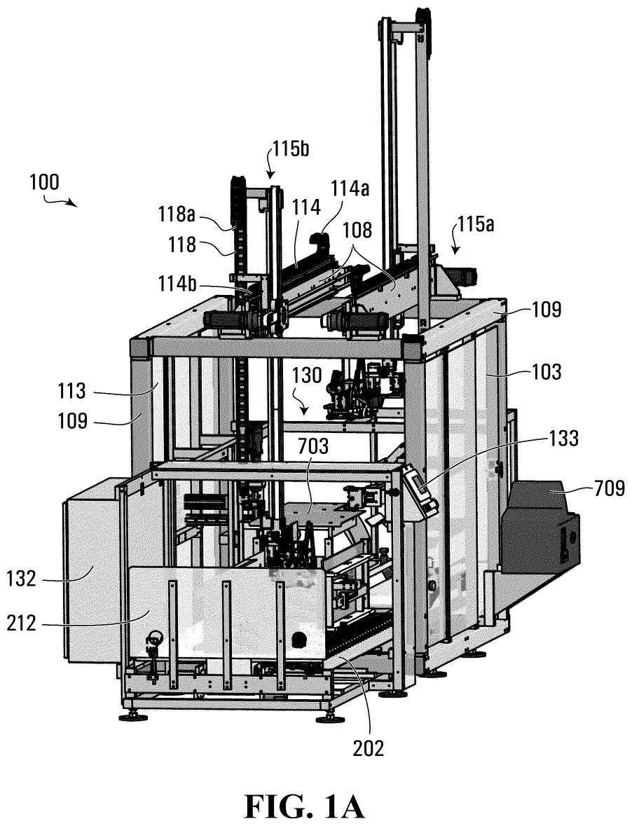

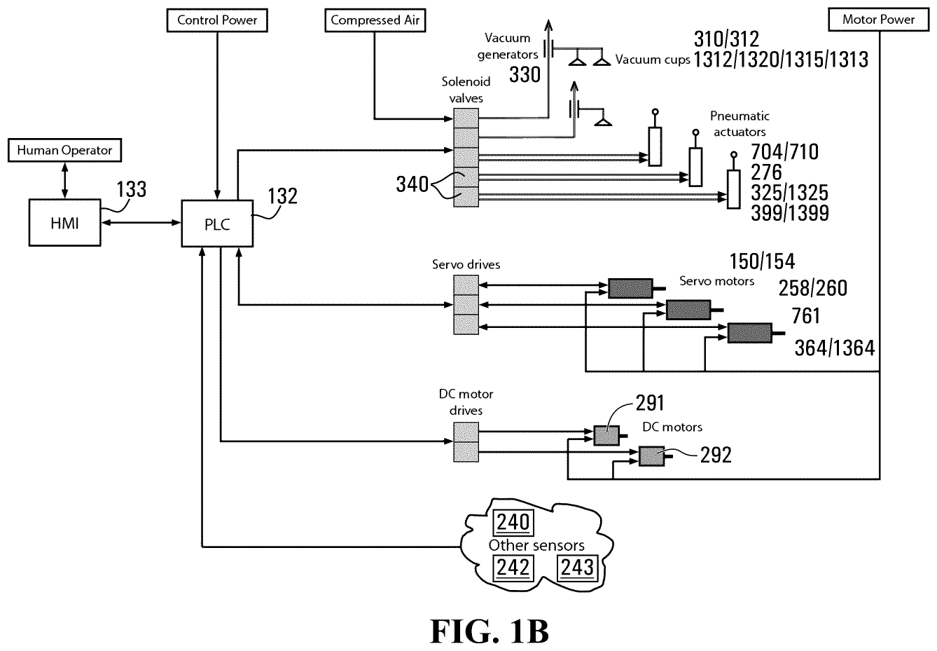

FIGS. 1A, 1B, 2 and 3 illustrate, in various forms and from various angles, an example of a carton/case forming system 100 that may be used as part of a product order fulfillment system. The carton forming system 100 may include a frame 109. The frame 109 may have, integrated with it, a series of panels 103 that may be made from a plastic or glass and that may or may not be transparent or semi-transparent. One or more of the panels 103 may be configured to operate as a hinged door so that interior portions of the carton forming system 100 can be accessed. The carton forming system 100 may also include a magazine 110 adapted to receive, hold and move a plurality of carton blanks 111 while the carton blanks 111 are in a substantially flat orientation. The carton forming system 100 may include at least a first erector head 120a and a second erector head 120b for retrieving carton blanks from the magazine 110. The erector heads 120a, 120b may pick up the carton blanks 111 from the magazine 110 and then manipulate the carton blanks 111 in such a way that, with the assistance of other components of the carton forming system 100, the carton blanks 111 are transformed into erected cartons.

The erector heads 120a, 120b may be moved by a movement sub-system. The movement sub-system may include one or more movement apparatuses. For example, the first erector head 120a may be mounted to and moved by a first moving apparatus 115a. The second erector head 120b may be mounted to and moved by a second moving apparatus 115b. In some embodiments, only a single erector head and movement apparatus may be provided, but this may result in a lower production rate of erected cartons compared to when multiple, particularly two or possibly more, movement apparatuses and erector heads are provided, as illustrated in the drawings.

The carton forming system 100 may also include a folding and sealing apparatus 130, which may be configured to fold one or more flaps of each carton blank and provide for sealing of one or more flaps as part of the process in forming fully erected cartons. In co-operation with the erector heads 120a, 120b, the folding and sealing apparatus 130 may be configured to handle in alternating sequence, the carton blanks 111 carried by both the first erector head 120a and the second erector head 120b. The carton forming system 100 may also include a carton discharge conveyor 117 for receiving and moving away the carton blanks 111 once the carton blanks 111 have been fully erected.

The structural/mechanical components of the carton forming system 100 may be made from any suitable materials. For example, frame members, and many of the parts that make up the erector heads 120a, 120b, the moving apparatuses 115a, 115b, many of the components and parts that make up the folding and sealing apparatus 130 and the magazine 110, may be made of steel or aluminum, or any other suitable materials. Aluminum is particularly suitable for most parts. However, plates that hold the suction cups on the erector head and flanges that mount on gearbox shafts can be made from stainless steel for strength and hardness. Parts and components may be attached together in conventional ways such as for example by bolts, screws, welding and the like.

An example of a scheme for the power and data/communication configuration for the carton forming system 100 is illustrated in FIG. 1B. The operation of the components of the carton forming system 100, and of the carton forming system 100 as a whole, may be controlled by a programmable logic controller (“PLC”) 132. The PLC 132 may be accessed by a human operator through a Human Machine Interface (HMI) module 133 secured to the frame 109. The HMI module 133 may be in electronic communication with the PLC 132. The PLC 132 may be any suitable PLC and may, for example, include a unit chosen from the Logix 5000 series devices made by Allen-Bradley/Rockwell Automation, such as the ControlLogix 5561 device. The HMI module 133 may be a Panelview part number 2711P-T15C4D1 module also made by Allen-Bradley/Rockwell Automation. It should be noted that not all of the sensors, motors, servo motors, drives, vacuums, vacuum generators and vacuum cups described hereinafter are specifically identified in FIG. 1B.

Electrical power can be supplied to the PLC 132/HMI 133 and to all the various servo motors and DC motors that are described further herein. Compressed/pressurized air can also be supplied to the vacuum generators and pneumatic actuators through valve devices such as solenoid valves that are controlled by the PLC 132, all as described further herein. Servo motors may be connected to, and in communication with, servo drives that are in communication with and controlled by the PLC 132. Similarly, DC motors may be connected to DC motor drives that are in communication with, and controlled by, the PLC 132; again all as described further herein. Additionally, various other sensors are in communication with the PLC 132 and may (although not shown) also be supplied with electrical power.

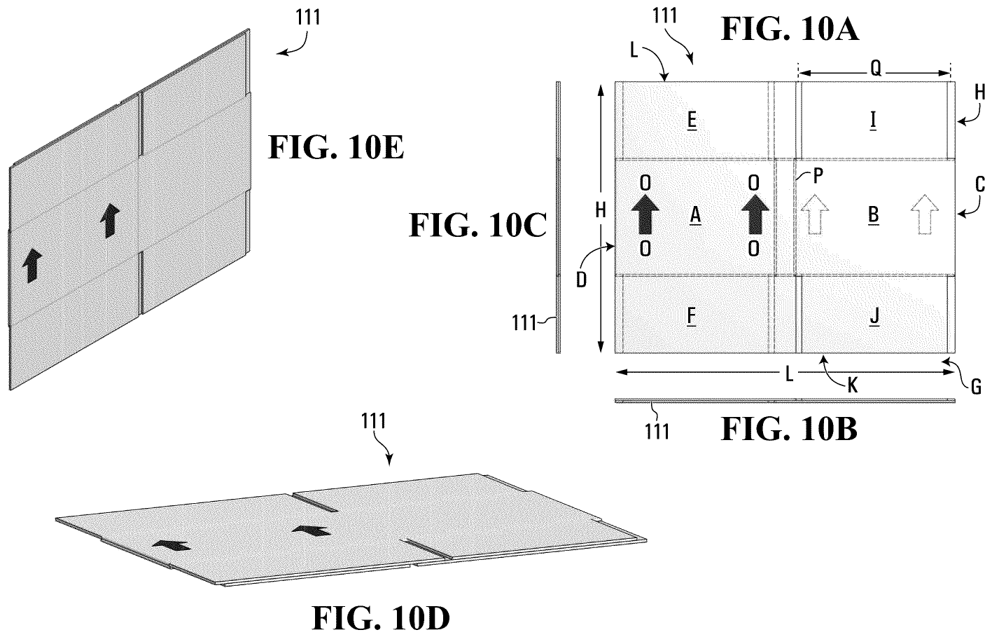

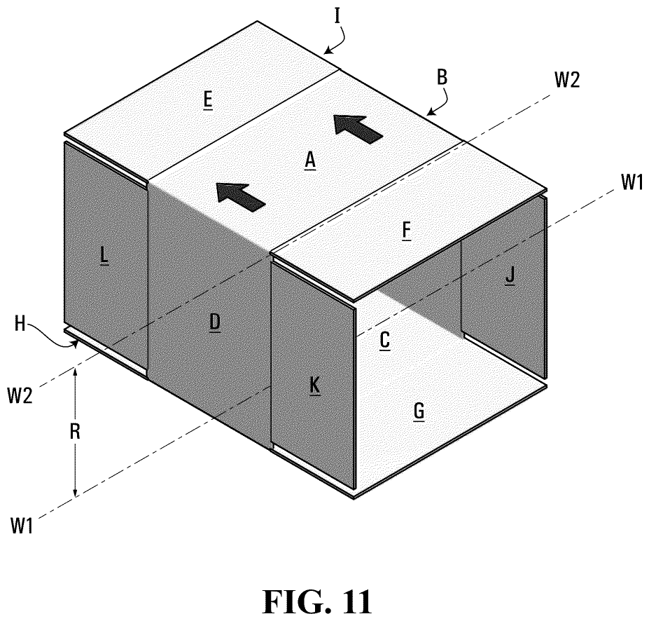

With reference now to FIG. 10A through to FIGS. 10E and 11A, an example of one kind of tubular carton blank 111 that can be processed by the system 100 to form a regular slotted case (RSC) is disclosed. It should be clear that other kinds of carton blanks, tubular carton blanks and tubular carton blanks of different sizes can be processed by system 100.

Each carton blank 111 may be generally initially formed and provided in a flattened tubular configuration as shown in FIGS. 10A, 10B, 10C, 10D, 10E. Each carton blank 111 has a height dimension “H”; a length dimension “L”; and a major panel length “Q” (see FIG. 10A). Responsive to the inputting of each of these three dimensions for a given carton blank 111 to be processed by the carton forming system 100, into the PLC 132, the PLC 132 may determine whether the carton forming system 100 can process the given carton blank 111 without the necessity for manual intervention to make an adjustment to one or more components of the carton forming system 100. If the PLC 132 determines that the adjustment can be made without human intervention, the PLC 132 may make the necessary adjustments to positions and/or movements of at least some of the components forming the carton forming system 100, including the path of movement of the erector heads 120a, 120b as the erector heads move and cycle through their processing sequences.

However, in some carton forming systems 100, for some sizes of carton blanks 111, the PLC 132 may determine that human intervention of some kind may facilitate the making of set-up adjustments to the positioning/orientations of at least some of the components of the system 100 to, thereby, enable the carton forming system 100 to process the carton blank 111 and may, accordingly, inform an operator of the carton forming system 100.

The carton blank 111 may have opposed major panels A and C integrally interconnected to a pair of opposed minor panels B and D to form a generally cuboid shaped blank when opened. An overlap strip of carton blank material may be provided between panel B and panel A that can be sealed by conventional means such as a suitable adhesive, to provide an overlapping seam joint in the vicinity of “P” (see FIG. 10A). This overlap may join the panels A, B, C and D into a continuous blank that is of generally flattened tubular configuration as shown in FIG. 10A. A number of such carton blanks 111, in a flattened configuration, can be delivered to the vicinity of the carton forming system 100 that may erect the carton blanks 111 into the generally open tubular configuration shown, for example, in FIG. 11.

Also, as shown in FIGS. 10A-10E and 11, the carton blank 111 may have a first set of upper side major and minor flaps E, H, L, I that are provided on one side of the respective major and minor panels A, B, C, D. A second set of major and minor flaps F, G, K and J are also provided on the opposite, lower/bottom sides of the major and minor panels A, B, C, D. Notably, in other embodiments, cartons having other side panel configurations can be formed. The panels and flaps can be connected to adjacent flaps and/or panels by predetermined fold/crease lines (shown in broken lines). These fold/crease lines may, for example, be formed by a weakened area of material and/or the formation of a crease with a crease forming apparatus. The effect of the fold lines is such that one panel, such as, for example, panel A can be rotated relative to an adjacent panel, such as, for example, panel D or panel B along the fold lines. Flaps may also fold and rotate about fold lines that connect the flaps to their respective panels.

As shown in FIG. 11, the carton blank 111 may be designated with a first datum line “W1” that passes through the mid-point of the fold line between panel D and flap K, and the mid-point of the fold line between panel B and flap J. The first datum line W1 may be determined by the PLC 132 for a particular carton blank 111 or a group of carton blanks 111 to be processed, based on the input of the dimensions H, L and Q of the carton blanks 111. The carton blank 111 may be designated with a second datum line “W2” that may be determined by the PLC 132 and which second datum line W2 passes along, and is generally parallel to, the fold line between panel A and flap F. The first datum line W1 will be parallel to the second datum line W2. The PLC 132 may also determine the relative position of the bottom of the erected carton, as this will be aligned with a vertical datum plane passing through the first datum line W1 and the second datum line W2. Aligning the position of the second datum line W2 and the position of the datum plane with other components in the carton forming system 100 may be shown to ensure that the carton is properly positioned during processing through the system 100. Also, the vertical distance R between the first datum line W1 and the second datum line W2 may be calculated by the PLC 132. This calculating can ensure that the PLC 132 knows where it needs to position the erector head so that the top panel A, and accordingly, the first datum line W1 are properly positioned throughout the processing of the blank by the carton forming system 100.

The carton forming system 100 may be shown to be able to track and modify the position of the carton blank 111 and, in particular, the vertical position of the first datum line W1 of the carton blank 111 as the carton blank 111 moves longitudinally through the carton forming system 100 and as various components of the carton forming system 100 engage the carton blank 111 during the movements of the carton blank 111. This may be shown to ensure that the carton blank 111 being processed is appropriately positioned relative to the system components so that the system components engage the carton blank 111 at the correct position on the carton blank 111 during processing of the carton blank 111.

As will be described hereinafter, the carton blank 111 may be transformed from a generally flattened tubular configuration to an open tubular configuration and the flaps may be folded and sealed to form a desired erected carton configuration. The erected carton may be configured as an open top carton suitable to be delivered to a carton loading conveyor with an upwardly facing opening or with a sidewards facing opening suitable for side loading.

The carton blanks 111 may have flaps that provide material that can, in conjunction with a connection mechanism (such as for example with application of an adhesive, sealing tape or a mechanical connection such as is provided in so-called “Klick-lok TM” carton blanks), interconnect flap surfaces to join or otherwise interconnect flaps to adjacent flaps (or in some embodiments flaps to panels), to hold the carton in its desired erected configuration.

The carton blanks 111 may be made of any suitable material(s) configured and adapted to permit the required folding/bending/displacement of the material to reach the desired configuration. Examples of suitable materials are chipboard, cardboard or creased corrugated fiberboard. It should be noted that the carton blank 111 may be formed of a material that, itself, is rigid or semi-rigid and not per se easily foldable but that is divided into separate panels and flaps separated by creases or hinge-type mechanisms so that the carton blank 111 can be erected and formed.

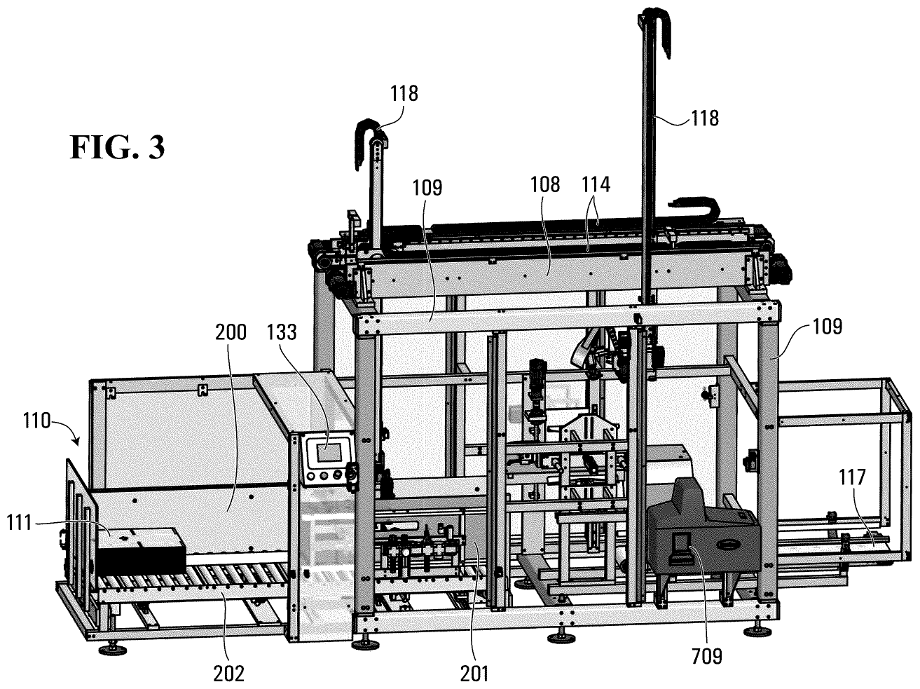

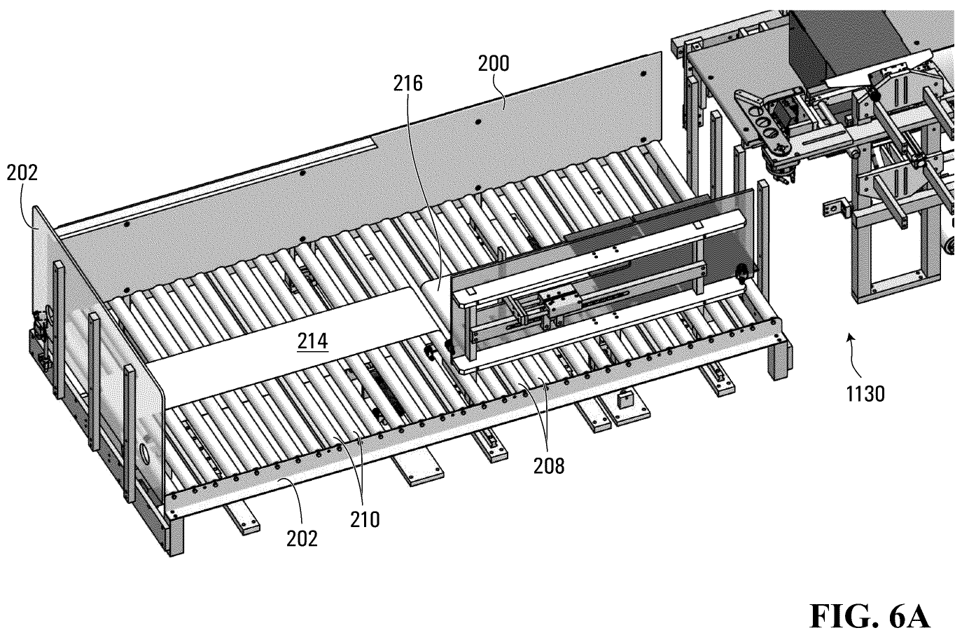

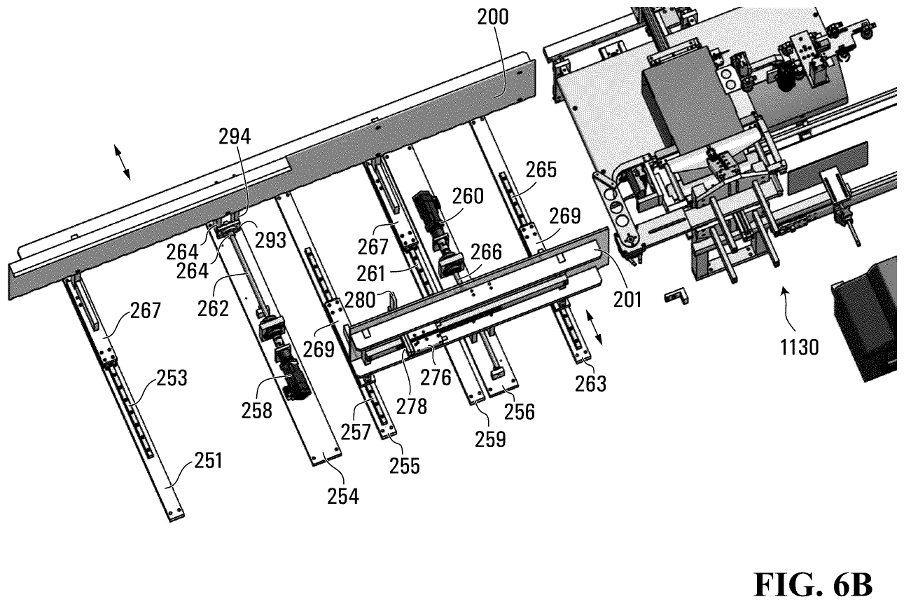

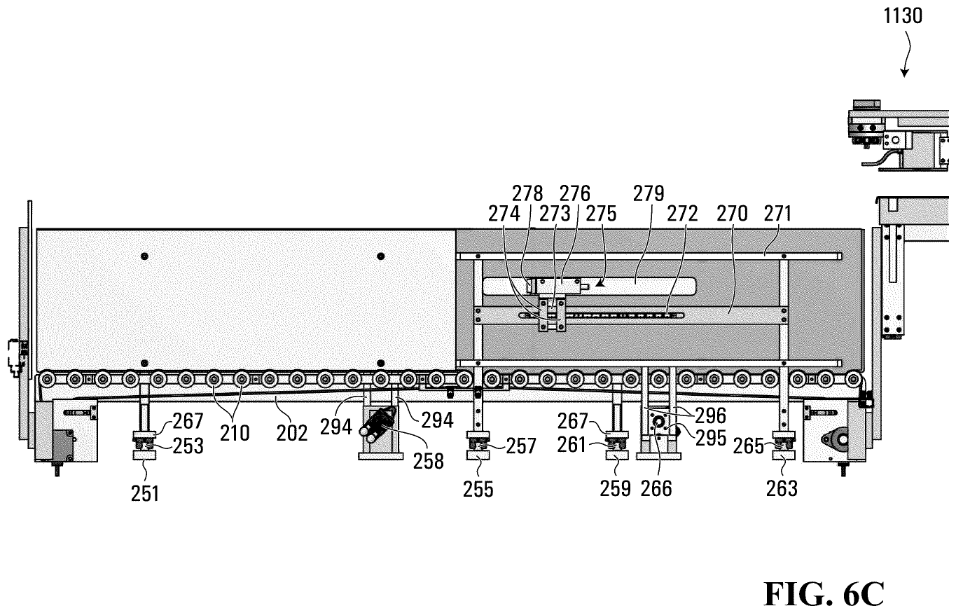

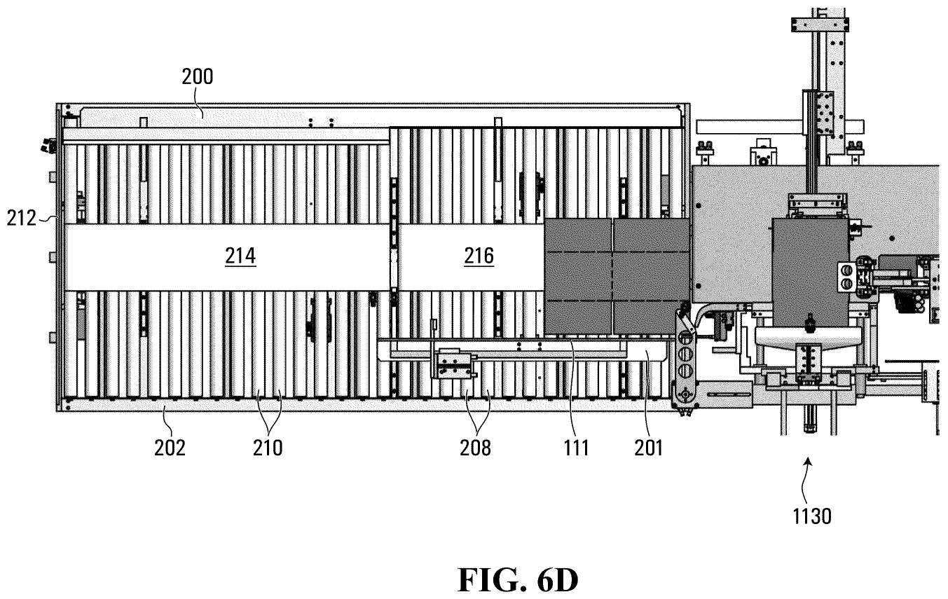

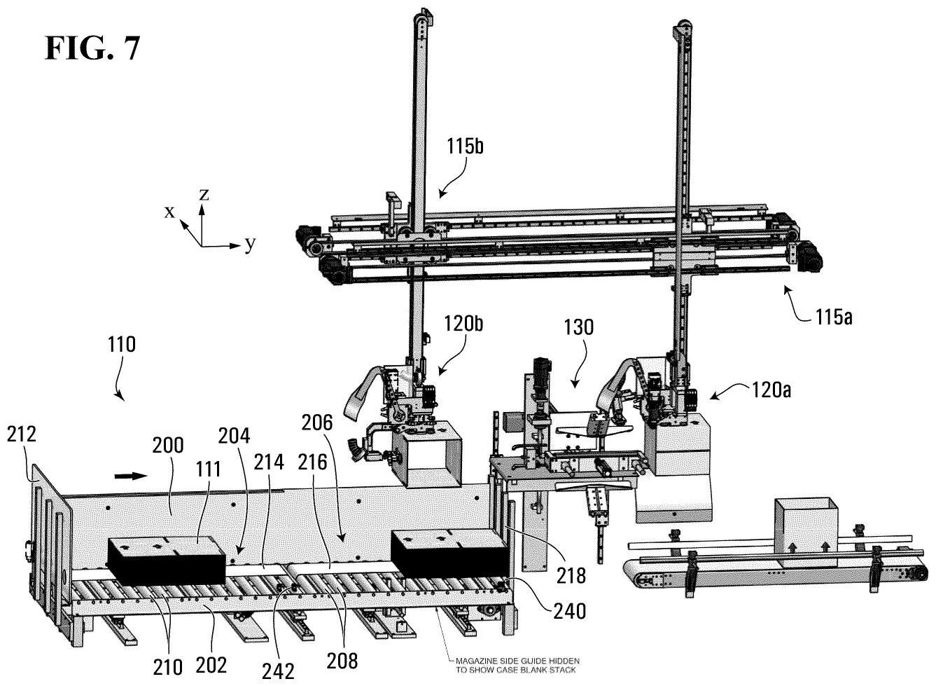

Turning now to the components of the carton forming system 100, various specific constructions of a suitable magazine 110 might be employed in the carton forming system 100. With particular reference now to FIG. 3, FIGS. 6A, 6B, 6C, 6D and FIG. 7, the magazine 110 may be configured to hold a plurality of carton blanks 111 in a vertically stacked, flattened configuration and be operable to move the stack of the carton blanks 111 longitudinally in a direction generally parallel to longitudinal axis, Y, under the control of the PLC 132, to a pick-up position where the first erector head 120a or the second erector head 120b can retrieve the carton blanks 111 from the magazine 110.

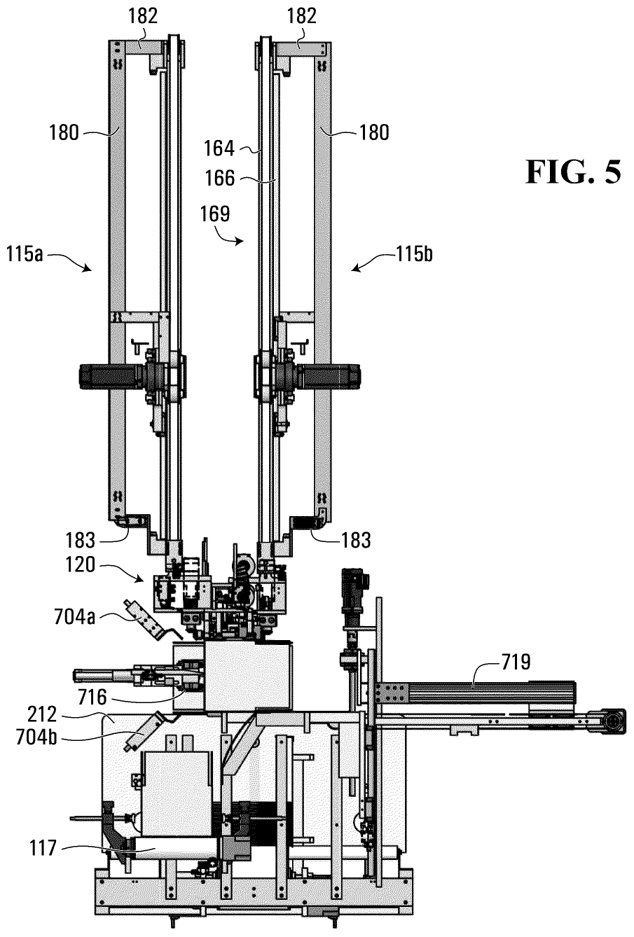

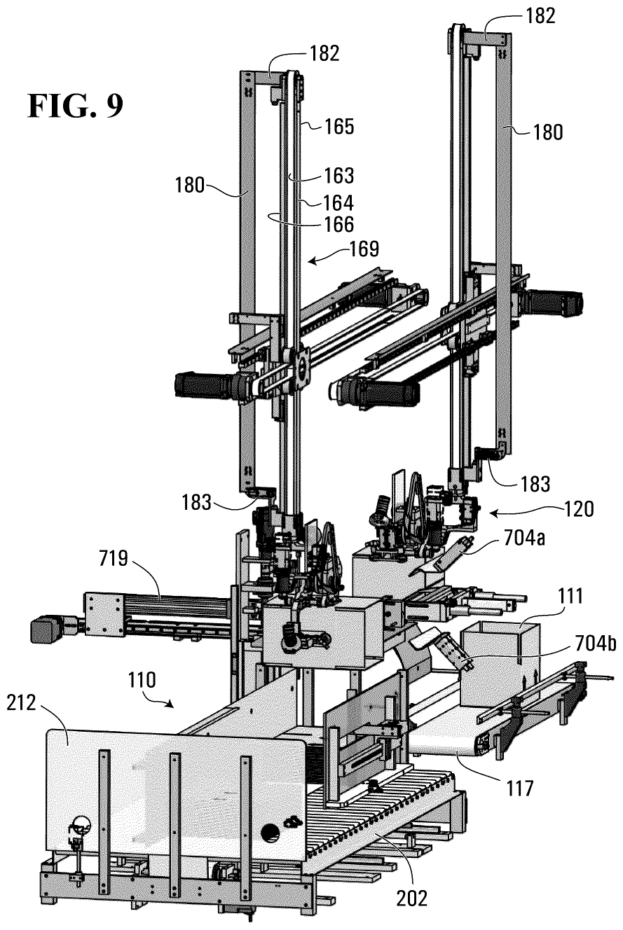

The magazine 110 may comprise a single conveyor, or other blank feed apparatus, configured to deliver the carton blanks 111 to the pick-up position. In the embodiment illustrated in FIGS. 1A through 9, two conveyors are disclosed: an in-feed conveyor 204; and an alignment conveyor 206. However, as will described hereinafter in relation to other embodiments, the blank feed apparatus may be configured with multiple in-feed conveyors, to feed carton blanks 111 from multiple magazines that hold the carton blanks 111 having different configurations. This enables the carton forming system 100 to, by automation, selectively and sequentially erect cartons that differ, in size, type and/or configuration, from each other.

Returning to the carton forming system 100 of FIGS. 1A through 9, the in-feed conveyor 204 may be configured and operable to move a stack of the carton blanks 111 from a stack input position (where a stack may be loaded onto the in-feed conveyor 204, such as by human or robotic placement) to a position where the stack of carton blanks 111 is transferred to horizontally and transversely aligned alignment conveyor 206. The alignment conveyor 206 may be positioned longitudinally downstream in relation to the in-feed conveyor 204 and may be used to move the stack of carton blanks 111 to the pick-up position. The magazine 110 may be loaded with, and initially hold, a large number of the carton blanks 111 in a vertical stack, with the stack resting on the in-feed conveyor 204. A rear wall 212 mounted to a lower portion of a magazine frame generally designated 202, can be configured to retain the one or more stacks from falling backwards when initially loaded on the in-feed conveyor 204. The rear wall 212 may have a generally planar, vertically and transversely oriented surface facing the stack of carton blanks 111. The rear wall 212 and the in-feed conveyor 204 may be of an appropriate length to be able to store a satisfactory number of stacks of the carton blanks 111 in series on the in-feed conveyor 204. The PLC 132 can control the operation of the in-feed conveyor 204 to move one stack at a time to the alignment conveyor 206.

The in-feed conveyor 204 may have one or more stacks of carton blanks 111 arranged longitudinally on an in-feed conveyor belt 214 so that they can, in turn, be fed onto the alignment conveyor 206. A sensor may be provided in the vicinity of the in-feed conveyor 204 to monitor the number of stacks waiting on the in-feed conveyor 204 and that sensor may be operable to send a warning signal to the PLC 132 that can alert an operator that the magazine 110 is low and needs to be replenished (e.g., because, on the alignment conveyor 206, the stack being processed by the erector head 120 is the only stack left). The sensor may be a part number 42GRP-9000-QD made by Allen-Bradley.

Of particular note, a plurality of stacks of the carton blanks 111 might be provided on the in-feed conveyor 204. Each stack may be included with some kind of information indicator that can be read by an information reader, such as an electronic reading device or an optical reading device. For example, a bar code may be provided on a stack of carton blanks 111 such as on the top carton blank 111 or on the bottom carton blank 111 of the stack. The bar code may be read by a suitably positioned bar code reader. The bar code reader may be in communication with the PLC 132. The bar code may provide information indicative of a characteristic of the carton blanks 111 in the stack. For example, the bar code may identify the size and/or type of carton blank 111 in a particular stack. Other information indicators and reading systems may be used, such as, for example, radio frequency identifier (RFID) tags/chips and RFID readers. The information can then be automatically provided, by the information reader, to the PLC 132, which can determine whether the current configuration of the carton forming system 100 can handle the processing of the particular type/size of carton blanks 111 without having to make manual adjustments to any of the components. It is contemplated that, within a certain range of types/sizes of carton blanks 111, the carton forming system 100 may be able to handle the processing of different types/sizes of carton blanks 111 without manual adjustment of any components of the system 100. The bar code/RFID tag may provide the information about the dimensions of the carton blank 111 as discussed above and then the PLC 132 can determine adjustments, if any, that may be made: (a) to the erector device operation; (b) to the magazine 110 and the tamping apparatuses in the magazine 110; (c) to provide a suitable path for the movement of the movement sub-system to provide for suitable pick up of a blank from the magazine and suitable handling by the erector device and the folding and sealing apparatus; and (d) to the components of the folding and sealing apparatus to be able to process a particular carton blank 111 or a particular stack of carton blanks 111. The result is that the carton forming system 100 may be able to automatically process at least some different types/sizes/configurations of carton blanks 111 to form different erected cartons, without having to make manual operator adjustments to any components of the carton forming system 100.

The in-feed conveyor 204 may include a series of transversely and horizontally oriented rollers 210 mounted to the lower portion of a magazine frame 202 for free rotation. The rollers 210 may allow for generally horizontal longitudinal downstream movement of the stack towards the alignment conveyor 206. The in-feed conveyor belt 214 may be provided and may be driven by a suitable in-feed motor 291, such as a direct current (DC) motor or a variable frequency drive motor (see FIG. 1B). The in-feed motor 291 may be DC motor and may be controlled through a DC motor drive (all sold by Oriental under model AXH-5100-KC-30) by the PLC 132.

The in-feed conveyor belt 214 may have an upper belt portion supported on the rollers 210. Once the PLC 132 is given an instruction (such as by a human operator through HMI module 133), the upper belt portion of the in-feed conveyor belt 214 may move longitudinally downstream towards the alignment conveyor 206. In this way, the in-feed conveyor belt 214 can move a stack of carton blanks 111 longitudinally downstream, with the stack of carton blanks 111 at its outer transverse portions also being supported on the rollers 210. The PLC 132 can control the in-feed motor 291 through the motor drive and, thus, the in-feed conveyor 204 can be operated to move and transfer the stack towards, and for transfer to, the alignment conveyor 206.

The alignment conveyor 206 may also include a series of transversely oriented rollers 208 that are mounted for free rotating movement to a lower portion of the magazine frame 202. An alignment conveyor belt 216 may be driven by an alignment motor 292 that may be like the in-feed motor 291 and with a corresponding motor drive. The alignment motor 292 may also be controlled by the PLC 132. The alignment conveyor belt 216 may be provided with an upper belt portion supported on the rollers 208 and upon which the stack of carton blanks 111 may be supported. The in-feed conveyor belt 214 may be operated to move the stack of carton blanks 111 further longitudinally until the front face of the stack abuts with a generally planar, vertically and transversely oriented inward facing surface of the front end wall 218.

The in-feed conveyor belt 214 of the in-feed conveyor 204 and the alignment conveyor belt 216 of the alignment conveyor 206 may be made from any suitable material such as, for example, Ropanyl.

A gap sensor 242, such as an electronic eye model 42KL-D1LB-F4 made by Allen-Bradley, may be located within a horizontal gap between the in-feed conveyor belt 214 and the alignment conveyor belt 216. The gap sensor 242 may be positioned and operable to detect the presence of the front edge of a stack of carton blanks 111 as the stack of carton blanks 111 begins to move over the gap between the in-feed conveyor belt 214 and the alignment conveyor belt 216. Upon detecting the front edge, the gap sensor 242 may send a digital signal to the PLC 132 (see FIG. 1B), thereby signaling that a stack has moved to a position where the alignment conveyor 206 can start to move. The PLC 132 can then cause the alignment motor 292 for the alignment conveyor 206 to be activated such that the top portion of the alignment conveyor belt 216 starts to move the stack downstream. In this way, there can be a “hand-off” of the stack of carton blanks 111 from the in-feed conveyor 204 to the alignment conveyor 206.

Once the rear edge of the stack of blanks 111 has passed the gap sensor 242 a signal may be sent to the PLC 132 (see FIG. 1B), which can then respond by sending a signal to shut down the in-feed motor 291 that drives the in-feed conveyor belt 214 of the in-feed conveyor 204. The in-feed conveyor 204 is then in a condition ready to be loaded with another stack of blanks 111. Meanwhile, the alignment conveyor belt 216 can continue to operate as the alignment conveyor belt 216 moves the stack of carton blanks 111 to the pick-up position.

The presence of a stack of carton blanks 111 at the pick-up position may be detected by a presence sensor 240 that may be the same type of sensor as the gap sensor 242. The presence sensor 240 may detect the presence of the front edge of a stack of carton blanks 111 at the pick-up position and may send a digital signal to the PLC 132, thereby signaling that a stack is at the pick-up position. At the pick-up position, the stack of carton blanks 111 may be “squared up” and thereafter, once properly aligned, single carton blanks 111 may be retrieved in series from the stack of carton blanks 111 by the alternate engagement of the erector heads 120a, 120b with the upper-most carton blank 111 in the stack.

The magazine 110 may be configured and operable to enable the stack of carton blanks 111 to be properly positioned and oriented in the pick-up position for proper engagement by one of the erector heads 120a, 120b. During movement of the stack of carton blanks 111 longitudinally by the in-feed conveyor 204 and the alignment conveyor 206, the left hand side of the stack of carton blanks 111 may be supported and guided by a left hand side guide wall 200. The left hand side guide wall 200 may be mounted to a lower portion of the lower frame 202 and the left hand side guide wall 200 may be oriented generally vertically and may extend longitudinally for substantially the full lengths of the in-feed conveyor 204 and the alignment conveyor 206.

The right hand side of the magazine 110, adjacent to the in-feed conveyor 204, may be left generally open; however, to the right hand side of the alignment conveyor 206, there may be a right hand side guide wall 201.

Possible mounting arrangements for the left hand side guide wall 200 and the right hand side guide wall 201 are illustrated in further detail in FIGS. 6A-6D. In this regard, the lower frame portion 202 may include bottom support plates 251, 255, 259 and 263 that are supported on the ground terrain/floor with bottom support plates 251, 255, 259 and 263 being spaced from each other and oriented in a generally transverse, parallel relationship to each other. Each of the support plates 251, 255, 259 and 263 has mounted to an upper surface thereof, one of the tracks 253, 257, 261 and 265. The left hand side guide wall 200 may be supported by connector blocks 267 that fit onto, and are capable of sliding laterally on and in relation to, tracks 253 and 261. Similarly, the right hand side guide wall 201 may be supported by connector blocks 269 that fit onto, and are capable of sliding laterally on and in relation to, tracks 257 and 265.

A drive mechanism may be provided to drive each of the left hand side guide wall 200 and the right hand side guide wall 201 on their respective tracks. For the left hand side guide wall 200, a drive mechanism that is in electronic communication with the PLC 132 can be provided. By way of example, a servo motor 258 with gear head may be provided and be in electronic communication with the PLC 132 through a servo drive (see FIG. 1B). Examples that could be used are servo motor MPL-B1530U-VJ42AA made by Allen-Bradley, in combination with servo drive 2094-BC01-MP5-S also made by Allen-Bradley and gear head AE050-010 FOR MPL-A1520 made by Apex.

A lead screw rod 262 may be inter-connected to the servo motor/gear head 258. The lead screw rod 262 may pass through a nut such as a brass nut 264. The brass nut 264 may be fixedly secured to a plate 293. The plate 293 may be interconnected to spaced, generally vertically oriented bar members 294. The bar members 294 may be interconnected to support a frame (not shown) forming part of the left hand side guide wall 200. By activating the servo motor/gear head 258, the rotation of the servo may rotate the screw rod 262. As the screw rod 262 passes through the nut 264, the nut 264 is moved laterally, either inwards or outwards, thereby causing the left hand side guide wall 200 to slide on the tracks 252, 261 inwards or outwards, depending upon the direction of rotation of the screw rod 262. An encoder may be provided within, or in association with, the servo motor 258 and the encoder may rotate in relation to the rotation of the respective drive shaft of the servo drive. The encoder may be in communication with, and provide signals to, the servo drive, which can then pass on the information to the PLC 132. Thus, the PLC 132 may be able to determine the longitudinal position of the screw rod 262 in real time and, thus, the PLC 132 may be able to determine the transverse position of the left hand side guide wall 200 and can operate the servo motor 258 to adjust the position of the left hand side guide wall 200. The particular type of encoder that may be used is known as an “absolute” encoder. Once the encoder is calibrated so that a position of the screw rod 262 is “zeroed,” it follows that, even if power is lost to the carton forming system 100, the encoder can maintain its zero position calibration. However, as the left hand side guide wall 200 is not moved during processing of a carton blank 111, the mechanism for adjusting the transverse position of the left hand side guide wall 200 may, alternatively, be a simple hand crank mechanism instead of a servo drive motor in communication with the PLC 132. It should be noted that a proper position for the left hand side guide wall 200 during the processing of a stack of carton blanks 111 is that shown in FIG. 7, with the left hand side guide wall 200 in abutment with the left side edges of the carton blanks 111 in each stack. The proper positioning of the left hand side guide wall 200 may be shown to ensure that, when the blanks are flattened, the first datum line W1 is properly transversely aligned to be picked up by the erector heads 120a, 120b and moved through the folding and sealing apparatus 130, as described hereinafter in detail, to achieve proper folding and sealing of the carton blank 111 into an erected carton.

Similarly, for the right hand side guide wall 201, a drive mechanism 260 (that may be the same types of components that used for the left hand side guide wall 200) that is also in electronic communication with the PLC 132 may be provided. By way of example, a servo motor with gear head designated “drive mechanism 260” may be provided and also be in electronic communication through a servo drive with the PLC 132. A lead screw rod 266 may be inter-connected to the servo motor/gear head 266 (which may be like the servo motor/gear head 268). The lead screw rod 266 may pass through a nut such as a brass nut (not visible in the figures) like the nut 264. The nut may be fixedly secured to a plate 295. The plate 295 may be interconnected to spaced, generally vertically oriented bar members 296. The bar members 296 may be interconnected to a side wall support frame, generally designated 271 (see FIG. 6C) that forms part of the right hand side guide wall 201. By activating the drive mechanism 260, the rotation of the servo may rotate the screw rod 266. As the screw rod 266 passes through the nut, the nut is moved laterally either inwards or outwards, thereby causing the right hand side guide wall 201 to slide on the tracks 257, 265. An encoder may be provided within or in association with the drive mechanism 260 and the encoder may rotate in relation to the rotation of the respective drive shaft of the servo motor. The encoder may be in communication with a servo drive and, thus, provide signals to the PLC 132. Thus, the PLC 132 may be able to determine the longitudinal position of the screw rod 266 in real time and, thus, the PLC 132 may be able to determine the transverse position of the right hand side guide wall 201. Thus, the PLC 132 can operate the drive mechanism 260 to adjust the position of the right hand side guide wall 201. An “absolute” encoder may also be used in this application.

During operation of the carton forming system 100 in erecting a carton, the left hand side guide wall 200 may remain stationary, but the right hand side guide wall 201 may be moved laterally as part of a blank stack alignment procedure to, thereby, provide for generally longitudinal alignment of the side edges of the carton blanks 111 in the stack as the carton blanks 111 are held between the left hand side guide wall 200 and the right hand side guide wall 201.

A lateral tamping apparatus may be secured to the right hand side guide wall 201 and may be used to affect lateral alignment of the front edges and the rear edges of the carton blanks 111 in the stack, i.e., the front edges and the rear edges of the carton blanks 111 in the stack are generally aligned with a vertical axis, Z, in FIG. 7. A lateral tamping apparatus, generally designated 275, may include a horizontally and longitudinally oriented support plate 270 that may be attached, at either end, to vertical members of the side wall support frame 271. Attached to an outer surface of the horizontally and longitudinally oriented support plate 270 may be a block track 272. Secured to the block track 272, for sliding longitudinal movement along the block track 272, may be a slider block 273. Attached to the slider block 273 may be a pair of upstanding support plates, which, at their upper ends, are secured to a double acting, pneumatic actuator 276, such as the model DFM-25-80-P-A-KF Part #170927, made by Festo. The double acting, pneumatic actuator 276 may have one or more piston arms (not visible in FIGS. 6B and 6C because the piston arms are retracted). The piston arms of the double acting, pneumatic actuator 276 may reciprocate between retracted and extended positions-backwards and forwards in a longitudinal direction. With reference to FIG. 1B, a pneumatic actuator may be supplied with pressurized air communicated through electronic solenoid valves for causing the piston arms to retract and extend. The solenoid valves may be implemented as a model CPE14-M1Bh-5J-1/8 made by Festo and may be controlled by the PLC 132. Alternatively, a linear servo drive system—similar to one described in connection with the movement of the left hand side guide wall 200 and the right hand side guide wall 201—may be provided for the double acting, pneumatic actuator 276. Such a servo drive system could be controlled by the PLC 132. The PLC 132 could make adjustments to the movement of both the left hand side guide wall 200 and the right hand side guide wall 201 as well as the double acting, pneumatic actuator 276 for the lateral tamping apparatus, such that the magazine 110 could be automatically adjusted to process a wide range of sizes of carton blanks 111.

It should be noted that, during the operation of the carton forming system 100 in erecting cartons, the slider block 273 will not move along the block track 272. The slider block 273 and the components attached directly or indirectly thereto, including the double acting, pneumatic actuator 276, may be shown to not move longitudinally during operation. However, the longitudinal position of the slider block 273 can be adjusted during the set-up of the carton forming system 100 when processing particular sizes of the carton blanks 111.

Attached to the end of the piston arms of the double acting, pneumatic actuator 276 may be a transverse plate 278 that may pass through a longitudinally extending slot 279 through the right hand side guide wall 201. An end of the transverse plate 278, distal from the piston arms attachment, is attached to a vertical tamping plate 280 that is positioned transversely inwards from the inner surface of the right hand side guide wall 201. Retraction of the piston arms of the double acting, pneumatic actuator 276 can cause the transverse plate 278 to engage the rear side edges of the carton blanks 111 in the stack and, as the front edges of those carton blanks 111 are pushed up against the inner surface of the front end wall 218, the front edges and the rear edges of the carton blanks 111 can be laterally aligned. While the actuator 276 is illustrated as being pneumatic, it should be clear that other, non-pneumatic alignment devices could be used. For example, a linear servo drive in communication with the PLC 132 might be employed. It may be shown that a linear servo drive would perform the same function as the double acting, pneumatic actuator 276 but the linear servo drive could electronically position the vertical tamping plate 280 and, consequently, the operator may not have to manually adjust the vertical tamping plate 280 during system set up.

By operation of the PLC 132, suitable adjustment of the right hand side guide wall 201 and the vertical tamping plate 280, the carton blanks 111 can be moved to precisely the known pick-up position and the orientation of the carton blanks 111 may be “squared-up” in a stack of blanks that is held against the front end wall 218 and may, thus, ensure that the carton blanks 111 are in the proper location for being engaged by the erector heads 120a, 120b.

In particular, once the stack of carton blanks 111 has generally reached the pick-up position, the PLC 132 can send a signal to the drive mechanism 260 to cause the drive mechanism 260 to cause the right hand side guide wall 201 to move laterally inwards towards the side of stack of carton blanks 111. The PLC 132 may be shown to cause the drive mechanism 260 to move a sufficient distance to cause the edges of the carton blanks 111 to become in contact, along their length, with the longitudinally aligned inner surface of the right hand side guide wall 201. However, the PLC 132 will not cause the right hand side guide wall 201 to be moved to such an extent that a force is created on the stack of carton blanks 111 that causes the carton blanks 111 to buckle and/or be damaged. Such damage may be shown to occur responsive to the carton blanks 111 being compressed to a significant extent between the left hand side guide wall 200 and the right hand side guide wall 201. The PLC 132 may be able to determine how much to move the right hand side guide wall 201 towards the left hand side guide wall 200 by virtue of the size dimensions, for the carton blanks 111, that have been inputted into the PLC 132, including dimension H (see FIG. 10A). The amount of slight compression can be fine-tuned, such as by trial and error, for different sized carton blanks 111. It should be noted that, for many sizes of the carton blanks 111, the manufacturers of the carton blanks 111 comply with industry standard carton sizes.

Once the longitudinal alignment has been completed by movement of the right hand side guide wall 201, the PLC 132 can cause the double acting, pneumatic actuator 276 to be activated to cause the vertical tamping plate 280 to engage the rear edges of the carton blanks 111 in the stack. The PLC 132 may cause the drive mechanism 260 to move a sufficient distance to cause the rear edges of the carton blanks 111 to come in contact along their length with the laterally aligned inner surface of the vertical tamping plate 280. However, the amount of retraction of the piston arms may be shown to not cause the vertical tamping plate 280 to be moved to such an extent that the amount of retraction creates a force on the stack of carton blanks 111 that would cause the carton blanks 111 to buckle and/or be damaged. Notably, buckling and/or damage may occur response to the carton blanks 111 being compressed too much between the vertical tamping plate 280 and the front end wall 218. An appropriate manual positioning and securement, such as by tightening screws appropriately positioned through the slider block 273, can secure the double acting, pneumatic actuator 276 at an appropriate longitudinal position on the block track 272.

By way of review, the double acting, pneumatic actuator 276 may ride on the left hand side guide wall 200. For a carton blank 111 of a particular size/shape, the double acting, pneumatic actuator 276 can be adjusted manually in a fore-aft direction so that when the double acting, pneumatic actuator 276 is retracted, the vertical tamping plate 280 is in the right position to push the carton blanks 111 up against the front end wall 218, without squeezing the carton blanks 111.

The sliding assembly of components that includes the double acting, pneumatic actuator 276 may also have a pointer or indicator and on the stationary part of the magazine 110 there may be a numeric scale to assist in rapidly manually adjusting the double acting, pneumatic actuator 276 to the correct position on the block track 272 for a known carton size.

In review, example steps in a tamping sequence, for ensuring that the carton blanks 111 are properly squared up at the pick-up position, include the following:

1. The right hand side guide wall 201, under control of the PLC 132, expands wide enough to allow the stack of carton blanks 111 to enter on the alignment conveyor 206, even if the stack is misaligned and/or the carton blanks 111 in the stack are not perfectly square with each other and in relation to the X and Y axes.

2. The alignment conveyor belt 216 advances the stack of carton blanks 111 until the carton blanks 111 abut the front end wall 218.

3. The double acting, pneumatic actuator 276 is extended and then the right hand side guide wall 201 is contracted to make contact with the side of the stack of carton blanks 111 and press the right hand side guide wall 201 against the left hand side guide wall 200. This aligns the carton blanks 111 so that the side edges of the carton blanks 111 are aligned with each other and aligned with the longitudinal side wall of the left hand side guide wall 200 and the right hand side guide wall 201.

4. The double acting, pneumatic actuator 276 may then be retracted and the vertical tamping plate 280 presses the stack of carton blanks 111 forward, thereby aligning the carton blanks 111 in the stack so that the front edges and the rear edges of the carton blanks 111 are vertically aligned with each other and with the inner face of the vertical tamping plate 280 and the inside surface of the front end wall 218.

5. The carton blanks 111 are then properly positioned so that the erector heads 120a, 102b can begin picking up blanks from the stack.

Turning now to other components of the carton forming system 100, to retrieve blanks from the magazine 110, at least a first engagement device may be provided to engage a panel of a carton blank 111 and, thus, hold and move the blank. Where the carton blank 111 is a tubular blank, the carton forming system 100 may be provided with a first engagement device for engaging one panel (e.g., Panel A) of the carton blank 111 and the carton forming system 100 may be provided with a second engagement device for engaging a second panel (e.g., Panel B) of the carton blank 111. The first engagement device and the second engagement device may comprise one or more suction cups for providing a suction force onto a panel acting generally normal to the surface of the panel that is engaged, as described further in the following. Other types of suitable engagement devices might be employed. The first engagement device and the second engagement device may be rotatable relative to each other so that the first panel can be rotated relative to the second panel. The first engagement device and the second engagement device may be mounted to a single common erector head.

With reference to FIG. 7, the carton forming system 100 may be provided with a movement sub-system that may be implemented as a pair of movement apparatuses, with each movement apparatus supporting and moving one of the erector heads 120a, 120b. Each of the erector heads 120a, 120b may have a dedicated, independently driven and controlled movement apparatus. Thus, the first erector head 120a may be supported and moved by a first movement apparatus 115a. Similarly, the second erector head 120b may be supported and moved by a second movement apparatus 115b. The first movement apparatus 115a may be constructed in a manner that is substantially identical to the manner in which the second movement apparatus 115b is constructed. The first movement apparatus 115a may be configured as mirror image of the second movement apparatus 115b. In this way, the first movement apparatus 115a may support the first erector head 120a from a right hand side and the second movement apparatus 115b may support the second erector head 120b from a left hand side, in such a manner that the erector heads 120a, 120b may both be moved along a common longitudinal and vertical path. The common path of the erector heads 120a, 120b, may be a cyclical path that lies substantially in, or is parallel to, a plane that is parallel to both the vertical axis Z and the longitudinal axis Y in FIG. 7. Thus, movement of the erector heads 120a, 120b may only be in the vertical Z directions and the longitudinal Y direction (i.e., directions parallel to the Z axis and the Y axis in FIG. 7) and there may be no substantial movement in a lateral X direction (i.e., a direction parallel to the X axis in FIG. 7). If the movement of the erector heads 120a, 120b is restricted to only the Z direction and the Y direction, a moving apparatus for each can be constructed that is relatively less complex than if movement in all three directions is required.

The movement of the erector heads 120a, 120b by the respective movement apparatuses 115a, 115b may be synchronized such that the erector heads 120a, 120b may travel along the same longitudinal and vertical path while moving out of phase with each other so that one erector head does not interfere with the other erector head, as will be described further in the following. Thus, the relative positions of the two erector heads 120a, 120b can be arranged so that the erector heads 120a, 120b do not collide or otherwise interfere with each other during operation of the carton forming system 100.

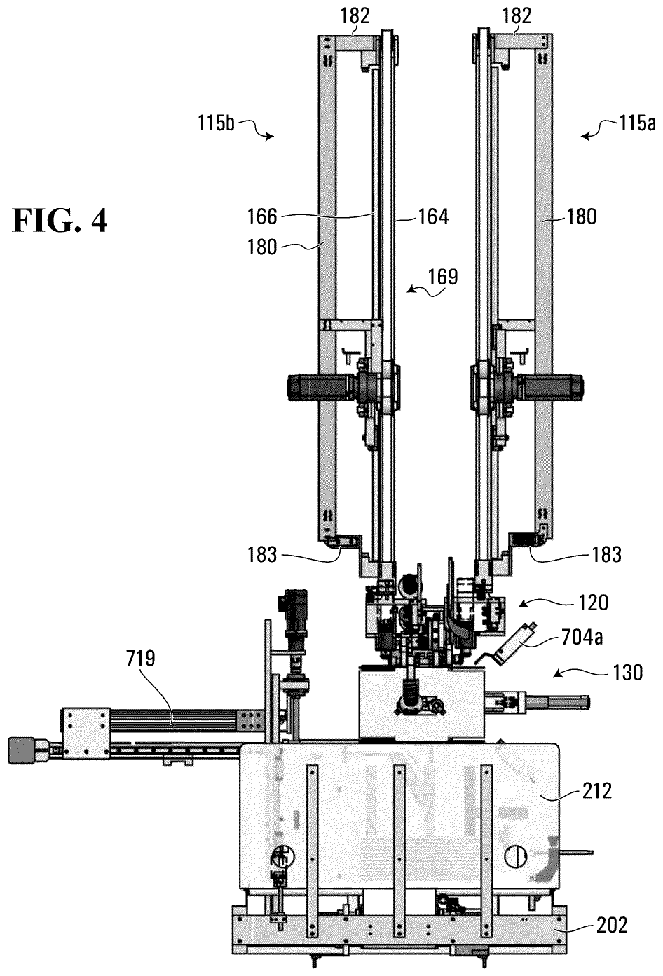

Only the detailed construction of the second movement apparatus 115b will be described herein, it being understood that the first movement apparatus 115a may be constructed in a substantially identical manner as a mirror image of the second moving apparatus 115b. With particular reference to FIGS. 4, 5, 7, 8, 9 and 17, the second movement apparatus 115b may include a vertical movement device and a horizontal movement device. The vertical movement device may include a generally hollow vertically oriented support tube 169 that may be generally rectangular in cross section. The support tube 169 may be formed from a unitary tubular piece of material or may be formed into opposed, vertically extending and oriented surfaces 164, 165, 166 and 168 that may be inter-connected together using conventional mechanisms such as bolts, welding, etc. The support tube 169 may be secured to a horizontally extending brace plate 182. The horizontally extending brace plate 182 may be interconnected to a vertically extending brace plate 180. A bottom portion of the vertically extending brace plate 180 may be interconnected, by way of a series of angled plates 183, to a lower end of the support tube 169.

At an upper end of the support tube 169 may be mounted a freely rotatable “b” pulley wheel 155b. At a bottom end of the vertically extending and oriented surfaces 164, 166, the second erector head 120b may be fixedly attached to the support tube 169 by means of a horizontally extending mounting plate. The horizontally extending mounting plate may be connected to the support tube 169. The support tube 169 may engage with a pair of spaced mounting blocks 190a, 190b that may be joined with bolts through bolt holes 191a, 191b in the mounting blocks 190a, 190b. The bolt holes 191a, 191b may also pass through the mounting plate at the bottom of the support tube 169. Thus, as the second erector head 120b is interconnected to the support tube 169, the second erector head 120b may be shown to move in space with the support tube 169.

To support the support tube 169 and the second erector head 120b that is connected thereto and to facilitate movement of the support tube 169 and the second erector head 120b in horizontal motion, a horizontal movement device may be provided. The horizontal movement device may include a slide block 158 that may use a rail system to move horizontally. The horizontal movement device may be provided with a pair of spaced, longitudinally and horizontally extending short inner blocks, each inner block fitting on one longitudinally extending rail 160, 162 that holds the inner blocks securely but allows the inner blocks to slide horizontally relative to the longitudinally extending rails 160, 162. An example of a suitable rail system is the Bosch Rexroth ball rail system in which the rails are made from steel and the blocks have a race of ceramic balls inside allowing the block to slide on the rails. The longitudinally extending rails 160, 162 are generally oriented horizontally and may be attached to the frame 109. The slide block 158 may be mounted to the longitudinally extending rails 160, 162 for horizontal sliding movement along the longitudinally extending rails 160, 162. Secured to the front face of the slider block 158 are four freely rotatable pulley wheels: an “a” pulley wheel 155a; a “c” pulley wheel 155c; a “d” pulley wheel 155d; and an “f” pulley wheel 155f. A drive belt may be shown to pass around the four freely rotatable pulley wheels, as described hereinafter. The slide block 158 may also use a rail system to allow the support tube 169 to be connected to the slide block 158 and also move vertically relative to the slide block 158. Accordingly, extending vertically along a back surface of the support tube 169 may be a vertically and longitudinally extending rail. A support block may have a runner block interconnected to the vertical rail on the support tube 169. Thus, the support tube 169 can slide horizontally relative to the slide block 158. Again, a suitable rail system is the Bosch Rexroth ball rail system referenced hereinbefore.

A drive apparatus may also be provided to drive the horizontal movement device and the vertical movement device. For example, the drive apparatus may include a pair of drive motors interconnected to a drive belt, with the drive belt being inter-connected to the horizontal and vertical movement devices. For example, the drive apparatus may include a left belt drive motor 150 (which may be a servo motor such as the model MPL-B330P-MJ24AA made by Allen-Bradley), which may be mounted to a longitudinally extending beam member 108 that is connected to the frame 109 (see FIGS. 1a, 2 and 3). The left belt drive motor 150 may have a left drive wheel 152. Similarly, a right belt drive motor 154, which may be a servo motor like the left belt drive motor 150, may also be mounted to the beam member 108 connected to the frame 109. The right belt drive motor 154 may have a right drive wheel 156. The left drive wheel 152 may be longitudinally spaced from, and may be horizontally aligned with, the right belt drive motor 154. Both the left belt drive motor 150 and the right belt drive motor 154 can be driven in both directions at varying speeds, such rotation being controllable through servo drives by the PLC 132 (see FIG. 1B). Both the left belt drive motor 150 and the right belt drive motor 154 may be provided with two separate ports 364a, 364b. One of the ports 364a, 364b may be for supplying a power line and the other of the ports 364a, 364b may be for a communication line to facilitate communication with the PLC 132. It should be noted that all of the servo motors described in this document may be similarly equipped. The left belt drive motor 150 and the right belt drive motor 154 may also have a third input, which may allow for an electric braking mechanism.

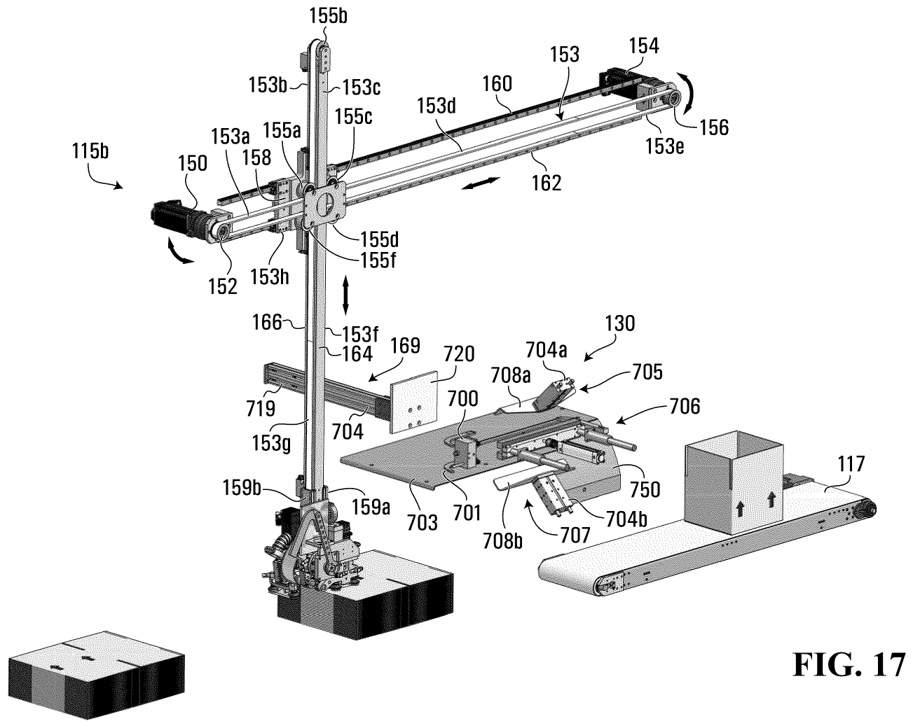

The first movement apparatus 115a may also include a continuous drive belt 153. The continuous drive belt 153 may, for example, be made from urethane with steel wires running through the drive belt 153. The drive belt 153 may be engaged and may be driven by the left belt drive motor 150 and the right belt drive motor 154 under control of the PLC 132. The PLC 132 may independently control, through respective servo drives, the operation of both the left belt drive motor 150 and the right belt drive motor 154. The drive belt 153 may be shown to extend, continuously, from a start location at the bottom left side of the support tube 169, where the drive belt 153 is fixedly attached to a right belt block 159a that is attached to the support tube 169. From the start location, the drive belt 153 extends upwardly, on a first drive belt portion 153g, to the “f” pulley wheel 155f, around the upper side of the “f” pulley wheel 155f. From the “f” pulley wheel 155f, the drive belt 153 extends horizontally, along a second drive belt portion 153h, to the left drive wheel 152. The drive belt 153 then passes around, and is engaged by, the left drive wheel 152, on a third drive belt portion 153a on the underside of the “a” pulley wheel 155a, upwards along a fourth drive belt portion 153b to the “b” pulley wheel 155b. From there, the drive belt 153 extends around the “b” pulley wheel 155b, downwards on a fifth drive belt portion 153c to the “c” pulley wheel 155c, around the “c” pulley wheel 155c along a sixth drive belt portion 153d to the right drive wheel 156. After passing around and being engaged by the right drive wheel 156, the drive belt 153 extends continuously from around the right drive wheel 156, on to a seventh drive belt portion 153e to the upper side of the “d” pulley wheel 155d. From the “d” pulley wheel 155d, the drive belt 153 then extends vertically downwards along an eighth drive belt portion 153f to the right belt block 159a, where the belt terminates. The drive belt 153 vertically supports the support tube 169 both at the bottom as it is interconnected to support tube 169 with the right belt block 159a and a left belt block 159a, and at the top of support tube 169 where the drive belt 153 passes the “b” pulley wheel 155b. Thus, the drive belt 153 may be shown to be indirectly also vertically supporting the second erector head 120b. Furthermore, by adjusting the relative rotations of the left drive wheel 152 and the right drive wheel 156, the relative lengths of all belt portions can be adjusted through the operation of the left belt drive motor 150 and the right belt drive motor 154. Thus, the relative vertical position of the support tube 169 relative to the slide block 158 can be adjusted. Additionally, by adjusting the relative rotations of the left drive wheel 152 and the right drive wheel 156, through the operation of the left belt drive motor 150 and the right belt drive motor 154, the horizontal position of the slide block 158 on the rails 160, 162 can be adjusted, thus altering the horizontal position of the support tube 169 and the second erector head 120b. It may be appreciated that, by adjusting the direction and speeds of rotation of the drive wheels 152, 156 relative to each other, the support tube 169 can be moved vertically and/or horizontally in space within the physical constraints imposed by, among other things, the position of the left drive wheel 152 and the right drive wheel 156, the length of the drive belt 153 and the length of support tube 169. The following will be appreciated with reference to FIG. 17. In particular:
If the left drive wheel 152 and the right drive wheel 156 both remain stationary, then the position of support tube 169 may be shown to not be altered;
If the left drive wheel 152 and the right drive wheel 156 both rotate in the same clockwise direction and at the same speed relative to each other, then the support tube 169, and, correspondingly, the second erector head 120b, may be shown to move horizontally from right to left;
If the left drive wheel 152 and the right drive wheel 156 both rotate in the same counter-clockwise direction and at the same speed relative to each other, then the support tube 169, and, correspondingly, the second erector head 120b, may be shown to move horizontally from left to right;
If the left drive wheel 152 rotates counter-clockwise and the right drive wheel 156 rotates in opposite clockwise rotational directions, but both the left drive wheel 152 and the right drive wheel 156 rotate at the same rotational speed relative to each other, then the support tube 169, and, correspondingly, the second erector head 120b, may be shown to move straight vertically downward; and
If the left drive wheel 152 rotates clockwise and the right drive wheel 156 rotates in opposite counter-clockwise rotational directions, but both the left drive wheel 152 and the right drive wheel 156 rotate at the same rotational speed relative to each other, then the vertically extending and oriented surfaces 164, 166 may be shown to move straight vertically upwards.

It will be appreciated that, if the speeds and directions of the left drive wheel 152 and the right drive wheel 156 are varied in different manner, then a motion of the support tube 169, and, correspondingly, the second erector head 120b, can be created that has both a vertical upwards component or a vertical downwards component as well as a horizontally right to left or left to right component. It follows that any desired path within these two degrees of freedom (vertical and horizontal) can be created for the support tube 169, and, correspondingly, the second erector head 120b. For example, a path having curved path portions may be created. By controlling, independently of each other, the rotational direction and speed of the left belt drive motor 150 and the right belt drive motor 154, the PLC 132 can cause the support tube 169, and, correspondingly, the second erector head 120b, to move along any path in vertical and horizontal directions to allow for the second erector head 120b to carry a carton blank 111 through the various processing steps performed by the carton forming system 100. Notably, the path has physical constraints imposed by the spacing of the left drive wheel 152 and the right drive wheel 156, the “b” pulley wheel 155b and the bottom of the support tube 169.

It will also be appreciated that, by providing two opposed moving apparatuses 115a, 115b, the movements of each of the first erector head 120a and the second erector head 120b can be coordinated and synchronized, so that, even though the first erector head 120a and the second erector head 120b move along the same path, the movement of first erector head 120a and the second erector head 120b are out of phase. For example, the first erector head 120a and the second erector head 120b may be out of phase by 180 degrees.

Thus, the movements of one erector head 120 will not interfere with the movement of the other erector head 120. An encoder may be provided for each of the left belt drive motor 150 and the right belt drive motor 154 and the encoders may rotate in relation to the rotation of the respective the left drive wheel 152 and the right drive wheel 156. The encoders may be in communication with the PLC 132. Accordingly, the PLC 132 may, in real time, know/determine/monitor the position of the drive belt 153 in space and, thus, may determine and know the position of the second erector head 120b in space at any given time. The particular types of encoders that may be used are known as “absolute” encoders. Thus, the carton forming system 100 can be zeroed, such that, due to the calibration of both encoders of both the left belt drive motor 150 and the right belt drive motor 154, the zero-zero position of the erector head 120 in both the Z direction and the Y direction is set within the PLC 132. The zero-zero position can be set with the erector head 120 at its most horizontally left and vertically raised position. The PLC 132 can then substantially, in real time, keep track of the position of the second erector head 120b as the second erector head 120b moves through the processing sequence for a given carton blank 111.

The PLC 132, the encoders associated with the left belt drive motor 150 and the right belt drive motor 154 and the respective servo drives on each of the apparatuses 115a, 115b may be capable of being set at zero-zero positions for each of the two separate erector heads 120a, 120b. The PLC 132 can then, substantially in real time, keep track of the position of both of the erector heads 120a, 120b as the erector heads 120a, 120b independently move through the processing sequence for a given carton blank 111.

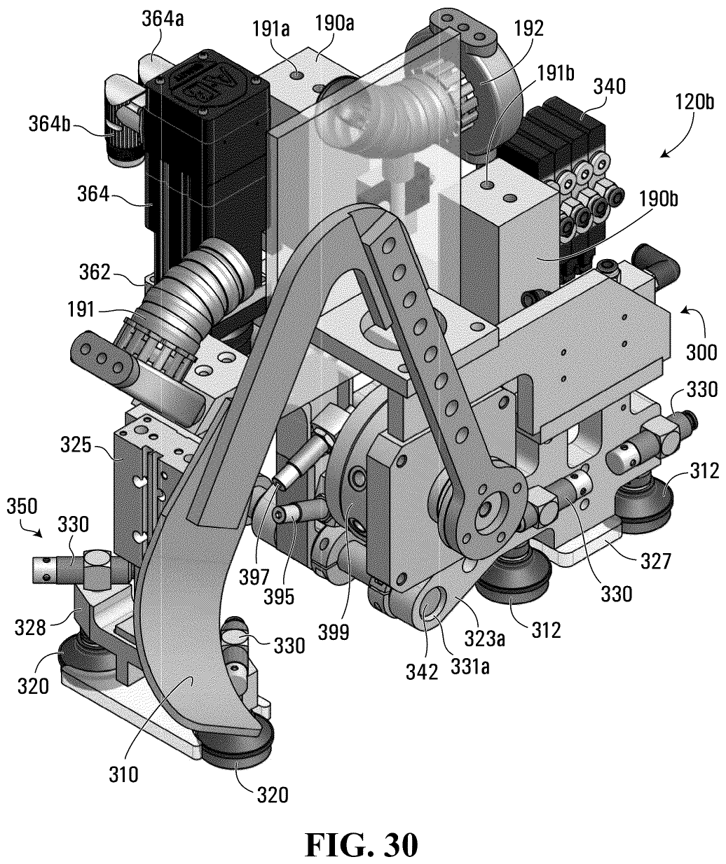

Also associated with the second movement apparatus 115b is a first, generally horizontally oriented caterpillar device 114 having a first caterpillar input end 114a and a first caterpillar output end 114b. A second, generally vertically oriented caterpillar device 118 is also provided and has a second caterpillar input end 118a and a second caterpillar output end 118b. The first caterpillar device 114 and the second caterpillar device 118 may each have a hollow cavity extending along their length. Within the cavities of the first caterpillar device 114 and the second caterpillar device 118, hoses carrying pressurized air/vacuum and wires carrying electrical/communication can be housed. The first caterpillar device 114 may allow such hoses and wires to move longitudinally as the support tube 169 and the second erector head 120b are moved longitudinally. The second caterpillar device 118 may allow such hoses and wires to move vertically as the support tube 169 and the second erector head 120b are moved vertically. The hoses and wires may extend from external sources to enter at the first caterpillar input end 114a and emerge at the first caterpillar output end 114b. Once having emerged from the first caterpillar output end 114b, the hoses and wires may extend to enter at the second caterpillar input end 118a and emerge at the second caterpillar output end 118b. These hoses and wires may then pass from the second caterpillar output end 118b into a first input hose 191 and a second input hose 192 on the second erector head 120b (see FIG. 30). In this way, both pressurized air/vacuum and/or electrical communication wires may be brought from locations external to the frame 109 onto the moving second erector head 120b. An example of a suitable caterpillar device that could be employed is the E-Chain Cable Carrier System model #240-03-055-0 made by Ignus Inc. It should be noted that electrical communication between the PLC 132 and the second erector head 120b could, in other embodiments, be accomplished using wireless technologies that are commercially available.

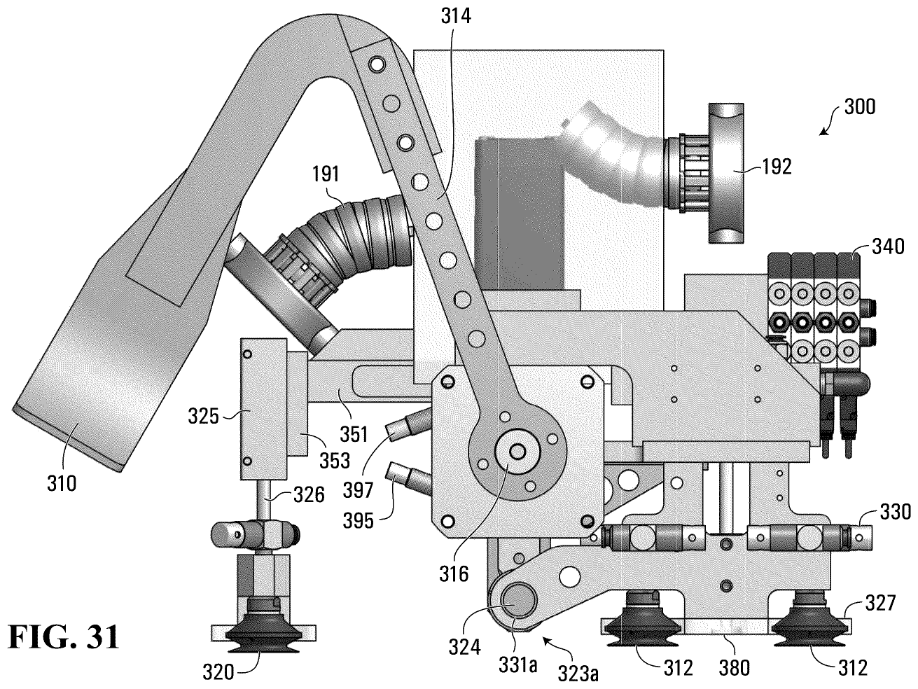

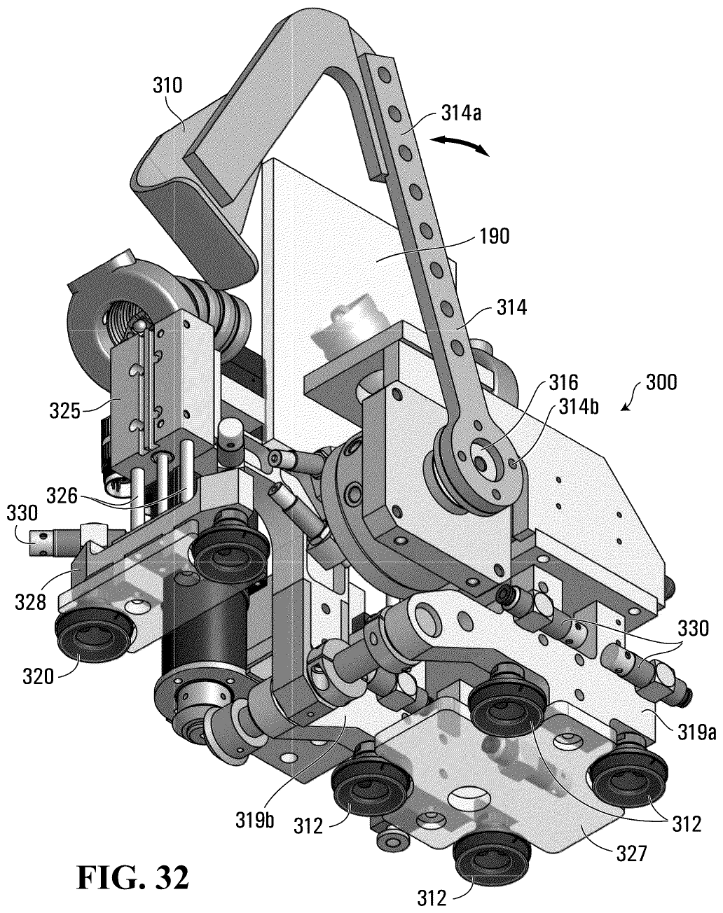

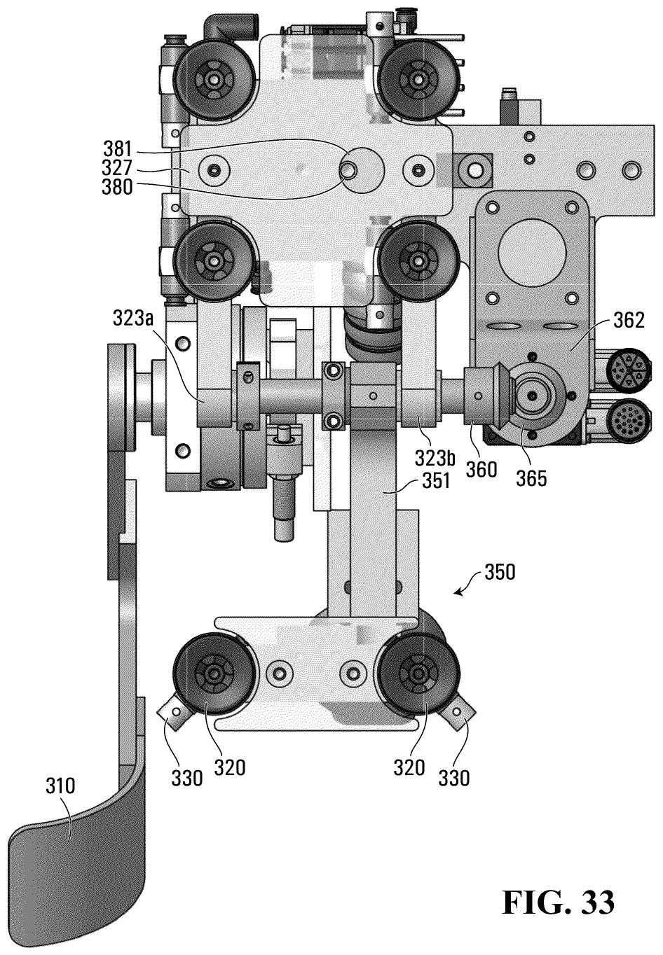

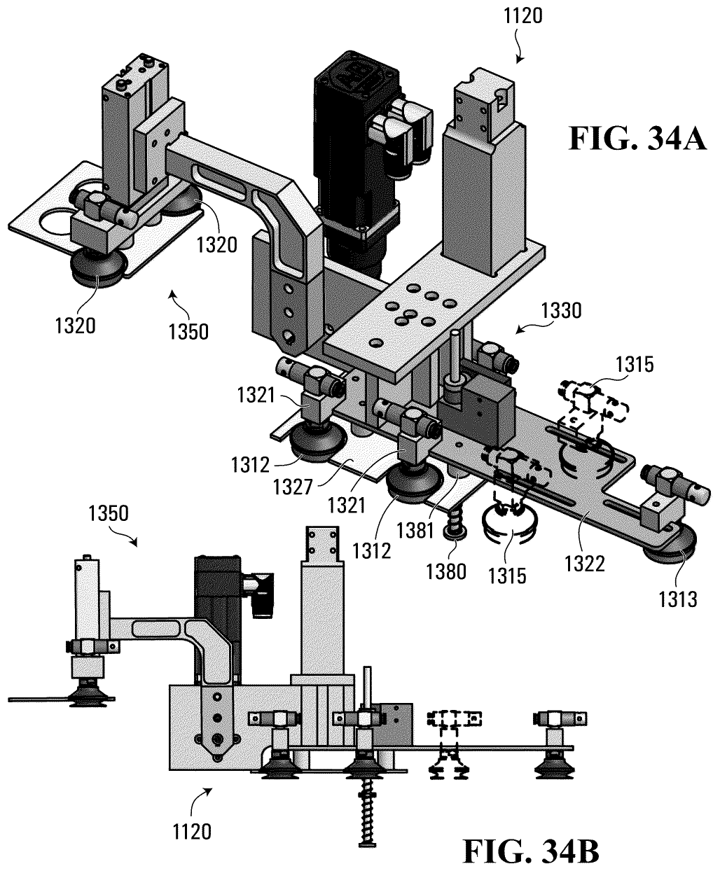

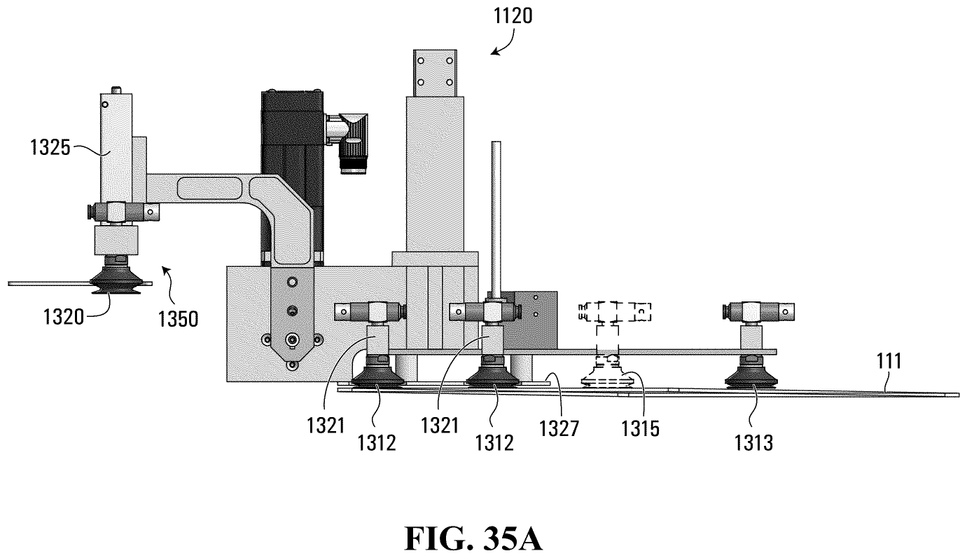

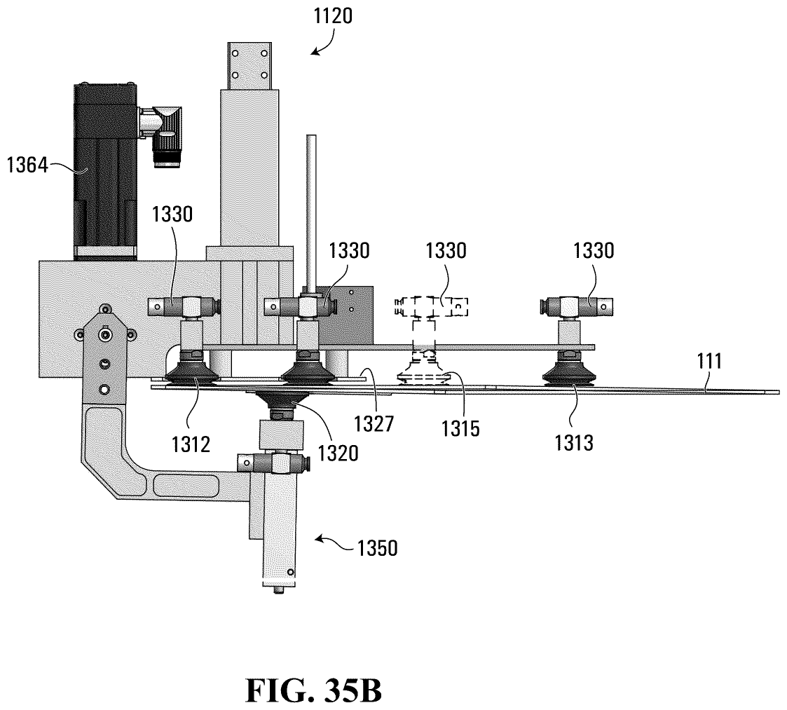

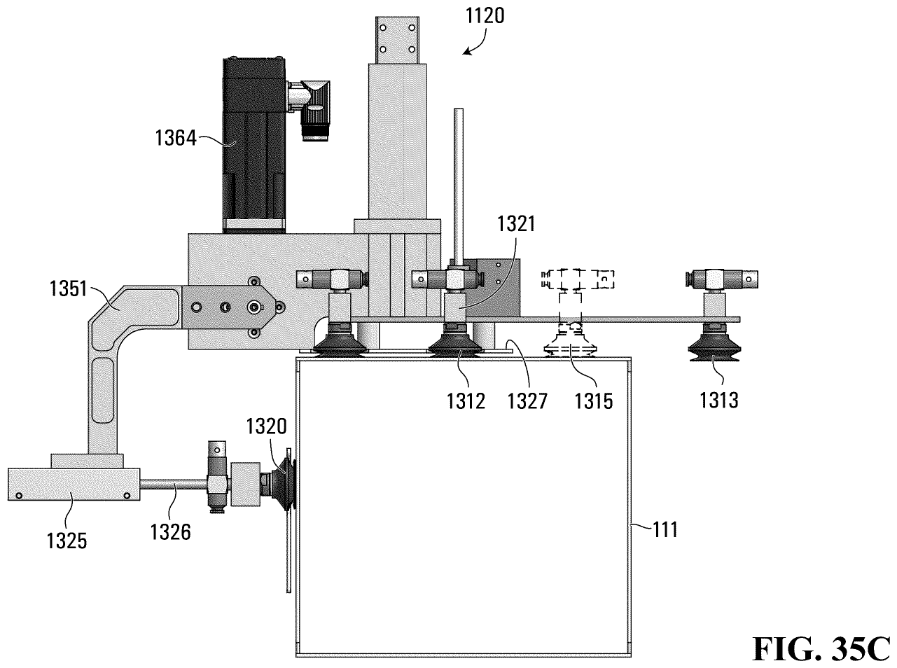

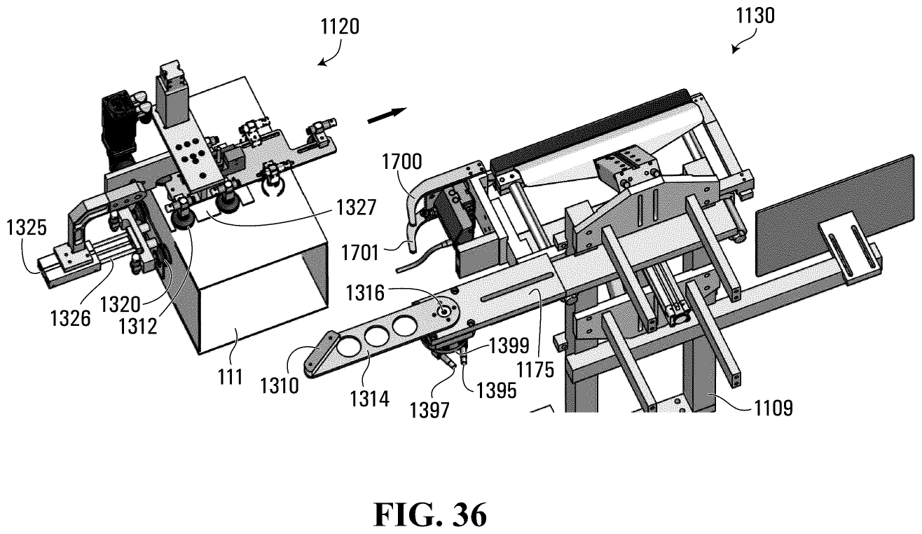

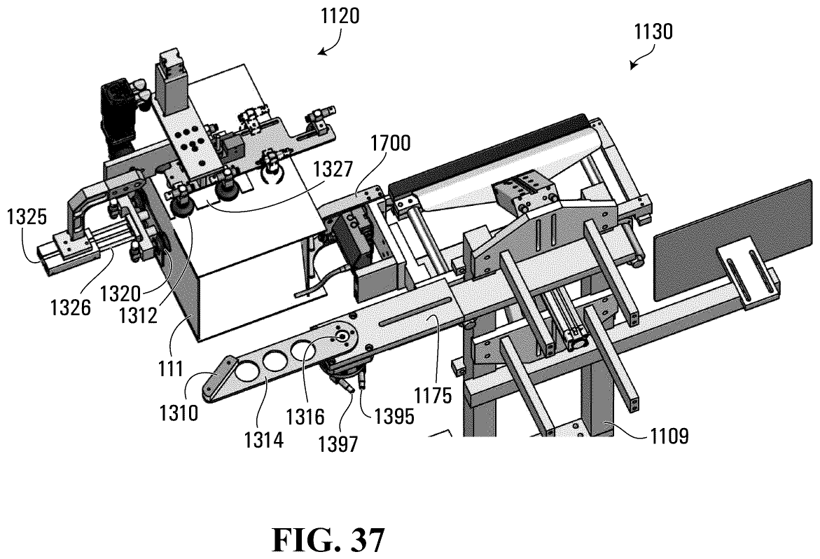

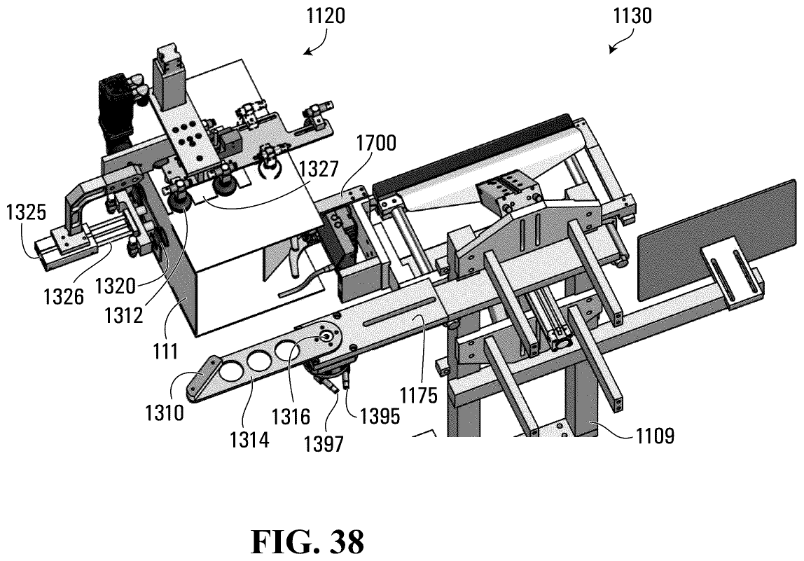

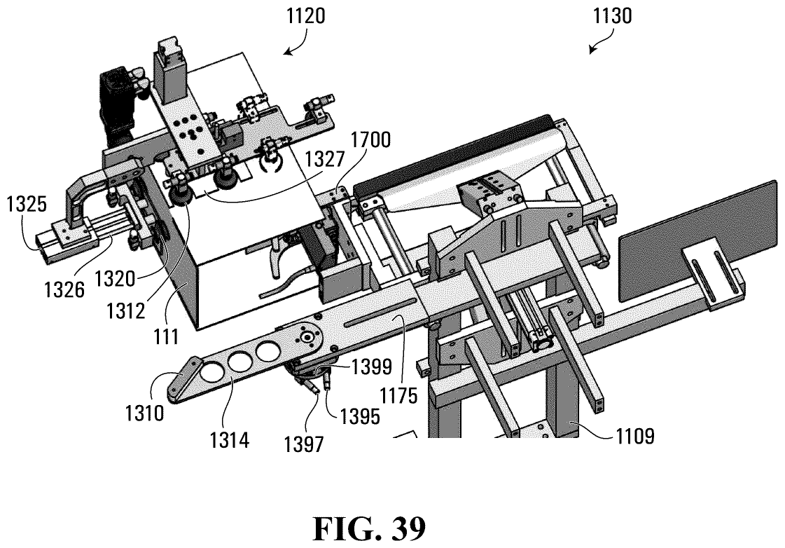

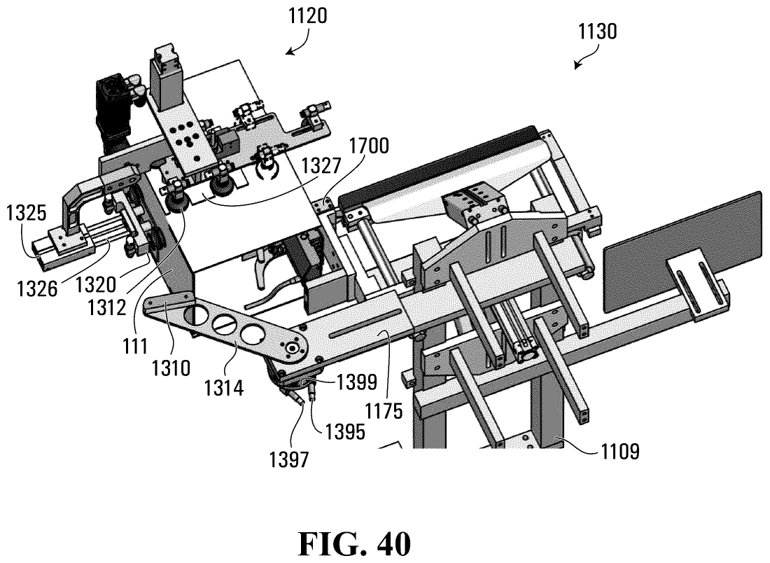

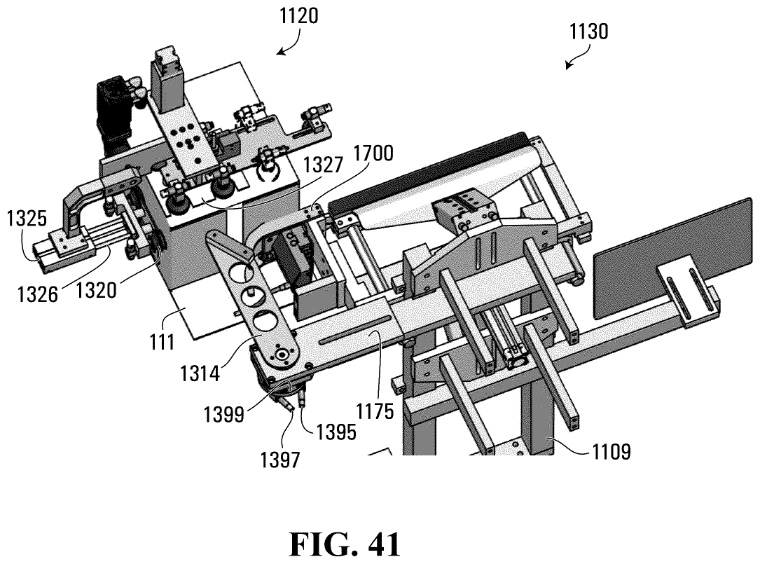

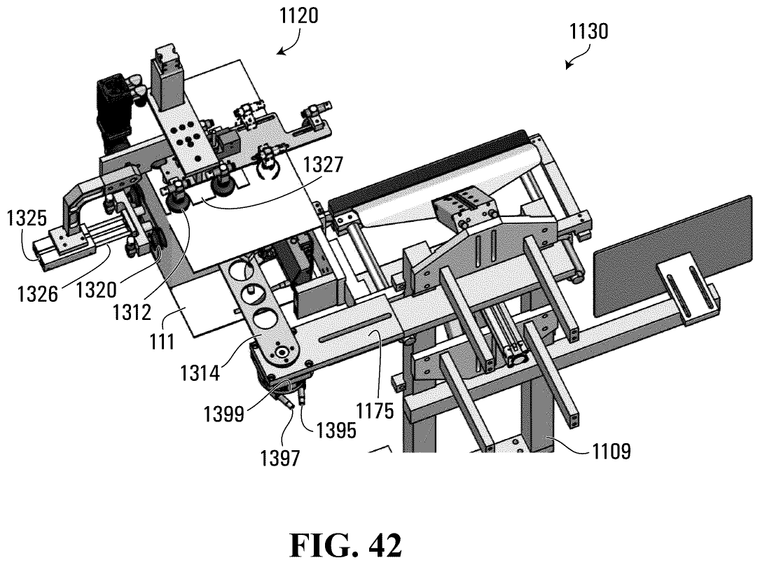

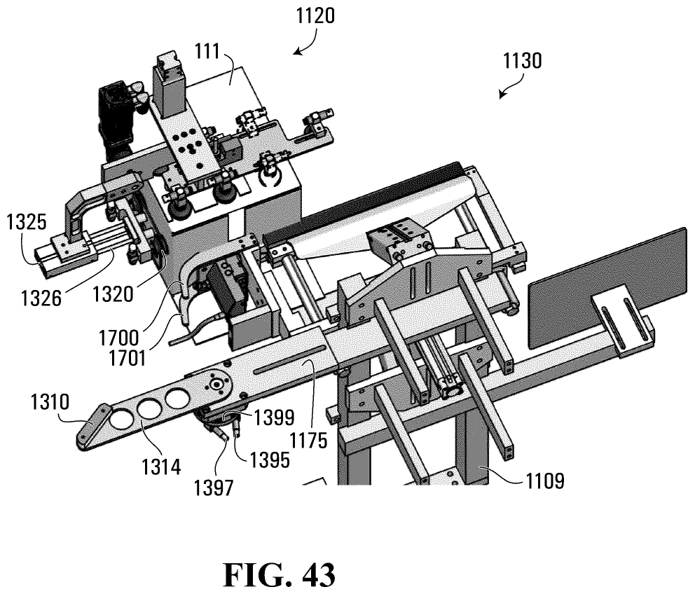

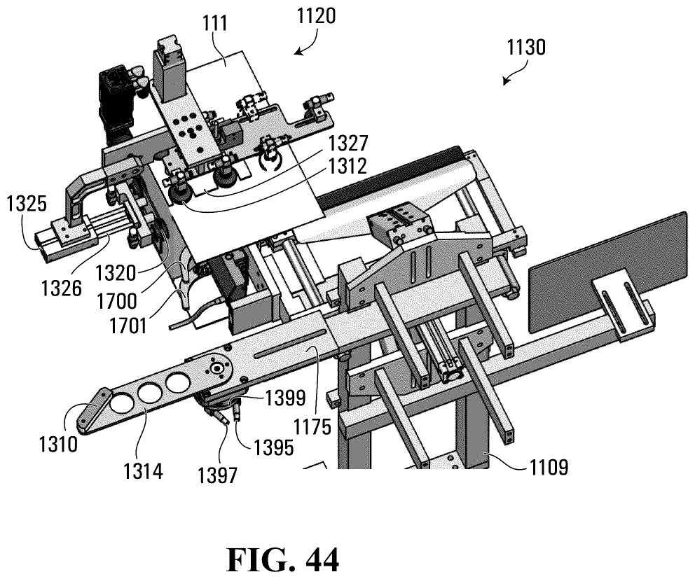

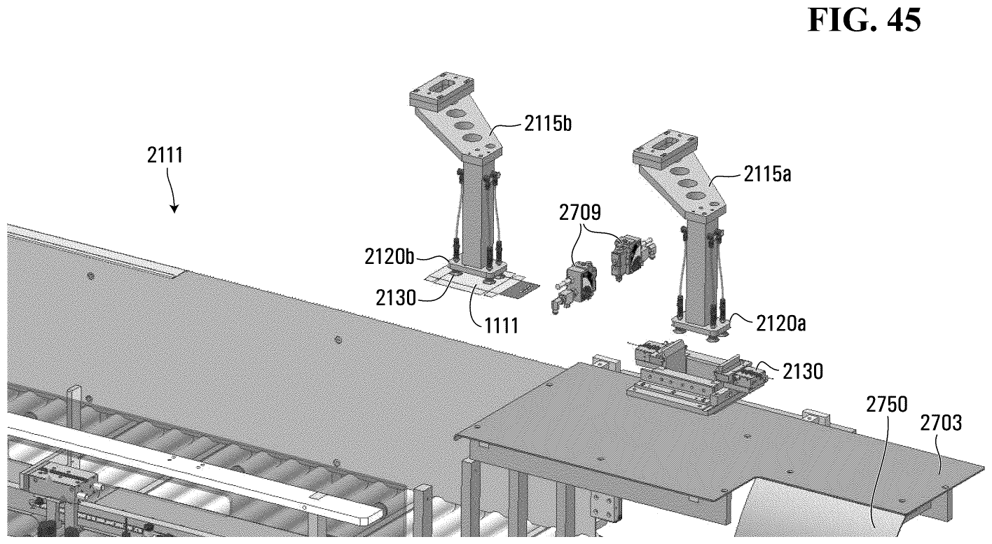

The second erector head 120b is illustrated in isolation in FIGS. 30, 31, 32 and 33. The first erector head 120a may be constructed in the same manner as the second erector head 120b, but may be supported from the right hand side by the first movement apparatus 115a, in contrast to the second erector head 120b, which may be supported from the left hand side by the second movement apparatus 115b.

The second erector head 120b may have a body generally designated as 300. The body 300 may comprise of a number of components. Many of the components of the second erector head 120b may be made from a strong material, such as a metal (e.g., aluminum, steel, etc.), a hard and strong plastic or other suitable materials, including composite materials.

The second erector head 120b may be generally configured to handle a range of sizes of the carton blanks 111 that can be formed into a carton. The second erector head 120b may be configured by providing easy attachment to the support tube 169 using the mounting blocks 190a, 190b and bolts, etc. to permit for the easy interchange of the erector heads 120. The easy interchange of the erector heads 120 may be shown to allow the carton forming system 100, in some circumstances, to be readily adapted to forming differently sized/shaped cartons from differently configured carton blanks 111.

In one embodiment, the second erector head 120b may include a rotatable paddle 310 connected to a distal end portion 314a of a paddle arm 314. The paddle arm 314 may have a proximal end portion 314b opposite to the distal end portion 314a. The proximal end portion 314b may be formed with a circular opening that facilitates the paddle arm 314 being connected to a paddle shaft 316. The paddle 310 can rotate with the paddle shaft 316 about the longitudinal axis of the paddle shaft 316. The paddle shaft 316 may be connected to a rotary actuator 399 such as a double acting rotary pneumatic actuator manufactured by Festo under engineering part #DSM-32-270-CC-FW-A-B. The rotary actuator 399 can cause rotation of the paddle shaft 316 clockwise and counter-clockwise, up to 270 degrees around an axis of the paddle shaft 316. The rotary actuator 399 may be supplied with pressurized air via hoses (not shown) connected to a first port 395 and a second port 397. Those hoses may also be connected to a solenoid valve device 340, which may be controlled by the PLC 132. In this way, the rotation clockwise and counter-clockwise of the paddle 310 may be controlled by the PLC 132.

Also formed as part of the body 300 of the second erector head 120b is a bottom suction plate 327 that is generally shaped in a square cross configuration to provide flanged openings for suction cups. In each of the flanged openings of the bottom suction plate 327 is positioned a suction plate suction cup 312. It should be noted that, while many types of suction cups may be employed on the second erector head 120b, a preferred type of suction cup is the model B40.10.04AB made by Piab. Two of the suction plate suction cups 312 are mounted to a first generally longitudinally oriented support block 319a and the other two suction cups are mounted to a second generally longitudinally oriented support block 319b.

The first support block 319a and the second support block 319b are generally oriented longitudinally in a spaced-apart, parallel relation to each other and the first support block 319a and the second support block 319b are joined to other components of the body 300. The first support block 319a and the second support block 319b each have open passageways that interconnect each suction plate suction cup 312 with an outlet from a vacuum generator 330. The vacuum generator 330 may be any suitable vacuum generator device, such as, for example, model VCH12-016C made by Pisco. Each of the suction plate suction cups 312 may be shown to have an inlet interconnected to a hose (not shown) that can carry pressurized air to the vacuum generator 330. The vacuum generator 330 converts pressurized air, supplied to a vacuum inlet port, into a vacuum at one of a plurality of vacuum outlet ports. The vacuum outlet port is interconnected, through the passageway in the first support block 319a and the second support block 319b, to a given suction plate suction cup 312, among the plurality of suction plate suction cups 312, so that the given suction plate suction cup 312 can implement a vacuum force. Interposed along the pressurized air channel running between the vacuum generator 330 and the source of pressurized air, which may be an air compressor (see FIG. 1B), may be located a solenoid valve device 340 that may, for example, be a model CPE14-M1BH-5L-1/8 made by Festo. The solenoid valve device 340 may be in electronic communication with the PLC 132 and be controlled by the PLC 132. In this way, the PLC 132 can turn on and off the supply of vacuum force to each of the suction plate suction cups 312. To channel the compressed air appropriately, valves in the solenoid valve device 340 can be driven between open and closed positions by solenoids responsive to signals from the PLC 132. Electrical lines carrying signals to and from the PLC 132 could also pass through the first input hose 191 to operate the solenoid valve device 340.

A first downward extending end portion 323a of the first support block 319a has a first opening 331a that is configured to receive a transversely mounted shaft 342. The transversely mounted shaft 342 may be mounted for rotation within the first opening 331a. A second downward extending end portion 323b of the second support block 319b has a second opening 331b that is configured to receive the transversely mounted shaft 342. The transversely mounted shaft 342 may be mounted for rotation within the second opening 331b.

At one end of the transversely mounted shaft 342 may be mounted a gear wheel device 360 that is configured to rotate with transversely mounted shaft 342. The gear wheel 360 may be interconnected to a drive wheel of a gear box 362 to form a miter gear connection. The gear box 362 may be driven by a servo motor 364 mounted above the gear box 362. The servo motor 364 may also be a model MPL-B1530U-VJ44AA made by Allen-Bradley and the gear box 362 may be a model AER050-030 FOR MPL-A1520 AB SERVO MOTOR made by Apex.

In FIG. 30, the servo motor 364 is shown with two separate servo motor ports 364a, 364b (individually or collectively, 364). One of the servo motor ports 364 may be for supplying a power line and the other servo motor port may be for a communication line to facilitate communication with a servo drive and the PLC 132. It should be noted that all of the servo motors described in this application may be similarly equipped. The servo motor 364 may, through connection with a servo drive (see FIG. 1B), be controlled by and be in communication with the PLC 132. An encoder may be provided within or in association with the servo motor 364. The encoder may rotate in relation to the rotation of the respective drive shaft of the servo motor 364. The encoder may be in communication with, and provide signals to, the servo drive and, thus, to the PLC 132. The PLC 132 may be able to determine the rotational position of the transversely mounted shaft 342. Thus, when appropriate signals are provided from the PLC 132, the servo motor 364 can be operated and can cause the transversely mounted shaft 342 to rotate in a particular desired direction at a particular desired rotational speed for a desired amount of time. Thus, the PLC 132 can control the rotational position of transversely mounted shaft 342.

Mounted to the transversely mounted shaft 342, between the first end portion 323a and the second end portion 323b, is a rotator device generally designated 350. The rotator device 350 is fixedly attached to the transversely mounted shaft 342 and may be shown to rotate with the transversely mounted shaft 342. The rotator device 350 includes a rotator arm 351 having one end fixedly mounted to the transversely mounted shaft 342. The opposite end of the rotator arm 351 has a mounting block 353 attached thereto.

Secured to mounting block 353 may be a mounting block pneumatic actuator device 325 that may, for example, be a model DFM-12-80-P-A-KF, or part #170905 made by Festo. The mounting block pneumatic actuator device 325 may be supplied with pressurized air to, thereby, activate the device that may be controlled by the solenoid valve device 340 in the supply line. The solenoid valve device 340 may be in communication with, and be controlled by, the PLC 132 (see FIG. 1B). The mounting block pneumatic actuator device 325 may be actuated to reciprocate piston arms 326 between an extended position and a retracted position. The PLC 132 may send a signal to the solenoid valve device 340 to operate the mounting block pneumatic actuator device 325 to extend the piston arms 326 at a particular angular position of the rotator arm 351 and/or at a particular location of the second erector head 120b. The particular angular position or the particular location may be provided by the encoder associated with the servo motor 364. Similarly, the PLC 132 may send a signal to the solenoid valve device 340 to cause the piston arms 326 to be retracted to a particular angular position of the transversely mounted shaft 342 and/or to cause the piston arms 326 to be retracted to a particular angular position of the rotator arm 351 and/or to cause the piston arms 326 to be retracted to a particular location of the second erector head 120b.

The PLC 132 may cause, by acting through the solenoid valve device 340, the mounting block pneumatic actuator device 325 to be actuated at approximately the same time as the suction plate suction cups 312 have contacted the surface of downward facing panel D and/or when rotation of the rotator arm 351 is just about to begin or has just commenced. Piston arms 326 may be completely extended by the time the rotator arm 351 has rotated about 45 degrees.

Mounted to a distal end of each piston arms 326 is a mounting block 328, which may be configured to support a pair of piston arm suction cups 320. Each mounting block 328 may have an open passageway (not shown) that interconnect each piston arm suction cup 320 with an outlet from the vacuum generator 330. The vacuum generator 330 may be any suitable vacuum generator device, such as, for example, the model VCH12-016C made by Pisco. As indicated above, the vacuum generators 330 each have an inlet port interconnected to a hose (not shown) that can carry pressurized air to the vacuum generator 330. The vacuum generators 330 convert the pressurized air supplied the inlet port to a vacuum at one of the outlet ports. The outlet port is interconnected, through the passageway in the mounting block 328, to one of the piston arm suction cups 320 so that the suction cup can implement a vacuum force. Interposed along the pressurized air channel, running between each vacuum generator 330 associated with piston arm suction cups 320 and the source of pressurized air, may be located the solenoid valve device 340. The solenoid valve device 340 may be interconnected electronically (either via a wireless communication connection or via a wired communication connection) to the PLC 132 and be controlled by the PLC 132. In this way, the PLC 132 can also turn on and off the supply of vacuum force to each of the piston arm suction cups 320.

With reference to FIG. 11, the suction plate suction cups 312 can be employed to engage and hold onto the top panel A of the carton blank 111. Once the carton blank 111 has been retrieved from the top of the stack of carton blanks 111, the rotator arm 351 can be rotated approximately 180 degrees, such that the piston arm suction cups 320 of the rotator device 350 can engage and hold onto the underside panel D of the carton blank 111. Once the piston arm suction cups 320 have engaged the panel D, the rotator arm 351 can be rotated 90 degrees backwards in the opposite rotational direction. The opposing vacuum forces, created by the suction plate suction cups 312 above and the piston arm suction cups 320 below, may be shown to cause the carton blank 111 to be transformed from a flattened configuration to an open configuration, as panel D is rotated substantially 90 degrees relative to panel A. The air suction force that may be developed at the outer surfaces of the piston arm suction cups 320 and the suction plate suction cups 312 may be shown to be sufficient so that, when activated, the piston arm suction cups 320 and the suction plate suction cups 312 can engage and hold top panel A in a stationary position, relative to the second erector head 120b, and rotate panel D relative to panel A to open up the tubular carton blank 111 to a generally rectangular configuration. The vacuum generated at the piston arm suctions cups 320 and the suction plate suction cups 312 can also be de-activated by the PLC 132 sending signals, at appropriate times, to the solenoid valve device 340.

Each erector head 120a, 120b may be configured to be able to handle a wider range of different sized/dimensioned carton blanks 111 by providing for additional piston arm suction cups and suction plate suction cups positioned at different locations on the erector heads 120a, 120b. The piston arm suction cups 320 and the suction plate suction cups 312 could each be “self-sealing” of “self-plugging” suction cups, which, if not engaging and sealing with a surface of a particular blank that is being processed, may automatically become blocked. This automatic blocking may be shown to allow the vacuum/suction forces to be maintained on other suctions cups that may have the source of pressurized air/vacuum interconnected thereto and that are engaging a panel of a carton blank 111. In this way, each of the erector heads 120a, 120b may be adapted to handle a wider variety of sized/dimensioned carton blanks 111 and cartons/cases that can be formed therefrom.

The opening of the carton blank 111 may be assisted by the extension of the piston arms 326 of the mounting block pneumatic actuator device 325 during rotation of the rotator arm 351. Preferably, when the rotator arm 351 has been rotated somewhere in the range of about 30-60 degrees back to the 90 degree position and, preferably, when the rotator arm 351 is at approximately 40-50 degrees and, most preferably, when the rotator arm 351 is at about 45 degrees, then the piston arms 326 may be fully extended. This extension of the piston arms 326 and, thus, of the piston arm suction cups 320, in a generally tangential direction relative to the rotation of the rotator arm 351 may be shown to compensate for an offset of the axis of rotation of the rotator arm 351 compared to the axis of rotation of the carton blank 111 that extends along the fold line between panels A and D. The effect of the extension of the piston arms 326 once the rotator arm 351 has been rotated, such as to 90 degrees, ensures that the panel D is also oriented at 90 degrees to panel A.

Once a carton blank 111 has been opened to the configuration shown in FIG. 11, then the PLC 132 can send a signal to the solenoid valve device 340, which signal causes the rotary actuator 399 to rotate the paddle shaft 316 and, thus, rotate the paddle 310. The paddle 310 can then engage the trailing flap K of the carton blank 111 and cause the trailing flap K to fold about its fold line where the trailing flap K joins to panel D. Thus, the trailing flap K can be folded inwards towards the bottom opening of the carton blank 111. The leading bottom flap J may also be folded about its fold line, which joins the leading bottom flap J with panel B by engagement of the leading bottom flap J with upper folding rails/ploughs 700 and lower folding rails/ploughs 701, that form part of the folding and sealing apparatus 130. As the carton blank 111 held by the second erector head 120b is moved longitudinally downstream into the folding and sealing apparatus 130, the leading bottom flap J can be folded inwards, so that both bottom flaps K and J are folded inwards to start the formation of the bottom of the carton.

Another feature of the second erector head 120b that can be noted is that a carton location sensor apparatus may be provided and may include a reciprocating sensor rod 380. The reciprocating sensor rod 380, when not in contact with a carton blank 111, extends downwards through an aperture 381 in the bottom suction plate 327, below the level of the plane of the suction plate suction cups 312. When the second erector head 120b is brought vertically downwards to retrieve a carton blank 111 on a stack of carton blanks 111 in the magazine 110, the movement of the second erector head 120b just prior to the suction plate suction cups 312 contacting with the upper surface of the carton blank 111 may be shown to be generally vertically downwards. Prior to the suction plate suction cups 312 contacting the surface of panel A of a carton blank 111, the sensor rod 380 may be shown to engage the surface of panel A and cause the sensor rod 380, which may be resiliently displaced due to a spring mechanism biasing the sensor rod 380 downwards, to be pushed upwards. This movement upwards of the sensor rod 380 relative to the bottom suction plate 327 may be shown to physically cause a sensor (not shown) to be activated and, responsively, a signal to be sent to the PLC 132. The sensor may be an inductive proximity sensor. A metal cylinder fixed on the sensor rod 380 may be sensed by sensor circuitry because movement of the metal cylinder may be shown to change the inductance of an induction loop inside the sensor. The sensor may be 871FM-D8NP25-P3 made by Allen-Bradley. The PLC 132 may respond to receipt of the signal by causing the left belt drive motor 150 and the right belt drive motor 154 to slow down so that the final few centimeters (e.g., 3.5 cm) of movement downwards towards contact between the suction plate suction cups 312 and the upper surface of panel A occurs at a much slower rate and also the PLC 132 knows how much further vertically downwards the second erector head 120b is to be lowered to establish proper contact between the suction plate suction cups 312 and panel A. It should also be noted that the sensor rod 380 and the associated sensor device can also be used to ensure that the PLC 132 is aware of whether, once a carton blank 111 has been engaged in the magazine 110, the carton blank 111 stays engaged with the second erector head 120b until an appropriate release location is reached, such as once erection of the carton has been completed.

The particular arrangement of suction cups and rotating paddle on erector heads 120 can be designed based upon the configuration of the carton blank and the particular panels and flaps that need to be rotated. It will also be appreciated that, on the erector head 120 that is illustrated, the suction cups are used to apply a force to hold onto and/or rotate panels of a carton blank 111. However, it should be clear that alternative engagement mechanisms to the suction plate suction cups 312 and the piston arm suction cups 320 could be employed.

With particular reference to FIGS. 1 to 15 and 17, at the folding and sealing apparatus 130, rail and plough apparatus may be configured to cause all remaining flaps of a carton blank 111 to be appropriately folded in preparation for sealing to, thereby, produce an open carton configuration that is suitable for delivery to a discharge conveyor, such as the discharge conveyor 117. The folding and sealing apparatus 130 may include the following components: upper folding rails/ploughs 700; lower folding rails/ploughs 701; a carton support plate 703; a discharge chute 750; an upper flap closing device 705; a lower flap closing device 707; a right hand compression device 706; a left hand compression device 704; and a glue applicator 709 (see FIG. 1). The glue applicator 709 may have one or more nozzles positioned to apply adhesive to flaps such as flaps J and K. Each of the rails and actuator devices of the folding and sealing apparatus 130 may be supported by rods or other members to interconnect the components to the support frame 109.

The upper flap actuation device 705 may include an upper pneumatic actuator device 704a having its piston arms connected to an upper plough 708a. Similarly, the lower flap actuation device 707 may include a lower pneumatic actuator device 704b having its piston arms connected to an upper plough 708b. The upper pneumatic actuator device 704a and the lower pneumatic actuator device 704b may be the model DFM-25-100-P-A-KF, part #170928 made by Festo.

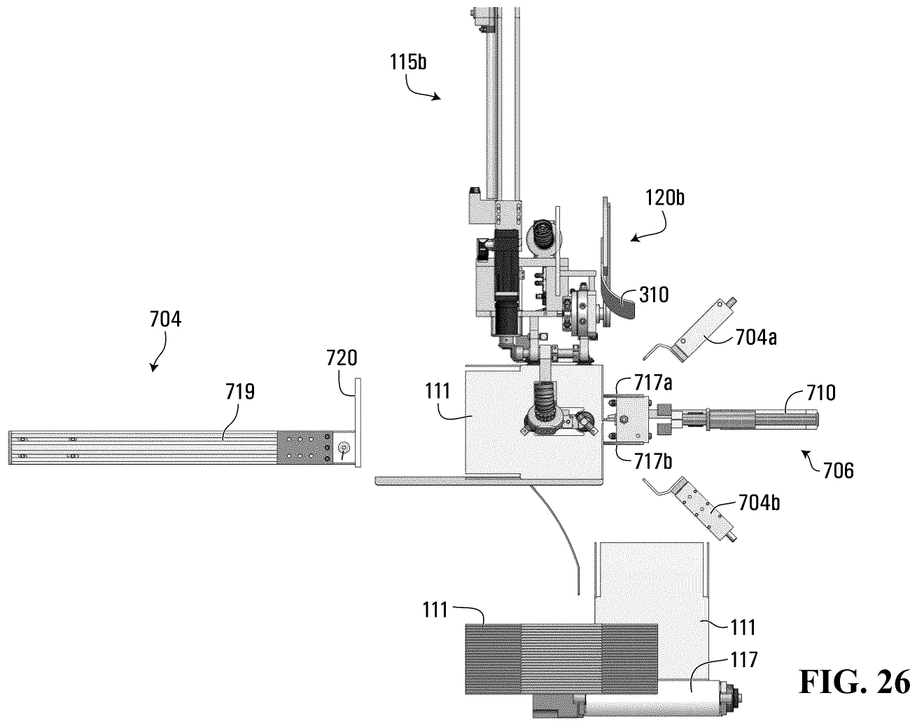

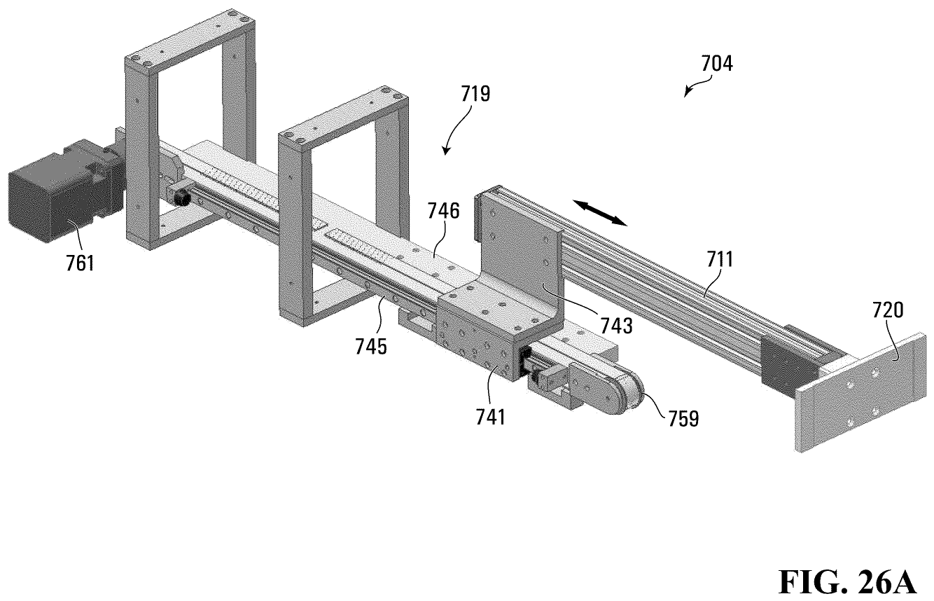

The right hand compression device 706 may include a central pneumatic actuator device 710 with telescoping extendible support rods 712, 714 horizontally aligned and disposed on either side of the central pneumatic actuator device 710. The central pneumatic actuator device 710 may be a model DNC-32-100-PPV-A part #163309 made by Festo. With particular reference to FIG. 26, the central pneumatic actuator device 710 may have piston arms that, along with ends of the support rods 712, 714, connect to a longitudinally extending sealing plate 716. The longitudinally extending sealing plate 716 may have, attached thereto, a longitudinally extending upper rail 717a and a longitudinally extending lower rail 717b. The upper rail 717a may be positioned to be able to engage upper major flap F and the lower rail 717b may be positioned to engage lower major flap G when piston arms of the central pneumatic actuator device 710 are extended horizontally and transversely inwards to push flaps F and G into engagement with flaps K and J that are positioned underneath.

The left hand compression device 704 has a left hand actuator arm 711, which may be actuated by an left hand actuator device 719 with a vertically and longitudinally disposed left hand compression plate 720 attached to the end of the actuator arm. The left hand actuator device 719 may be a double acting pneumatic actuator (not shown) that may be provided with pressurized air through hoses, with the air flow being controlled by the solenoid valve device 340 that may be controlled by the PLC 132. Other embodiments are possible. For example, with reference to FIG. 26A, a servo-driven actuator for the left hand actuator arm 711 may be provided that includes a mounting block 741 that can travel along a rail guide 745 that is secured to a horizontal and longitudinally extending plate forming part of a left hand support frame 746. The mounting block 741 can slide horizontally along the rail guide 745. An L-shaped plate 743 may interconnect the left hand actuator arm 711 to the mounting block 741. The mounting block 741 may also be connected, such as with nuts and bolts, on its underside to a continuous drive belt 757 made of any suitable material, such as, for example, the same material that may be used in the belts for first movement apparatus 115a and the second movement apparatus 115b, namely a urethane timing belt with steel wires running therethrough. The continuous drive belt 757 may extend between a freely rotating pulley 759, mounted to an end of the left hand support frame 746, and a drive wheel of a left hand servo motor 761. Through a servo drive and an absolute encoder, the left hand servo motor 761 may be an Allen-Bradley model AB MPL-B320P-MJ22AA and may be interconnected, with a servo drive, to the PLC 132. The servo drive may be Allen-Bradley model AB. 2094-BM01-S. The left hand servo motor 761 may be coupled to a drive wheel for the belt thorough an APEX GEARBOX model AE070-005.

The PLC 132 may control the rotation of the drive wheel driven by the left hand servo motor 761 through use of an encoder (that may be an absolute encoder). Thus, the movement of the continuous drive belt 757 may be controlled and the PLC 132 may determine, in real time, the position of the left hand actuator arm 711. It follows that the PLC 132 may determine, in real time, the position of the left hand compression plate 720. Depending upon the type, and thickness, of material from which the carton blank 111 is formed, the positioning of the left hand compression plate 720, relative to the plate of the right hand compression device 706, may be adjusted by the PLC 132 to ensure an appropriate degree of compression of the flaps of the carton blank 111 positioned there between.

Each of the upper pneumatic actuator device 704a, the lower pneumatic actuator device 704b and the central pneumatic actuator device 710 may be double acting cylinders and they may be supplied with pressurized air that is controlled through an electronic valve device (not shown). The electronic valve device may a model CPE14-M1Bh-5J-1/8 valve unit that may be in communication with, and be controlled by, the PLC 132. Accordingly, the PLC 132 may cause the piston arms to be extended and retracted during the processing of the carton blanks 111 to achieve closure and sealing of the flaps.

The upper pneumatic actuator device 704a and the upper plough 708a may be appropriately positioned and angled downwards (such as at about 45 degrees to the vertical) to be able to fold down major flap F sufficiently to be able to be engaged by the right hand compression device 706. Similarly, the lower pneumatic actuator device 704b and the lower plough 708b may be appropriately positioned and angled upwards (such as at about 45 degrees to the vertical) to be able to fold up major flap G sufficiently to be able to be engaged by the right hand compression device 706, substantially simultaneously, or at least allowing for the right hand compression device 706 to be able to compress both flaps F and G at the same time towards minor flaps J and K that have upper surfaces containing some adhesive.

The glue applicator 709 may have nozzles appropriately positioned and the operation of the nozzles may be controlled by the PLC 132. The glue applicator 709 may apply a suitable adhesive to the flaps, such as leading minor flap J and trailing minor flap K, once these flaps have been folded inwards to form part of the carton bottom. An example of a suitable known applicator, which may be employed for the glue applicator 709, is the model ProBlue 10 applicator made by Nordson Inc. An example of a suitable adhesive that could be employed on a carton blank 111 made of cardboard is Cool-Lok 034250A-790 adhesive available from Lanco Adhesives, Inc. The glue applicator 709 may be in electronic communication with the PLC 132, which may be operable to signal the glue applicator 709 to apply adhesive at an appropriate time during the positioning of the erector heads 120a, 120b.

The left hand compression device 704 may be used to enter the carton from the left side and compress flaps F, G, J and K between the left hand compression plate 720, the upper rail 717a of the right hand compression device 706 and the lower rail 717b of the right hand compression device 706. This compression may be shown to assist in ensuring that the panels are compressed together to allow the adhesive to appropriately bond the flaps together to make a solid carton bottom.

In some embodiments, once the left hand compression device 704 and the right hand compression device 706 have completed the compression of the flaps, the PLC 132 may send a signal to solenoid valve devices, thereby causing the left hand compression device 704 and the right hand compression device 706 to be withdrawn. The carton blank 111 may be shown to then have been fully opened to for an erected carton suitable to be loaded with one or more items. The second erector head 120b may then carry the erected carton to a discharge chute 750 and then release the erected carton, such that the erected carton falls onto the discharge conveyor 117, which can then move the erected carton away for further processing. In other embodiments, such as the embodiment illustrated, the erected carton 111 may be released and fall onto the support plate 703 and remain on the support plate 703 until the next carton blank 111, carried by another erector head moved by another movement apparatus (such as the first erector head 120a moved by the first movement apparatus 115a), moves the next carton blank 111 into the location where the next carton blank 111 is to be folded, sealed and compressed. In doing so, the next carton blank 111 pushes the previous erected carton downstream, where the previous erected carton may fall onto the discharge conveyor 117. Carton discharge conveyors are well known in the art and any suitable known carton conveyor may be utilized for the discharge conveyor 117.

Other examples of transfer devices, which might be employed to transfer the erected carton from the folding and sealing apparatus 130 to a carton discharge conveyor, include a “blow-off” system that may use one or more jets of compressed air, a suction cup system, the use of pushing arm or simply allowing for freefall of the erected carton.

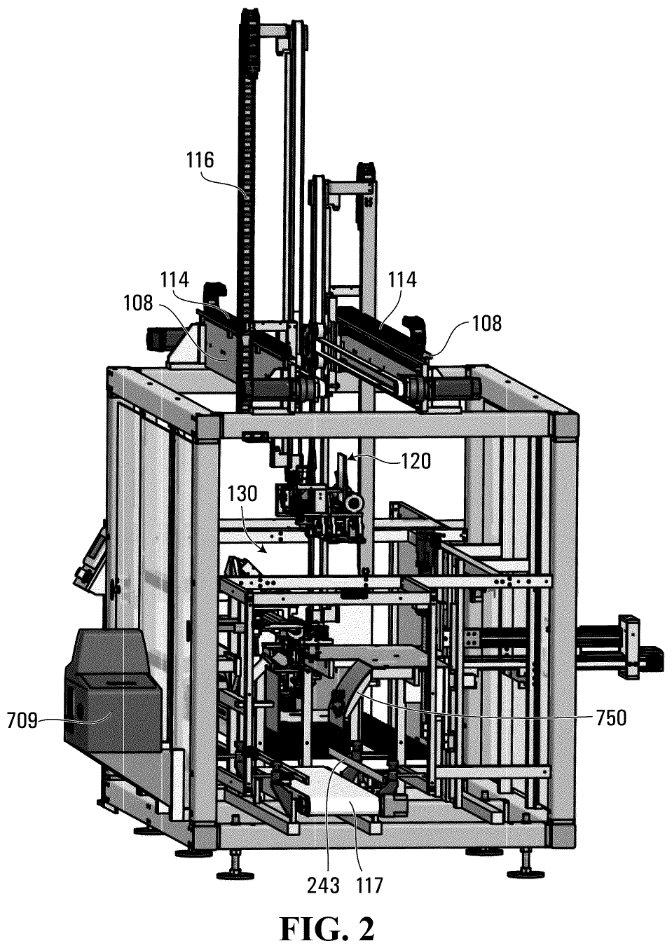

A discharge sensor 243 (see FIG. 2), such as an electronic eye model 42KL-P2LB-F4 made by Allen-Bradley, may be located near the bottom of the discharge chute 750. The discharge sensor 243 may be positioned and operable to detect the presence or absence of an erected carton at the input to the discharge conveyor 117. In this way, the PLC 132 can be digitally signaled that an erected carton is in place at the bottom of the discharge chute 750, such that another erected carton cannot be discharged down the discharge chute 750. If an erected carton is in place at the bottom of the discharge chute 750, the carton forming system 100 can be stopped by the PLC 132 until any fault at the discharge conveyor 117 can be rectified.

The overall operation of the carton forming system 100 will now be described further.

As an initial step, the PLC 132 may be accessed by an operator, through the HMI 133, to activate the carton forming system 100. Responsive to activation, the carton forming system 100 may be initialized by the PLC 132 establishing that all components are put in their “start” positions. A stack of carton blanks 111 may be placed at the input end of the in-feed conveyor 204 and the carton forming system 100 may then be allowed to commence operation, such as by the PLC 132 being instructed, through the HMI 133, to commence the processing of the stack of the carton blanks 111.

The PLC 132 may then send an instruction to the drive motor of the in-feed conveyor 204 to commence to drive the in-feed conveyor belt 214, thereby causing the stack of carton blanks 111 to move downstream. Sometime prior to the stack of carton blanks 111 reaching the alignment conveyor 206, the right hand side guide wall 201, under control of the PLC 132, may be shown to be driven, by the drive mechanism 260, to expand wide enough to allow the stack of carton blanks 111 to enter the alignment conveyor 206, even if the stack is misaligned and/or the carton blanks 111 in the stack are not perfectly square with each other. The stack of carton blanks 111 may then be moved downstream, until the front edge of the stack of blanks passes the downstream edge of the in-feed conveyor 204, the gap sensor 242 may be shown to send a signal to the PLC 132, the signal indicating that the front edge of the stack has reached the input to alignment conveyor 206. In response to receiving the signal, the PLC 132 may send an instruction to the drive motor of the in-feed conveyor 204 to commence to drive the alignment conveyor belt 216 causing the stack of carton blanks 111 to move downstream towards the front end wall 218 of the magazine 110. Once the front edge of the stack of carton blanks 111 reaches the front end wall 218, the presence sensor 240 may be shown to send a signal to the PLC 132 indicating that the front edge of the stack of blanks has reached the front end wall 218. In response to receiving the signal, the PLC 132 may initiate the tamping sequence to “square up” the stack of carton blanks 111, as detailed hereinbefore.

In review, the tamping sequence, for ensuring that the carton blanks 111 are properly squared up at the pick-up position, may include the following steps. The tamping actuator 276 may be extended upon having been activated by pressurized air controlled by the PLC 132 and the associated valve. Then, the right hand side guide wall 201 may contract to make contact with the side of the stack of carton blanks 111 to, thereby, press the stack of carton blanks 111 against the left hand side guide wall 200. This pressing may be shown to align the carton blanks 111 so that the side edges of the carton blanks 111 are aligned with each other and the respective longitudinal side walls of the left hand side guide wall 200 and the right hand side guide wall 201. The tamping actuator 276 may then retract and the vertical tamping plate 280 may press the stack of carton blanks 111 forward, thereby aligning the carton blanks 111 in the stack so that their front edges and rear edges are vertically aligned with each other and with the inner face of the vertical tamping plate 280 and the inside surface of the front end wall 218. The stack of blanks 111 is then properly positioned so that the erector heads 120a and 120b can begin picking up blanks from the stack.

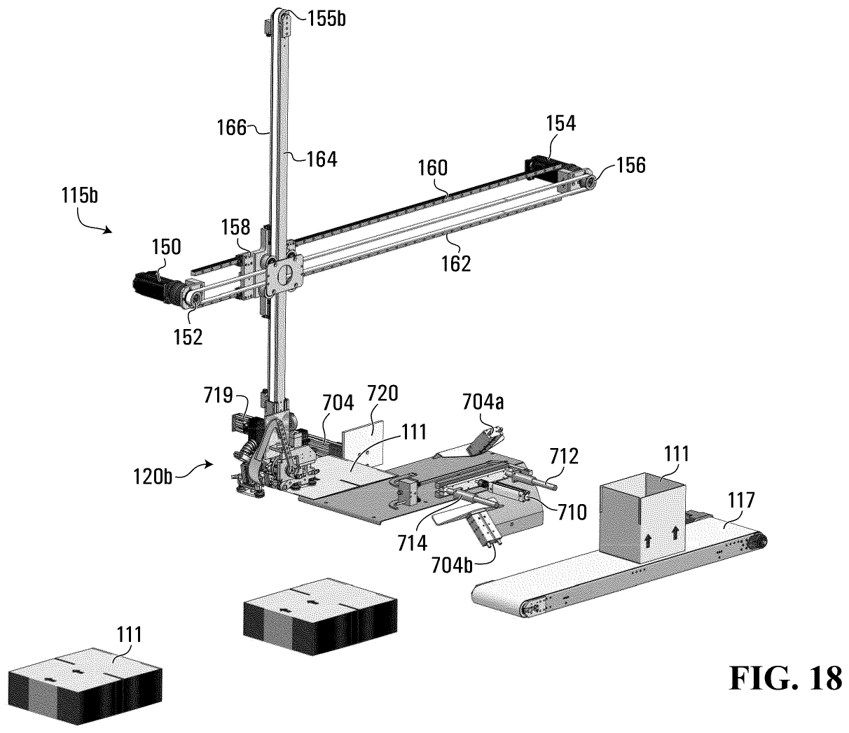

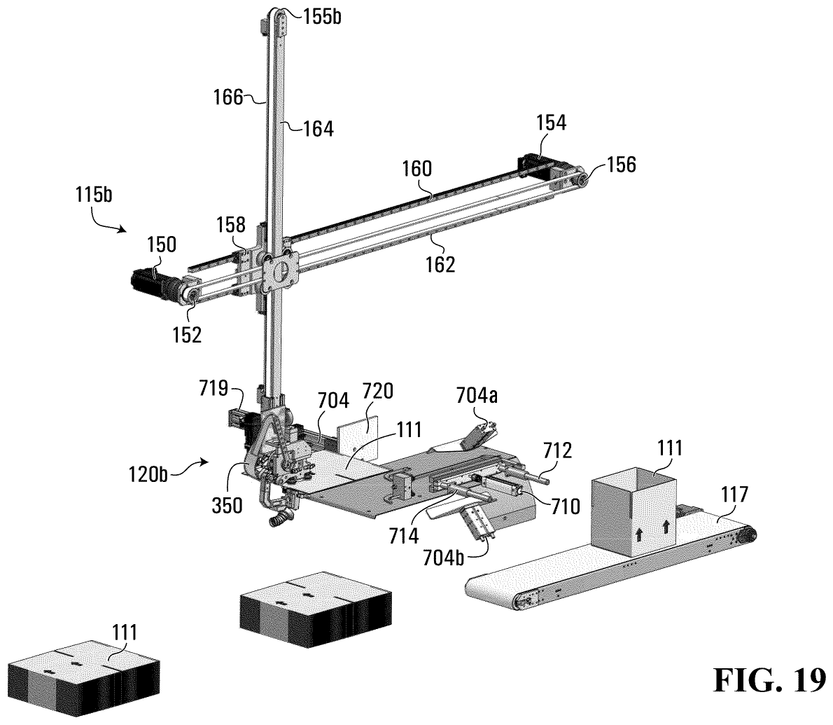

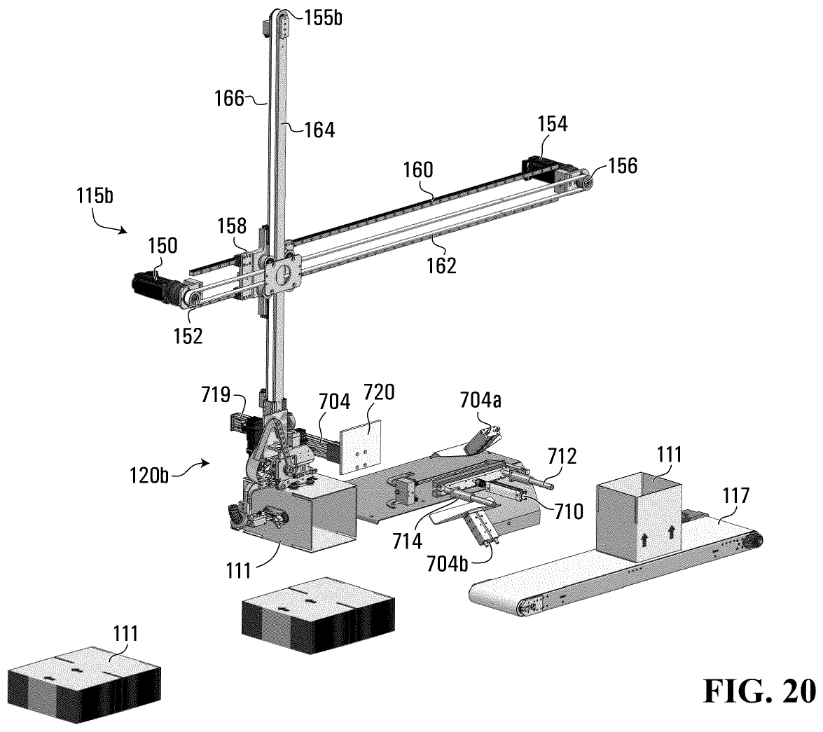

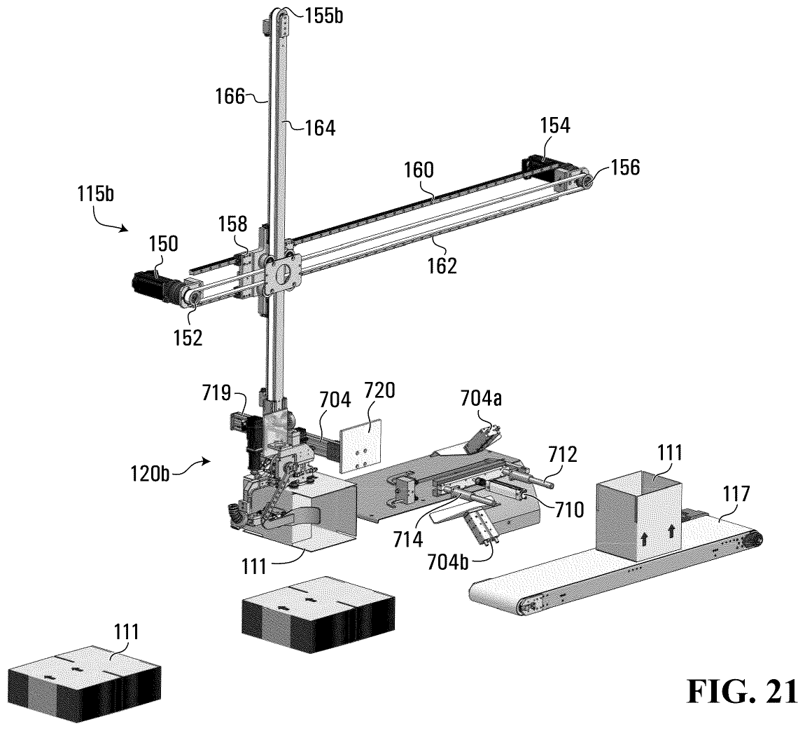

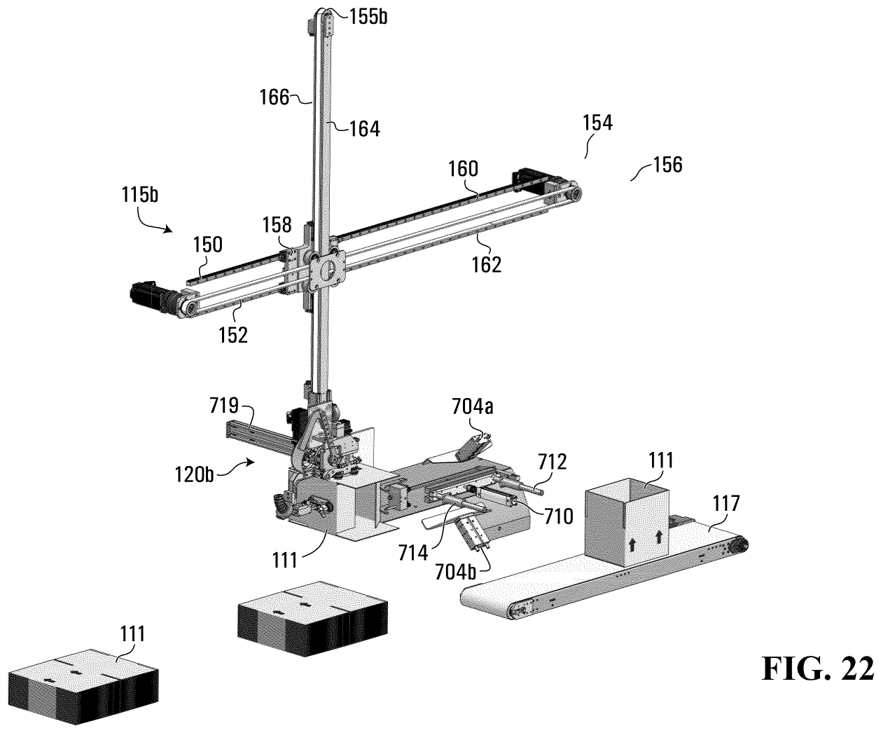

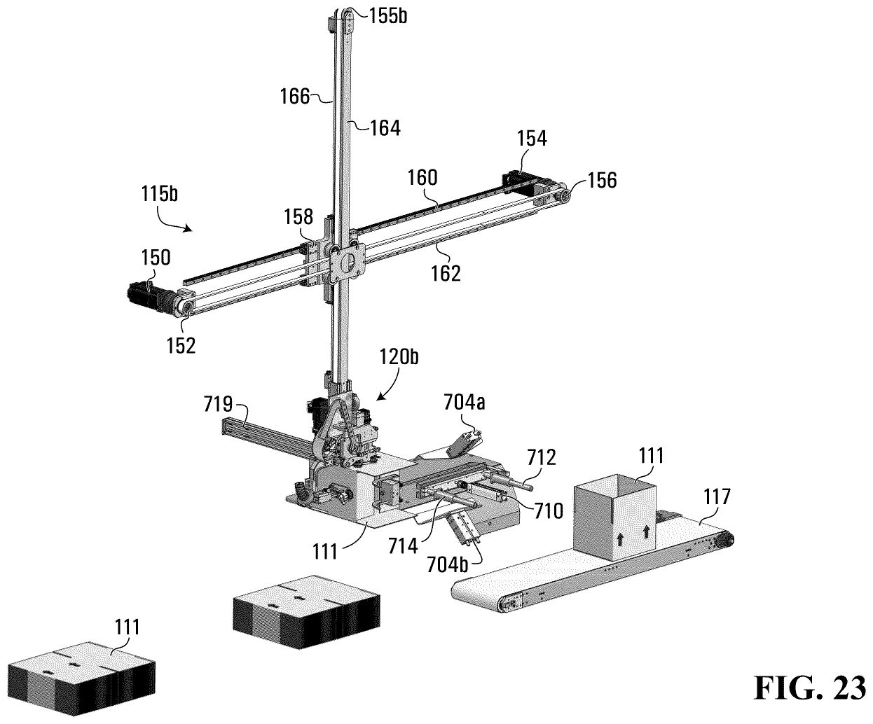

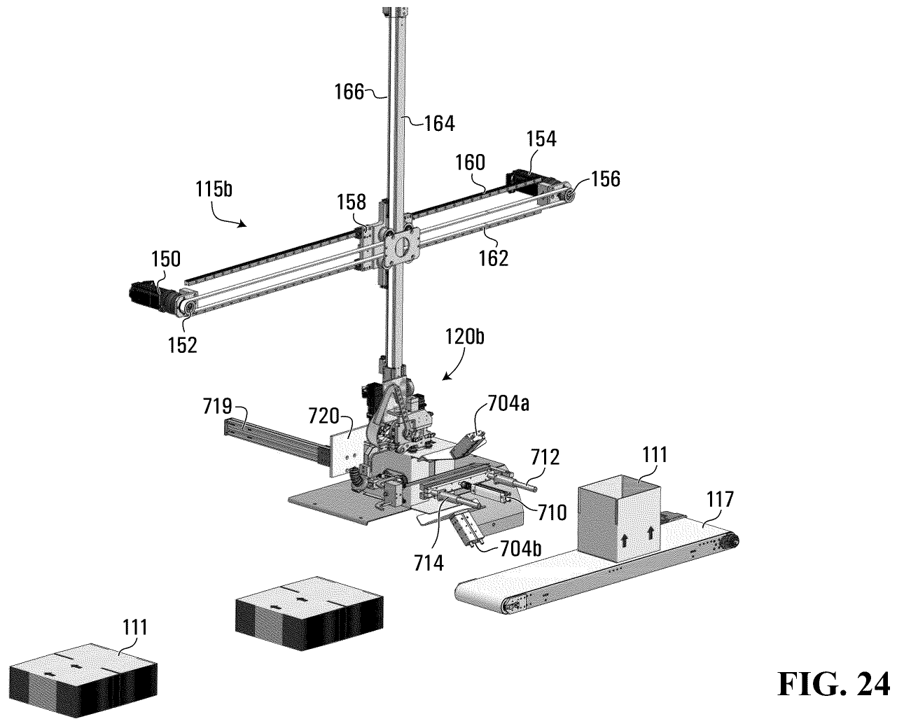

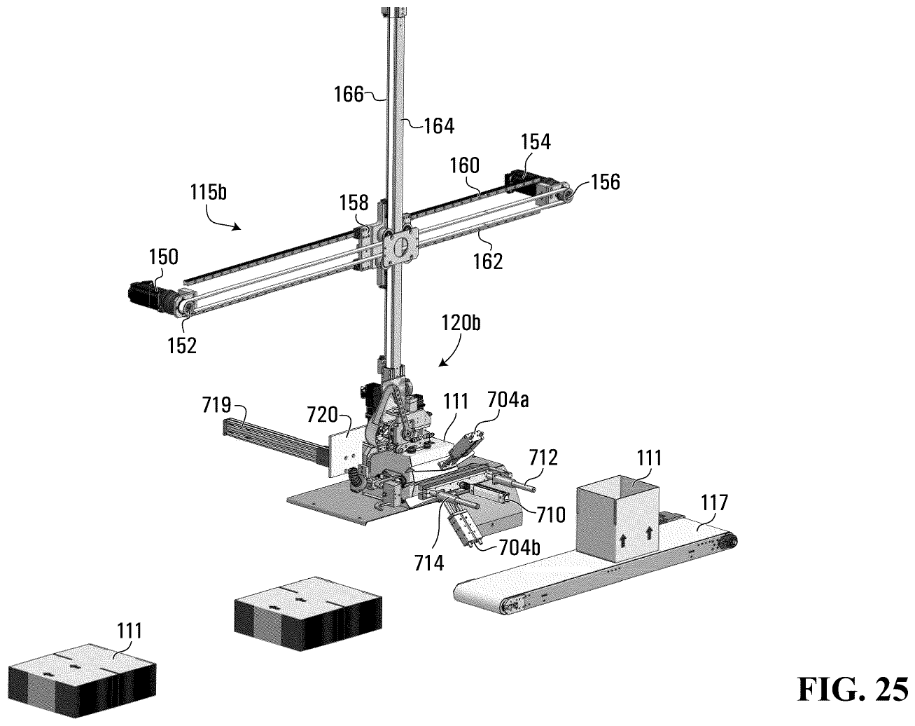

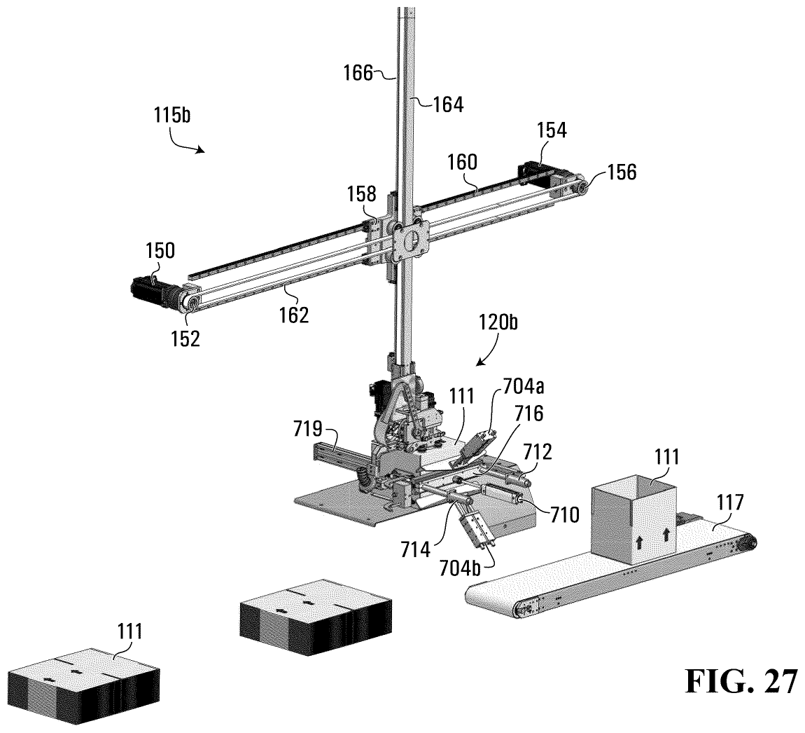

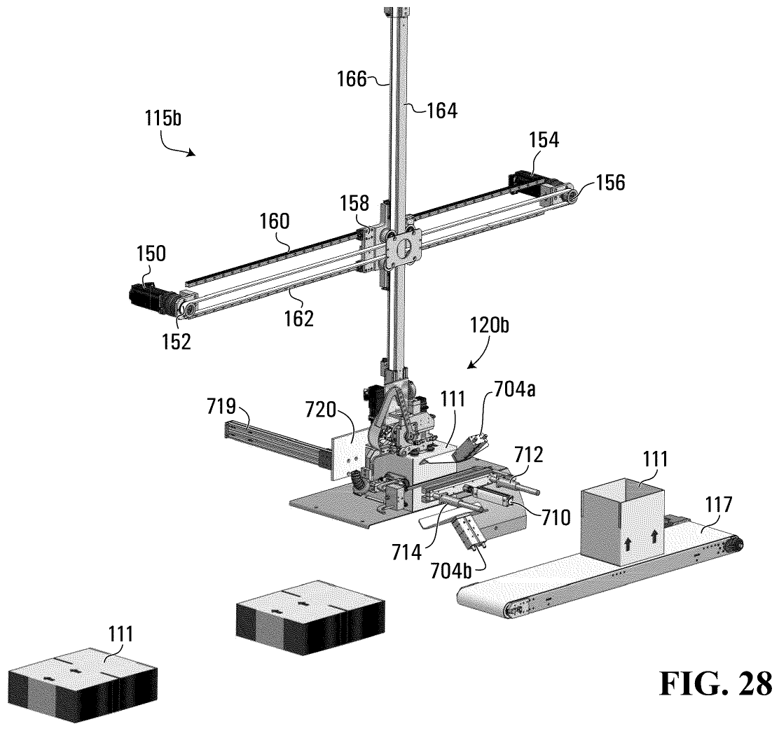

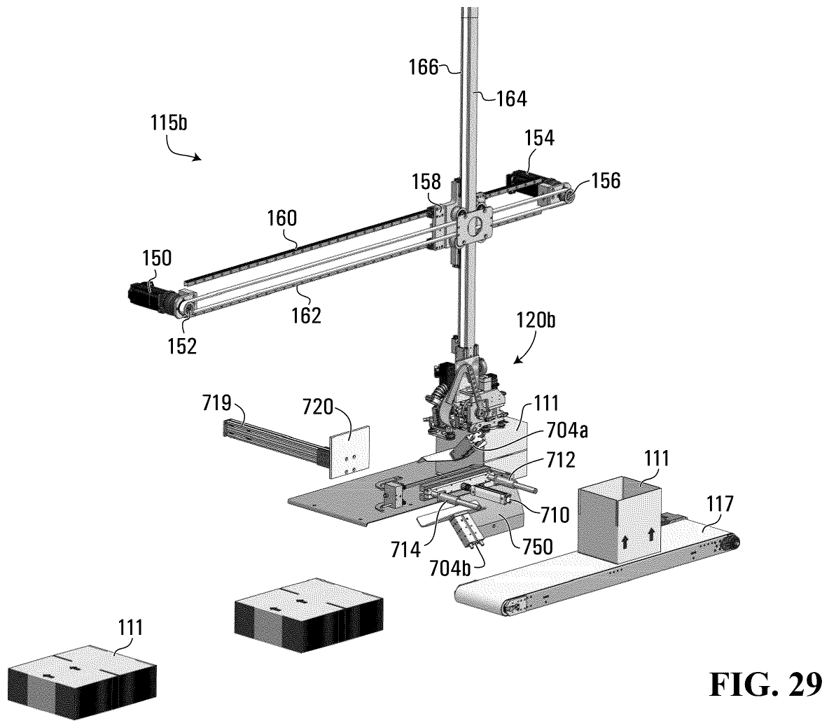

One of the erector heads, such as the second erector head 120b may be shown to be positioned, by the control of the PLC 132 over the second movement apparatus 115b, at the zero position calibrated for the second erector head 120b. The PLC 132 may then cause the left belt drive motor 150 and the right belt drive motor 154 to be operated to achieve the following sequence of operations.
First, the second erector head 120b may be moved to the pick-up position, as illustrated in FIG. 17.
As the second erector head 120b is being brought vertically downwards to retrieve the top carton blank 111 on the stack of carton blanks 111 in the magazine 110, the movement of the second erector head, just prior to the suction plate suction cups 312 contacting with the upper surface of the carton blank 111 may be shown to be generally vertically downwards. Prior to the suction plate suction cups 312 contacting the surface of panel A of the carton blank 111, the sensor rod 380 may be shown to engage the surface of panel A, thereby causing the sensor rod 380 to be pushed upwards. This upward movement of the sensor rod 380 relative to the bottom suction plate 327 may be shown to physically cause the sensor rod 380 to be activated and, responsively, send a signal to the PLC 132. The PLC 132 may respond to receiving the signal by causing the left belt drive motor 150 and the right belt drive motor 154 to slow down, so that the final few centimeters (e.g., 3.5 cm) of movement downwards towards contact between the suction plate suction cups 312 and the upper surface of panel A occurs at a much slower rate. Also, the PLC 132 knows how much further vertically downwards the second erector head 120b is to be lowered to establish proper contact between the suction plate suction cups 312 and panel A. It should also be clear that the sensor rod 380, and the associated sensor device, can also be used to establish that the PLC 132 is aware of whether, once a give carton blank 111 has been engaged in the magazine 110, the given carton blank 111 stays engaged with the second erector head 120b until the appropriate release location is reached, such as once erection of the carton blank 111 has been completed.
The PLC 132 may also be shown to operate the solenoid valve device 340 on the second erector head 120b to, thereby, cause a suction force to be developed at the suction plate suction cups 312 and, optionally, also at the piston arm suction cups 320 (although suction at the piston arm suction cups 320 can be delayed).
With the second erector head 120b in the pick-up position, as illustrated in FIG. 17, and the suction force being applied at the suction plate suction cups 312, the second erector head 120b may engage the panel A (see location of suction cup outline on FIG. 10A) and then commence to lift the given carton blank 111 upwards, as illustrated in FIG. 18. The PLC 132 may be shown to know how high to lift the upper surface of the given carton blank 111 to, thereby, ensure that, once opened up, the first datum line W1 will be appropriately vertically located, so that components of the folding and sealing apparatus 130 will be able to fulfil their respective functions, as described hereinbefore.
Preferably, when the second erector head 120b has reached a determined vertical position and, preferably, while the second erector head 120b is not moving longitudinally towards the folding and sealing apparatus 130, the PLC 132 sends a signal to cause the servo motor 364 to rotate. Rotation of the servo motor 364 may be shown to cause the transversely mounted shaft 342 to rotate in a particular desired direction at a particular desired rotational speed for a desired amount of time. The PLC 132 may control a rotational position of the transversely mounted shaft 342 to cause the rotator device 350, which is fixedly attached to the transversely mounted shaft 342, to rotate with the transversely mounted shaft 342. Thus, the rotator device 350 may be rotated to the position shown in FIG. 19 and, at that position, the piston arm suction cups 320, which will have suction engaged, may be shown to attach to the underside of the given carton blank 111 and, in particular, to panel D.
In the next operation, the “blank opening” operation, through control of the PLC 132, opposed forces provided by the suction plate suction cups 312 acting upwards on the top and the piston arm suction cups 320 acting in an opposite downward direction may be shown to start to pull the flat given carton blank 111 apart. The forces are then continued by the suction plate suction cups 312 above and the piston arm suction cups 320 below, as the rotator device 350 is given a backwards rotation of 90 degrees to, thereby, move the given carton blank 111 into the position illustrated in FIG. 20.
During the backwards rotation of the rotator device 350, the mounting block pneumatic actuator device 325 may be supplied with pressurized air controlled through the solenoid valve device 340. The PLC 132 may send a signal to the solenoid valve device 340 to operate the mounting block pneumatic actuator device 325 to extend the piston arms 326 at a particular angular position of the rotator arm 351 and/or a particular angular position of the second erector head 120b that is provided by the encoder associated with the servo motor 364. The PLC 342 may cause, by acting through the solenoid valve device 340, the mounting block pneumatic actuator device 325 to be actuated at approximately the same time as the piston arm suction cups 320 have contacted the surface of downward facing panel D and the rotation of the rotator arm 351 is just about to begin or has just commenced. The piston arms 326 may be completely extended by the time the rotator arm 351 has rotated about 45 degrees. The piston arms 326 may continue to be extended and stay extended when the rotator device 350 is at the 90 degrees position, illustrated in FIG. 20.
Once the given carton blank 111 has been opened, the second erector head 120b can securely hold the blank by the suction forces exerted to panel A by the suction plate suction cups 312 and exerted to panel D by the piston arm suction cups 320. Also, once opened, the flaps K and J need to be folded inwards towards the bottom opening of the given carton blank 111. In the embodiment illustrated in FIG. 21, the trailing minor flap K is closed by actuation of the paddle 310. Accordingly, the PLC 132 can send a signal to the solenoid valve device 340. The signal causes the rotary actuator 399 to rotate the paddle shaft 316 and, thus, rotate the paddle 310. The paddle 310 can then engage trailing minor flap K of the given carton blank 111 and cause trailing minor flap K to fold about its fold line where trailing minor flap K joins to panel D. Thus, trailing minor flap K can be folded inwards towards the bottom opening of the given carton blank 111.
Leading bottom flap J may also be folded about its fold line, which joins leading bottom flap J with panel B, by engagement of the leading bottom flap J with the upper folding rails/ploughs 700 and the lower folding rails/ploughs 701 that form part of the folding and sealing apparatus 130. This folding may occur as the second erector head 120b is moved longitudinally downstream towards the folding and sealing apparatus 130. As the given carton blank 111, held by the second erector head 120b, is moved longitudinally downstream into the folding and sealing apparatus 130, the leading bottom flap J can be folded inwards by the upper folding rails/ploughs 700 and the lower folding rails/ploughs 701, so that both bottom flaps K and J have been folded inwards to start the formation of the bottom of the carton, as illustrated in FIG. 22.
Also, when the flaps K and J have been folded inwards, under the control of the PLC 132, or pursuant to another control or trigger, the adhesive applicator 709 can, through appropriately positioned nozzles, apply a suitable adhesive at appropriate positions on the flaps K and J. The application of glue can occur before, during or after the PLC 132 has caused the second movement apparatus 115b to move the second erector head 120b to a downstream location where the major flaps F and G can be folded and compressed onto minor flaps K and J. As illustrated in FIG. 23, glue may be applied while the second movement apparatus 115b is moving the second erector head 120b to the downstream location for closing the bottom opening by folding and compression.
Next, the upper flap actuation device 705 may be activated by the PLC 132 acting through a valve device to cause the upper pneumatic actuator device 704a to extend piston arms connected to the upper plough 708a. Similarly, the lower flap actuation device 707 may be activated by the PLC 132, such that the lower pneumatic actuator device 704b extends its piston arms connected to the lower plough 708b, as shown in sequential FIGS. 24 and 25.
Next, as shown in FIG. 26, the right hand compression device 706, with the central pneumatic actuator 710, may have piston arms extended so that the longitudinally extending sealing plate 716, having attached thereto the upper rail 717a and the lower rail 717b, engages upper major flap F and lower major flap J. The upper rail 717a may be positioned to be able to engage upper major flap F and the lower rail 717b may be positioned to engage lower major flap G when piston arms of the actuator device 710 are extended horizontally and transversely inwards to push major flaps F and G into engagement with flaps K and J that are positioned underneath. The upper flap actuation device 705 and the lower flap actuation device 707 may be withdrawn by the PLC 132 when the compression device 706 has engaged major flaps F and G.
Next, as illustrated in FIG. 27, the left hand compression device 704 may be used to enter the carton blank 111 from the left side and compress flaps F, G, J and K between the left hand compression plate 720 of the left hand compression device 704, the upper rail 717a of the right hand compression device 706 and the lower rail 717b of the right hand compression device 706. This compression may be shown to assist in establishing that the panels are compressed together to ensure that the adhesive appropriately bonds the flaps together to make a solid carton bottom.
Once the compression has been held for a short time (for example, about 0.5 seconds), to allow the glue to sufficiently set/harden and bond the flaps together, the compression can be released by withdrawing the left hand compression device 704 and the right hand compression device 706 as illustrated in FIG. 28. The carton may then be considered to be a fully erected carton and released from the folding and sealing apparatus 130 and from the second erector head 120b. The release may be shown to occur responsive to the PLC 132 causing the piston arm suction cups 320 and the suction plate suction cups 312 to have their suction force turned off by the solenoid valve device 340. Additionally, the PLC 132 may cause the rotator device 350 to be rotated backwards a further 90 degrees to the horizontal ready position illustrated in FIG. 29.
Thereafter, the second erector head 120b may release the erected carton, which can then fall onto the support plate 703 and remain there, on the support plate 703, until the next carton blank 111, carried by another erector head moved by another movement apparatus (such as the first erector head 120a moved by the first movement apparatus 115a) moves the next carton blank 111 into the location where the next carton blank 111 will be folded, sealed and compressed and, in doing so, pushes the fully erected carton downstream to the discharge chute 750, where the erected carton may fall onto the discharge conveyor 117.

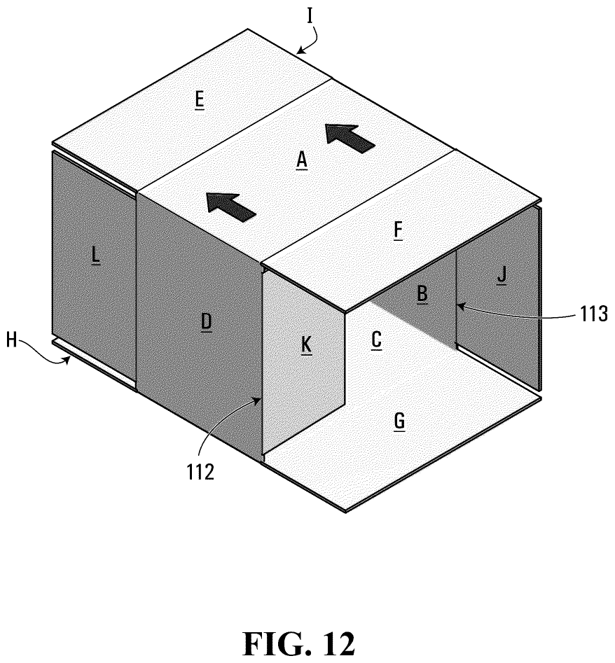

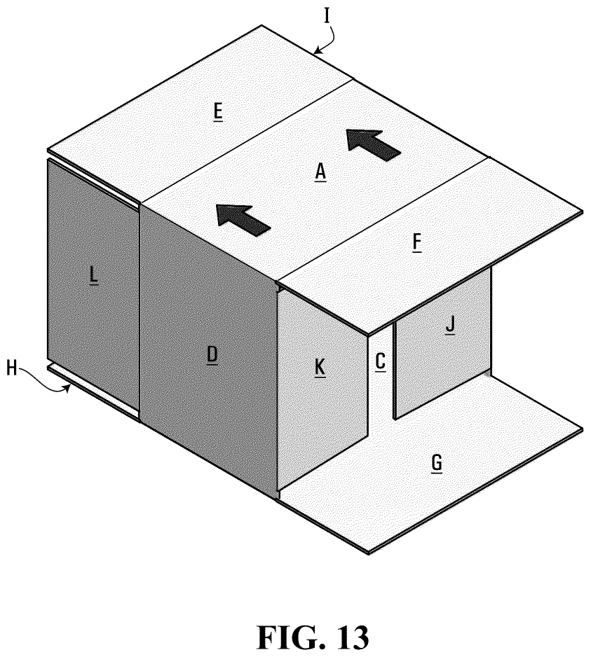

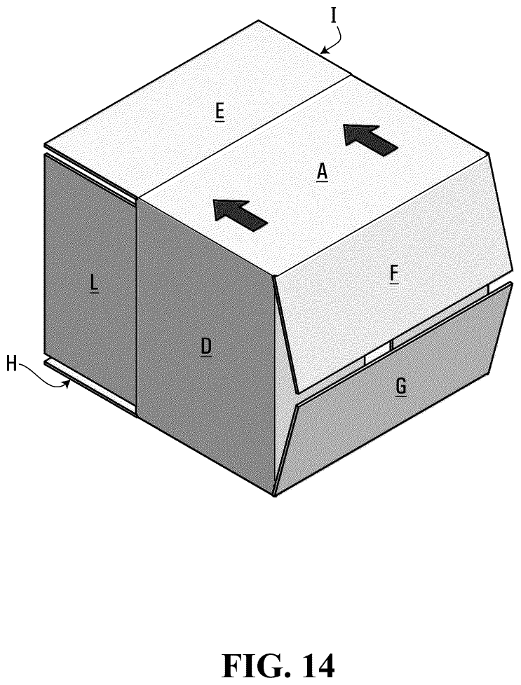

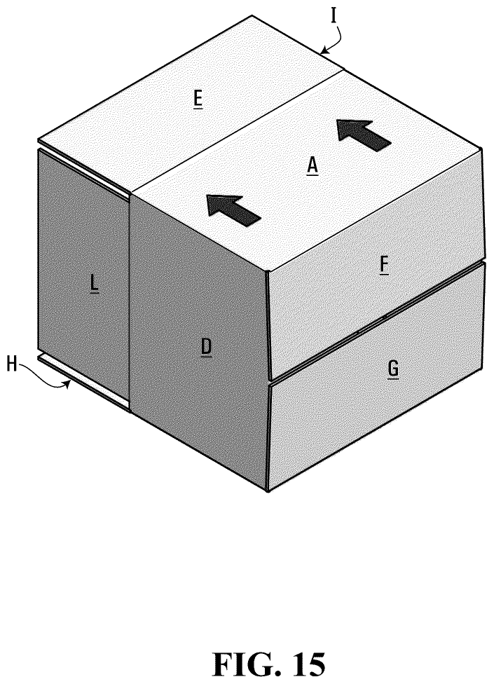

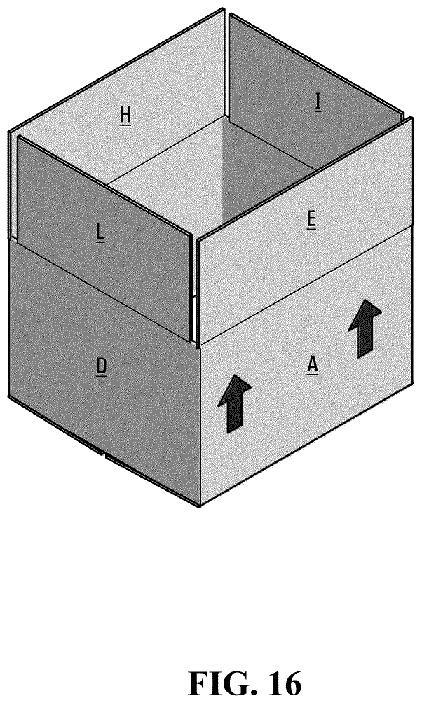

The entire sequence of movement of a given carton blank 111, as the given carton blank 111 is processed by the carton forming system 100, is illustrated in isolation in FIGS. 10A, 10B, 10C, 10D and FIGS. 11 to 16. In FIGS. 10A, 10B, 10C, 10D, the given carton blank 111 is illustrated in its flattened tubular configuration. In FIG. 11, the given carton blank 111 is illustrated in its opened configuration, after being opened by an erector head like the second erector head 120b. In FIG. 12, the given carton blank 111 is illustrated with the trailing minor flap K folded inwards and in FIG. 13, the given carton blank 111 is illustrated with leading minor flap J also folded inwards. In FIG. 14, the given carton blank 111 is illustrated with the major bottom flaps F and G folded inwards. In FIG. 15, the given carton blank 111 is illustrated when the flaps J, K, F and G are being, or have been, compressed to seal the bottom of the erected carton. Finally, in FIG. 16, the erected carton is illustrated with its opening facing upwards, so that the erected carton may be loaded with one or more items.

While the foregoing handling of a carton blank 111 by the second erector head 120b has been occurring, the first erector head 120a, being supported and moved by the first movement apparatus 115a, can be carrying out the same process out of phase with the second erector head 120b. For example, cyclical movement and operation of the first erector head 120a may be 180 degrees out of phase with the movement and operation of the second erector head 120b. By providing the first erector head 120a and the second erector head 120b operating simultaneously, but out of phase, it may be shown that one does not interfere with the other. It follows that the capacity of the carton forming system 100 to process the carton blanks 111 can be shown to be increased significantly relative to a system with only a single erector head. Notably, the use of only a single erector head, the processing capacity of the carton forming system 100 may still be considered to be relatively high. In part, the relatively high processing capacity is also due to a relatively short “stroke” (i.e., longitudinal distance) that the erector heads travel when carrying out the blank retrieval, erection, folding, sealing and compression. This relatively short stroke means that the components do not travel as great a distance as travelled by components in conventional carton erectors. When using two erector heads with moving apparatuses, the carton forming system 100 may be capable of processing about 35 cartons blanks per minute.

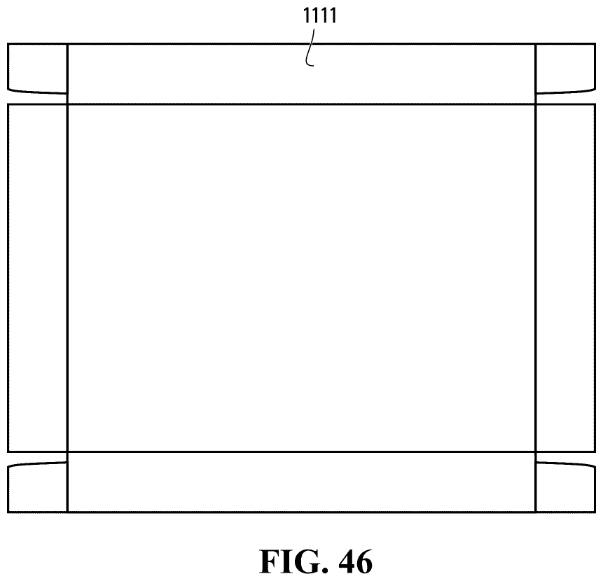

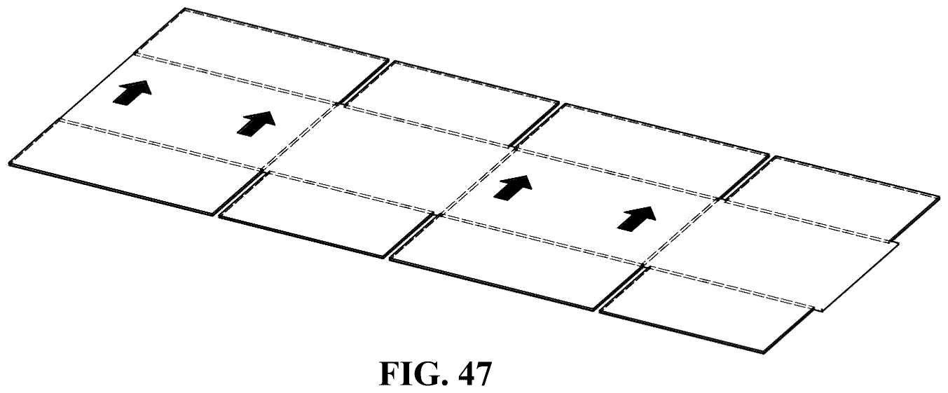

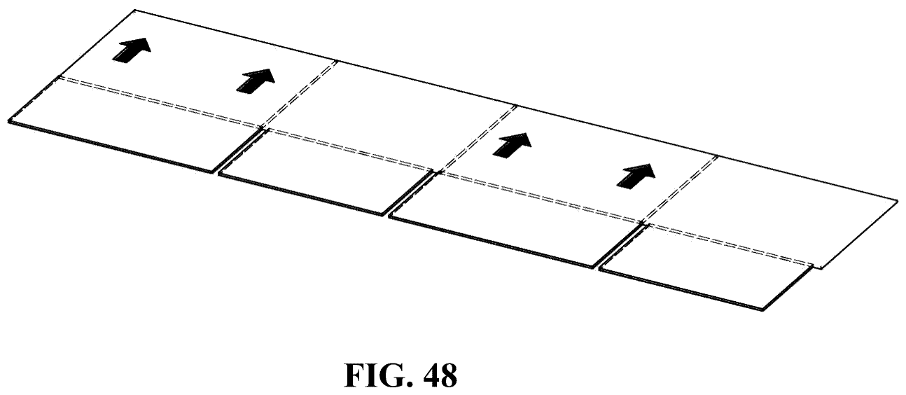

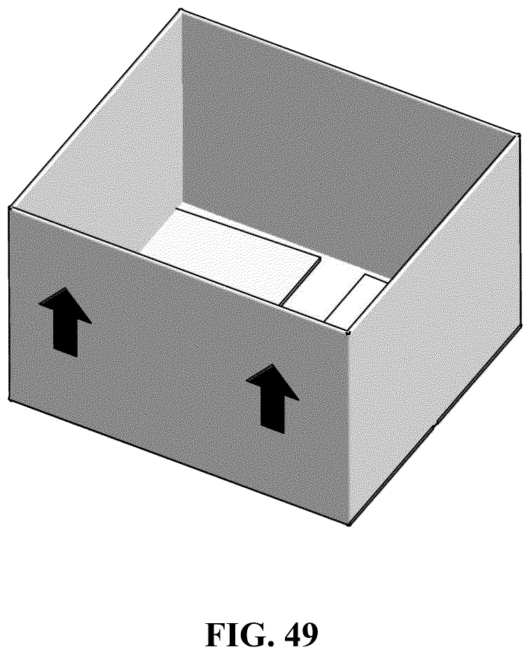

It will be appreciated that, by making a relatively small number of changes to the components of the carton forming system 100, the carton forming system 100 may be altered from being able to process blanks for open top cartons to being able to process blanks that can be turned into open top trays. FIG. 46 illustrates a plan view of a blank for a tray that may be processed according to some embodiments. Examples of other blanks that may be processed, cartons that may be formed are illustrated in FIGS. 47, 48 and 49 and include blanks for a so-called wrap around half slotted case (HSC) and HSC blanks, as well as blanks for a wraparound RSC.

It should be clear that carton forming systems may be arranged in a manner distinct from the carton forming system 100 of FIG. 1A. For example, several arrangements for carton forming systems are disclosed in U.S. patent application Ser. No. 16/230,979, filed Dec. 21, 2018 and issued as U.S. Pat. No. 10,556,713 on Feb. 11, 2020 and disclosed in U.S. patent application Ser. No. 16/808,140, filed Mar. 3, 2020 and published as United States patent publication no. US 2021/0138756 A1 on May 13, 2021, all of which documents are hereby incorporated in their entirety herein by reference.

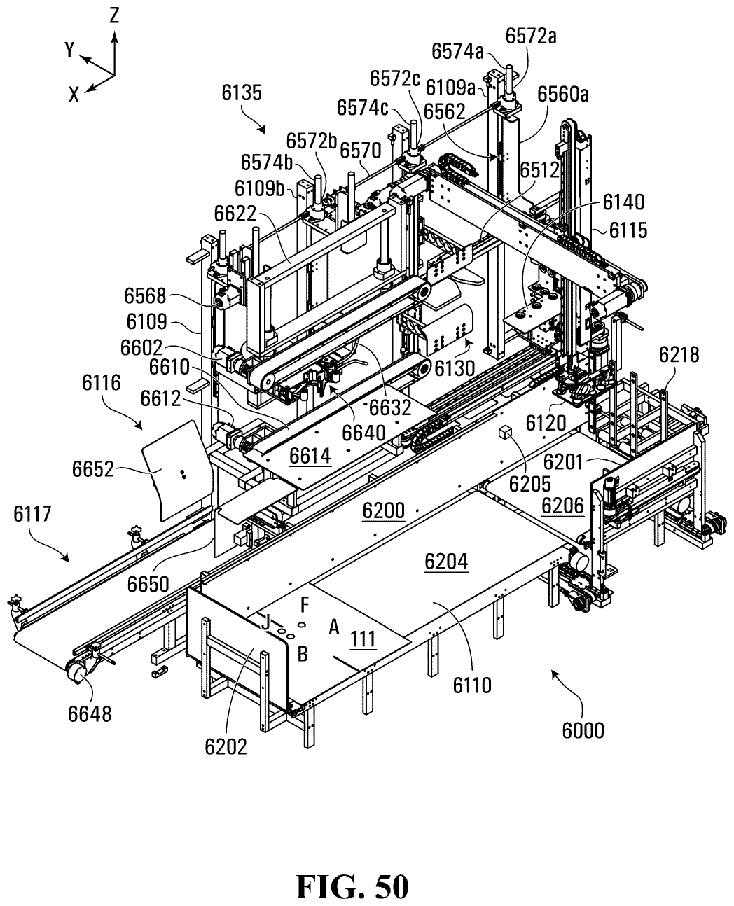

With reference to FIG. 50, in overview, a carton forming system 6000, which is presented as an alternative to the carton forming system 100 of FIG. 1A, has a magazine 6110 adapted to receive and hold a plurality of knock-down carton blanks 111 and an end effector 6120 for retrieving the knock-down carton blanks 111 from a pick-up area and placing the knock-down carton blanks 111 on a shuttle 6140. As will be described hereinafter, the end effector 6120 and the shuttle 6140 co-operate to manipulate the knock-down carton blanks 111 in such a way as to erect the knock-down carton blanks 111 into sleeves.

The carton forming system 6000 may also include a folding apparatus, generally designated 6130 and configured to fold one or more flaps of each sleeve, and a sealing station 6135 at which flaps of the carton blanks 111 are sealed. The carton forming system 6000 may also include a carton re-orienting station 6116 and a carton discharge conveyor 6117 for receiving and moving cartons away once they have been fully erected.

The operation of the components of the carton forming system 6000 may be controlled by a PLC. The PLC may be accessed by a human operator through a Human Machine Interface (HMI) module secured to a frame 6109 of the carton forming system 6000. The HMI module may be in electronic communication with the PLC. The PLC may be any suitable PLC and may for example include a unit chosen from the Logix 5000 series devices made by Allen-Bradley/Rockwell Automation, such as the ControlLogix 5561 device. The HMI module may be a Panelview part number 2711P-T15C4D1 module also made by Allen-Bradley/Rockwell Automation.

Turning now to the various portions of the carton forming system 6000, with reference to FIG. 50, the magazine 6110 may be configured to hold a stack including a plurality of vertically stacked knock-down carton blanks 111 and may be operable to move the stack of the carton blanks 111 in a horizontal direction generally parallel to horizontal axis X under the control of the PLC, to a pick-up location where the end effector 6120 can retrieve cartons from the magazine 6110.

The magazine 6110 may comprise a single conveyor or other blank feed apparatus to deliver the carton blanks 111 to a pick-up location. In the illustrated embodiment, two conveyors are disclosed: an in-feed conveyor 6204; and an alignment conveyor 6206. The in-feed conveyor 6204 may be configured and operable to move a stack of the carton blanks 111 from a stack input position (where a stack may be loaded onto the in-feed conveyor 6204 such as by human or robotic placement) to a position where the stack of the carton blanks 111 is transferred to the alignment conveyor 6206 for horizontally aligning and transversely aligning. The alignment conveyor 6206 may be positioned downstream in relation to the in-feed conveyor 6204 and may be used to move the stack of the carton blanks 111 to the pick-up location. The magazine 6110 may be loaded with, and initially hold, a large number of the carton blanks 111 in vertical stacks, with the stacks resting on the in-feed conveyer 6204. A rear wall 6202 mounted to the frame 6109 may be configured to prevent a stack from falling backwards when initially loaded on the in-feed conveyor 6204. The rear wall 6202 may have a generally planar, vertically and transversely oriented surface facing the stack of the carton blanks 111. The in-feed conveyor 6204 may be of an appropriate length to be able to store a satisfactory number of stacks of the carton blanks 111 in series on the in-feed conveyor 6204. The PLC can control the operation of the in-feed conveyor 6204 to move one stack at a time to the alignment conveyor 6206.

With the in-feed conveyor 604 having one or more stacks of the carton blanks 111 arranged longitudinally thereon, the stacks can be fed, in turn, onto the alignment conveyor 6206. A sensor (not shown) may be provided in the vicinity of the in-feed conveyor 6204 to monitor whether there is a stack waiting on the in-feed conveyor 6204 and that sensor may be operable to send a warning signal to the PLC that can alert an operator that the magazine 6110 is low and needs to be replenished. The sensor may be a part number 42GRP-9000-QD made by Allen Bradley.

Of particular note, a plurality of stacks of blanks might be provided on the in-feed conveyor 6204 and each stack may be have associated information that can be read by an information reader 6205, such as electronic or an optical reading device. For example, a bar code may be provided on each stack of the carton blanks 111, such as on the top or bottom carton blank 111 of the stack. The bar code may be read by a bar code reader associated with the in-feed conveyor 6204. The bar code reader may be in communication with PLC. The bar code may provide information indicative of a characteristic of the carton blanks 111 in the stack. For example, the bar code may identify the size and/or type of the carton blanks 111 in a particular stack. Other information indicators may be used, such as, for example, RFID tags/chips and RFID readers. The information can then be automatically provided, by the information reader, to the PLC, which can determine whether the current configuration of the carton forming system 100 can handle the processing the particular type/size of blanks without having to make manual adjustments to any of the components. It is contemplated that, within a certain range of types/sizes of carton blanks 111, the carton forming system 6000 of FIG. 50 is able to handle the processing of different types/sizes of carton blanks 111 without manual adjustment of any components of the carton forming system 6000 of FIG. 50. The bar code/RFID tag may provide the information about the dimensions of the carton blank 111, as discussed hereinbefore, and then the PLC can determine adjustments, if any, that need to be made to (a) the components of the magazine 6110; (b) the movement of the end effector 6120; (c) the movement of the shuttle 6140; and (d) at least some of the components of the folding apparatus 6130 and some components at the sealing station 6135 to be able to process a particular carton blank 111 or a particular stack of carton blanks 111. The result is that the carton forming system 6000 of FIG. 50 may be able to automatically process at least some different types of carton blanks 111 to form different erected cartons, without having to make manual operator adjustments to any components of the carton forming system 6000.

The belt of the in-feed conveyor 6204 may be driven by a suitable motor, such as a DC motor or a variable frequency drive motor controlled through a DC motor drive (all sold by Oriental under model AXH-5100-KC-30) by the PLC.

Once the PLC has given an instruction (such as, by a human operator through the HMI module), the in-feed conveyor 6204 may be activated to move a stack of the carton blanks 111 horizontally downstream. The PLC can control the motor through the motor drive and, thus, control the in-feed conveyor 6204 to move and transfer the stack towards, and for transfer to, the alignment conveyor 6206.

The alignment conveyer 6206 may be driven by a motor with a corresponding motor drive. The motor for the alignment conveyer 6206 may also be controlled by the PLC. The alignment conveyer 6206 may be operated to move the stack of the carton blanks 111 further horizontally until the front face of the stack abuts a planar front stop picket wall 6218.

The respective belts of the in-feed conveyor 6204 and the alignment conveyer 6206 may be made from any suitable material, such as, for example, Ropanyl.

During movement of the stack of the carton blanks 111 horizontally by the in-feed conveyor 6204 and the alignment conveyor 6206, the left hand side of the stack of the carton blanks 111 may be supported and guided by a left hand side wall 6200, which may be fixed to the frame 6109. The left hand side wall 6200 may be oriented generally vertically and may extend horizontally for substantially the full length of the in-feed conveyor 6204 and the full length of the alignment conveyor 6206.

The outer side of the magazine 6110 adjacent to the in-feed conveyor 6204 may be left open; however, the outer side of the alignment conveyor 6206 is illustrated as having a moveable outer guide wall 6201.

During operation of the carton forming system 6000 of FIG. 50, the left hand side wall 6200 is fixed and the outer guide wall 6201 may be moved laterally as part of a blank stack alignment procedure to provide for generally longitudinal alignment of the end edges of the carton blanks 111 in the stack being prepared for processing as the stack is held between the left hand side wall 6200 and the outer guide wall 6201. Specifically, the PLC may position the outer guide wall 6201 based on a height dimension of the knock-down carton blanks 111 in the stack being readied for processing, based on information previously read by the information reader 6205.

In order to pick-up blanks, the end effector 6120 may have one or more suction cups providing a suction force to a panel acting generally normal to the surface of the panel that is engaged. Other types of suitable engagement devices might be employed.

The end effector 6120 is illustrated as having a dedicated, independently driven and controlled movement apparatus 6115 that allows the end effector 6120 to move in a plane defined by both vertical axis, Z, and horizontal axis, Y. Thus, movement of the end effector 6120 can only be in the vertical, Z, and horizontal, Y, directions—the end effector 6120 cannot move in a horizontal, X, direction. If the movement of the end effector 6120 is restricted to only Z and Y directions, a moving apparatus can be constructed that is relatively less complex than if movement in all three directions is desired.

The movement apparatus 6115 includes a vertically oriented support tube that may be generally rectangular in cross section and to which the end effector 6120 may be mounted by mounting blocks such that the end effector 6120 moves in space with the support tube.

The folding apparatus 6130 is illustrated as having opposed horizontally reciprocating fin ploughs, namely an upstream fin plough and a downstream fin plough. These fin ploughs are slidably supported on a horizontal rail 6512 that extends in the X-direction.

The horizontal rail 6512 on which the fin ploughs run is attached at either end to the base of L-shaped supports. One of the L-shaped supports is associated with reference numeral 6560a. The L-shaped supports ride in channels 6562 of vertical ribs 6109a, 6109b of the frame 6109. A servo motor 6568 is geared to a common drive shaft 6570 to turn pinions (not shown) inside hubs 6572a, 6572b. The pinions mesh with ring gear portions of shafts 6574a, 6574b to turn, and thereby adjust, the vertical position of the shafts 6574a, 6574b. The shafts 6574a, 6574b are rotatably connected to the top of the L-shaped supports. The result is that operation of the servo motor 6568 in one rotational direction raises the L-shaped supports—and, therefore, the fin ploughs—and operation of the servo motor 6568 in the opposite rotational direction lowers the L-shaped supports.

Similarly, a vertical rail, on which folding ploughs run via support arms and carriages, is attached to a linear support that rides in a channel of a vertical rib of the frame 6109. A common drive shaft also turns a pinion (not shown) inside a hub 6572c and this pinion meshes with a ring gear portion of a shaft 6574c in order to turn, and thereby adjust, the vertical position of the shaft 6574c. The shaft 6574c is rotatably connected to the top of a linear support. The result is that operation of the servo motor 6568 in one rotational direction raises the linear support—and, therefore, the folding ploughs—and operation of the servo motor 6568 in the opposite rotational direction lowers the linear support. Moreover, since all of the supports are adjusted by the common drive shaft 6570, these supports are all adjusted to the same vertical extent by operation of the servo motor.

The sealing station 6135 has a tape sealer 6640 and flap folding rods 6632, which are supported by the fin supporting rail 6512 and move vertically with the fin ploughs. The sealing station 6135 also has a pair of opposed conveyor belts, an upper conveyor belt driven by an upper conveyor belt servo motor 6602 and a lower conveyor belt 6610 driven by a lower conveyor belt servo motor 6612, with the tape sealer 6640 disposed between the upper conveyor belt and the lower conveyor belt. The lower conveyor belt 6610 and a supporting platform 6614 are supported by the factory floor. The upper conveyor belt is mounted to a sub-frame 6622. The servo motor 6568 has a second drive shaft that is operatively associated with a drive train (not shown) so that operation of the servo motor 6568 adjusts the vertical position of the sub-frame 6622 and, therefore, adjusts the vertical position of the upper conveyor belt with respect to the lower conveyor belt 6610. Moreover, it will be noted that the drive shaft and the common drive shaft 6570 are driven by the same servo motor 6568, such that a vertical adjustment of the upper conveyor belt is mirrored by a vertical adjustment of the fin ploughs. However, the drive train is configured with a 2:1 drive ratio so that the drive shaft rotates twice for any rotation of the common drive shaft 6570. The result is that a vertical adjustment of n cm of the fin ploughs, folding ploughs, tape sealer and flap supporting rods results in a vertical adjustment of 2n cm of the upper conveyor belt. This ensures that the centerline of a carton sleeve remains at the level of the fins and tape sealer for any position of the upper conveyor belt.

The sealing station 6135 terminates at the carton re-orienting station 6116. The carton re-orienting station 6116 has a pair of deflection plates 6650, 6652, which re-orient an erected carton as the erected carton falls off the end of the sealing station to the discharge conveyor 6117 from a position lying on its side at the sealing station 6135 to an upright position on the discharge conveyor 6117 with the open top of the erected carton facing upwardly. The discharge conveyor 6117 may be implemented as a simple endless belt conveyor driven by a discharge conveyor servo motor 6648.

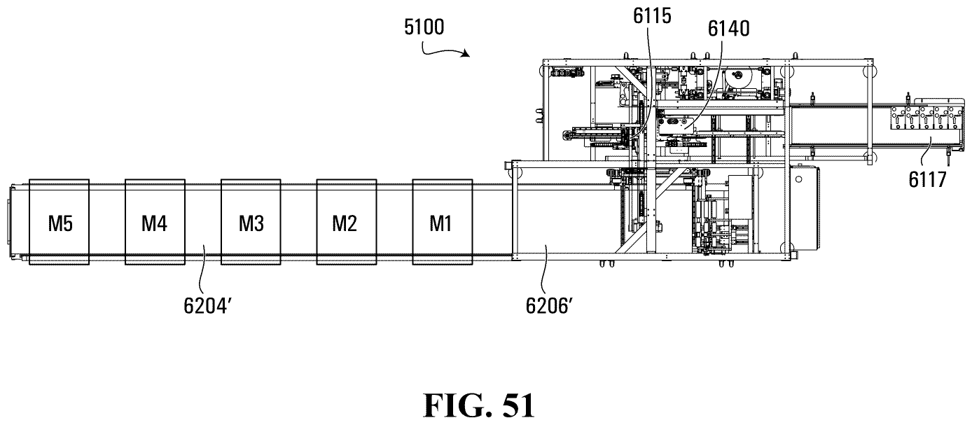

In another aspect of the present application, illustrated schematically in FIG. 51, a carton forming system 5100 is constructed substantially the same as the carton forming system 6000 of FIG. 50, except as described hereinafter. In the carton forming system 5100 of FIG. 51, a plurality of magazines M1-M5 may be supported by one or more frame structures above a common in-feed conveyor 6204′, which may be constructed generally like the in-feed conveyor 6204 of FIG. 50. The magazines M1-M5 may be arranged in spaced longitudinal relation to each other vertically above the in-feed conveyor 6204′. The in-feed conveyor 6204′ feeds an alignment conveyor 6206′, which may be like the alignment conveyor 6206 of FIG. 50. Except as described hereinafter, the remainder of the carton forming system 5100 of FIG. 51 may be the same as the carton forming system 6000 of FIG. 50.

The magazines M1-M15 may each contain one or more stacks of product packaging, such as case blanks which each may generally be like the carton blanks 111 processed by as the carton forming system 6000 of FIG. 50, with at least some and possibly each of the magazines M1-M15 containing different types/sizes and/or configurations of packaging/case blanks compared to other magazines. The size, configurations and types of the case blanks (and the cases that can be formed therefrom) can vary to provide a range of case sizes, configurations and types that can be automatically processed by the carton forming system 5100 of FIG. 51 without the need for any manual intervention to modify any components of the carton forming system 5100 of FIG. 51. A PLC for the carton forming system 5100 of FIG. 51 may be programmed such that the particular dimensions/overall size/configuration (e.g., such as, regular slotted carton or “RSC”)/type of each of the carton blanks held in each one of the magazines M1-M5 is stored in the memory of the PLC.

Each magazine M1-M5 may provide a vertical stack of case blanks above the in-feed conveyor 6204′ and be operable to dispense single case blanks on demand under the control of the PLC, in a flattened orientation onto the in-feed conveyor 6204′. An example arrangement of a suitable type of vertical case dispensing magazine is the magazine that forms part of the 310E case erector made by Wepackit Inc. of Orangeville, Ontario, Canada (see www.wepackitmachinery.com/310E/310E.pdf).

The PLC may give an instruction to form a case and, if required, the PLC may cause one of the magazines M1-M5 to dispense a carton blank of an appropriate configuration/size onto the in-feed conveyor 6204′ for delivery to the alignment conveyor 6206′. The PLC is expected to selectively move and transfer a single carton blank at a time onto the in-feed conveyor 6204′ from any one of the magazines M1 to M5. Therefore, separate individual case blanks may be fed, in series and longitudinally, in a desired sequence by the in-feed conveyor 6204′ to the alignment conveyor 6206′. The particular sequence/order of the carton blanks that are placed onto the in-feed conveyor 6204′ of the carton forming system 5100 of FIG. 51 may be determined and selected by the PLC or another control system, such that the case blanks may arrive at the alignment conveyor 6206′ in such a desired sequence in which it is desired to process the blanks within the carton forming system 5100 of FIG. 51.

The PLC may maintain, in its memory, records of the sequence of the case blanks that have been placed onto the in-feed conveyor 6204′. For example, this information may include the type/size/configuration of the case blank and, where the carton forming system 5100 of FIG. 51 includes a labeler, some label information for a label that is to be applied to the carton blank. A new record can be added each time a request for a new carton is received and, optionally, records can be removed once a carton has been formed (and labeled). Thus, such records may be organized and maintained in sequence in the memory of the PLC using a conventional shift registering technique. In this way, the record for the next carton blank scheduled to arrive at the alignment conveyor 6206′ may be provided at the output of the shift registers as that carton blank arrives and the type/configuration/size of that carton blank and the label information for that carton blank may be determined from the provided output.

Additional features that may be employed in carton forming system 6000 are provided in United States patent publication no. US 2021/0138756 A1 published May 13, 2021, in the name of H. J. Paul Langen, the entire contents of which are hereby incorporated herein by reference.

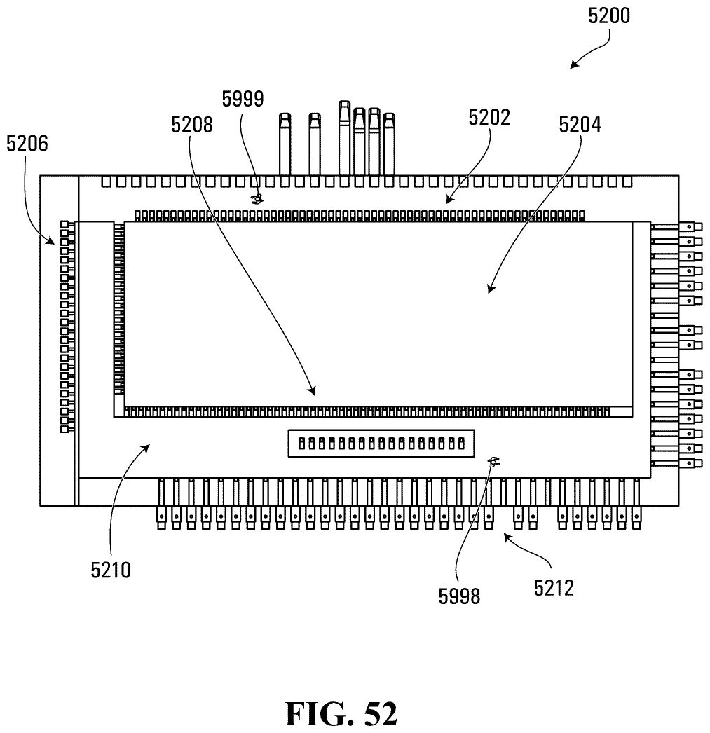

FIG. 52 illustrates, in a plan view, an order fulfillment location 5200. The order fulfillment location 5200 may be considered to be physically organized, in a logical manner or a physical manner, into areas or regions associated with various functions. The order fulfillment location 5200 includes a product storage induction region 5202, a tower storage region 5204, a shipping container induction region 5206, a product induction region 5208, an autonomous mobile robot movement region 5210 and a route distribution accumulation region 5212. In practice, depending upon the size of the order fulfillment location 5200, the order fulfillment location 5200 may include multiples of the regions illustrated in FIG. 52 and may, in some cases, omit one or more regions. The product induction region 5208 may be enclosed by a plurality of walls and a roof.

At the product storage induction region 5202, various products may be shown to arrive at the order fulfillment location 5200 in, say, a plurality of transport trailers.

The products that have arrived, often organized upon a pallet, may be stored into a plurality of towers, which towers are located at the tower storage region 5204. Personnel and/or robots 5999 may unload products delivered (such as by transport trailers and which products may be delivered on pallets) to the order fulfilment system 5200. The personnel and/or robots 5999 may store, in the towers, the unloaded products. Upon being filled with products, a given tower may then be moved, by a tower-transportation AMR (discussed hereinafter), so that the given tower is located within the tower storage region 5204. The process of storing the products, which have arrived at the order fulfillment location 5200, into the plurality of towers, is described in more detail hereinafter.

The shipping container induction region 5206 may be populated with a plurality of carton forming systems, perhaps following the design of the carton forming system 100 disclosed hereinbefore.

According to aspects of the present application, a plurality of autonomous mobile robots (AMRs) may be deployed for movement within the autonomous mobile robot movement region 5210.

As will be discussed in detail hereinafter, an AMR may be controlled to visit the shipping container induction region 5206 to obtain a shipping container.

The combination of the AMR and the shipping container may then be controlled to visit one or more stations in the product induction region 5208. At a given station in the product induction region 5208, one or more products may be received within the shipping container carried by the AMR. The stations in the product induction region 5208 may be associated with provision of products that are stored in the tower storage region 5204.

Upon the receipt of a product that completes an order, the AMR may then be controlled to move around the autonomous mobile robot movement region 5210 so that further order fulfillment functions may be carried out. For a few examples, the AMR may then be controlled to move the shipping container to a location within the autonomous mobile robot movement region 5210 at which location the weight of the shipping container may be verified. The shipping container may then be sealed and labelled.

The weight-verified, sealed and labelled shipping container may then be received at the route distribution accumulation region 5212, where the shipping container may be loaded, by personnel and/or robots 5998, upon a delivery vehicle.

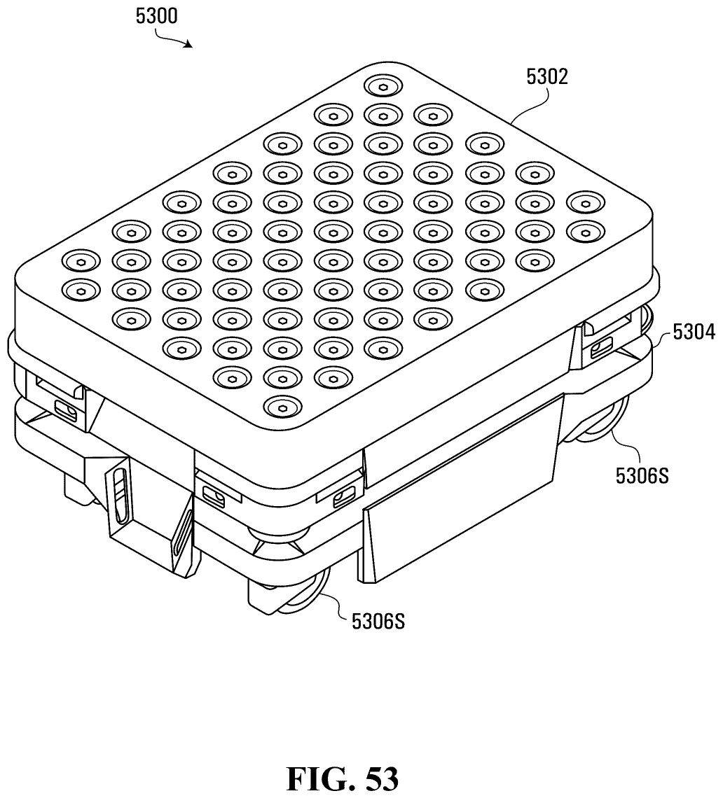

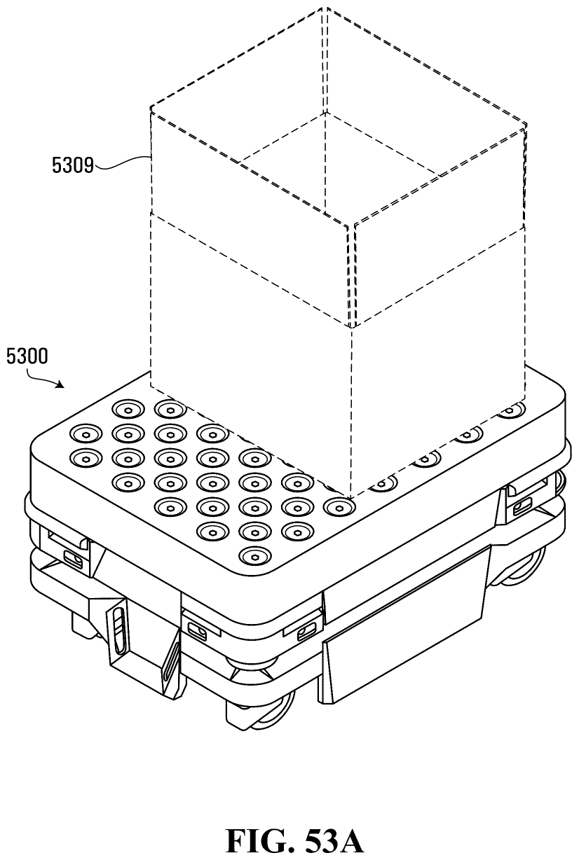

FIG. 53 illustrates, in a top-right perspective view, an AMR 5300 in accordance with aspects of the present application.

FIG. 53A illustrates, in a top-right perspective view, the AMR 5300 of FIG. 53 with the addition of a shipping container 5309.

The AMR 5300 may have a base that forms part of a mobile cart 5304. Other components may be attached to the base of the cart 5304 or interconnected with the base of the cart 5304. The AMR 5300 may include an outer case 5302 carried by the cart 5304. Features of the cart 5304 may be familiar from known autonomous mobile robots. Indeed, the cart 5304 may be expected to include a rechargeable power source, such as a battery (not explicitly shown), and a transmission (not explicitly shown). The transmission, or a drive motor, may be configured to cause a set of drive wheels (not shown) to move the cart 5304. The rechargeable power source, the transmission and drive wheels may be mounted to the base of the cart 5304. A typical, modern-day AMR can run up to three hours between charges. The AMR 5300 may be configured to return to a designated charging station as required. At the designated charging station, the AMR 5300 may establish a connection between charging circuitry (not shown) and an external energy source, such as an electrical wall receptacle.

In addition to the set of drive wheels, the cart 5304 may also feature a set of stability wheels 5306S, which may be caster wheels, to allow for ease of rotational movement of cart 5304 during operation. There may, in total, be at least three wheels, including drive wheels and stability wheels 5306S, which, in combination, both support and drive the movement of the cart 5304 over a surface. The cart 5304 may also be expected to include a control system (not explicitly shown), which may be implemented as a processor in communication with a memory. The AMR 5300 may include a transceiver for use in establishing a wireless connection with a controller that forms part of an overall system to be discussed, in detail, hereinafter.

Details of an example design for the AMR 5300 may be found in U.S. Provisional Patent Application Ser. No. 63/424,676, the contents of which are hereby included herein by reference. The details of the example design include a description of a plurality of suction cups mounted to the outer case 5302. It may be shown that the suction cups act to maintain the shipping container 5309 on the AMR 5300, as illustrated in FIG. 53A.

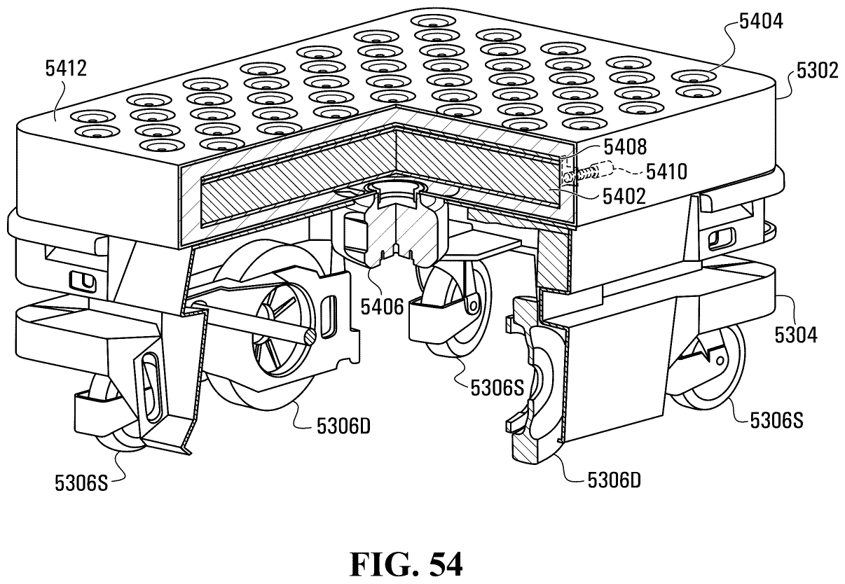

FIG. 54 illustrates, in a sectional perspective view, the AMR 5300. The outer case 5302, which may be made from a suitable material, such as molded plastic, fiberglass, aluminum or other metal, is illustrated using stippled lines to illustrate contents of the outer case 5302 held within an interior cavity of the outer case 5302. Contents of the outer case 5302 may include a vacuum reservoir 5402 and a plurality of suction cups 5404 mounted to the outer case 5302. The suction cups 5404 may be mounted in a generally vertically upwards direction with an upwardly directed contact surface. In other embodiments, the suction cups 5404 may be oriented additionally, or alternately, in other directions, such as sideways.

Preferably, the plurality of suction cups 5404 mounted to the outer case 5302 in a manner with upward facing contact surfaces of the suction cups 5404 that maintains a flush top surface 5412 of the outer case 5302. Indeed, the top surface 5412 of the outer case 5302 may appear to have a plurality of recesses corresponding to the plurality of suction cups 5404. The suction cups 5404 may be implemented using, for example, 2″ piGRIP suction cups manufactured by PIAB of Täby, Sweden. Mounted to the cart 5304 of the AMR 5300 may be a vacuum pump 5406 in pneumatic communication with the vacuum reservoir 5402. The vacuum pump 5406 may be driven by an integral electric motor (not shown). Examples of electric vacuum pumps that are suitable for use as the vacuum pump 5406 are those available from McMaster-Carr of Cleveland, OH and Thomas of Sheboygan, WI. The vacuum reservoir 5402 is also in pneumatic communication with the plurality of suction cups 5404 via a corresponding plurality of apertures/openings in the vacuum reservoir 5402. Interposing between the apertures/openings in the vacuum reservoir 5402 and each respective suction cup 5404 (and respective valve 5502 as referenced below) in the plurality of suction cups 5404 is a slide plate 5408. The slide plate 5408 may be made from a suitable material, such as molded plastic, fiberglass, aluminum or other metal, and may be configured with a perforation/opening corresponding to each aperture in the vacuum reservoir 5402. The slide plate 5408 may be movable between a closed position/state, in which the openings in the vacuum reservoir and the opening to each respective valve 5502/suction cup 5404 combination (as described further below) are blocked, and an open position/state, in which the openings in the vacuum reservoir and the opening to each respective valve 5502/suction cup 5404 combination (as described further below) are unblocked, thereby allowing a suction force to be developed at the top contact surface of each respective valve 5502/suction cup 5404 combination.

The slide plate 5408 may be moved between the open position and the closed position through actuation of an electric actuator 5410. One example of the type of actuator that may be employed, as the electric actuator 5410, is a solenoid valve type of actuator such as the model a14092600ux0438 Open Frame Actuator Linear Mini Push Pull Solenoid Electromagnet, DC 4.5V, 40 g/2 mm made by uxcell of Hong Kong, China. Another example of the type of electric actuator that may be employed, as the electric actuator 5410, is a linear stepper motor type of actuator such as the model VSM0632 6 mm micro linear stepper motor screw motor with bracket, which is made by Changzhou Vic Tech Motor Co. Ltd. of Jiangsu, China. A further example of the type of electric actuator that may be employed, as the electric actuator 5410, is a linear potentiometer type of actuator such as a model in the LMCR8 Series from P3 America of San Diego, California.

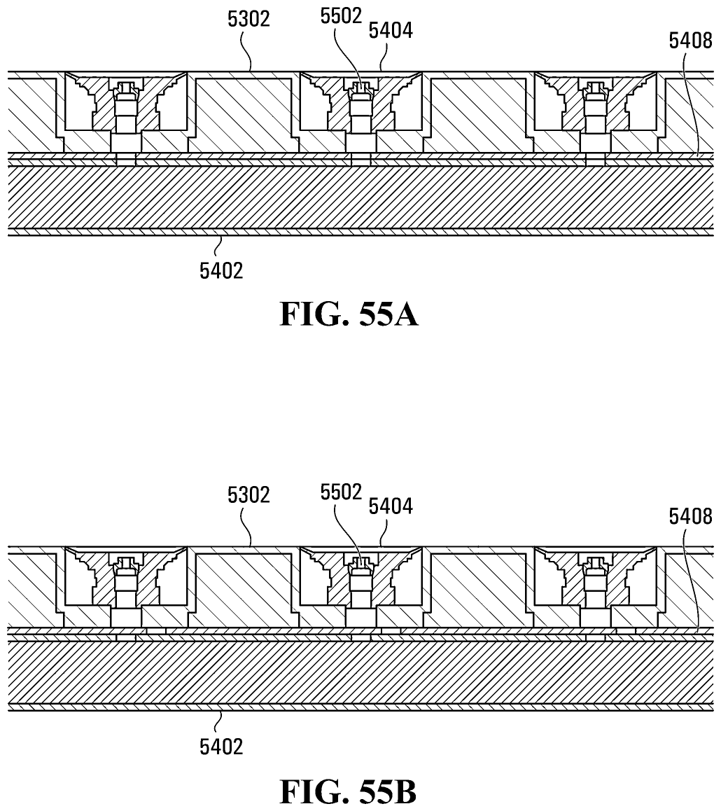

FIG. 55A illustrates, in section view, a portion of the outer case 5302 in conjunction with a plurality of the suction cups 5404, the vacuum reservoir 5402 and the slide plate 5408. The section view of FIG. 55A illustrates that each suction cup 5404 incorporates a one-way valve 5502. The one-way valves 5502 may be implemented, for example, using piSave sense flow control/check valves manufactured by PIAB of Täby, Sweden.

In FIG. 55A, the slide plate 5408 is in a first open position. In the first open position, perforations in the slide plate 5408 align with apertures in the vacuum reservoir 5402. The alignment illustrated in FIG. 55A may be shown to allow a possibility of a flow of air, through each suction cup 5404, into and through the one-way valves 5502 of the suction cups 5404, and into the negative air-pressure vacuum reservoir 5402. Notably, when the slide plate 5408 is in the first open position, flow of air through the suction cups 5404 is controlled by the one-way valves 5502.

FIG. 55B illustrates, in section view, the same portion of the outer case 5302 that is illustrated in FIG. 55A. In FIG. 55B, the slide plate 5408 is in a second closed position. In the second closed position, perforations in the slide plate 5408 do not align with apertures in the vacuum reservoir 5402. The lack of alignment illustrated in FIG. 55B may be shown to disallow or block the flow of air, into the suction cups 5404, through the one-way valves 5502 of the suction cups 5404, and into the vacuum reservoir 5402.

In operation, pressure within the vacuum reservoir 5402 is reduced through action carried out by the vacuum pump 5406. Indeed, the vacuum pump 5406 may, responsive to an instruction received from the control system, cause the integral electric motor to create negative pressure within the vacuum reservoir 5402. The slide plate 5408 may be maintained in the second position, thereby reducing leakage of vacuum pressure, as the control system controls the drive wheels 5306D to maneuver the AMR 5300.

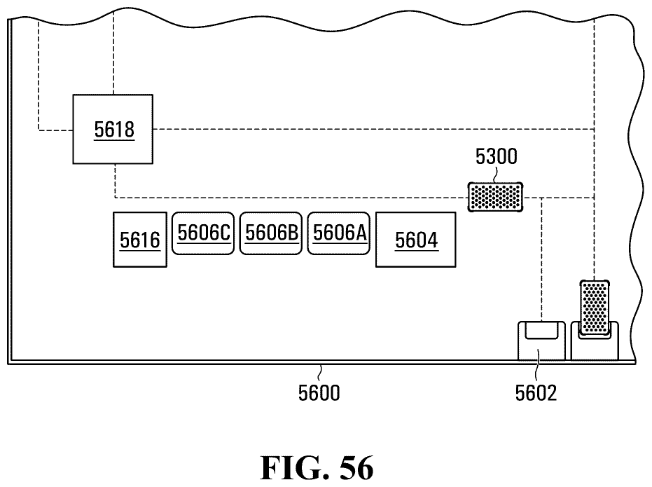

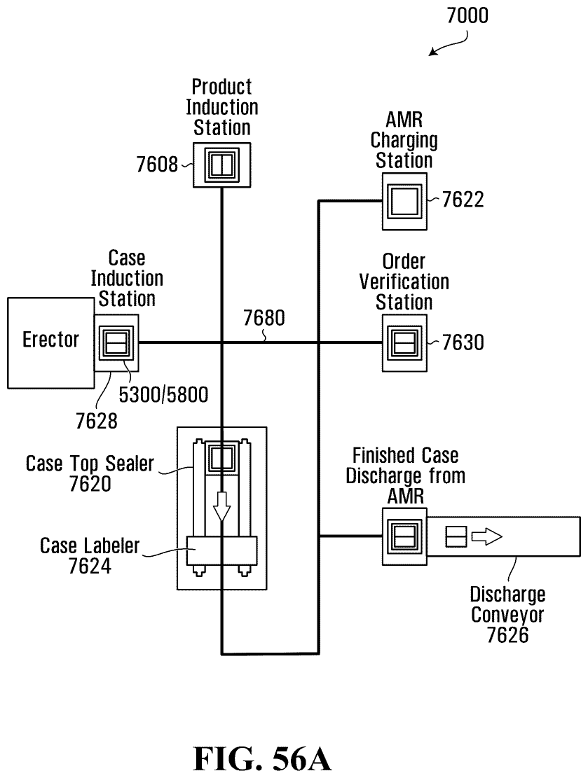

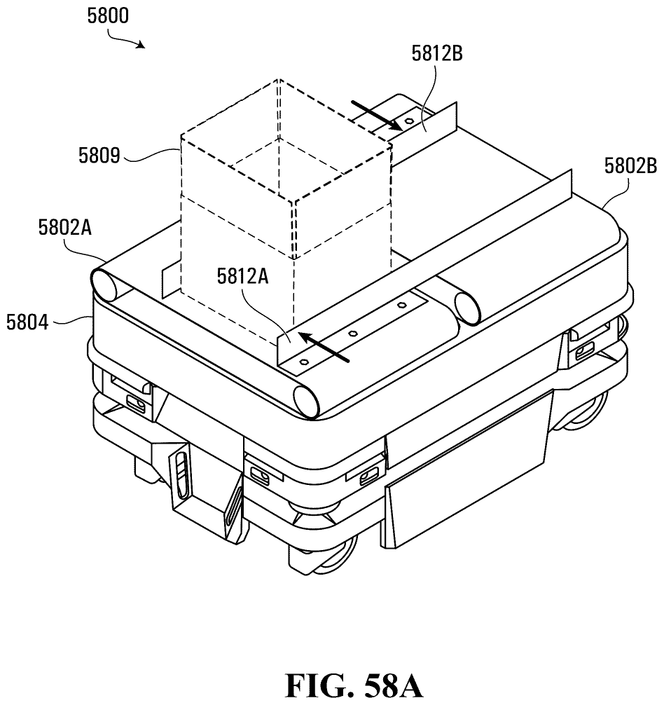

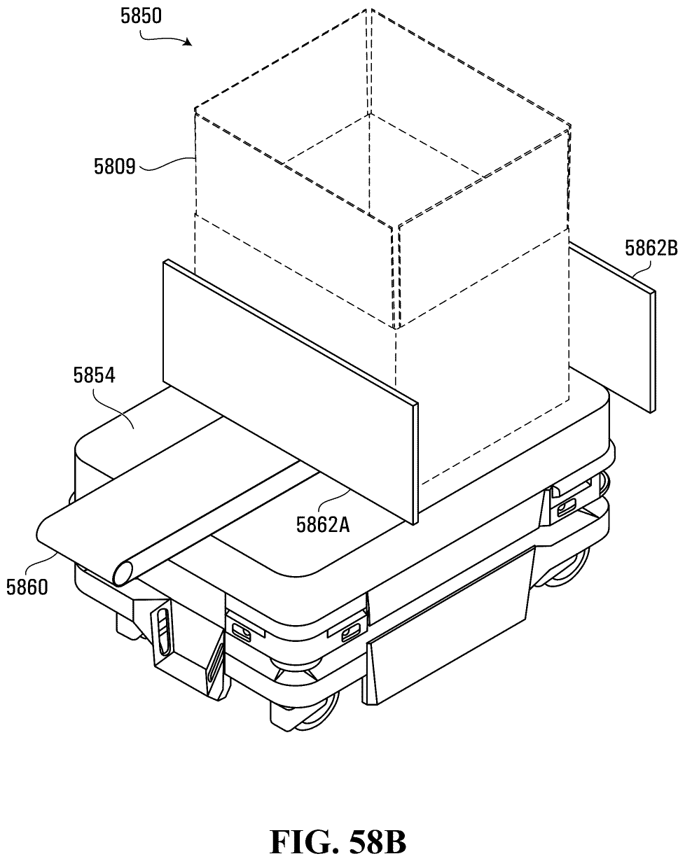

FIG. 56A illustrates an embodiment of a basic concept of a fulfillment center 7000 that utilizes AMR devices such as the AMR 5300 of FIG. 53 and/or an AMR 5800 and/or an AMR 5850, which AMRs 5800 and 5850 are illustrated in FIGS. 58A and 58B and described hereinafter.

Each AMR, such as AMR 5800/5850 (and/or AMR 5300), of the multiple AMRs in the system can be programmed to move from station to station along a path 7680 as follows:
1. Each AMR 5300/5800/5850 moves to one of several case induction stations 7628, where a case erector transfers an erected and bottom sealed carton onto the AMR 5300/5800/5850.
2. Each AMR 5300/5800/5850 then moves to one or more product induction stations in a product induction region 7608, which may be manual product induction stations and/or robotic product induction stations, where an operator and/or a robot places the one or more order products into the erected carton. A robotic product induction station may also be called a product transfer apparatus.
3. Each AMR 5300/5800/5850 then moves to one of a plurality of order verification stations 7630 to verify that the contents of the case corresponds to the products of the order products.
4. Each AMR 5300/5800/5850 then moves to and through a top sealer 7620 and a case labeler 7624.
5. Each AMR 5300/5800/5850 then moves to a finished case discharge conveyor 7626.
6. Each AMR 5300/5800/5850 may then move to a charging station 7622 or return to one of the case induction stations 7628, where a case erector may transfer, onto the AMR 5300/5800/5850, an erected and bottom sealed case, to allow the cycle to be repeated.

The case erector at the case induction station 7628 may be a model MC-17169 case erector made by AFA Systems Ltd. of Ontario, Canada or it may be another case erector described herein. The case induction station 7628 may also be referred to as a shipping container delivery system. The case top sealer 7620 and the case labeler 7624 may be apparatuses also available from AFA Systems Ltd. The case erector at the case induction station 7628 may be a case erector as disclosed in United States patent publication no. US 2021/0138756 A1 published May 13, 2021, the entire contents of which are hereby incorporated herein by reference.

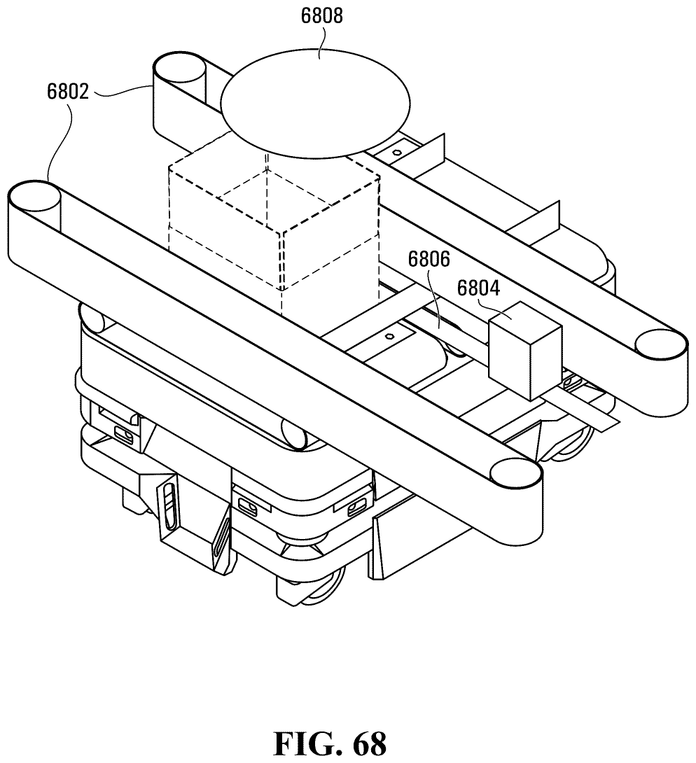

FIG. 68 illustrates, in a front left perspective view, an example arrangement for the case top sealer 7620 (and which may also provide an example case sealer for other order fulfillment systems described herein). The example case top sealer 7620 of FIG. 68 may be understood to have many of the same features and components of known case top sealers. However, the example case top sealer 7620 of FIG. 68 may be distinguished from known case top sealers in that the erected carton is maintained on the AMR 5300/5800/5850 while the erected carton is being acted upon by the components of the example case top sealer 7620 of FIG. 68. That is, the example case top sealer 7620 of FIG. 68 may be considered to be a “drive-through” sealing apparatus. The AMR 5300/5800/5850 may utilize solely its own drive mechanism to move and be powered through the sealing apparatus 7620.

The components of the example case top sealer 7620 of FIG. 68 may include a pair of transversely spaced, longitudinally extending guide belts 6802. The pair of transversely spaced, longitudinally extending guide belts 6802 may be made of a suitable material, such as rubber. Each guide belt 6802 may be arranged to loop around a pair of freely rotatable pulley wheels, which may be rotatable about a generally vertically oriented axle. The guide belts 6802 may be shown to be operable to guide the erected carton during longitudinal movement of the AMR 5300/5800/5850 with the erected carton thereon, through the example case top sealer 7620. The guide belts may be shown to be in contact with respective opposed side surfaces of the erected carton during longitudinal movement of the AMR 5300/5800/5850 with the erected carton secured thereon, through the example case top sealer 7620 of FIG. 68.

In aspects of the present application, movement and the positioning of the guide belts 6802 may be sensed by a guide belt movement sensor (not shown). Output from the guide belt movement sensor, which may be shown to be indicative of the movement of the AMR 5300/5800/5850 and the erected carton through the through the case top sealer 7620, may be transmitted to an order fulfillment processor, operation of which will be discussed in greater detail hereinafter. Conveniently, the position of the pulley wheels may be transversely adjustable to change the distance between the guide belts 6802 to, thereby, accommodate erected cartons of different dimensions.

In common with known case top sealers, the components of the example case top sealer 7620 of FIG. 68 may include one or more folding rails 6806, one or more flap kickers such as a rear flap kicker 6808 and a sealing system 6804. In operation, as the guide belts 6802 guide the erected carton during longitudinal movement of the AMR 5300/5800/5850 with the erected carton thereon, through the example case top sealer 7620, the rear flap kicker 6808 may act to close the trailing top flap and the folding rails 6806 (and/or one or more other flap kicker devices) may act to close the leading top flap and the side top flaps. In common with known case top sealers, subsequent to, or in conjunction with, the top flaps being closed, the sealing system 6804 may act to seal the carton with the application of tape or other adhesive to hold the top flaps in a closed position.

In a manner similar to the manner in which the example case top sealer 7620 of FIG. 68 may be considered to be a “drive-through” sealing apparatus, the case labeler 7624 may be considered to be a “drive-through” case labeler such that the AMR 5300/5800/5850 moves through the case labeler 7624 entirely under its own motive power. Indeed, the case top sealer 7620 and the case labeler 7624 may be co-located so that an open, erected carton may be closed, sealed and labeled as the AMR 5300/5800/5850 transfers the erected carton through the co-located case top sealer 7620 and case labeler 7624.

FIG. 56 illustrates, in a plan view, a portion 5600 of an order fulfillment center. The fulfillment center portion 5600 includes a charging station 5602, a shipping container induction station 5604, a plurality of goods loading stations 5606A, 5606B, 5606C (collectively or individually 5606), a dunnage induction station (not shown), an inspection station (not shown), a rework station (not shown), an order verification station (not shown in FIG. 56), a closing station 5616 and a routing staging station 5618. The shipping container induction station 5604 may also be referred to as a shipping container delivery system.

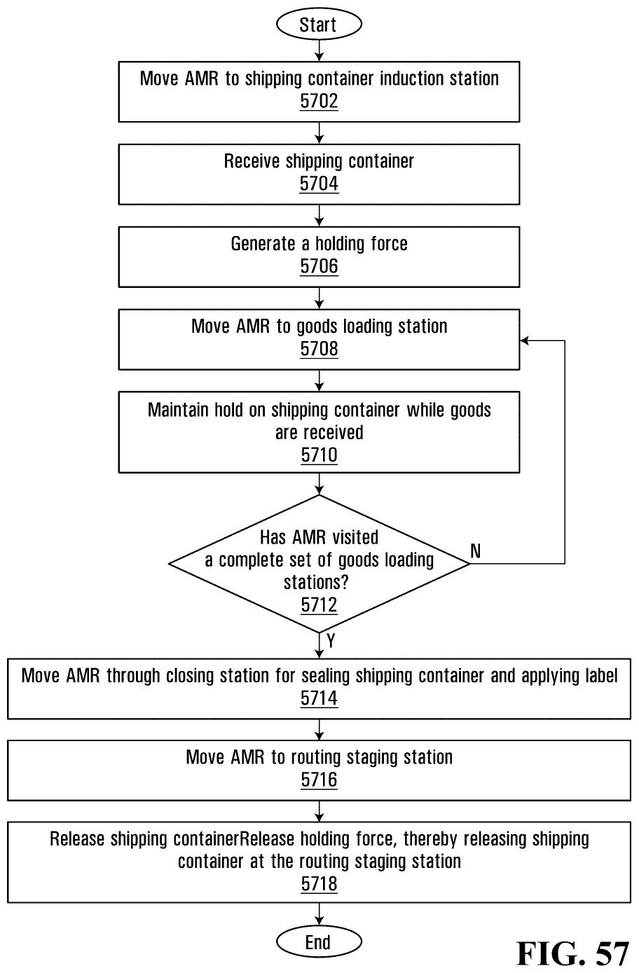

FIG. 57 illustrates example steps in a method of fulfilling an order.

In view of FIG. 56, the control system may control the drive wheels 5306D to move (step S702, FIG. 57) the AMR 5300 from the charging station 5602 to the shipping container induction station 5604. Upon arrival of the AMR 5300 at the shipping container induction station 5604, the control system may control the electric actuator 5410 to move the slide plate 5408 into the first position. Minimizing vacuum leakage in the reservoir may be considered to be an important step toward minimizing a number and duration of activations of the vacuum pump 5406. Frequent activations of the on-board vacuum pump 5406 may be shown to reduce a cycle time (time between recharging sessions) of the AMR 5300.

At the shipping container induction station 5604, a shipping container 5309, which is appropriately sized to fulfill a customer order, may be received (step S704, FIG. 57) on the top surface 5412 of the outer case 5302 (see FIG. 53A). Under conditions wherein the shipping container 5309 does not completely cover the top surface 5412 of the outer case 5302, it may be shown that a subset of the one-way valves 5502 sense being covered by the shipping container. Responsive to the sensing, the subset of the one-way valves 5502 may autonomously act to open. The remaining one-way valves 5502 may remain closed. The shipping container 5309 may be a flexible (e.g., plastic) type bag, an envelope, a tray, a carton, a case, a box. When the shipping container 5309 is not filled with items, the shipping container 5309 may have a relatively low mass/weight and, so without being secured to top surface 5412 with suction force(s), may be vulnerable to becoming displaced, particularly during movement of the cart 5304 during operation.

The AMR 5300 may generate (step S706, FIG. 57) a suction force at each suction cup 5404 of at least some of the suction cups of the plurality of suction cups 5404 to, thereby, hold the shipping container 5309 on the AMR 5300.

The combination of the slide plate 5408 having been moved into the first position and the subset of the one-way valves 5502 having autonomously opened may be shown to allow the suction cups 5404 to act upon the shipping container 5309 to maintain the shipping container 5309 in place on the top surface 5412 of the outer case 5302. In some embodiments, the footprint of the shipping container 5309, when placed and held on the top surface 5412, will be such that the boundaries of the shipping container 5309 will not extend beyond the perimeter of the top surface 5412.

Under conditions wherein the shipping container does not completely cover the top surface 5412 of the outer case 5302, only a subset of the plurality of suction cups 5404 corresponding to the subset of autonomously opened one-way valves 5502, act upon the shipping container 5309. The one-way valves 5502 may be configured and operate such that only when a surface area of an object (e.g., a portion of a lower surface of the shipping container 5309) covers a corresponding suction cup 5404, will the corresponding state of the valve change from a substantially non-active mode (which may permit only a very low level of air flow into the suction cup 5404/valve 5502 combination), to an active mode that provides a substantially increased (e.g., full) suction force to be developed by that suction cup created by a substantially increased (e.g., maximum) developed air flow into the suction cup 5404/valve 5502 combination. By only activating the suction cups 5404 that are covered by a portion of a surface of a shipping container, this may result in reduced energy consumption by the AMR 5300 as when compared with an embodiment in which all of the one-way valves 5502 are opened at the same time and all of the suction cup 5404 are activated regardless of whether or not the shipping container 5309 contact surface covers all or only some of contact surfaces of the suction cups 5404. For example, a relatively smaller vacuum pump may be able to be used, resulting in lower pump investment and lower energy consumption.

It may be shown that the one-way valves 5502 allow the AMR 5300 to adapt to maintain the shipping container in place on the top surface 5412 of the outer case 5302 for a variety of sizes and shapes of shipping container. That is, the AMR 5300 may adapt to maintain the shipping container 5309 in place when the shipping container is a regular slotted bottom-erected case, a paper carton with an open top or side, a cardboard carton with an open top or side, a flexible bag with an open end, or an open top or side envelope, for just four examples. In general, the AMR 5300 may be seen to be able to efficiently adapt to maintain the shipping container in place for a variety of sized shipping containers, such as when the shipping container is any type of shipping container with bottom surface portions that can cover one or more suction cups, and which may have an opening that may be on a top, a side or at an end of the shipping container.

As the shipping container 5309 is maintained in place on the top surface 5412 of the outer case 5302, the shipping container 5309 is able to remain fixed on the AMR 5300. In other words, the shipping container 5309 may be prevented from moving or falling off while the AMR 5300 transports the shipping container 5309 to and from various stations around the fulfillment center (see FIG. 56), or while actions such as loading goods into the shipping container 5309 or closing and labelling the shipping container 5309, are performed. It will be appreciated that the embodiments disclosed herein may be particularly advantageous where the shipping container 5309 is empty or contains goods that are light in weight such that the shipping container 5309 is, accordingly, associated with a higher likelihood of moving around upon, or falling from, the top surface 5412, especially when the cart 5304 is in motion during operation.

In some embodiments, while the suction force is being generated at each suction cup 5404 of at least some of the suction cups of the plurality of suction cups 5404 to hold the shipping container 5309 on the AMR 5300, the control system of the cart 5304 may, subsequently, execute instructions to move (step S708, FIG. 57) the AMR 5300, from the shipping container induction station 5604 to one or more goods loading stations 5606, by directing the transmission to cause the set of drive wheels 5306D to move appropriately.

Accordingly, the AMR 5300 may be shown to move (step S708, FIG. 57) the shipping container 5309 from the shipping container induction station 5604 to the first goods loading station 5606A, at which the AMR 5300 may maintain (step S710, FIG. 57) its hold on the shipping container 5309 while the shipping container 5309 receives goods loaded there into. The loading of the goods into the shipping container 5309 may be done autonomously, for example, by a product-loading robot (not shown) that receives instructions, or manually, for example, by a person. The AMR 5300 may transport the shipping container 5309 from the first goods loading station 5606A to a second goods loading station 5606B, at which more goods may be loaded into the shipping container 5309.

Upon determining (step S712, FIG. 57) that the AMR 5300 has not yet visited a complete set of goods loading stations 5606 for a particular customer order, the control system may move (step S714, FIG. 57) the AMR 5300 to transport the shipping container 5309 to a further goods loading station 5606.

Upon determining (step S712, FIG. 57) that the AMR 100 has visited a complete set of goods loading stations 5606 for a particular customer order, the control system may move (step S714, FIG. 57) the AMR 5300 to transport the shipping container 5309 from the last goods loading station 5606 to a top closing and labeling system (not shown) at the closing station 5616.

The top closing and labeling system may be designed to accept regular slotted cases, envelopes or bags, among other shipping containers. The shipping container 5309 may be closed and labeled, by the top closing and labeling system, without the shipping container 5309 leaving its secured position on the top surface 5412 of the outer case 5302.

Conveniently, it may be shown that a number of fulfillment operations may be carried out when, as proposed herein, goods are loaded directly into the shipping container 5309 secured to the AMR 5300, is significantly reduced relative to a number of fulfillment operations currently required to be carried out in traditional fulfillment operations.

Upon having visited the closing station 5616, the control system may move (step S716, FIG. 57) the AMR 5300 to transport the shipping container 5309 from the closing station 5616 to the appropriate routing staging station 5618. At the routing staging station 5618, the control system of the AMR 5300 may control the electric actuator 5410 to move the slide plate 5408 into the second position. It should be understood that, when the slide plate 5408 is in the second position, the vacuum cups 5404 do not act to maintain their grip on the shipping container 5309 and the shipping container 5309 is released (step S718, FIG. 57) from the AMR 5300. Accordingly, the shipping container 5309 may be removed from the AMR 5300 and dropped off at the routing staging station 5618, for example, onto an appropriate routing staging conveyor.

In addition to the goods loading stations 5606, the closing station 5616 and the routing staging station 5618 described above, the AMR 5300 may be shown to transport the shipping container 5309 to and from various other stations or areas, such as a dunnage induction station, an inspection station, a rework station and an order verification station.

Once the shipping container 5309 has been removed from the AMR 5300, the AMR 5300 may be controlled to return to the shipping container induction station 5604 to obtain a new shipping container, where the new shipping container is appropriate to a next customer order that is to be fulfilled.

Conveniently, the one-way valves 5502 and their ability to autonomously open in response to sensing that a shipping container 5309 covers them, may be shown to minimize vacuum loss when any portion of the suction cups 5404 are not covered by the shipping container, thereby giving the AMR 5300 a feature of universality.

Furthermore, the sliding plate 5408 may be shown to act as vacuum cut off, thereby establishing that any size of shipping container that is secured on the AMR 5300 may be released at any time in a fulfillment process without the loss of vacuum in the vacuum reservoir 5402.

Notably, it is contemplated that the combination of the outer case 5302 and the vacuum pump 5406 may be used, in combination, to retrofit a pre-existing version of the cart 5304. Of course, for proper operation, the control system for the cart would be subjected to an appropriate software update. Additionally, the AMR 5300 may be formed integrally. That is, there may be no discernable distinction between the cart 5304 and the elements that have been described hereinbefore as being contained by the outer case 5302.

Features of the cart 5304 in FIG. 53 may be familiar from known autonomous mobile robots. Indeed, the cart 5304 may be expected to include a rechargeable power source, such as a battery (not explicitly shown), and a transmission (not explicitly shown). The transmission, or a drive motor, may be configured to cause the set of drive wheels 5306D to move the cart 5304. The rechargeable power source, the transmission and drive wheels 5306D may be mounted to the base of the cart 5304. A typical, modern-day AMR can run up to three hours between charges. The AMR 5300 may be configured to return to a designated charging station 5602 as required. At the designated charging station 5602, the AMR 5300 may establish a connection between charging circuitry (not shown) and an external energy source, such as an electrical wall receptacle.

It should be clear that other mechanisms are available for maintaining a shipping container on an AMR. FIG. 58A illustrates an AMR 5800 as an alternative to the AMR 5300 of FIG. 53, in accordance with aspects of the present application.

The AMR 5800 may have a base that forms part of a mobile cart 5804. Other components may be attached to the base of the cart 5804 or interconnected with the base of the cart 5804. In common with the AMR 5300 of FIG. 53, the AMR 5800 of FIG. 58A may have an on-board control system (not shown). The AMR 5800 may include a first belt 5802A and a second belt 5802B carried by the cart 5804. The first belt 5802A may be controlled, by, say, the on-board control system (not shown), in a manner that is independent from the manner in which the second belt 5802B is controlled. Attached to the first belt 5802A may be a first lug 5812A. Attached to the second belt 5802B may be a second lug 5812B.

Through the on-board control system controlling the first belt 5802A, the first lug 5812A may be urged in a direction towards or away from the second lug 5812B. Similarly, the on-board control system controlling the second belt 5802B, the second lug 5812B may be urged in a direction towards or away from the first lug 5812A. In this manner, by manipulation of the positions of the first lug 5812A and the second lug 5812B in relation to each other, the on-board control system may control the first belt 5802A and the second belt 5802B to prepare a gap between the first lug 5812A and the second lug 5812B that is suitable for easily loading of an erected shipping containers of a selected dimension (e.g., a selected length and/or width of bottom surface of erected carton). By further manipulation of the positions of the first lug 5812A and the second lug 5812B in relation to each other, the on-board control system may control the first belt 5802A and the second belt 5802B to close the gap between the first lug 5812A and the second lug 5812B to secure the erected carton between the first lug 5812A and the second lug 5812B. The action of the first lug 5812A and the second lug 5812B may be shown to prevent the erected carton from inadvertently falling off of the AMR 5800. For example, in the embodiment illustrated in FIG. 58A, the shipping container 5809 is maintained, on the AMR 5800, while acted upon by the first lug 5812A and the second lug 5812B. Upon arrival at a location at which the erected carton, with goods inside, is to be unloaded from the AMR 5800, the on-board control system may control the second belt 5802B to move the second lug 5812B out of engagement with the erected carton. The on-board control system may also control the first belt 5802A and, consequently, the first lug 5812A, to urge the erected carton, with one or more goods inside, onto an input conveyor associated with further processing the erected carton. For example, the input conveyor may be associated with a carton sealer, as will be discussed hereinafter. In another aspect of the present application, a robotic arm (not shown) may pick the erected carton from the AMR 5800 and place the erected carton onto the input conveyor associated with further processing the erected carton.

Thus AMR 5800 may be used for transporting a shipping container, and may comprise a mobile cart; a control system for controlling operation of the autonomous mobile robot; a first belt having an upper surface comprising a first lug; a second belt having an upper surface comprising a second lug. The control system may be operable to control and adjust the spacing of the first lug relative to the second lug to move between: a first position in which the spacing between the first lug and the second lug is suitable to allow a shipping container to be positioned between or removed from between the first and second lugs on the upper surfaces the first and second belts; and a second position where the spacing of the second lugs provides for the first and second lugs to engage side surfaces of the shipping container to secure the shipping container between the first and second lugs above the first and second surfaces of the belts. The upper surfaces of first and second belts may be configured to support a shipping container thereon, such that when the shipping container is secured between the first and second lugs, the shipping container is supported on the first and second surfaces of the belts. Movement of the AMR 5800 illustrated in FIG. 58A may be similar to movement (discussed in reference to FIG. 56) of the AMR 5300 illustrated in FIG. 53.

In view of FIG. 57, some of the steps differ when the AMR 5800 illustrated in FIG. 58A is used in place of the AMR 5300 illustrated in FIG. 53. In particular, step S706 indicates a step of generating a suction force at each suction cup of at least some of the suction cups of the plurality of suction cups 5404 to, thereby, hold the shipping container 5309 on the AMR 5300. In the context of the AMR 5800 illustrated in FIG. 58A, step S704 may be expected to involve holding the shipping container 5809 on the AMR 5800 through the action of the lugs 5812A, 5812B. Step S718 of FIG. 57 has been discussed as relating to releasing the shipping container 5309 from the AMR 5300 by reducing the suction provided by the plurality of suction cups 5404. In the context of releasing the shipping container 5809 from the AMR 5800, the on-board control system may control the first belt 5802A and the second belt 5802B to eject the shipping container 5809 from the AMR 5800 into the routing staging station 5618.

FIG. 58B illustrates yet another AMR 5850 as an alternative to the AMR 5300 of FIG. 53 and AMR 5800 of FIG. 58A, in accordance with aspects of the present application.

The AMR 5850 may have a base that forms part of a mobile cart 5854. Other components may be attached to the base of the cart 5854 or interconnected with the base of the cart 5854. In common with the AMRs 5300 of FIG. 53 and the AMR 5800 of FIG. 58A, the AMR 5850 may have an on-board control system (not shown).

The AMR 5850 may include a first lug 5862A and a second lug 5862B. The first lug 5862A may be attached to a belt 5860 that may be carried by the cart 5854. The belt 5860 may be controlled by, for example, the on-board control system. The second lug 5862B may be mounted on an upper surface of the cart 5854. The second lug 5862B may be fixed, i.e., not movable with respect to the cart 5854. The first lug 5862A, however, may be movable through the on-board control system controlling the belt 5860.

Specifically, the first lug 5862A may be urged in a direction towards or away from the second lug 5862B. In this manner, by manipulation of the position of the first lug 5862A relative to the second lug 5862B, the on-board control system may control the belt 5860 to prepare a gap between the first lug 5862A and the second lug 5862B that is suitable for easily loading of an erected shipping container of a selected dimension (e.g., a selected length and/or width of bottom surface of erected carton). By further manipulation of the position of the first lug 5862A relative to the second lug 5862B, the on-board control system may control the belt 5860 to close the gap between the first lug 5862A and the second lug 5862B to a degree that enables the erected carton to be secured between the first lug 5862A and the second lug 5862B. For example, the erected carton may be squeezed between lugs 5862A, 5862B. This may prevent the erected carton from inadvertently falling off of the AMR 5850. For example, in the embodiment illustrated in FIG. 58B, the shipping container 5809 is maintained, on the AMR 5850, while acted upon by the first lug 5812A and the second lug 5812B. Upon arrival at a location at which the erected carton, with goods inside, is to be unloaded from the AMR 5850, the on-board control system may control the belt 5860 to move the first lug 5862A further away from the second lug 5862B, and thus out of engagement with the erected carton. Further processing of the erected carton may include a robotic arm (not shown) picking the erected carton from the AMR 5850 and placing the erected carton onto an input conveyor associated with a carton sealer, as will be discussed hereinafter.

Thus AMR 5850 may be used for transporting a shipping container or receptacle, and may comprise a mobile cart; a control system for controlling operation of the autonomous mobile robot; and a receptacle securement mechanism operable to releasably secure the receptacle to the mobile cart during movement in a warehouse, when the receptacle carries at least one product in a product order and when the receptacle is empty of any products. The control system may be operable to control and adjust the operation of the receptacle securement mechanism between a first state in which the receptacle is secured to the mobile cart and can be moved within the warehouse when the receptacle is both carrying at least one product in a product order and when the receptacle is empty of any products, and a second state wherein the receptacle can be removed from the mobile cart. The receptacle securement mechanism may comprise first and second lugs, the first lug attached to a belt and the second lug mounted in place. The first lug may be moveable, by controlling the belt, relative to the second lug to, thereby, alter a spacing between the first and second lugs. The first state may be characterized by a first spacing between the first lug and the second lug that provides for the first lug and the second lug to engage side surfaces of the receptacle to, thereby, secure the receptacle to the AMR 5850. The second state may be characterized by a second spacing between the first lug and the second lug that is suitable to allow the receptacle to be positioned between, and removed from between, the first lug and the second lug. Movement of the AMR 5850 illustrated in FIG. 58B may be similar to movement of the AMR 5300 and AMR 5800.

Like the AMR 5800, in view of FIG. 57, some of the steps differ when the AMR 5850 illustrated in FIG. 58B is used in place of the AMR 5300 illustrated in FIG. 53. In the context of the AMR 5850, step S704 may include holding the shipping container 5809 on the AMR 5850 through the action of the lugs 5862A, 5862B. In the context of releasing the shipping container 5809 from the AMR 5850, step S718 may include the on-board control system controlling the belt 5860 out of engagement with the shipping container 5809, so that an individual or a robot may pick the shipping container 5809 from the AMR 5850 and place it in the routing staging station 5618.

In the context of the AMR 5300 of FIG. 53, the AMR 5800 of FIG. 58A and the AMR 5850 of FIG. 58B, step S714 of moving the AMR 5300/5800/5850 to the closing station may involve the AMR 5300/5800/5850 driving the shipping container through the case top sealer 7620 and the case labeler 7624 (see FIG. 56A), thereby closing the open flaps, sealing the shipping container and labeling the shipping container.

In an example cycle through the portion 5600 of the fulfillment center that is illustrated in FIG. 56, the AMR 5800/5850 may move to the shipping container induction station 5604, where an erected and bottom-sealed carton may be transferred onto the AMR 5800/5850. The AMR 5800/5850 may then move to one or more of the goods loading stations 5606, where a human operator or a robot may place one or more products into the erected and bottom-sealed carton. The AMR 5800/5850 may then move to the order verification station 7630 (see FIG. 56A) to verify the contents of the erected and bottom-sealed carton. The AMR 5800/5850 may, further, move to, and through, the closing station 5616. The closing station 5616 may be implemented to include a top sealer and a labeling system. Accordingly, at the closing station 5616, the erected and bottom-sealed carton may be top-sealed and labeled. The AMR 5800/5850 may then move the top-sealed and labeled carton to the routing staging station 5618. The routing staging station 5618 may be implemented to include a finished case discharge conveyor. The AMR 5800/5850 may release the top-sealed and labeled carton at the routing staging station 5618. The AMR 5800 may then move to the charging station 5602. Alternatively, the AMR 5800/5850 may return to the shipping container induction station 5604, where another erected and bottom sealed carton may be transferred onto the AMR 5800/5850 to, thereby, allow the cycle outlined hereinbefore to be repeated.

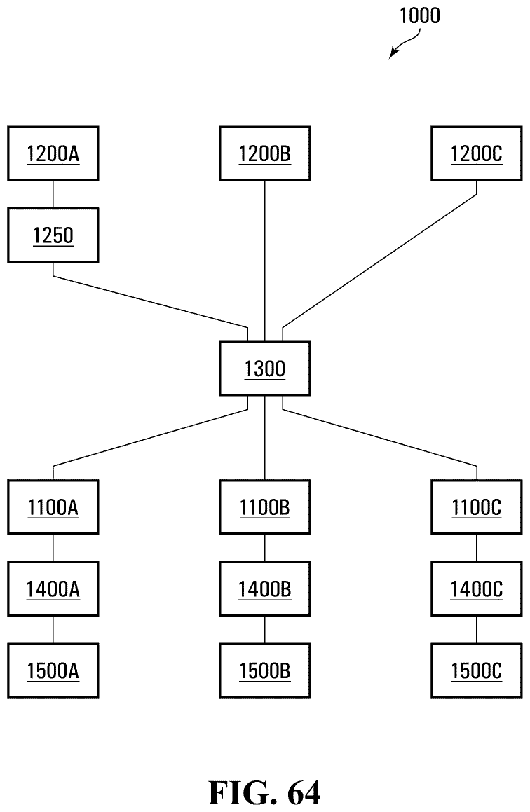

An order fulfillment system 1000 is illustrated, schematically, in FIG. 64. The order fulfillment system 1000 of FIG. 64 may be understood to operate in the context of the order fulfillment location 5200 of FIG. 52. The order fulfillment system 1000 is illustrated, in FIG. 64, as including several components, including an order fulfillment processor 1300. The order fulfillment system 1000 may include a plurality of carton forming systems 1100A, 1100B, 1100C, located, for example, in the shipping container induction region 5206. The carton forming systems 1100A, 1100B, 1100C, may also be referred to as a shipping container delivery systems.

The order fulfillment system 1000 may include a plurality of AMRs 1400A, 1400B, 1400C. The order fulfillment system 1000 is illustrated, in FIG. 64, as including a plurality of carton sealers 1500A, 1500B, 1500C. A plurality of customer order devices may also be provided, including a first customer order device 1200A, a second customer order device 1200B and a third customer order device 1200C. The customer order devices 1200A, 1200B and 1200C may be linked with the order fulfillment processor 1300. The first customer order device 1200A may, for example, be a telephone that may be capable of communication with a call center 1250. The call center 1250 may be adapted to receive orders from customers operating the first customer order device 1200A and then, by virtue of call center software, a call center operator may input an order for one or more products. The order may be communicated, by a communication link, to the order fulfillment processor 1300. The second customer order device 1200B and the third customer order device 1200C may, for example, be personal computing devices including mobile phones, personal computers, etc., that may be capable of direct communication, such as by communication over a wireless and/or land-based communication network with the order fulfillment processor 1300. This communication network may, for example, be an IPV4, IPv6, X.25, IPX-compliant or similar network. Thus, this network may be the public Internet. Through operation of appropriate software on the customer order devices 1200B, 1200C and the order fulfillment processor 1300, the customer order devices 1200B, 1200C may be adapted to input an order for one or more products into the order fulfillment processor 1300. For example, the customer order devices 1200B, 1200C may be adapted to execute a suitable HyperText Transfer Protocol (HTTP)-enabled browser to access data and services provided by an HTTP server application executed by the order fulfillment processor 1300. Through use of the HTTP-enabled browser, the customer order devices 1200B, 1200C may input, into order fulfillment processor 1300, orders for one or more products.

The order fulfillment processor 1300 may be a mainframe computer, a server, or other computing device capable of processing customer orders received directly or indirectly from the customer order devices 1200A, 1200B, 1200C. The order fulfillment processor 1300 may include a database that includes information that may be stored in a suitable memory therein, including information relating to: (a) information/details of all products that may be ordered by a customer through the order fulfillment system 1000, including one or more characteristics of each product, such as the physical volume occupied by the space and/or the actual physical dimensions (e.g., height, width, length and/or diameter) of each product (such as the dimensions of the box in which one or more items is held), optionally, the weight of each product and, further optionally, product codes associated with each product, such as a Universal Product Codes (UPC) or, if the product is a book, an International Standard Book Number (ISBN); (b) information/details of each of a plurality of types/sizes/configurations of carton/carton blanks that can or are being used in the order fulfillment system 1000 to package one or more products ordered by a customer including the dimensions of each type of carton/carton blank; (c) information/details of each carton forming system (e.g., carton forming systems 1100A, 1100B, 1100C), including information/details of the carton that each carton forming system is capable of forming (such as the type, size and/or configuration) and, optionally, when a carton forming system includes multiple magazines, the type, size and/or configuration of the carton blanks provided in each of those magazines and the corresponding type, size and/or configuration of the erected carton that can be formed from each type of carton blank and, further optionally, the quantity of carton blanks provided in each of those magazines; (d) information/details about each customer, including the name of the entity and shipping address to which an order fulfilled by the order fulfillment system 1000 is to be shipped and (e) information/details about where each product is located in a product storage facility, such as a warehouse building holding products that may be ordered. The database may continually be updated to include new data. For example, new data may include data related to information/details about new inventory items, for example, new items that are inducted into the product storage induction region 5202 of the order fulfillment location 5200, or information/details about a new type/size/configuration of carton/carton blanks that can be used in the order fulfillment system 1000 to package one or more products ordered by a customer.

As noted, the order fulfillment processor 1300 may also include an HTTP server application adapted to provide database information to the customer order devices 1200B, 1200C and to receive orders from the customer order devices 1200B, 1200C. Some or all of the aforementioned information/details may be input into the order fulfillment processor 1300 manually by an operator of the order fulfillment system 1000. Additionally, or alternatively, the information/details of each available carton may be updated periodically or on an ongoing basis. The PLC 132 of each carton forming system 1100A, 1100B, 1100C may, during operation, be adapted to monitor the status of the carton blanks in its magazine(s) and provide information relating to that status to the order fulfillment processor 1300. In this way, the order fulfillment processor 1300 may be continually provided with up-to-date information on available carton blanks that are in the magazines of each of the carton forming systems.

The order fulfillment processor 1300 may also include a product packaging utility/product packaging software module that identifies, from among a plurality of available carton types, a suitable type of carton (or types of carton) for packaging the products in an order placed by a customer. An example of such a product packaging utility is disclosed in U.S. Pat. No. 6,876,958 to Chowdhury et al., issued to assignee New Breed Corporation on Apr. 5, 2005 (hereinafter, “Chowdhury”), the contents of which is hereby incorporated by reference herein in its entirety. In particular, the product packaging utility in Chowdhury processes each order placed by a customer to automatically identify, from available carton types/sizes/configurations, a type/size/configuration of suitable carton (or cartons) suitable for packaging the products in the order. The product packaging utility in Chowdhury identifies/determines suitable carton(s) according to an algorithm/function that accesses and uses one or more electronically-stored characteristics of each product in the order (e.g., dimensions, weight, etc.) and one or more electronically-stored characteristics of available carton types (e.g., dimensions, size, configuration, type, maximum volume that can be held, maximum weight that can be held, etc.). This algorithm identifies suitable cartons such that a minimum number of cartons and the smallest size cartons suitable for packaging the products in the order may be provided. Thus, identification of suitable carton types/sizes/configurations can be optimized to provide an optimal carton type/size/configuration that optimizes packaging material used and optimizes empty space in cartons and a carton identified as suitable may be referred to as an “optimal” carton. It will be appreciated that identification of suitable carton types/sizes/configurations may also be identified or optimized according other pre-defined criteria. The carton identification algorithm of the product packaging utility in Chowdhury may also take into account other factors and constraints such as, e.g., the availability of each type/size/configuration of carton, the maximum fill ratio of each type/size/configuration of carton, the maximum number of products that can be placed into each type/size/configuration of carton and whether certain products are pre-packaged together and therefore must be placed in the same carton. Thus, when the order fulfillment processor 1300 includes a product packaging utility, such as product packaging utility disclosed by Chowdhury, the order fulfillment processor 1300 may process a customer order for specific products by accessing information in memory and utilizing an algorithm/function to identify, from among a plurality of available cartons, a suitable carton (or cartons) for packaging those products.

It should be noted that the size of the carton may be the overall internal available volume of the carton in which items may be held. The size may also be the specific dimensions of the carton. Information regarding the type of carton may include a reference to a material (e.g., paperboard or corrugated cardboard) from which the carton blank is made. Information regarding the type of carton may include a reference to a configuration, which may indicate that the carton is a top opening carton that is generally cuboid in shape when closed, or another configuration such as a regular slotted case, etc.

The product packaging utility disclosed by Chowdhury may generate, for each carton of a particular type/size/configuration identified to fulfil an order, a packing list indicating an order in which each of the products is to be placed into the carton, as well as placement information indicating where each product is to be placed in the carton. For example, the placement information may be expressed using three-dimensional coordinates (e.g., 0, 0, 0) in a coordinates system defined for the carton and/or descriptors of locations in the carton (e.g., front, right hand side, second layer, etc.). It follows that, when the order fulfillment processor 1300 includes a product packaging utility, such as the product packaging utility disclosed by Chowdhury, the order fulfillment processor 1300 may generate a packing list and/or placement information for each identified carton. The order fulfillment processor 1300 may also generate a diagram illustrating a desired optimal physical arrangement of the products in each carton. Such a diagram may be readily generated using placement coordinates for each product, as provided by the product packaging utility disclosed in Chowdhury.

For each carton of a particular type identified to fulfil an order, the order fulfillment processor 1300 may also be configured to select one of the carton forming systems 1100A, 1100B, 1100C (individually or collectively 1100) to form a suitable carton of the type/size/configuration identified by the order fulfillment processor 1300. The order fulfillment processor 1300 may access and use information stored in its memory regarding the suitability of the carton forming systems to handle an identified suitable carton. For example, suitability of a carton forming system may be determined by the order fulfillment processor 1300 based on stored information regarding whether the carton forming system includes magazines designated to hold the types/size/configuration of carton blanks required forming the identified carton. Suitability of a carton forming system may also be determined based on stored information regarding the quantity of the required type/size/configuration of carton blanks in a magazine of the carton forming system. Such quantities may be measured using suitable sensors placed at each carton forming system and updated during operation. Alternatively, the order fulfillment processor 1300 may simply select a carton forming system randomly or according to a pre-defined sequence.

Once the order fulfillment processor 1300 has selected a suitable carton forming system (e.g., one of the carton forming systems 1100 of FIG. 64) has been selected, the order fulfillment processor 1300 may generate a fulfillment order data structure (e.g., a file, an object, a message or the like) containing information for, or instructions to, the selected carton forming system 1100 to form a suitable carton blank into an erected carton. A generated fulfillment order data structure may be communicated, by a communication link to the PLC 132 of the selected carton forming system 1100.

The fulfillment order data structure may include indicators indicating (i) the type/size/configuration of the carton, determined by the product packaging utility, that is to be formed by the selected carton forming system 1100; (ii) the particular magazine of the selected carton forming system 1100 containing carton blanks for forming the suitable carton; (iii) a list of the particular product(s), from the customer order being fulfilled, that are to be loaded into the erected carton once formed, with the list, optionally, identifying the products by associated product codes and, optionally, arranged in an order in which the products are to be loaded into the erected carton once formed; (iv) the stations in the product induction region 5208, of each particular product from the customer order being fulfilled; and (v) customer shipping information for that carton indicating the destination name and address for that carton. In some cases, the fulfillment order data structure may include information for multiple cartons to be handled by the selected carton forming system 1100.

A fulfillment order data structure may be received and processed by the PLC 132 of the selected carton forming system 1100. In particular, the PLC 132 of the selected carton forming system 1100 processes the fulfillment order data structure to identify a requested type/size/configuration of carton (or cartons) to be formed and the particular magazine of the carton forming system containing carton blanks for forming each required carton. Once a suitable carton and the particular magazine containing carton blanks for forming the suitable carton have been identified, the PLC 132 of the selected carton forming system 1100 may then cause a suitable carton blank to be formed into the requested type/size/configuration of carton.

Optionally, the data structure may be stored in memory of the PLC 132 of the carton forming system or in memory of the order fulfillment processor 1300 for later retrieval when the order is picked and packed, as described below.

Once the carton has been erected for a particular customer product order, the erected carton may then be physically transferred to an AMR (collectively or individually, referenced as 1400).

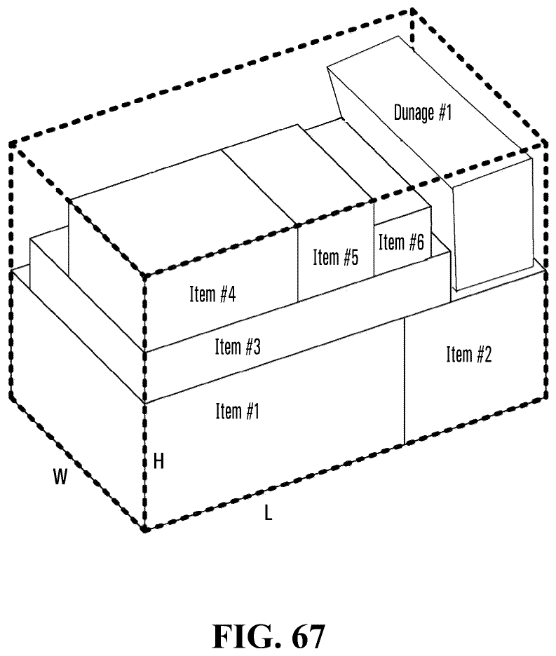

An erected carton, formed from a carton blank, and having dimensions of width W, height H and length L, can be loaded, as illustrated in FIG. 67, with items (i.e., products) numbered 1 to 6 arranged in a particular arrangement and may also include some additional dunnage or packing material (e.g., bubble wrap type material) that may be inserted to maintain the stability and integrity of the items in the packaging arrangement during shipping to the customer. In view of the particular arrangement of items specified for an order, an AMR may be controlled to visit stations in a particular order (say, the station holding the largest item may be visited first) so that an erected carton may be loaded in a manner consistent with the specified arrangement.

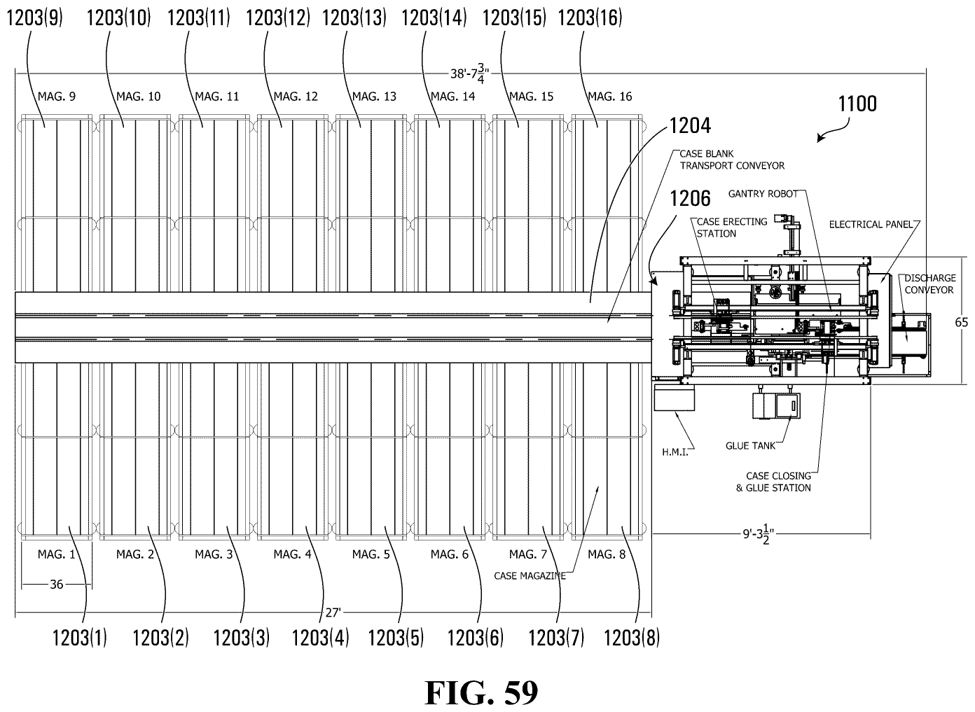

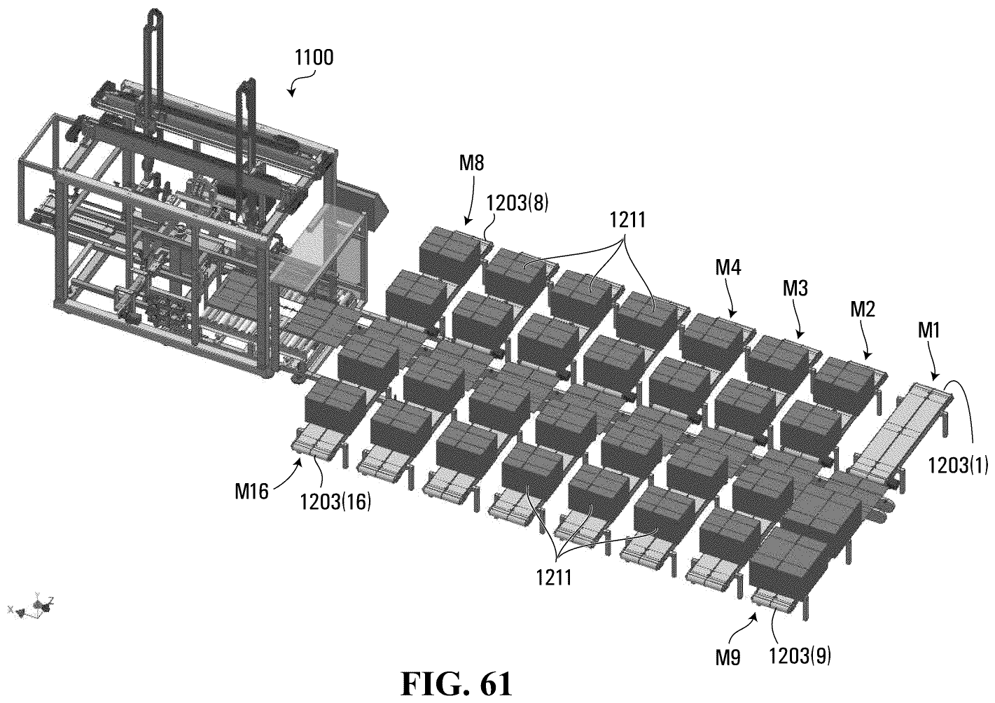

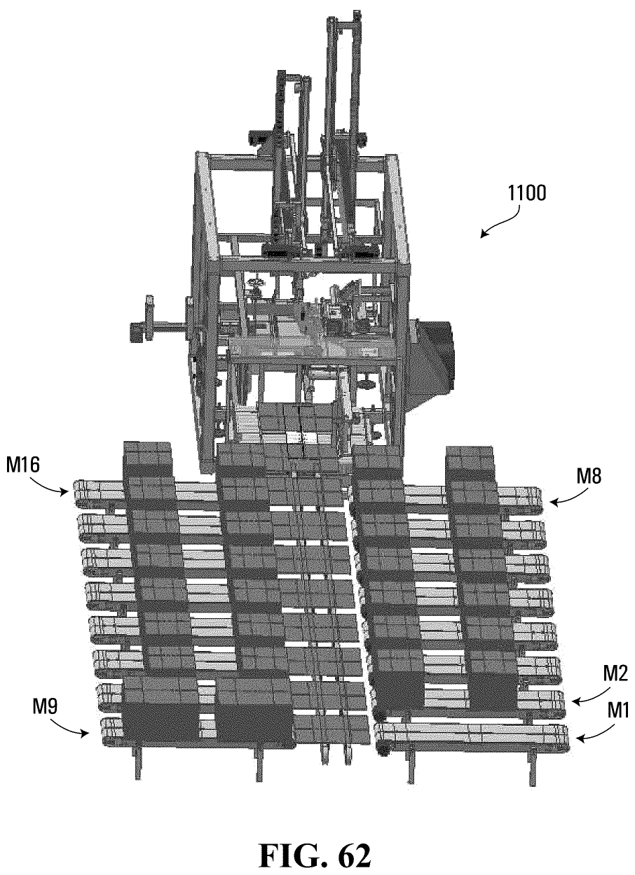

Turning now to FIGS. 59, 60, 60A, 61, 62 and 63, the carton forming system 1100 may comprise the same or substantially the same components as the carton forming system 100 of FIG. 1A, described above, except where differences are hereinafter described. Like in the carton forming system 100 of FIG. 1A, the structural/mechanical components of the carton forming system 1100 may be made from any suitable materials. The carton forming system 1100 is particularly useful as part of a customer order fulfillment order fulfillment system 1000 that may fulfil product orders placed or initiated by customers as described above. However, the carton forming system 1100 may also be used in other applications.

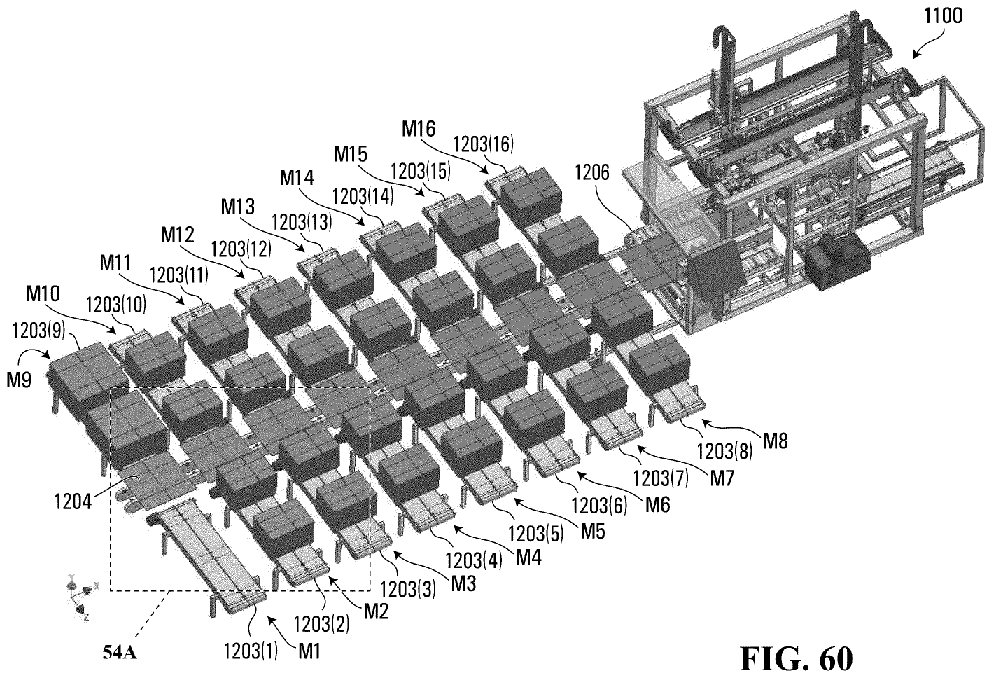

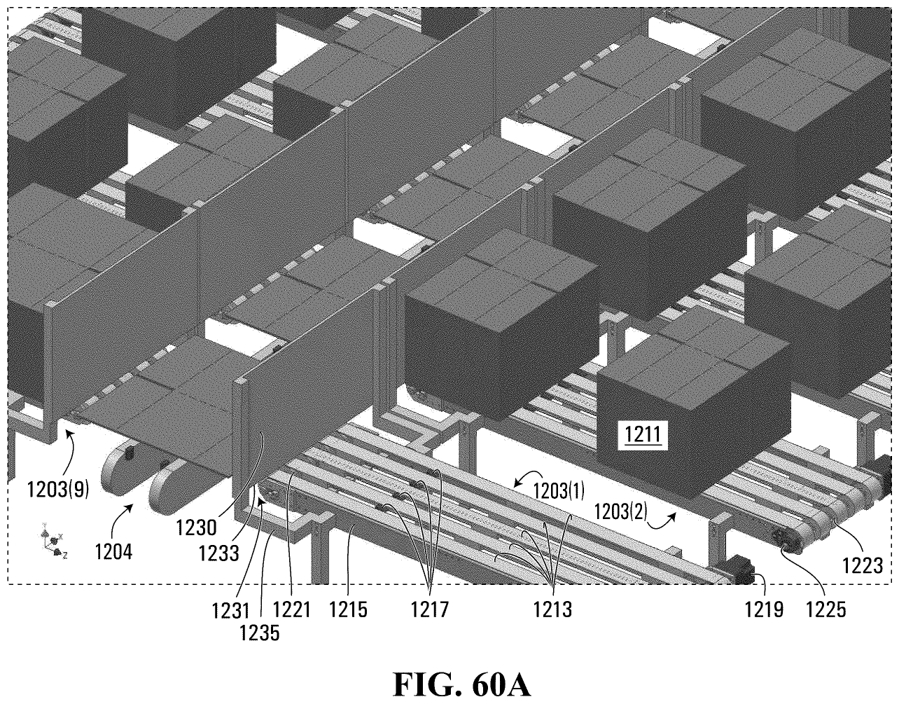

As an alternate to a magazine like the magazine 110 of the carton forming system 100 of FIG. 1A, described above, the carton forming system 1100 may include or utilize a plurality of magazines, such as magazines labeled M1 through M16 in FIG. 60. The magazines M1-M16 may each contain one or more stacks of product packaging, such as carton blanks, which each may generally be like the carton blanks 111 processed by the system 100, with at least some of the magazines M1-M16 containing different types/sizes and/or configurations of packaging/carton blanks to other magazines. The size, configurations and types of carton blanks (and the cartons that can be formed therefrom) can vary to provide a range of carton sizes, configurations and types that can be automatically processed by carton forming system 1100 without the need for any manual intervention to modify any components of the carton forming system 1100. The PLC 132 of the carton forming system 1100 may be programmed such that the particular dimensions/overall size/configuration (e.g., such as regular slotted carton or “RSC”)/type of each of the carton blanks held in each one of the magazines M1-M16 is stored in the memory of the PLC 132. Recall that alternatives to the RSC configuration include envelope configurations and tray configurations. When such alternatives are used, some of the carton forming systems 1100 may be replaced with envelope feeders or tray feeders.

It should also be noted that the carton forming system 1100 may be configured with magazines having a different set/selection of sizes/configurations/types of carton blanks from that of the other magazines, so that each of the carton forming systems 1100 is operable to process different cartons blanks. The carton forming systems 1100 may be configured with magazines such that they collectively process a pre-defined set of carton blank types, thereby providing a range of carton sizes, configurations and types.

Each of the magazines M1-M16 may have its own carton blank transfer apparatus that may include a transversely oriented magazine conveyor 1203(1) to 1203(16) (referred to individually or collectively using reference numeral 1203), respectively. Each of the magazine conveyors 1203 may be controlled by the PLC 132 of the carton forming system 1100, such that a stack of carton blanks in each of the magazines M1-M16 may be moved to a position adjacent a longitudinally oriented, central carton blank in-feed conveyor 1204. Each magazine M1-M16 may have a transfer apparatus under the control of the PLC 132 that is operable to extract and move a carton blank from a stack in the magazine M1-M16 adjacent to the in-feed conveyor 1204 and feed the carton blank onto the central in-feed conveyor 1204 to that the carton blank may be transported in a manner like the manner described above in connection with the system 100.

With reference now to FIG. 60A, by way of a representative example of the construction of a magazine, the magazine conveyor 1203 may include a frame 1215 that supports five, generally parallel, and spaced continuous belts 1213 that may be made of any suitable flexible material such as Ropanyl. The continuous belts 1213 may each extend between a plurality of rotatable idler wheels 1221, mounted on a freely rotatable shaft, and a plurality of rotatable drive wheels 1223. The drive wheels 1223 may be mounted for rotation with a common drive shaft 1225 of a magazine conveyor servo motor 1219 that may be interconnected, via and in communication with a servo drive, to the PLC 132 of the carton forming system 1100. The continuous belts 1213 may each have an upper belt portion that together may support one or more stacks of carton blanks 1211 thereon. The PLC 132 may give an instruction (such as by order fulfillment processor 1300) to form a carton and, if required, the PLC 132 may cause the upper belt portion of the in-feed conveyor belt 214 to move towards the in-feed conveyor 1204 by operation of the magazine conveyor servo motor 1219 rotating the drive wheels 1223. In this way, the in-feed conveyor belt 214 can, if necessary, move a stack of carton blanks 1211 to a position adjacent to the in-feed conveyor 1204.

Positioned proximate the end of each magazine conveyor 1203 adjacent to the in-feed conveyor 1204 may be a vertically and longitudinally oriented plate 1230. Each plate 1230 may be supported by a plurality of plate support members 1235 that may be part of the frame 1215. A lower longitudinally extending edge 1233 of the plate 1230 may be positioned so that only the bottom carton blank 1211 in a stack of carton blanks (i.e., the blank that is immediately above the upper portions of the belts) can pass through a slot provided beneath the lower edge 1233 of the plate 1230 and the horizontal plane formed by the upper surface of the upper portions of the continuous belts 1213. In this way, a slot 1231 can be provided that can permit a single carton blank 1211 at a time from the bottom of the stack to be pushed transversely through the slot 1231 and onto the in-feed conveyor 1204.

A pushing mechanism may be provided to respond to signals from the PLC 132 of the carton forming system 1100 to push a carton blank 1211 in a magazine from the bottom of the stack though the slot 1231 and onto the in-feed conveyor 1204. The pushing mechanism may be any suitable type of device and may, for example, include a plurality of lugs 1217 located in the spaces between the continuous belts 1213. The lugs 1217 may be driven, in a cyclical path, by a common type crank mechanism (not shown) that may include a common pneumatic or hydraulic cylinder with a piston controlled, by the PLC 132, by activating appropriate valves to suitably control the flow of pressurized air/hydraulic fluid to the cylinder. The cylinder may have a piston arm attached to a longitudinally oriented bar member that may be mounted for rotation. The crank mechanism may be configured to provide a path for the lugs 1217 that commences in a position behind the bottom carton blank in a stack; then moves transversely between the continuous belts 1213 while engaging the rear side edge of the bottom carton blank thereby pushing the bottom carton blank through the slot 1231. Once the crank mechanism reaches the end of the stroke, the lugs 1271 may be shown to descend downwards beneath the stack of carton blanks and move transversely in an opposite direction back to the starting position, while, at the same time, not engaging the next bottom carton blank on the stack and passing beneath the stack. The path returns the lugs 1217 back to the start position so that, when signaled by the PLC 132, to load another carton blank onto the in-feed conveyor 1204, the operation can be repeated.

In summary, the PLC 132 can, thus, control the magazine conveyor servo motor 1219 and, thus, the movement of each conveyor 1203 and, consequently, the movement of the lugs 1271. Accordingly, the PLC 132 may selectively move and transfer a single carton blank at a time onto the in-feed conveyor 1204 from any one of the magazines M1 to M16.

Therefore, unlike in system 100, where a stack of carton blanks may be fed to the alignment conveyor 206 by the in-feed conveyor 204, in the order fulfillment system 1000, separate individual carton blanks may be fed in series and longitudinally by the in-feed conveyor 1204 to the alignment conveyor 1206. The particular sequence/order of carton blanks that are placed onto the in-feed conveyor 1204 of each carton forming system 1100 may be determined and selected by the PLC 132 such that the carton blanks may arrive at the alignment conveyor 1206 in such a manner in which it is desired to process the carton blanks, at least within the carton forming system 1100.

Further, each PLC 132 may maintain, in its memory, records of the carton blanks that have been placed onto the in-feed conveyor 1204 to be formed. Each record may include information received by the PLC 132 from the order fulfillment processor 1300 (e.g., by way of the fulfillment order data structure) for a particular carton blank to be formed. For example, this information may include the type/size/configuration of the carton blank. A new record can be added each time a request for a new carton is received from the order fulfillment processor 1300 and, optionally, records can be removed once a carton has been formed. Thus, such records may be organized and maintained in sequence in the memory of the PLC 132 using a conventional shift registering technique. In this way, the record for the next carton blank scheduled to arrive at the alignment conveyor 1206 may be provided at the output of the shift registers as the next carton blank arrives. Furthermore, the type/configuration/size of the next carton blank may be determined from the provided output.

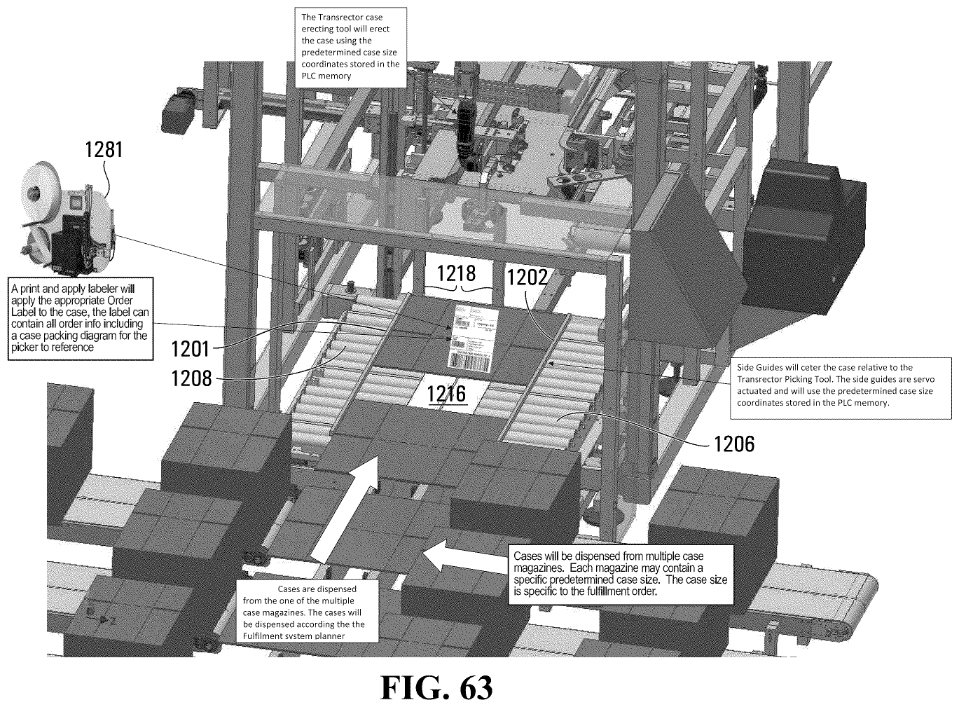

Once a given carton blank has been transferred from the in-feed conveyor 1204 to the alignment conveyor 1206, the alignment conveyor 1206 may then, under control of the PLC 132, move the given carton blank to the pick-up position. The pick-up position may, in part, be determined by the front edge of each carton blank abutting the surfaces of a pair of spaced vertical plates 1218 (see FIG. 63) as they are moved longitudinally downstream by the alignment conveyor 1206.

The in-feed conveyor 1204 may be constructed, in a manner substantially similar to the construction of the in-feed conveyor 204 of FIG. 7, to include a pair of spaced in-feed conveyor belts 214 that may be driven by a suitable motor, such as a DC motor or a variable frequency drive motor. In a case wherein the motor is a DC motor, the motor may be controlled, by the PLC 132, through a DC motor drive (such as are all sold by Oriental under model AXH-5100-KC-30).

The in-feed conveyor belts 214 may have an upper belt portion supported on rollers (not shown). The PLC 132 can, as required, cause upper portions of the in-feed conveyor belts 214 to move longitudinally downstream towards the alignment conveyor 1206. In this way, the in-feed conveyor belts 214 can move a series of spaced-apart carton blanks longitudinally downstream. The PLC 132 can control the motor driving the in-feed conveyor 1204 through the motor drive and, thus, the in-feed conveyor 1204 can be operated to move and transfer a series of carton blanks obtained from multiple magazine of magazines M1 to M16 towards, and for transfer to, the alignment conveyor 1206.

The alignment conveyor 1206, like the alignment conveyor 206 of FIG. 7, may also include a series of transversely oriented rollers 1208 that may be mounted for free rotating movement to a lower portion of the magazine frame 202. An alignment conveyor belt 1216 may be driven by a motor that has a corresponding motor drive. This motor and motor drive for the alignment conveyor 1206 may also be controlled by the PLC 132. The alignment conveyor belt 1216 may be provided with an upper belt portion supported on rollers 1208, upon which one or more carton blanks may be supported. The alignment conveyor belt 1216 may be operated to move each carton blank in turn further longitudinally until the front face of the carton blank abuts with a generally planar, vertically and transversely oriented inward facing surface of upstanding spaced plates 1218, so that each carton blank is, in turn, placed into the pick-up position.

An in-feed conveyor belt 1214 of the in-feed conveyor 1204 and the alignment conveyor belt 1216 of the alignment conveyor 1206 may be made from any suitable material such as for example Ropanyl.

A sensor (not shown), such as an electronic eye model 42KL-D1LB-F4 made by Allen-Bradley, may be located within the horizontal gap between the in-feed conveyor belt 1214 and the alignment conveyor belt 1216. The sensor may be positioned and operable to detect the presence of the front edge of a blank as each blank in turn begins to move over the gap between the in-feed conveyor belt 1214 and the alignment conveyor belt 1216. Upon detecting the front edge, sensor may send a digital signal to the PLC 132 signaling that a particular carton blank (the size/configuration/type of which the PLC 132 is aware) has moved to a position where the conveyor 1206 can start to move. The PLC 132 can then cause the motor for the conveyor 1206 to be activated such that the top portion of the alignment conveyor belt 1216 starts to move the carton blank downstream. In this way, there can be a “hand-off” of each carton blank from the in-feed conveyor 1204 to the alignment conveyor 1206.

Once the rear edge of each carton blank passes the sensor, a signal may be sent to the PLC 132, which can then respond by sending a signal to shut down the motor driving the in-feed conveyor belt 1214 of the in-feed conveyor 1204. The in-feed conveyor 1204 is then in a condition to await a further signal thereafter to feed the next carton blank in the series of carton blanks on the in-feed conveyor 1204 to the alignment conveyor 1206. Meanwhile, the alignment conveyor 1206 can be operated to move the carton blank placed thereupon to the pick-up position.

The presence of a carton blank on the alignment conveyor 1206 at the pick-up position may be detected by another sensor that may be the same type of sensor as the presence sensor 240 and the gap sensor 242 of FIG. 7. The sensor may detect the presence of the front edge of a blank at the pick-up position and may send a digital signal to the PLC 132 signaling that a carton blank is at the pick-up position. At the pick-up position, the carton blank may also be centered longitudinally by a pair of moveable longitudinally oriented side wall guides 1201, 1202.

Each carton blank may be suitably longitudinally and transversely positioned and oriented in a pick-up position for proper engagement by one of the erector heads, like the erector heads 120a, 120b of the system 100. The side guide walls 1201, 1202 may be mounted, on tracks, to a lower portion of a lower frame and both side guide walls 1201, 1202 may be oriented generally vertically and may extend longitudinally for substantially the full length of the alignment conveyor 1206. The side guide walls 1201, 1202 may be mounted in a similar manner as the left hand side guide wall 200 and the right hand side guide wall 201 in the system 100.

A drive mechanism may be provided to drive each of the side walls 1201, 1202 on respective tracks. For the side walls 1201, 1202, one or more drive mechanisms that are in electronic communication with the PLC 132 can be provided. By way of example, a servo motor 258 (see FIG. 1B) with gear head may be provided and be in electronic communication with the PLC 132 through a servo drive. Examples that could be used are servo motor MPL-B1530U-VJ42AA made by Allen-Bradley, in combination with servo drive 2094-BC01-MP5-S also made by Allen-Bradley and gear head AE050-010 FOR MPL-A1520 made by Apex.

Like in the carton forming system 100, in the carton forming system 1100, lead screw rods may be inter-connected to servo motor/gear heads. The lead screw rods may pass through nuts, which may be fixedly secured to plates. The plates may be interconnected to spaced, generally vertically oriented bar members. The bar members may be interconnected to a support frame (not shown) forming part of the side walls. By activating the servo motor/gear heads, the rotation of the servo motor may rotate the screw rods. As the rods pass through nuts, the nuts can be moved laterally either inwards or outwards, thereby causing the side walls 1201, 1202 to slide on their tracks inwards or outwards depending upon the direction of rotation of the screw rods. Encoders may be provided within, or in association with, the servo drive motors and the encoders may rotate in relation to the rotation of the respective drive shaft of the servo drives. The encoders may be in communication with, and provide signals to, the servo drives, which can then pass the information to the PLC 132. Thus, the PLC 132 may be able to determine the longitudinal position of the screw rods in real time and, thus, determine the transverse position of the side walls 1201, 1202. The PLC 132 may, accordingly, operate the servo drives to adjust the position of the side walls 1201, 1202. The particular type of encoder that may be used is known as an “absolute” encoder. Thus, once the encoders are calibrated so that a position of each the screw rod is “zeroed,” even if power is lost to the order fulfillment system 1000, the encoders can maintain their zero position calibrations. With the transverse alignment mechanism of the side guides walls 1201, 1202 in abutment with the left and right side edges of the carton blank, the guide walls can ensure that the datum line, when the carton blanks are flattened, is properly transversely aligned to be labelled by a labelling device 1281 (only shown in FIG. 63) and to be picked up by the erector head 120 of the carton forming system 1100 and moved through folding and sealing apparatus 130, as described above to achieve proper folding and sealing of the carton blank.

Optionally, the PLC 132 may verify that the type/size/configuration of the carton blank at the pick-up position matches the expected type/size/configuration of carton blank. For example, the top surface of each carton blank may include a bar code identifying its type/size/configuration and this bar code may be read at the pick-up position by a suitably positioned bar code reader. The type/size/configuration of the carton blank, read from this bar code, may be compared to the expected type/size/configuration of the carton blank, which may be determined from a record of the next scheduled carton blank stored in memory of the PLC 132, as described above. Verification is successful when there is a match. When there is not a match, the PLC 132 may issue a signal requesting manual operator intervention.

As indicated above, each carton blank in each magazine may be generally initially formed and provided in a flattened tubular configuration, such as, by way of the example that is illustrated in FIGS. 10A-10E. Each carton blank has a height dimension “H”; a length dimension “L”; and a major panel length “Q” (see FIG. 10B). The PLC 132 of each carton forming system 1100 may maintain, in its memory, each of these three dimensions for a carton blank to be processed by the carton forming system 1100 and, using these stored dimensions, the PLC 132 can determine the necessary positions and/or movements of at least some of the components of the carton forming system 1100, including the path of movement of the erector heads 120a, 120b as the erector heads 120a, 120b move and cycle through their processing sequences.

In this regard, for each carton blank in each of magazines M1 to M16, the PLC 132 may have the information necessary to adequately process each carton blank selected.

As was indicated above, in relation to a representative carton blank as shown in FIG. 11, each carton blank in each magazine may be designated with a first datum line “W1” that passes through the mid-point of the fold line between panel D and flap K and through the mid-point of the fold line between panel B and flap J. This first datum line W1 may be determined by the PLC 132 for a carton blank to be processed, based on the dimensions H, L and Q of the blanks stored by the PLC 132 or obtained by the PLC 132. The carton blank may also be designated with a second datum line “W2” that may be determined by the PLC 132 and which passes along, and is generally parallel to, the fold line between panel A and flap F. The first datum line W1 will be parallel to the second datum line W2. The PLC 132 may also determine the relative position of the bottom of the erected carton for the carton blanks in each magazine, as this will be aligned with a vertical datum plane passing through the first datum line W1 and the second datum line W2. Aligning the position of the second datum line W2 and of the datum plane with other components in the carton forming system 1100 may be shown to establish that the carton is properly positioned during processing. Also, the vertical distance R between the first datum line W1 and the second datum line W2 may be calculated by the PLC 132. This can ensure that the PLC 132 knows where it needs to position the erector head so that top panel A and, accordingly, the first datum line W1 are properly positioned throughout the processing of the carton blank by the carton forming system 1100.

The carton forming system 1100 may be shown to be able to track and modify the position of each carton blank as the carton blank is being processed and, in particular, the vertical position of the first datum line W1 of the carton blank as the carton blank moves longitudinally through carton forming system 1100 and as various components of the carton forming system 1100 engage the carton blank during its movements. This may be shown to establish that the carton blank being processed is appropriately positioned relative to the system components so that the system components engage the carton blank at the correct position on the carton blank during processing of the carton blank. For carton blanks that may be configured differently than the carton blank 111, suitable adjustments may possibly be required to the dimensions and datums maintained by the PLC 132, in order for the carton forming system 1100 to be able to process a particular size/configuration/type of carton blank.

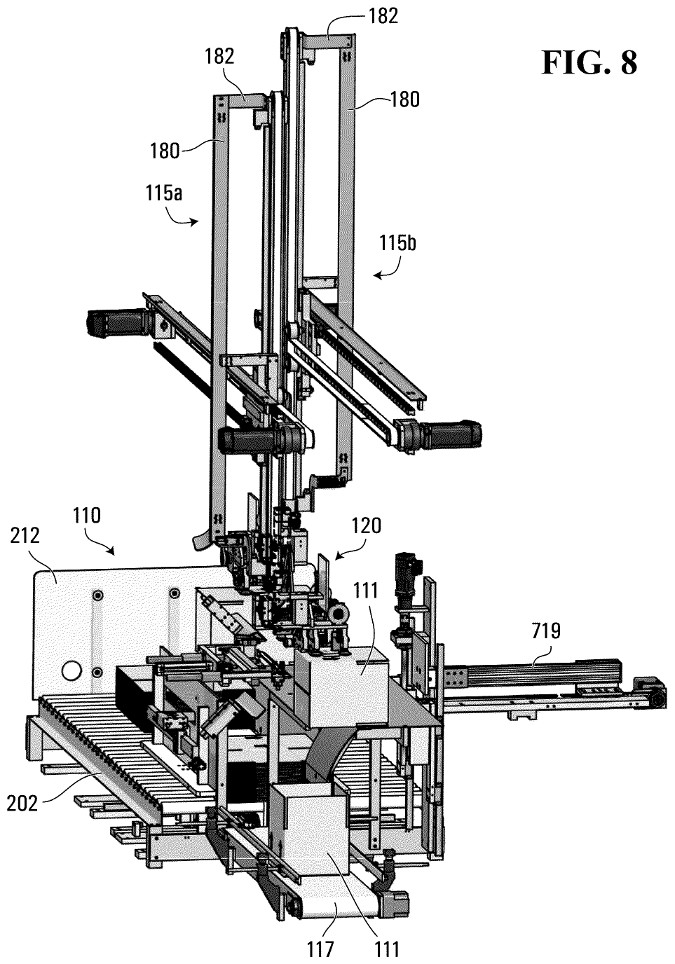

Once the carton blank has been formed and sealed to form an erected carton that is partially sealed and may be in a configuration such as shown in FIG. 16, the erected carton may be delivered from the discharge conveyor 117 (see, for example, FIG. 8) and may be placed onto an accumulation conveyor that may be part of the respective carton loader such as a particular one of the AMRs 1400 that may be associated with the particular carton forming system 1100 that formed the erected carton. Indeed, in aspects of the present application, responsive to the particular AMR 1400 arriving at the particular carton forming system 1100, a robotic arm (not shown) may be controlled to pick the erected carton from the discharge conveyor 117 and place the erected carton on the particular AMR 1400.

An order obtaining process may be considered to be initiated when an empty erected carton is moved from an accumulation conveyor and placed onto an AMR 1400 that can autonomously move around the warehouse, where the products handled by system 1100 are located. The AMR 1400 may be controlled to visit one or more loading stations in the product induction region 5208.

Once the order (or part order for a particular carton) has been obtained within the erected carton carried by the AMR 1400, such that all products have been loaded into the erected carton, the AMR may carry the erected carton to one of the final carton sealing apparatuses 1500. For example, the AMR 1400 may transfer the erected carton, with all products loaded therein, onto a predetermined Random Top Carton Seal (RTCS) in-feed conveyor that may feed the erected carton to a suitable top sealing device. The RTCS may be adapted to receive information provided by the order fulfillment processor 1300 so the RTCS may automatically adjust the sealing components of the device so that the device may close and seal the top of the erected and loaded carton. The sealed carton may then be conveyed into the route distribution accumulation region 5212 for further sorting and processing. An example of the type of suitable RTCS apparatus that could be employed as part of the order fulfillment system 1000 is the random carton sealer made by Marq Packaging Systems.

In operation of the order fulfillment system 1000, each one of a plurality of customers may use a customer order device, such as the order placement devices 1200, including possibly accessing the call center 1250. Through operation of appropriate software on the order placement devices 1200, the order placement devices 1200 may communicate directly or indirectly with the order placement processor 1300 so that multiple orders may be placed by customers, each order being for one or more products, into the order fulfillment processor 1300.

The order fulfillment processor 1300 may process the customer orders received directly or indirectly from customer order devices 1200. The order fulfillment processor 1300 may, for each order, utilize its database that includes information that may be stored therein, including information relating to: (a) details of all products that may be ordered by a customer through the order fulfillment system 1000, including the actual physical dimensions of each product (such as the dimensions of the item package in which an item is packaged), optionally, the weight of each product and, further optionally, product codes associated with each product; (b) details of each of a plurality of types/sizes/configurations of carton blanks that can be used in the order fulfillment system 1000 to package one or more products ordered by a customer, including the dimensions of each carton/carton blank; (c) details of each carton forming system (e.g., the carton forming systems 1100A, 1100B, 1100C), including the types of erected cartons that each carton forming system is capable of forming and, optionally, when a carton forming system includes multiple magazines, the type of carton blank provided in each of those magazines and the corresponding type of erected carton that can be formed from each type of carton blank and, further optionally, the quantity of carton blanks provided in each of those magazines; (d) information about each customer, including the name of the entity and the shipping address to which an order fulfilled by the order fulfillment system 1000 is to be shipped; and (e) information about where each product is located in a warehouse building housing products that may be ordered.

The order fulfillment processor 1300 may also, for each order, use the product packaging utility to identify a suitable carton and, possibly, an optimum carton (e.g., having a particular type/size/configuration) from the packaging suite of a limited and predetermined number of types/sizes/configurations of cartons. Thus, when each order for specific products is input into the order fulfillment processor 1300, the product packaging utility can determine the optimal carton or carton that can be used to package the products for each order (e.g., determine the least number of cases and/or the smallest size of cases that are required to package all the products in the customer order).

The order fulfillment processor 1300 may then, for each order, generate a fulfillment order data structure that may be communicated by a communication link to the PLC 132 of one of the carton forming systems 1100. The order fulfillment processor 1300 may have determined to which of the carton forming systems 1100 to send each fulfillment order data structure either randomly or based on availability and/or suitability to handle the carton type/size/configuration determined for a particular customer order. The fulfillment order data structure may include information including: (i) the type/size/configuration of erected carton determined by the product packaging utility that is required to be formed by the carton forming system 1100; (ii) the particular magazine of the carton forming system containing carton blanks for forming the required type/size/configuration of carton; (iii) a list of the particular product(s) from the customer order being fulfilled that are required to be loaded into the required erected carton once formed, optionally arranged in the order in which the products should be loaded into the carton once formed; (iv) optionally, a diagram illustrating a desired optimal physical arrangement of the product(s) in loading the erected carton; (v) optionally, the location in the warehouse building of each particular product from the customer order being fulfilled; and (vi) customer shipping information for that carton, indicating the destination name and address for that carton.

Each fulfillment order data structure may then be received and processed by the PLC 132 of the carton forming system to which the data structure is sent. In particular, the PLC 132 of the carton forming system processes the fulfillment order data structure to identify the type/size/configuration of the erected carton required, the particular magazine of the carton forming system containing carton blanks for forming each required type/size/configuration of erected carton and the contents of the label (or labels) to be applied. Once a required type/size/configuration of carton blank and the particular magazine containing carton blanks for forming the required type/size/configuration of erected carton have been identified, the PLC 132 of the carton forming system may cause a carton blank from the identified magazine to be formed, generally as outlined above.

In particular, the PLC 132 activates the appropriate conveyor of magazine conveyors 1203(1) to 1203(16), corresponding to the identified magazine, if required to move a stack of carton blanks of the identified type adjacent to the in-feed conveyor 1204. The transfer apparatus may, under the control of the PLC 132, then transfer the desired carton blank from the identified magazine to the in-feed conveyor 1204. The in-feed conveyor 1204 may be shown to then, under the control of the PLC 132, move that carton blank longitudinally and then, when signaled by the PLC 132, to do so, transfer the carton blank to the alignment conveyor 1206.

The alignment conveyor 1206, also under the control of the PLC 132, may then move the carton blank to the pick-up position and the PLC 132 may then also cause the side walls 1201, 1202, to transversely align the carton blank so that the carton blank is at the correct pick-up position. The PLC 132 may then cause the carton forming components of the carton forming system, including an erecting head 120, to be moved by the movement sub-system to pick up the carton blank 111 from the pick-up position and erect and partially seal an erected carton from the carton blank 111. The PLC 132 may, on an on-going basis, as each carton blank is being processed, cause any adjustments in components of the folding and sealing apparatus 130 to be made to accommodate each carton blank 111 as a plurality of carton blanks 111 are processed.

Once the erected carton has been formed for a particular customer product order, the erected carton may then be physically transferred to an AMR 1400. The AMR 1400 may then be controlled to visit stations in the product induction region 5208 at which the products may be received within the erected carton.

As briefly discussed hereinbefore, the stations in the product induction region 5208 may be associated with provision of products that are stored in the tower storage region 5204. Also as briefly discussed hereinbefore, in some embodiments, a plurality of towers, which may be used to store products, may be located in the tower storage region 5204, although towers are not specifically illustrated in the tower storage region 5204 in FIG. 52.

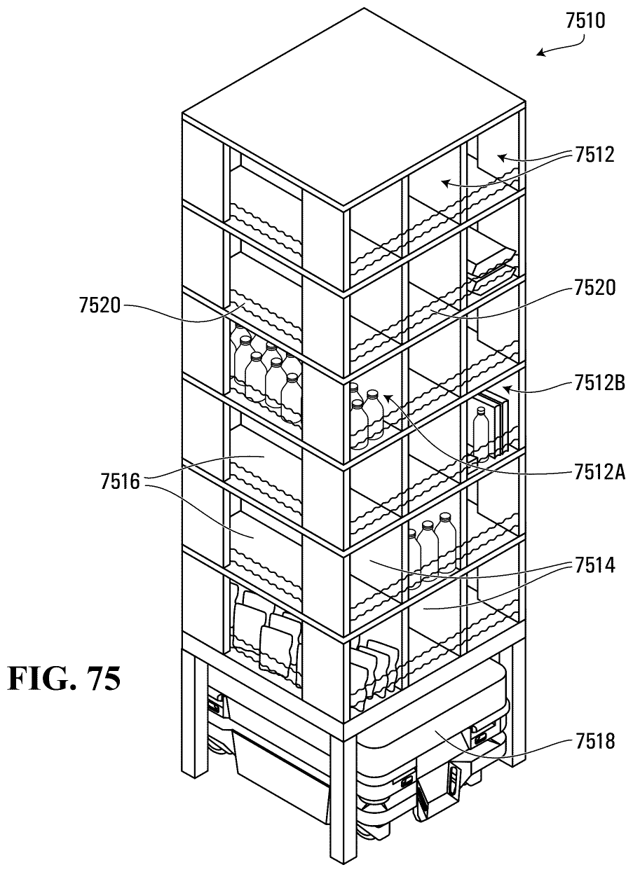

FIG. 75 illustrates a perspective view of a tower 7510, among the plurality of towers, which may be used to store products, in accordance with an example embodiment of the present application. As shown, the tower 7510 may have compartments 7512 for storage of individual products within the compartments 7512. Some compartments, such as a first compartment 7512A, of the tower 7510 may be filled with individual products corresponding to the same stock keeping unit (SKU). Some other compartments, such as a second compartment 7512B, of the tower 7510 may be filled with individual products corresponding to at least two different SKUs. Each compartment 7512 may have one or more openings, such as first openings 7514 or second openings 7516, through which individual products may be stored in the tower 7510 and taken out of the tower 7510.

The storing of products in the plurality of towers 7510 may, generally, involve the following steps. When products arrive at the order fulfillment location 5200, often organized on a pallet, any packaging surrounding the products may first be removed, so that individual product items may be accessible. In some embodiments, the individual product items may also be checked for obvious defects. Assuming no defects are found, personnel may pick up the individual product items and store them into the compartments 7512 of the plurality of towers 7510. Once a particular product item has been stored into a particular compartment 7512, the personnel may scan a barcode on the particular product item and/or a barcode located on the tower 7510 (e.g., a barcode associated with the particular compartment 7512 in which the particular product item has been stored), so that the order fulfilment processor 1300 is aware of a location for the particular product item. This process may also be done automatically. For example, there may be one or more robots for removing packaging, one or more robots for picking up individual product items and storing them into the compartments 7512 of the plurality of towers 7510, and one or more robots for ensuring that information regarding the location (e.g., a particular component 7512 of a particular tower 7510) of each stored individual product item is known to the order fulfilment processor 1300.

Each opening, such as the first opening 7514 or the second opening 7516, of the compartments 7512 may be covered by one or more flexible strips 7520, which may prevent the individual products stored within the compartments 7512 from falling out of the respective compartment 7512, for example, during transportation of the tower 7510 by a tower-transportation AMR 7518.

In operation, the tower-transportation AMR 7518 may engage with the tower 7510 and transport the tower 7510 to the product storage induction region 5202, where, as discussed hereinbefore, personnel and/or robots 5999 may unload products delivered to the order fulfilment system 5200 (such as by transport trailers and which product may be on pallets) store products into the tower 7510. Once the tower 7510 is sufficiently filled with products, the tower-transportation AMR 7518 may transport the tower 7510 to an available location within the tower storage region 5204.

When one or more products stored in the tower 7510 are required for fulfilling an order, the order fulfilment processor 1300 may instruct the tower-transportation AMR 7518 to transport the tower 7510 between a first location in the midst of the tower storage region 5204 and a second location in the product induction region 5208. The tower-transportation AMR 7518 may be a device manufactured by Amazon Robotics, formerly Kiva Systems, of North Reading, MA. The tower-transportation AMR 7518 may navigate around the tower storage region 5204. When the tower-transportation AMR 7518 reaches the first location, the tower-transportation AMR 7518 may slide underneath the tower 7510 and lift the tower 7510 off the ground through, e.g., a corkscrew action. The tower-transportation AMR 7518 may then carry the tower 7510 to the second location in the product induction region 5208.

Conventional AMRs are known to navigate in a variety of ways. A conventional AMRs may include an upward facing camera to be used to read a bar code on the underside of the tower 7510. Additionally, a conventional AMRs may include a downward facing camera to be used to read bar codes on the floor of the tower storage region 5204. The bar codes may be understood to allow an AMR to determine its instant location information and navigate accordingly. The location information may be combined with readings from other navigation sensors, such as encoders, accelerometers and rate gyroscopes. Conventional AMRs are also known to include collision detection systems, which may be implemented as infrared sensors and touch-sensitive bumpers, which may act to cause the AMR to stop in response to people or objects getting in the way of AMR navigation.

In some embodiments, a tower 7510 in the tower storage region 5204 may be identified, for example, by the order fulfillment processor 1300, as storing one or more products for fulfilling an order. The tower 7510 storing the one or more products for fulfilling the order, or simply the one or more products, may be transported from the tower storage region 5204 to a particular station in the product induction region 5208. This transportation may be performed manually or automatically. For example, a plurality of tower-transportation AMRs 7518 (not shown) may generally be designated for transporting towers 7510 between the tower storage region 5204 and the product induction region 5208. A fulfillment order data structure generated by the order fulfillment processor 1300 may include tower-transportation AMR instructions for one of the plurality of tower-transportation AMRs 7518 to engage with the tower 7510 and transport the tower 7510 to the particular station in the product induction region 5208, where the erected carton may receive the one or more products for fulfilling the order. Indeed, loading of the one or more products into the erected carton may be carried out manually or in a robotic manner. A station in the product induction region 5208 at which the loading of the one or more products into the erected carton is carried out manually may be called a “manual product induction station.” A station in the product induction region 5208 at which the loading of the one or more products into the erected carton is carried out in a robotic manner may be called a “robotic product induction station” or a “product transfer apparatus.” For example, a loading robot (not shown) may be positioned near and/or be assigned to a robotic product induction station in the shipping container induction region 5208. When a tower (see, for example, the tower 7510 of FIG. 75) storing one or more products for fulfilling an order is transported to the robotic product induction station, the loading robot may be instructed by the order fulfillment processor 1300 to retrieve the one or more products from one or more compartments of the tower 7510 and load them into the appropriate case or carton. For example, the loading robot may include an extendable arm capable of reaching for a specific product within the one or more compartments of the tower 7510 and loading the specific product into the case. The product induction region 5208 may include one or more loading robots for loading products from towers 7510 into cases, e.g., one loading robot may serve one robotic product induction station, or a plurality of robotic product induction stations, in the product induction region 5208. In this way, the AMR 1400, which supports the erected carton, may travel to one or more stations in the product induction region 5208 and, at each station, receive, from a respective tower 7510, one or more products for fulfilling the order, each tower 7510 having been transported from a first location in the tower storage region 5204 to the respective station by a respective tower-transportation AMR 7518 having received tower-transportation AMR instructions by the order fulfillment processor 1300.

Once the order (or part order for a particular carton) has been obtained by the AMR 1400, such that all products have been loaded into the erected carton, either at a manual product induction station or at a robotic product induction station, the AMR 1400 may carry the loaded carton to one of the final carton sealing apparatuses 1500A, 1500B, 1500C. For example, the AMR 1400 may carry the erected carton, with all products loaded therein, through a predetermined Random Top Carton Seal (RTCS) in-feed conveyor that may feed the erected carton to a suitable top sealing device. The RTCS may be adapted to receive information provided by the order fulfillment processor 1300 so the RTCS may automatically adjust the sealing components of the device so that the device may close and seal the top of the erected and loaded carton. The finished carton may then be conveyed into the central carton distribution system for further sorting and processing.

The further sorting and processing may include labeling the finished carton. The labelling device 1281, illustrated in FIG. 63, may be considered to be configured for labeling a carton blank 111 before the carton blank 111 is formed by the carton forming system 1100. Alternatively, a labelling device (not shown) may be employed to label the finished carton at the output end of the final carton sealing apparatuses 1500A, 1500B, 1500C.

In the case of labeling a erected carton while the erected carton remains in control of the carton forming system 1100, the labelling device 1281 may be mounted to the frame of carton forming system 1100 in the vicinity of the alignment conveyor 1206. For example (although not depicted as such in FIG. 63, for simplicity), the labelling device 1281 may be mounted to a frame portion of carton forming system 1100 generally above where a carton blank 111 is located when the carton blank 111 is in the pick-up location. The labelling device 1281 may be operable to print and apply one or more labels to one or more panels, preferably upward facing panels, of the carton blank 111 located at the pick-up location. The labelling device 1281 may be any suitable device, such as the PLS-500 label application system made by Paragon Labeling Systems Inc. of White Bear Lake, MN, in conjunction with an integral print engine, such as a Lt408 print engine or a S84 Series print engine (e.g., model nos. S8408, S8412 or S8424) made by SATO America, Inc. of Charlotte, NC. While, in some embodiments, a labelling device may apply a physically separate label to a finished carton or a carton blank 111, in other embodiments, the labelling device may apply printing to the finished carton or the carton blank 111 without providing the printing on a physically separate label.

As noted above, the label or labels applied to an upward facing panel of each carton blank 111 by the labelling device 1281 may be specifically configured for that particular carton blank 111 and may contain various types of information relating to an order of products to be fulfilled and placed into the erected carton to be formed from that particular carton blank 111. The label or labels may contain information providing certain order information including types of products to be loaded into the erected carton to be formed from that blank, optionally including product codes of those products, the customer to whom the case is to be shipped and the customer's address. The label or labels may also contain a unique carton identifier. Some or all of the information may be provided in bar code format.

The label is, in aspects of the present application, printed and applied to the carton blank 111 while the carton blank 111 is in a flattened configuration at the pick-up location and prior to being erected and bottom sealed. This may make the label application process more reliable and provides the carton blank 111 with a unique identification.

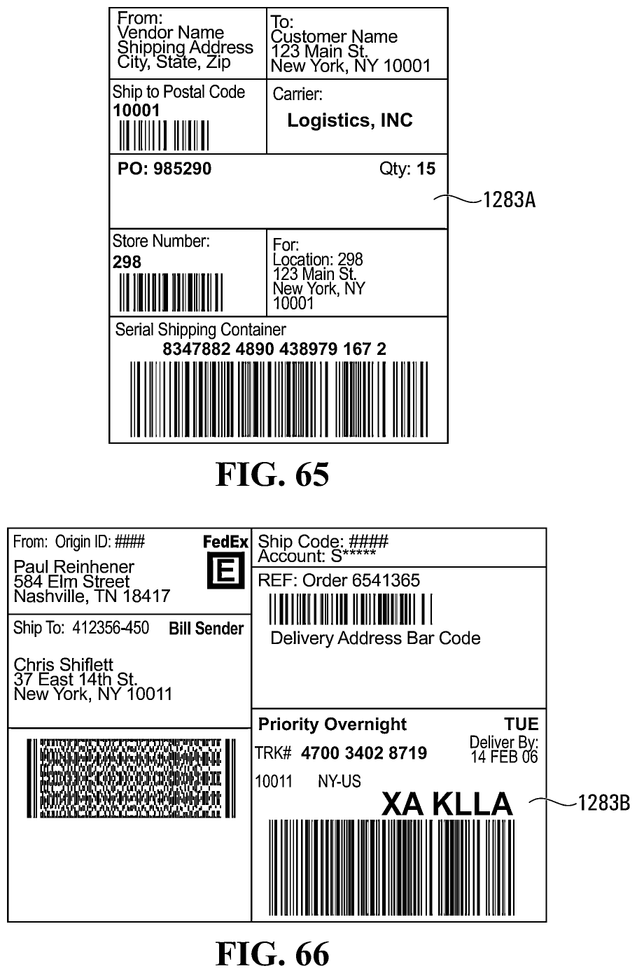

A first example label 1283a that might be applied by the labeling device 1281 is illustrated in FIG. 65. A second example label 1283b that might be applied by the labeling device 1281 is illustrated in FIG. 66.

Various modifications are also possible in some embodiments. By way of example only, instead of providing for the magazine conveyors 1203(1) to 1203(N) for magazines M1 to M(N), it may be possible to provide for a robotic system which could extract carton blanks as demanded by the PLC 132 from any one of a stack of carton blanks in each of the magazines. The robotic system could place a particular carton blank that may be required on an in-feed conveyor. In other embodiments, the in-feed conveyor could be eliminated and the robotic system may place each carton blanks that is required at the pick-up position.

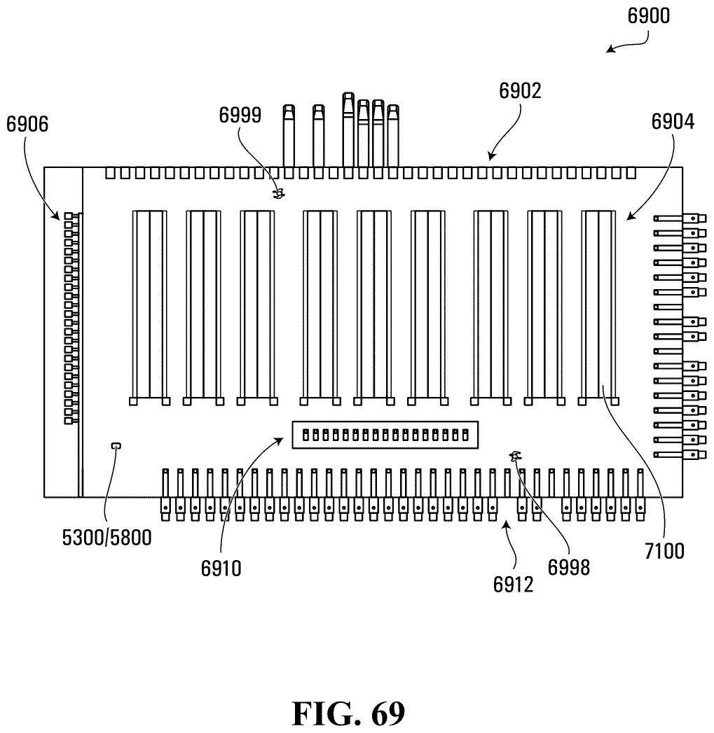

Other fulfilment systems are contemplated. For example, FIG. 69 illustrates a schematic plan view of an order fulfilment center 6900. The order fulfilment center 6900 may share similarities with the order fulfilment center 5200 described in detail above. In this example embodiment, the order fulfilment center 6900 includes a product storage induction region 6902, a product storage region 6904, a shipping container induction region 6906, an order verification and sealing region 6910, and a route distribution accumulation region 6912. Depending on the size of the order fulfillment center 6900, the order fulfillment center 6900 may include multiples of one or more of the regions illustrated in FIG. 69 and may, in some cases, omit one or more regions.

Like shipping container induction region 5206 described above, the shipping container induction region 6906 of FIG. 69 may be populated with a plurality of receptacle forming systems, which may also be referred to as shipping container delivery systems, perhaps with one or more of such systems following the design of the carton forming system 100 disclosed hereinbefore. In some embodiments one or more of the receptacle forming/delivery systems of a plurality of receptacle forming/delivery systems may only be capable of producing/delivering a single size/configuration/type of receptable to an AMR.

According to aspects of the present application, a plurality of AMRs (e.g., AMRs 5300 and/or 5800 and/or 5850) may be deployed for movement within the warehouse, between the various illustrated regions, as will be explained in greater detail further below. For example, an AMR may be controlled to visit the shipping container induction region 6906 to obtain a shipping case (or other receptacle), and subsequently controlled, with the shipping container secured thereon, to visit the product storage region 6904 to receive one or more products within the shipping container for fulfilment of an order.

At the product storage induction region 6902, various products may be shown to arrive at the order fulfillment center 6900, for example, in a plurality of transport trailers. Multiple units of a single SKU may be grouped into a container, and multiple containers may be grouped into a pallet. The term “pallet” may, in some cases, refer to a stacked structure of containers resting on a pallet base, for handling using machines, such as forklifts 6999. The term “pallet” may, in some other cases, refer to the pallet base. In some embodiments, a plurality of pallets may arrive as one unit and the unit may have to be separated into individual pallets by personnel and/or machinery. For example, the plurality of pallets may be tied or wrapped together and subsequently untied or unwrapped prior to being stored.

Pallets may be transported to specific corresponding locations in the product storage region 6904. Such transportation may be done using forklifts 6999, which forklifts may be operated manually by an operator or, in other instances, may operate automatically. In a preferred embodiment, the forklifts 6999 may be implemented as automated guided vehicles (AGVs).

The product storage region 6904 may comprise a plurality of product storage racks 7100. At the product storage region 6904, the pallets may each be placed in a corresponding storage location. For example, for a particular pallet, the forklifts 6999 may receive, e.g., a set of coordinates or directions, pertaining to a particular storage rack located within the product storage region 6904, and a specific area within the particular storage rack, the particular pallet should be stored. In this way, each product storage rack 7100 may be populated with pallets corresponding to the various products.

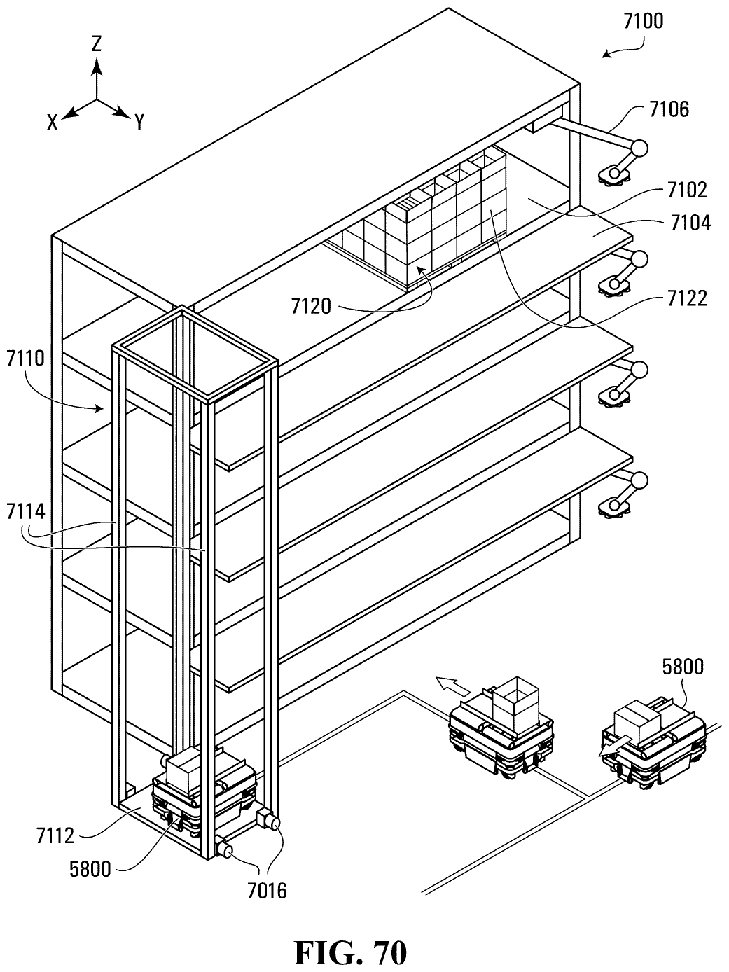

FIG. 70 illustrates a perspective view of part of a product unloading system of an order fulfilment center, in accordance with an example embodiment of the present application. The product unloading system part of FIG. 70 is illustrated as including a product storage rack, among the plurality of product storage racks 7100 in FIG. 69, and an AMR elevator 7110. The product storage rack 7100 may include a plurality of storage levels 7102 for storing pallets, such as a first pallet 7120, containing products. As mentioned hereinbefore, each pallet may contain individual products of a particular SKU. In some embodiments, each pallet may contain a structured set of identical containers, such as containers 7122, each container 7122 containing one or more of a particular SKU (e.g., the container may be a box containing one or more sets of a trio of books sold as one unit). In some embodiments, one or more pallets may contain various different products as opposed to one particular SKU.

The product storage rack 7100 may further include a plurality of raised platforms 7104, each one of the plurality of raised platforms 7104 positioned proximate to a respective one of the plurality of storage levels 7102. Each of the raised platforms 7104 may be configured for travel of an AMR 5800/5850 thereon.

The product storage rack 7100 may further include one or more product retrieval robots, such as a robotic picker arm 7106. In some embodiments, a robotic picker arm 7106 may be associated with one respective storage level 7102 of the product storage rack 7100, as illustrated. In some embodiments, a robotic picker arm 7106 may serve multiple storage levels 7102 of the product storage rack 7100. Each robotic picker arm 7106 may be configured to retrieve individual products from the pallets, and load the products into appropriate shipping containers carried by the AMRs 5800/5850.

Specifically, each robotic picker arm 7106 may be equipped with an end effector suitable for selectively retrieving individual articles from containers within the pallets, and releasing the articles into the appropriate shipping containers carried by the AMRs 5800/5850. The configuration of the end effector of a robotic picker arm 7106 may depend on characteristics of articles to be moved. For example, articles with planar surfaces and relatively low weight may be effectively engaged using an end effector with one or more vacuum cups. Other articles, for example, articles having curved or irregular surfaces or relatively high weight, may be grasped with claws or with clamping devices of corresponding size and shape.

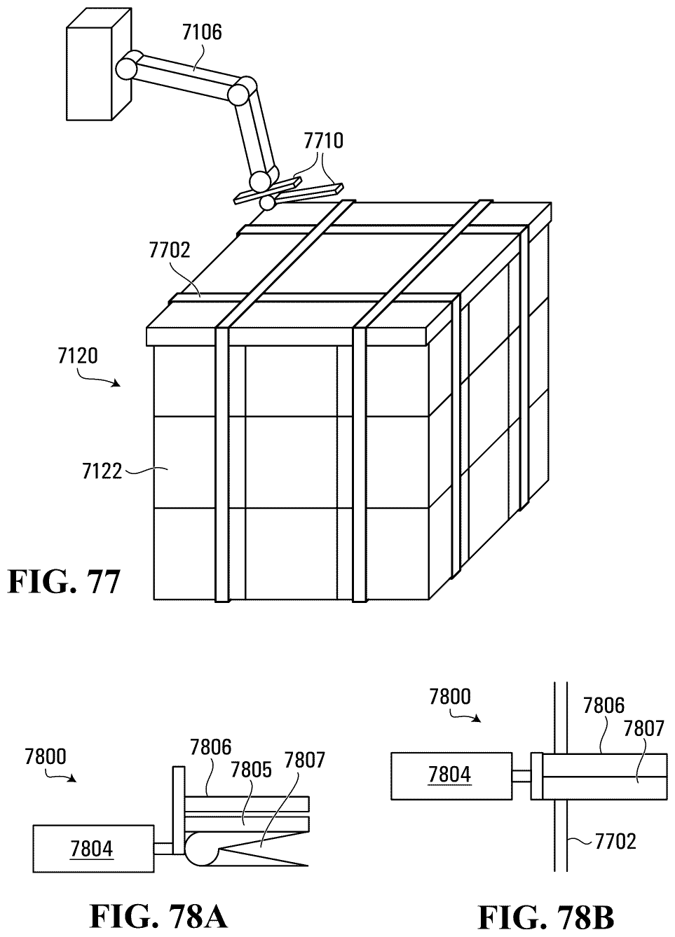

In some embodiments, multiple, interchangeable end effectors may be available. For example, one or more of the robotic picker arms 7106 may be equipped with a releasable linkage, the linkage configured to engage with or disengage with a selected one of a plurality of end effectors. For example, FIG. 77 shows an example robotic picker arm 7106 having connectors 7710, which may be used to engage with the plurality of end effectors. The connectors 7710 may include physical linkages, such as quick connects for electrical connections and pneumatic connections. Available end effectors (not shown) may be placed in one or more rest locations accessible by the robotic picker arms 7106. When needed, a robotic picker arm 7106 may move to engage, via the connectors 7710, with a suitable end effector and employ the end effector to perform a specific task. After the task has been performed, or when a different end effector is needed, the robotic picker arm 7106 may return to a rest location and release the connectors 7710 to return the end effector.

The robotic picker arm 7106 may be further configured to perform de-palletizing operations. For example, the robotic picker arm 7106 may be configured to remove packing material from a pallet, such as strapping 7702, or to open or dismantle containers within the pallet in order to access individual articles held in the containers. The robotic picker arm 7106 may be further configured to dispose of any removed packaging material. For example, the robotic picker arm 7106 may grasp the packaging material and transfer the packaging material to a disposal site, such as a chute (not shown).

To achieve the de-palletizing operations, the robotic picker arm 7106 may engage with an end effector configured to be used in de-palletizing operations. In some embodiments, such an end effector may be a destrapper-debander.

For example, FIGS. 78A and 78B illustrate a destrapper-debander 7800. The destrapper-debander 7800 may include one or more of a motor 7804, a roller (not shown), a scissor 7807, and a clamp including a clamp top part 7806 and a clamp bottom part 7805. In operation, a cycle may begin as the robotic picker arm 7106 positions the destrapper-debander 7800 proximate the strapping 7702. The clamp parts 7805/7806, using a pinching mechanism, may hold the strapping 7702 in place. Once the strapping 7702 is held in place, the scissor 7807 may slice the strapping 7702. Because the clamp parts 7805/7806 are holding the strapping 7702 in place, the strapping 7702 may maintain its position while tension is released, thereby avoiding undesired unpredictable movement. Once the strapping 7702 is cut, the motor 7804 may spin the destrapper-debander 7800 to wind the strapping 7702 about the entire destrapper-debander 7800. The roller (not shown) may be a spring-loaded roller employed to maintain the position of the strapping 7702 on the destrapper-debander 7800 as the strapping 7702 forms a wound reel around the destrapper-debander 7800.

Once the strapping 7702 is completely wound, the robotic picker arm 7106 may place the strapping 7702 in a dunnage drop zone or chute (not shown). Specifically, the robotic picker arm 7106 may move the destrapper-debander 7800 to be positioned above the dunnage drop zone or chute. There, the clamp parts 7805/7806 may disengage from holding the strapping 7702, thereby allowing the wound reel of the strapping 7702 to fall down the chute. Alternatively, there may be a mechanism (not shown) to push the wound reel of the strapping 7702 off the destrapper-debander 7800 so that the wound reel of the strapping 7702 may fall down the chute. This cycle may be repeated as necessary to remove any/all straps from a pallet 7120.

The robotic picker arm 7106 may be mounted on a rail (not shown) above an associated storage level 7102. Such configuration provides effective access to articles through the tops of cases. However, other mounting arrangements are possible. For example, the robotic picker arm 7106 may be mounted below the associated storage level 7102 or suspended on a side frame. Alternatively, the robotic picker arm 7106 may be an element of a free-standing autonomous robot, which can move along the storage levels 7102 and/or the raised platforms 7104, perhaps utilizing the AMR elevator 7110 to travel to other raised platforms 7104 or to the ground level of the order fulfilment center 6900.

The robotic picker arm 7106, as illustrated in FIG. 70, may be able to move in multiple axes, e.g., in the x-axis, the y-axis, and the z-axis, on rails (not shown) and, therefore, may be able to reach any product stored on the associated storage level 7102.

The AMR elevator 7110 may be configured to transport an AMR 5800/5850 between the ground and any of the raised platforms 7104 of the product storage rack 7100. The AMR elevator 7110 may include a receiver dock 7112 positioned between vertical rails 7114. The loading dock 7112 may be configured to move vertically along the vertical rails 7114 using actuators 7016. In some embodiments, the AMR elevator 7110 may further include wheels or other means to configure the AMR elevator 7110 to travel along the x-axis and the y-axis. In some embodiments, one AMR elevator 7110 may serve one product storage rack 7100. Alternatively, one AMR elevator 7110 may serve multiple product storage racks 7100.

In operation, the AMR elevator 7110 may be controlled to receive an AMR having a shipping container, or other receptacle, secured thereon, such as the AMR 5800/5850 illustrated in FIG. 70, at the loading dock 7112, and transport the AMR 5800/5850 from the ground level to one of the raised platforms 7104. Once the AMR 5800/5850 has reached its intended platform 7104, the AMR 5800/5850 may exit the loading dock 7112 onto the raised platform 7104 and move along the raised platform 7104 until the AMR 5800/5850 reaches an instructed spot for receiving a specific product required for fulfilling an order. The robotic picker arm 7106 may engage with and retrieve the required product from a container within a corresponding pallet, such as the container 7122 within the first pallet 7120, and load the required product into the shipping container, after which the AMR 5800/5850 travels back towards the AMR elevator 7110 and onto the loading dock 7112, after which the AMR 5800/5850 is transported to the ground level. If a particular product storage rack 7100 has multiple items required to fulfil the order, the AMR elevator 7110 may be controlled to transport the AMR 5800/5850 to all of the necessary raised platforms 7104 of the product storage rack 7100 to receive the various items. This process may repeat at one or more product storage racks 7100 until the shipping container has received all of the products required to fulfil an order. The AMR 5800/5850 may then be controlled to travel elsewhere for further processing.

In some embodiments, a product retrieval robot, such as the robotic picker arm 7106, may include a sensor for detecting the product to be retrieved for a shipping case. For example, the sensor may include a camera and the robotic picker arm 7106 may be configured to use computer vision to detect the product to be retrieved. The robotic picker arm 7106 may be configured with one or more grippers, such as suction cups or any other suitable grippers, for retrieving products. In some embodiments, the product unloading system may be organized in such a way that at least a section of a storage level 7102 has pallets or containers containing similarly shaped and/or similarly sized, and/or similarly packaged, positioned close to one another. The corresponding robotic picker arm 7106 serving that section may be equipped with a gripper, which may more easily interact with products of that shape and/or size and/or packing.

In embodiments where one or more pallets contain a structured set of identical containers, each container containing one or more of a particular SKU, the dimensions of each container, as well as the way in which the containers are organized, may be known to the product retrieval robot. For example, the embodiment illustrated in FIG. 70 shows the first pallet 7120 containing a structured set of identical containers 7122. In such embodiments, instead of, or in addition to, using computer vision, the product retrieval robot may be numerically guided to retrieve one of the containers and load the retrieved container into a shipping case.

In some embodiments, each product retrieval robot may be configured to load products into one type of shipping case (e.g., one robot may be configured to load products into an open-top regular slotted case and another robot may be configured to load products into an open-sided envelope). In some embodiments, one or more product retrieval robots may be configured to load products into more than one type of shipping case, and the robot may be able to determine, e.g., using the camera and computer vision, which type of shipping case into which the product retrieval robot is to load a particular product, so that the product retrieval robot may accurately load the product into the shipping case.

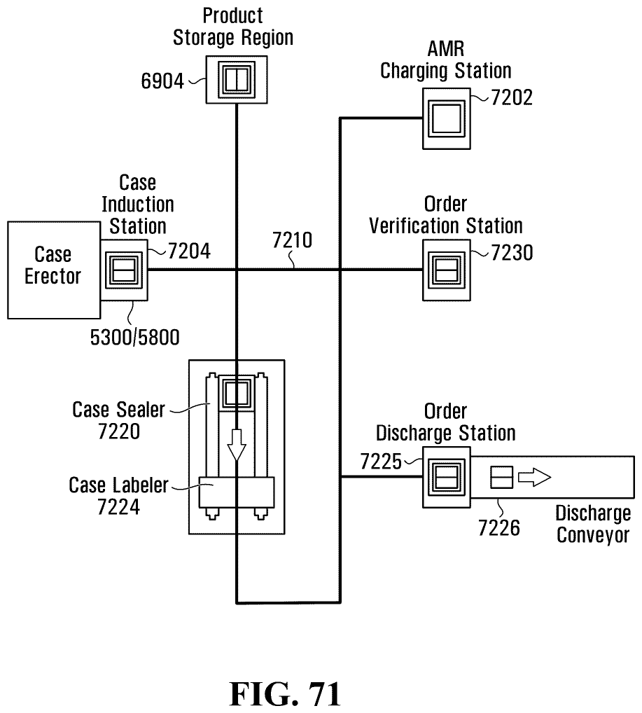

FIG. 71 illustrates an embodiment of an example concept of the fulfillment center 6900 that utilizes AMR devices such as the AMR 5300 of FIG. 53 and/or the AMR 5800 of FIG. 58A and/or the AMR 5850 of FIG. 58B, as described herein. In similar fashion to what has been previously described in relation to FIG. 56A, an AMR, such as the AMR 5300 or the AMR 5800 or the AMR 5850 in the system, can be programmed to move from station to station along an example path 7210 and process orders as follows.

The AMR 5300/5800/5850 moves to one of several case induction stations 7204, where a shipping container delivery system (e.g., a case erector, as described hereinbefore) has produced a shipping case that is sized appropriately for a particular customer order. The case induction stations 7204 may be part of the shipping container induction region 5206 (FIG. 52), 6906 (FIG. 69). The case erector transfers the shipping case onto the AMR 5300/5800/5850 and the AMR 5300/5800/5850 secures the shipping case onto itself according to one of the methods described previously.

The AMR 5300/5800/5850 moves to the product storage region 6904, where the shipping case secured onto AMR 5300/5800/5850 receives, from one or more product storage racks 7100, one or more products required to fulfil the customer order according to the methods described above in relation to FIG. 70.

The AMR 5300/5800/5850 then moves to one of a plurality of order verification stations 7630 so that the contents of the shipping case can be verified as corresponding to the products of the customer order.

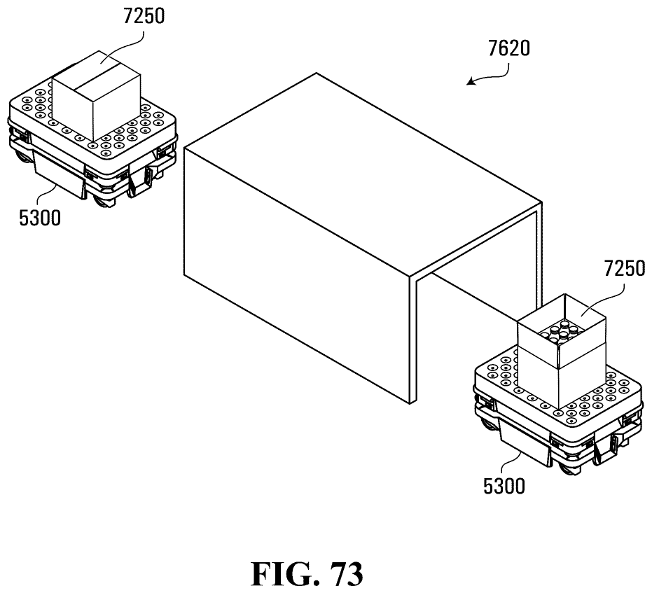

The AMR 5300/5800/5850 then moves to a case sealer 7220, among a plurality of case sealers 7220, and to a case labeler 7224 so that the shipping case may, in turn, be sealed and labelled. For example, if the shipping case is a bottom-sealed regular slotted case, the top of the case can then be sealed by the case sealer 7220 and labelled, e.g., with a label containing information helpful for shipping the sealed shipping case to the customer. In some embodiments, order verification, case sealing, and/or case labelling may be achieved at the same station, as described below in relation to FIG. 73.

The AMR 5300/5800/5850 then moves to a case discharge station 7225, where the sealed shipping case can be unloaded from the AMR 5300/5800/5850 onto a discharge conveyor 7226 to be subsequently loaded, by personnel and/or robots 6998, into a delivery vehicle.

The AMR 5300/5800/5850 may then move to a charging station 7202 or return to a case induction station 7204 to receive a shipping container that is sized appropriately for a different customer order and repeat the cycle.

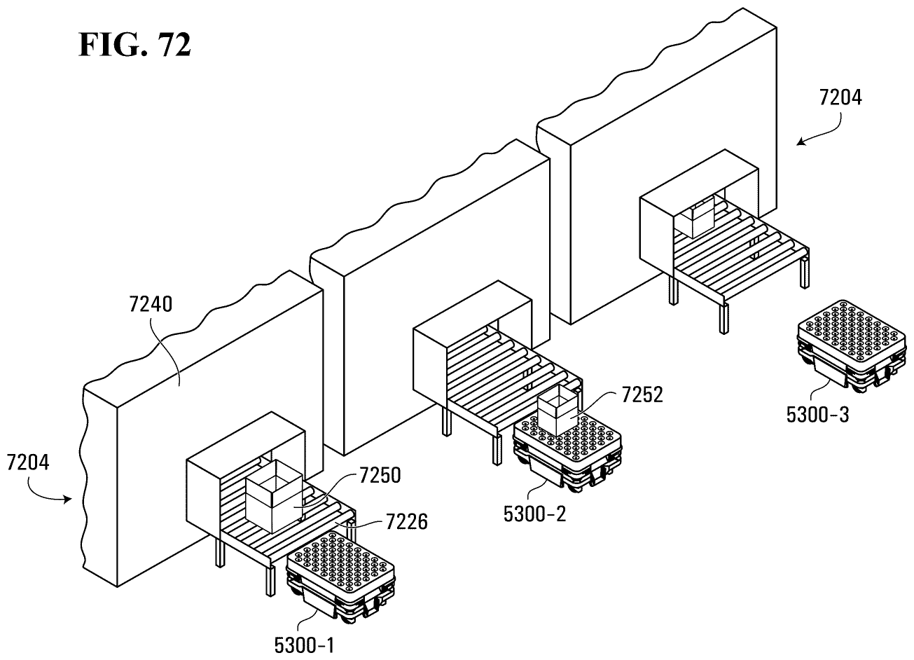

FIGS. 72-74B provide more detail on steps 1, 3, 4, and 5 of the example process 7210.

FIG. 72 illustrates a perspective view of a plurality of case induction stations 7204 of the order fulfilment center FIG. 69. Each case induction station 7204 is positioned at a tail end of a case erector or a carton forming system, such as the carton forming system 100, located within shipping container induction region 6906. Each case induction station 7204 may include a case discharging system 7240, which may include a discharge conveyor 7226. As shown, a shipping case, such as a case 7250, may be constructed by a case erector and may be loaded onto the discharge conveyor 7226. An AMR may be instructed to travel to the discharge conveyor 7226. The AMR may then be instructed to wait to receive the case (AMR 5300 is shown, but it may, alternatively, be AMR 5800 or AMR 5850 or another shipping container AMR). For example, illustrated is a first AMR 5300-1, which has traveled to a first case induction station 7204 and is waiting to receive a first case 7250, a second AMR 5300-2, which has traveled to a second case induction station 7204 and received a second case 7252, and a third AMR 5300-3, which is traveling to a third case induction station 7204 to then wait to receive a third case.

In some embodiments, each case erector may be configured to construct and deliver one type of shipping case (e.g., a regular slotted case), and may be configured to construct and deliver only one particular size of case. In some embodiments, one or more of the case erectors may be configured to construct more than one type of shipping case (e.g., a regular slotted case and an open-sided envelope). In such embodiments, one or more of the case erectors may be configured to construct more than one size of case. Regardless of the capabilities of any one particular case erector, the plurality of case erectors within the shipping container induction region 6906 may be able to construct a variety of shipping case types, in a variety of sizes, so that an appropriately sized, appropriate type of container may be constructed for a customer order. For example, as illustrated in FIG. 72, the first case 7250 may be larger than the second case 7252, as the first case 7250 may have been constructed for a customer order having more products, or larger-sized products, than the second case 7252.

Once the AMR 5300/5800/5850 has received a case, the AMR 5300/5800/5850 may be instructed to travel to the product storage region 6904 so that the case may be filled with one or more products required to fulfil the customer order.

FIG. 73 illustrates a perspective view of an order verification and case sealing station 7620 located in the order verification and sealing region 6910. Conveniently, each order verification and case sealing station 7620 may be configured such that the first case 7250 containing a customer's requested products does not have to be unloaded from and re-loaded onto the AMR 5300/5800/5850 it travels on. Instead, the first case 7250 remains secured onto the AMR 5300/5800/5850, and the AMR 5300 and the first case 7250 move through the case sealing station 7620 together. The case sealing station 7620 may be configured with means (not shown) for verifying that the one or more products within the first case 7250 is accurate and complete and means for sealing the container. In some embodiments, each order verification and case sealing station 7620 may be configured to interact with one type of shipping case (e.g., an top-open regular slotted case vs. a side-open envelope). In some embodiments, one or more verification and case sealing stations 7620 may be configured to interact with more than one type of shipping case. Regardless of the capabilities of any one verification and case sealing station 7620, the plurality of stations 7620 within the order verification and sealing region 6910 may be able to perform verification and sealing services for a variety of shipping case types and for a variety of size types.

In some embodiments, one or more of the order verification and case sealing stations 7620 may further be configured for labelling a case after verification and sealing, with a label (not shown) containing information required for proper delivery to (e.g., sender name and address, recipient name and address, weight, tracking barcode, etc.). In some embodiments, the labelling of a case may occur elsewhere, e.g., at a different station.

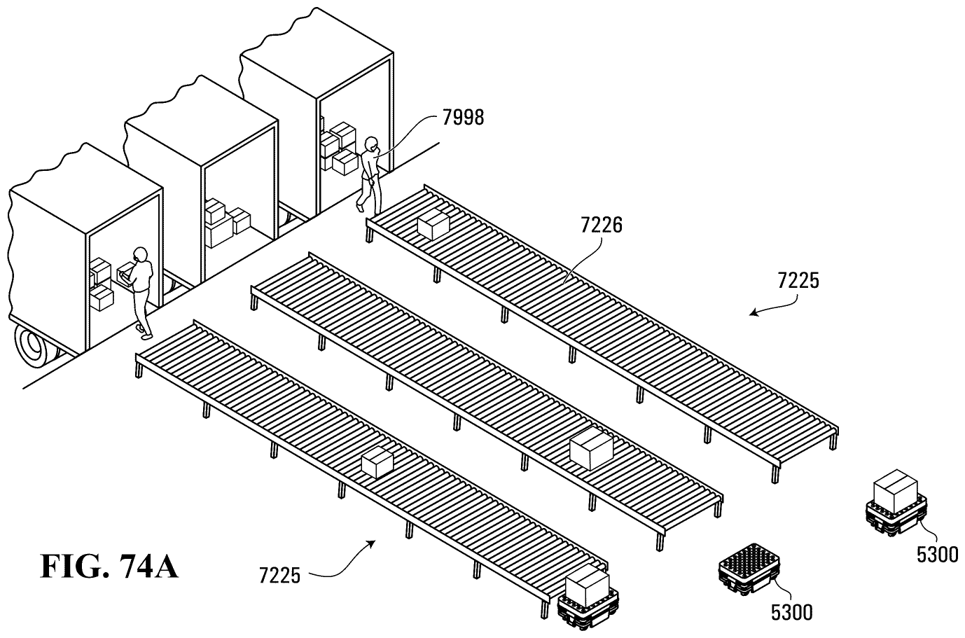

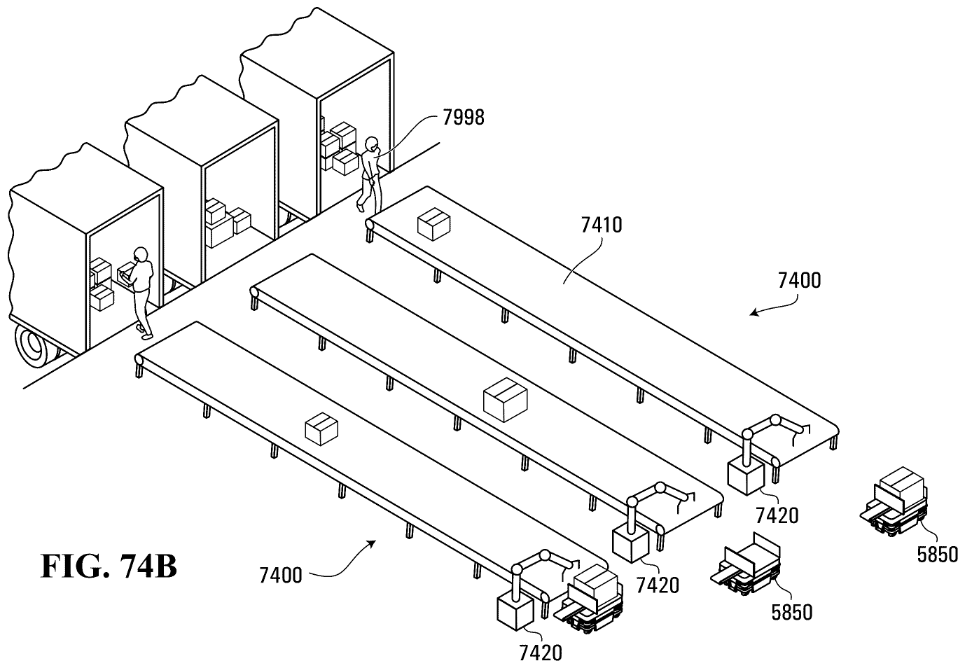

FIGS. 74A and 74B illustrate perspective views of a plurality of case discharge stations 7225 (FIG. 74A) and a plurality of case discharge stations 7400 (FIG. 74B) of the order fulfilment center of FIG. 69.

In FIG. 74A, each case discharge station 7225 includes a discharge conveyor 7226 with a receiving end, for receiving a verified, sealed and labelled shipping case from an AMR 5300/5800/5850, and a discharge end, at which end the case may be loaded into a delivery container (e.g., a storage space of a delivery transport trailer) for delivery to the respective customer. In some embodiments, the AMR 5300 and the AMR 5850 may have means (e.g., as explained elsewhere with respect to AMR 5800) to automatically unload its shipping case onto the discharge conveyor 7226. In some embodiments, an automated vehicle or person may assist the unloading of a shipping case from its respective AMR 5300 or AMR 5800 or AMR 5850. Loading of cases from the discharge end of the discharge conveyor 7226 into delivery vehicles may be achieved by one or more persons or automated robots 7998. Alternatively, loading of cases from the discharge end of the discharge conveyor 7226 into delivery vehicles may be achieved by automated vehicles.

In FIG. 74B, each case discharge station 7400 includes a discharge conveyor 7410 with a receiving end, for receiving a verified, sealed and labelled shipping case from an AMR 5300/5800/5850, and a discharge end, at which end the case may be loaded into a delivery container (e.g., a storage space of a delivery transport trailer) for delivery to the respective customer. One or more automated robots 7420 may service the discharge conveyors 7410, picking a sealed and labelled shipping case from the AMR 5300/5800/5850, for example using a robotic arm, and placing it on one of the discharge conveyors 7410 for loading into a delivery container. In some embodiments, instead of a robot 7420, a person may assist the unloading of a shipping case from its respective AMR 5300/5800/5850. Loading of cases from the discharge end of the discharge conveyor 7410 into delivery vehicles may be achieved by one or more persons or automated robots 7998. Alternatively, loading of cases from the discharge end of the discharge conveyor 7410 into delivery vehicles may be achieved by automated vehicles.

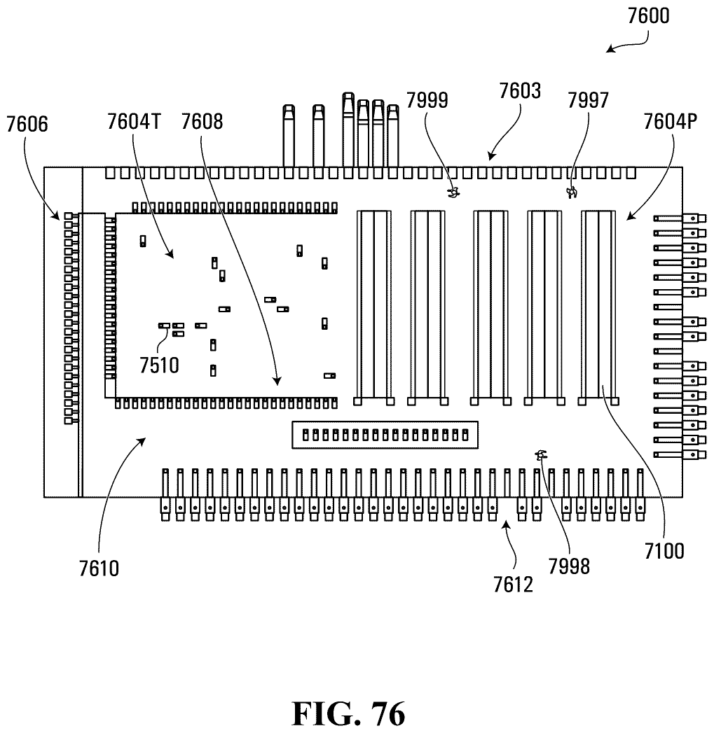

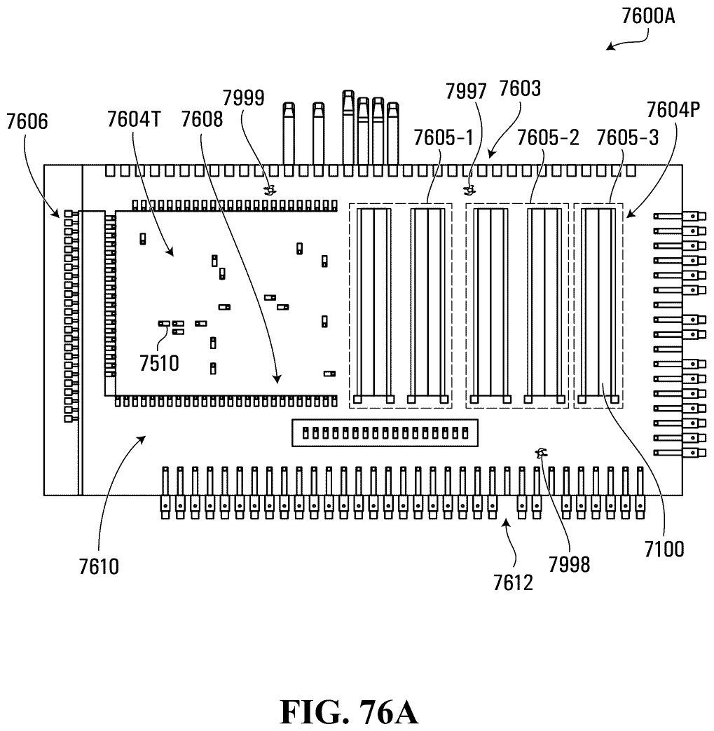

FIG. 76 illustrates, in a schematic plan view, an order fulfilment location 7600 that may be viewed as a hybrid of the order fulfilment center 5200 of FIG. 52 and the order fulfilment center 6900 of FIG. 69. The order fulfillment location 7600 may be considered to be physically organized, in a logical manner, into areas or regions associated with various functions. The order fulfillment location 7600 includes a product storage induction region 7603, a tower storage region 7604T, a product rack storage region 7604P, a shipping container induction region 7606, the product induction region 7608, an autonomous mobile robot movement region 7610 in which are located a plurality of AMRs (such as for example AMRs 5300 and/or AMRs 5800 and/or AMRs 5850), and a route distribution accumulation region 7612. In practice, depending upon the size of the order fulfillment location 7600, the order fulfillment location 7600 may include multiples of the regions illustrated in FIG. 76 and may, in some cases, omit one or more regions. The product induction region 7608 may be enclosed by a plurality of walls and a roof.

The tower storage region 7604T may be populated by a plurality of towers 7510 (see FIG. 75). In some embodiments, the plurality of towers 7510 in the tower storage region 7604T may store higher margin, lower volume products. Examples of such products may include consumer electronics, clothing, toys, and health and beauty items. In some embodiments, the number of different individual products (SKUs) stored by the plurality of towers 7510 may be on the order of several hundred thousand, or one or more millions, of different products (e.g., a vast range of different books or DVDs).

The product rack storage region 7604P may be populated by a plurality of product storage racks 7100, as well as a plurality of AMR elevators 7110 (see FIG. 70). In some embodiments, the plurality of product storage racks 7100 in the product rack storage region 7604P may store lower margin, higher volume products. For example, the plurality of product storage racks 7100 may store grocery items. In some embodiments, as described in more detail hereinafter, the product rack storage region 7604P may be subdivided into various sub-regions maintained at different conditions, e.g., different temperatures. In this way, the product rack storage region 7604P may be able to simultaneously store refrigerated grocery goods and frozen grocery goods, in addition to grocery goods that can be maintained at ambient/normal room temperature. In some embodiments, the number of different types (SKUs) of products stored by the plurality of product storage racks 7100 in the product rack storage region 7604P may be on the order of several thousand, but may be storing many multiple units of the same SKUs/type of products (e.g., multiple individual oranges, multiple cartons of milk, etc.).

In operation, at the product storage induction region 7603, various products may be shown to arrive at the order fulfillment center 7600 in, for example, a plurality of transport trailers.

Some of the products that have arrived, often organized upon a pallet, may be stored into compartments of the plurality of towers, which towers are eventually located at the tower storage region 7604T.

Personnel and/or robots 7999 may unload products delivered (such as by transport trailers and which products may be delivered on pallets) to the order fulfilment system 7600. Individual products organized upon a pallet may be retrieved through de-palletization and dismantlement processes. Each individual unloaded product may, subsequently, be placed by personnel and/or robots 7999 in a given tower 7510 among the towers 7510, as described hereinbefore. Upon being filled with products, a given tower may then be moved, by a tower-transportation AMR 7518, so that the given tower 7510 is located within the tower storage region 7604T. Information regarding the location in which each individual product is stored (e.g., the specific tower 7510 and the compartment 7512 of the specific tower), may be stored in a suitable memory of the order fulfilment processor 1300.

Some of the products that have arrived, often organized upon a pallet, may be transported, upon their respective pallets, to specific corresponding locations in the product rack storage region 7604P, where a plurality of product storage racks 7100, at which the pallets may be stored, are located. Such transportation may be done using forklifts 7997. The forklifts 7997 may be operated manually by an operator or may operate autonomously. In a preferred embodiment, the forklifts 7997 may be automated guided vehicles (AGVs).

In some embodiments, products to be stored at the product rack storage region 7604P, may arrive to the order fulfilment location 7600/7600A or order fulfilment center 6900 in a standardized storage case, palletized on a standardized pallet base. In other words, suppliers may place products, which are to be stored at the product rack storage region 7604P and used in the fulfilment of orders, into a standardized storage case and may palletize a plurality of such cases on a standardized pallet base, as described hereinafter.

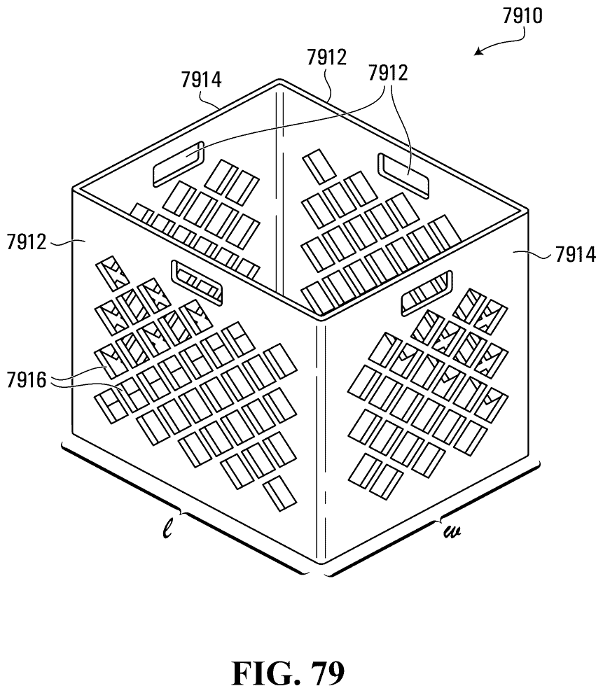

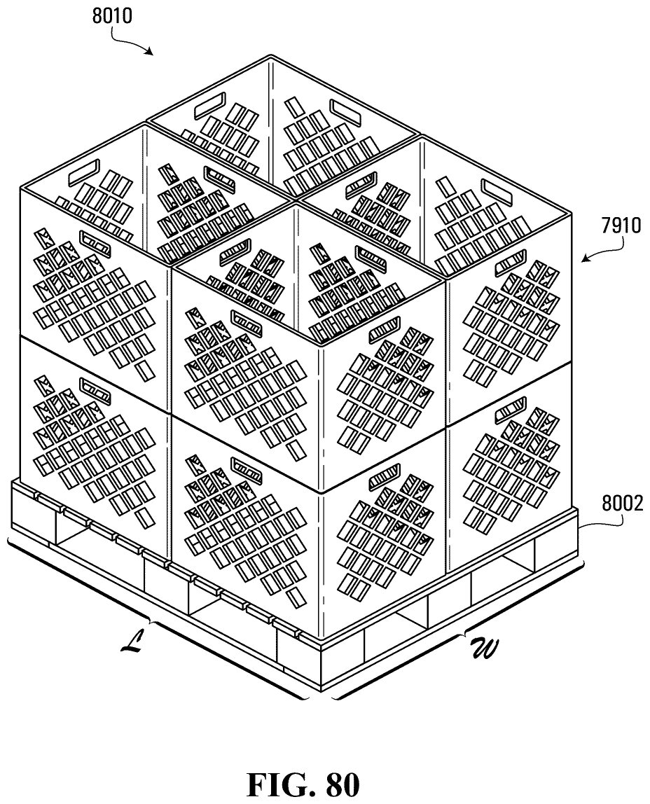

Referring briefly to FIGS. 79 and 80, FIG. 79 illustrates an example standardized storage case 7910. The standardized storage case 7910 may be one type of standardized storage case. The standardized storage case 7910 may be manufactured from plastic and may be designed to be durable and reusable. Each type of standardized storage case, among a plurality of standardized storage cases, may be manufactured to exact standardized dimensions. For example, the standardized storage case 7910 may be manufactured to have a length, l, of 24 inches, a width, w, of 20 inches, and a height of 22 inches. The standardized storage case 7910 may generally conform to the shape of an open top case, with two parallel faces 7912 along the length of the standardized storage case 7910 and two parallel faces 7914 along the width of the standardized storage case 7910. The standardized storage case 7910 may further include a handle 7912 and a plurality of holes 7916 in each of the faces 7912 and 7914. The handles 7912 may enable easier lifting of the standardized storage case 7910 by an individual (such as an employee of a supplier), and the plurality of holes 7916 may enable the individual to more easily see what is contained in the standardized storage case 7910.

The type of standardized storage case that is chosen may be based on product type. For example, the standardized storage case 7910 may be the chosen standardized storage case type for certain or all bakery products because the dimensions, material, and other features of the standardized storage case 7910 may be ideal for such goods. Other types of standardized storage cases may be well suited for other types of grocery goods, such as dairy, meat and poultry, fruits and vegetables, frozen goods, etc. Thus, the dimensions, material, and features of one type of standardized storage case may differ from other types. Regardless of the number of different types, in some embodiments, all standardized storage cases, to be delivered to the order fulfilment location 7600/7600A or order fulfilment center 6900 and stored at the product rack storage region 7604P, may be known to the order fulfillment system, and therefore to a robot configured to be used in de-palletizing operations, such as the robotic picker arm 7106. The individual suppliers may be responsible for maintaining and refurbishing the standardized storage cases, ensuring that the standardized storage cases, such as standardized storage case 7910, which arrive at the order fulfilment location or center are without defects.

Some products may not arrive in standardized storage cases like the standardized storage case 7910. These products may be those which are prepackaged into a unit, and sold by the unit, such as cases of consumer beverages. These products may be palletized onto a pallet base without being contained in a standardized storage case, or any other container. In some embodiments, these products may be wrapped with straps which can be removed by an end effector of a robotic picker arm, such as the destrapper-debander 7800. Alternatively, these products may also arrive to the order fulfilment location in a standardized storage case, such as the standardized storage case 7910.

As mentioned above, in some embodiments, many, most or all products to be stored at the product rack storage region 7604P may arrive palletized on a standardized pallet base. FIG. 80 shows a pallet 8010 containing products to be stored at the product rack storage region 7604P. The pallet 8010 includes a plurality of standardized storage cases 7910 palletized on a standardized pallet base 8002. The illustrated embodiment shows eight standardized storage cases 7910 in the pallet 8010, organized into two layers comprising four standardized storage cases 7910 each, but this is only an example. In some embodiments, the number of layers may be increased. In some embodiments, the number of standardized storage cases per layer may be increased, e.g., for standardized storage cases with smaller dimensions that the standardized storage case 7910. Similar to processes described elsewhere, the pallet 8010 may be wrapped with straps which can be removed by an end effector of a robotic picker arm, such as the destrapper-debander 7800 of the robotic picker arm 7106.

The standardized pallet base 8002 may be manufactured from wood or plastic and may be designed to be durable and reusable. The standardized pallet base 8002 may be manufactured to exact standardized dimensions. In some embodiments, these dimensions include a length, L, of 48 inches (1219.2 mm) and a width, W, of 40 inches (1016 mm). This standard size for the standardized pallet base 8002 ensures compatibility and ease of use across various industries and supply chain networks. The standardized pallet base 8002 may have a “stringer” design, including three parallel wooden or plastic beams running the length of the pallet, with deck boards placed across them. This design may offer good load-bearing capacity and stability. Additionally, the standardized pallet base 8002 may have block support at the corners, which block support may enable forklift tines to easily engage with and move the standardized pallet base 8002, thereby allowing for efficient handling during loading and unloading. The standardized pallet base 8002 may be a “four-way entry” pallet base. As such, forklifts or pallet jacks may be able to engage the pallet from any side. The individual suppliers may be responsible for maintaining and refurbishing the standardized pallet bases 8002 to, thereby, ensure that the standardized pallet bases 8002, which arrive at the order fulfilment location, are without defects.

Returning to FIG. 76, the product rack storage region 7604P may comprise a plurality of product storage racks 7100. At the product rack storage region 7604P, the pallets, which may include the standardized pallet base 8002 and standardized storage cases like the standardized storage case 7910, may each be placed in a corresponding storage location. For example, for a particular pallet, the forklifts or pallet jacks may receive, e.g., a set of coordinates or directions, pertaining to a particular storage rack located within the product rack storage region 7604P, and a specific area within the particular storage rack 7100, the particular pallet should be stored. In this way, each product storage rack 7100 may be populated with pallets corresponding to the various products.

In some embodiments, the product rack storage region 7604P may be divided into a plurality of partitions, and each of the plurality of partitions may be maintained at different conditions.

For example, FIG. 76A shows an order fulfillment location 7600A where the product rack storage region 7604P is divided into three partitions 7605-1, 7605-2, and 7605-3. Each of the three partitions 7605-1, 7605-2, and 7605-3 may include one or more product storage racks 7100, which may be populated with pallets corresponding to various products.

The partitions 7605-1, 7605-2, and 7605-3 may be maintained at different conditions. For example, a first partition 7605-1 may maintain products at a moderate temperature, e.g., at room temperature or ambient temperature; a second partition 7605-2 may maintain products at a reduced temperature as compared to the temperature of the first partition 7605-1, e.g., at a refrigerated temperature; and a third partition 7605-3 may maintain products at a temperature at or below freezing. In this way, the partitions 7605-1, 7605-2, and 7605-3 may provide three different storage conditions for storage of different products. For example, as previously mentioned the product rack storage region 7604P may house grocery items. Items that are safe to be stored at room temperature, such as non-perishable grocery goods, may be kept in the first partition 7605-1; perishable grocery items such as fresh produce and meats may be kept in the second partition 7605-2; and frozen grocery items may be kept in the third partition 7605-3.

In some embodiments, an air curtain or air door may be provided for the product storage racks 7100 located within the second partition 7605-2 and/or the third partition 7605-3. The air curtain may be a device configured to blow a consistent and controlled high-velocity stream of air to create an air seal and separate two environments from each other. Specifically, the air curtain may separate a portion of a product storage rack 7100 storing products at a refrigerated or freezing temperature, from an average warehouse temperature, which may be an ambient temperature.

For example, referring to FIG. 70, for a product storage rack 7100 located within the second partition 7605-2 or the third partition 7605-3, an air curtain (not shown) may be positioned above the product storage rack 7100 and configured to blow a high-velocity stream of air, in a substantially vertical direction, between the plurality of storage levels 7102 and the plurality of raised platforms 7104. The air curtain may therefore allow a first environment which includes the plurality of storage levels 7102 and the products stored on the plurality of storage levels 7102, to be maintained at different conditions from a second environment which includes the plurality of raised platforms 7104, the one or more robotic picker arms 7106, the AMR elevator 7110, the AMRs 5800/5850, and any forklifts or automated guided vehicles travelling along the ground level. For example, for a product storage rack 7100 located within the second partition 7605-2, the first environment may be maintained at a refrigerated temperature and the second environment may be maintained at an ambient temperature, while for a product storage rack 7100 located within the third partition 7605-3, the first environment may be maintained at a below freezing temperature and the second environment may be maintained at an ambient temperature. In this way, within the second partition 7605-2 and the third partition 7605-3, the AMR 5800/5850, the AMR elevator 7110, and any other equipment or material located within the second partition 7605-2 and the third partition 7605-3, may be protected from damage that may be caused by refrigerated or freezing temperatures. The one or more robotic picker arms 7106 may be configured to enter and exit the first environment to retrieve products stored on the plurality of storage levels 7102 and release them into one or more shipping containers carried by an AMR 5800/5850. In a rest position, the one or more robotic picker arms 7106 may be located in the second environment to minimize any damage from prolonged exposure to refrigerated or below freezing temperatures. In some embodiments, more than one air curtains may be provided for a product storage rack 7100, to ensure that air seals are created all around the products stored on the plurality of storage levels 7102. In other words, as opposed to creating an air seal at just a front side of the plurality of storage levels 7102, air curtains may be provided to create air seals at the left, right, and rear sides of the plurality of storage levels 7102. In some embodiments, air curtains or other means for maintaining various areas or environments of the second partition 7605-2 and/or the third partition 7605-3 at different temperatures may not be implemented. Instead, the second partition 7605-2, including the entirety of the product storage racks 7100 and AMR elevators 7110 may generally be maintained at a refrigerated temperature such that when any AMRs 5800/5850 and vehicles travelling along the ground level enter the second partition 7605-2, they are exposed to the refrigerated temperature at which the second partition 7605-2 is maintained. Similarly, the third partition 7605-3, including the product storage racks 7100 and AMR elevators 7110, may generally be maintained at a below freezing temperature such that when any AMRs 5800/5850 and vehicles travelling along the ground level enter the third partition 7605-3, they are exposed to the refrigerated temperature at which the third partition 7605-3 is maintained.

Referring to either FIG. 76 or FIG. 76A, the shipping container induction region 7606 may be populated with a plurality of carton forming systems, which may also be referred to as shipping container delivery systems, perhaps following the design of the carton forming system 100 disclosed hereinbefore. In embodiments where the product rack storage region 7604P is split into the three partitions 7605-1, 7605-2, and 7605-3, which maintain products at different temperatures and conditions, one or more of the plurality of carton forming systems may be configured to form shipping containers that can safely transport one or more items stored in the second partition 7605-2 or the third partition 7605-3 to a delivery destination. For example, the one or more of the plurality of carton forming systems may be configured to form a shipping container having an inner insulated lining, or a shipping container made only from insulative material, to prevent melting or spoiling of items during transport to a delivery destination. Alternatively or additionally, one or more of the plurality of carton forming systems may be configured to form shipping containers that include an insulated portion and a non-insulated portion, so that an item from the tower storage region 7604T or the first partition 7605-1, which item does not require particular insulation, may be delivered in a same shipping container as an item from the second partition 7605-2 or the third partition 7605-3, which item does require insulation.

According to aspects of the present application, a plurality of autonomous mobile robots (AMRs) such as for example AMRs 5300 and/or AMRs 5800 and/or AMRs 5850, may be deployed for movement within the autonomous mobile robot movement region 7610.

In some embodiments, the order fulfillment processor 1300 may receive an order requiring one or more products stored in the tower storage region 7604T and one or more products stored in the product rack storage region 7604P.

Once the order is received, an appropriately sized, appropriate type of container may be constructed for the order, e.g., by a case erector within the shipping container induction region 7606, and an AMR, such as AMR 5300 or AMR 5800 or AMR 5850, may be controlled to visit the shipping container induction region 7606 to obtain the shipping container.

The combination of the AMR and the shipping container may then be controlled to visit one or more stations in the product induction region 7608. At a given station or at given stations in the product induction region 7608, the one or more products required to fulfil the order, which are stored in the tower storage region 7604T, may be received within the shipping container carried by the AMR. The stations in the product induction region 7608 may be associated with provision of products that are stored in towers 7510 in the tower storage region 7604T.

In operation, the tower-transportation AMR 7518 (see FIG. 75) may engage with the tower 7510 and transport the tower 7510 between a first location in the midst of the tower storage region 7604T and a second location in the product induction region 7608. The tower-transportation AMR 7518 may be a device manufactured by Amazon Robotics, formerly Kiva Systems. The tower-transportation AMR 7518 may navigate around the tower storage region 7604T. When the tower-transportation AMR 7518 reaches the first location, the tower-transportation AMR 7518 may slide underneath the tower 7510 and lift the tower 7510 off the ground through, e.g., a corkscrew action. The tower-transportation AMR 7518 may then carry the tower 7510 to the second location in the product induction region 7608.

In some embodiments, a tower in the tower storage region 7604T may be identified, for example, by the order fulfillment processor 1300, as storing one or more products for fulfilling an order. The tower storing the one or more products for fulfilling the order, or simply the one or more products, may be transported from the tower storage region 7604T to a particular station in the product induction region 7608. This transportation may be performed manually or automatically. For example, a plurality of AMRs (not shown) may generally be designated for transporting towers between the tower storage region 7604T and the product induction region 7608. A fulfillment order data structure generated by the order fulfillment processor 1300 may include tower-transportation AMR instructions for one of the plurality of tower-transportation AMRs 7518 to engage with the tower and transport the tower to the particular station in the product induction region 7608, where the erected carton may receive the one or more products for fulfilling the order. Indeed, loading of the one or more products into the erected carton may be carried out manually or in a robotic manner. For example, a loading robot (not shown) may be positioned near and/or be assigned to a station in the product induction region 7608. When a tower (see, for example, the tower 7510 of FIG. 75) storing one or more products for fulfilling an order is transported to the station, the loading robot may be instructed by the order fulfillment processor 1300 to retrieve the one or more products from one or more compartments of the tower and load them into the appropriate case or carton. For example, the loading robot may include an extendable arm with vacuum suction cups, capable of reaching for a specific product within the one or more compartments of the tower and loading the specific product into the case. The product induction region 7608 may include one or more loading robots for loading products from towers into cases, e.g., one loading robot may serve one station, or a plurality of stations, in the product induction region 7608. In this way, the AMR (such as AMR 5300/5800/5850), which supports the erected carton, may travel to one or more stations in the product induction region 7608 and, at each station, receive, from a respective tower, one or more products for fulfilling the order, each tower having been transported from a first location in the tower storage region 7604T to the respective station by a tower-transportation AMR 7518 having received tower-transportation AMR instructions by the order fulfillment processor 1300.

Upon having received the one or more products that have been stored in various locations in the tower storage region 7604T, to fulfil the customer order, the AMR 5300/5800/5850 may be controlled to move to the product rack storage region 7604P to receive the one or more products stored in the product rack storage region 7604P, which are required to fulfil the customer order. In the product rack storage region 7604P, the shipping case secured onto the AMR 5300/5800/5850 may receive, from one or more product storage racks 7100, one or more further products to complete the customer order according to the methods, described hereinbefore, in relation to the product storage rack 7100 illustrated in FIG. 70.

Upon the receipt of a product that completes an order (or at least a part of the order to be loaded into that case), the AMR may then be controlled to move around the autonomous mobile robot movement region 7610 so that further order fulfillment functions may be carried out. For a few examples, the AMR 5300/5800/5850 may be controlled to move the shipping container to a location within the autonomous mobile robot movement region 7610 at which location the weight of the shipping container may be verified. The shipping container may then be sealed and labelled.

The weight-verified, sealed and labelled shipping container may then be received at the route distribution accumulation region 7612, where the shipping container may be loaded, by robots and/or personnel 7998, upon a delivery vehicle.

In embodiments where the product rack storage region 7604P is split into the three partitions 7605-1, 7605-2, and 7605-3, the one or more products stored in the product rack storage region 7604P, which are required to fulfil the customer order, may include products from at least two of the three partitions 7605-1, 7605-2 and 7605-3 and, therefore, may include products that are stored at least at two different temperatures and conditions. In such embodiments, the shipping container may be one that includes both an insulated and a non-insulated portion, as described elsewhere. When the combination of the AMR 5300/5800/5850 and the shipping container is controlled to visit one or more stations in the product induction region 7608 to receive the one or more products stored in the tower storage region 7604T required to fulfil the order, or to the product rack storage region 7604P to receive the one or more products stored in the first partition 7605-1 of the product rack storage region 7604P required to fulfil the order, the one or more products may be received in the non-insulated portion of the shipping container. When the combination of the AMR and the shipping container is controlled to move to the second partition 7605-2 or to the third partition 7605-3 of the product rack storage region 7604P to receive the one or more products, which are required to fulfil the customer order, the one or more products may be received in the insulated portion of the shipping container. The insulated portion of the shipping container may be sealed from the non-insulated portion of the shipping container. In this way, the insulated portion may prevent the one or more products contained within the insulated portion from melting or spoilage and, simultaneously, protect the one or more products contained within the non-insulated portion from becoming damaged due to a product in the insulated portion, e.g., water damage from being in contact with a frozen product.

Alternatively, more than one shipping container may be used to fulfil the customer order. For example, assuming a customer order requires one or more products stored in each of the tower storage region 7604T, the first partition 7605-1 of the product rack storage region 7604P, the second partition 7605-2 of the product rack storage region 7604P, and the third partition 7605-3 of the product rack storage region 7604P, a first AMR may be controlled to visit the shipping container induction region 7606 to receive a first shipping container. The first shipping container may not include any material for insulation and the combination of the first AMR 5300/5800/5850 and the first shipping container may be controlled to move to the product induction region 7608 to receive the one or more products required to fulfil the order, which are stored in the tower storage region 7604T. The combination of the first AMR 5300/5800/5850 and the first shipping container may further be controlled to move to the product rack storage region 7604P to receive the one or more products required to fulfil the order, which are stored in the first partition 7605-1. A second AMR 5300/5800/5850 may be controlled to visit the shipping container induction region 7606 to receive a second shipping container. The second shipping container may include material for insulation and the combination of the second AMR 5300/5800/5850 and the second shipping container may be controlled to move to the product rack storage region 7604P to receive the one or more products required to fulfil the order which are stored in the second partition 7605-2. A third AMR 5300/5800/5850 may be controlled to visit the shipping container induction region 7606 to receive a third shipping container. The third shipping container may also include material for insulation and the combination of the third AMR 5300/5800/5850 and the third shipping container may be controlled to move to the product rack storage region 7604P to receive the one or more products required to fulfil the order, which are stored in the third partition 7605-3. The employment of the first, second and third shipping containers is only an example. In some embodiments, the second shipping container may be used to receive the products stored in both the second partition 7605-2 and the third partition 7605-3. In some embodiments, a shipping container may be used to receive items stored in the tower storage region 7604T and a different shipping container may be used to receive items stored in the first partition 7605-1. In some embodiments, more than one shipping container may be used to receive items from the first partition 7605-1, more than one shipping container may be used to receive items from the second partition 7605-2, and more than one shipping container may be used to receive items from the second partition 7605-2.

The combination of the first AMR 5300/5800/5850 and the first shipping container, the second AMR 5300/5800/5850 and the second shipping container, and the third AMR 5300/5800/5850 and the third shipping container, may subsequently be controlled to move to the order verification and sealing region 6910 and move through any one case sealing station 7620, which verifies that the one or more products within the first shipping container, the second shipping container, and the third shipping container are accurate and complete, and seals the first shipping container, the second shipping container, and the third shipping container. The combination of the first AMR 5300/5800/5850 and the first shipping container, the second AMR 5300/5800/5850 and the second shipping container, and the third AMR 5300/5800/5850 and the third shipping container, may subsequently be controlled to move to a particular order discharge station 7225 to be loaded into a delivery container (e.g., a storage space of a delivery vehicle) for delivery to the respective customer.

Over the normal course of order fulfilment, the products contained within a particular pallet stored on a product storage rack 7100 may be continuously removed from the pallet and provided to shipping containers held by AMRs 5300 or 5800 or 5850, in order to fulfil orders requesting the products. As discussed previously, a pallet stored on product storage racks 7100 may include a plurality of standardized storage cases, such as the standardized storage cases 7910, palletized on a standardized pallet base 8002, where each of the standardized storage cases 7910 store products that can be used for a customer order. A robotic picker arm 7106 may retrieve the individual products from the standardized storage cases 7910 and load the retrieved individual products into shipping containers carried by the AMR 5300/5800/5850. The robotic picker arm 7106 may retrieve individual products from a particular one of the standardized storage case 7910 until there are no more products inside of the particular standardized storage case 7910. Responsive to there being no more products inside of the particular standardized storage case 7910, an “empty” AMR (i.e., an AMR that is not carrying a case/shipment container or a standardized storage case 7910), such as AMR 5300/5800/5850, may be controlled to visit the product storage rack 7100 where the particular standardized storage case 7910 is located. An empty AMR 5300/5800/5850 may be defined as an AMR that is not carrying a shipping container or a standardized storage case 7910 but can accept at least one of the foregoing. For example, the empty AMR 5300/5800/5850 may be one that previously carried thereon a shipping container, which it received from a shipping container induction region (e.g., the shipping container induction region 7606 of FIG. 76), and subsequently was controlled to travel to various locations for fulfilment of an order, until the shipping container was released at a route distribution accumulation region (e.g., the route distribution accumulation region 7612 of FIG. 76) to be loaded upon a delivery vehicle. The empty AMR 5300/5800/5850 may be controlled to travel to the location of the particular standardized storage case 7910 (e.g., the storage level 7102 where the particular standardized storage case 7910 is stored). The robotic picker arm 7106 may then retrieve the (now empty) particular standardized storage case 7910, and load the particular standardized storage case 7910 onto the empty AMR 5300/5800/5850. The combination of the formerly empty AMR 5300/5800/5850 and the particular standardized storage case 7910 may travel to an exit station (not shown) where the particular standardized storage case 7910 may be unloaded. The once-again empty AMR 5300/5800/5850 may subsequently be controlled to visit another product storage rack 7100 to receive another empty standardized storage case 7910 and unload it at the exit station or, alternatively, may be controlled to visit the shipping container induction region 7606 to receive a shipping container to start off an order fulfilment process, as discussed in detail hereinbefore. Therefore, the AMR 5300/5800/5850 may be dually purposed to, on the one hand, receive a shipping container and participate in an order fulfilment process and, on the other hand, receive an empty standardized storage case 7910 and transport it to an exit station to be added to a pallet of empty standardized storage cases 7910, as described hereinafter. Therefore at least some, and possibly all, of the plurality of AMRs 5300/5800/5850 which operate as such dual purpose AMRs, will be configured and operable so that they are capable of carrying both: (i) one or more sizes of cases/shipment containers; and (ii) a standardized storage case 7910.

The process of removing products and/or empty standardized storage cases 7910 stored atop a particular standardized pallet base 8002 may continue until the particular standardized pallet base 8002 is empty (i.e., has no products stored thereon). Responsive to the particular standardized pallet base 8002 being empty, an AGV may be controlled to visit the product storage rack 7100 where the particular standardized pallet base 8002 is located. The AGV may be controlled to retrieve the particular standardized pallet base 8002 and may be controlled to travel to the exit station, where the AGV may unload the particular standardized pallet base 8002.

In some embodiments, various autonomous machines, such as AGVs or AMRs 5300/5800/5850, may be controlled to repalletize a plurality of the same type of empty standardized storage cases onto an empty standardized pallet base 8002 located at the exit station to form an empty repalletized pallet. The empty repalletized pallet may then be returned to a supplier, producer, or manufacturer, who may then reuse the plurality of empty standardized storage cases and the empty standardized pallet base 8002 for storing products and, then once again, send the palletized products to the order fulfilment location 7600/7600A or the order fulfilment location 6900 to be used for the fulfilment of orders. The use of standardized storage cases and standardized pallet bases may, therefore, allow a closed loop system to be formed, as regards to the standardized storage cases and the standardized pallet base 8002.

Aspects of the present application may be implemented in a transformation of an existing fulfilment center. It may be expected that the existing fulfilment center has a layout similar to the order fulfillment location 5200 illustrated in FIG. 52 and that the layout is defined, for example, over 1,000,000 square feet. In an example transformation, it is proposed to transform a fulfilment center having a layout similar to the order fulfillment location 5200 illustrated in FIG. 52 to a fulfilment center having a layout similar to the order fulfillment location 7600 illustrated in FIG. 76. Notably, a layout similar to the order fulfillment location 5200 illustrated in FIG. 52 has an area designated as the tower storage region 5204. In an example transformation, it is proposed to convert part of an area designated as the tower storage region 5204 to an area designated as the product rack storage region 7604P. The remainder of the area may remain as the tower storage region 7604T.

Notably, the configuration illustrated in FIG. 76 is just one of many possible configurations. In FIG. 76, the area designated as the product rack storage region 7604P is approximately equal to the area designated as the tower storage region 7604T. In another configuration, the area designated as the product rack storage region 7604P may be approximately one ninth of the area designated as the tower storage region 7604T. That is, 100,000 square feet of the original 1,000,000 square feet may be given over to the product rack storage region 7604P. The product rack storage region 7604P may, alternatively, be described as a “High Bay” warehouse area capable of handling product storage racks 7100 (see FIG. 70) having 10-15 levels. Post conversion, the product rack storage region 7604P may be capable of storing in excess of 100,000 pallets with in the order of 3,000,000 grocery products. The product rack storage region 7604P may, as described in conjunction with FIG. 76A, be divided into three temperature partitions 7605-1, 7605-2, and 7605-3 for storing grocery products at ambient temperatures, refrigerated temperatures and frozen temperatures.

The product rack storage region 7604P may contain 4,000 to 5,000 individual SKU pallet storage positions. Each SKU pallet storage position may be capable of storing up to 20 full SKU pallets on two levels of roller-driven conveyor. Each SKU pallet position may support, at a discharge end, a dedicated SKU robotic picker arm 7106 (see FIG. 77). The dedicated SKU robotic picker arm 7106 may be programmed exclusively for the SKU that it handled by the dedicated SKU robotic picker arm 7106.

As part of modification performed at an existing fulfilment center, approximately 15 miles of so-called “tote and case conveyor” may be replaced by 100,000 square feet of AMR track. The AMR track may allow for a connection among all of the functions of the fulfillment process. The AMR track may allow individually programmed AMRs 5300/5800/5850 to complete individual order fulfillment processes.

It may be expected that the AMR track will allow AMRs 5300/5800/5850 to visit the existing manual product induction stations, perhaps in the order of 300-500 manual product induction stations in the product induction region 7608, and the 4,000-5,000 individual SKU pallet storage positions in the product rack storage region 7604P. It may be expected that the AMR track will allow AMRs 5300/5800/5850 to visit: shipping container induction stations in the shipping container induction region 7606 (see FIG. 76); order verification stations 7630 (see FIG. 56A); rework stations; case sealing stations 7620 (see FIGS. 56A, 73); order discharge stations 7225 (see FIG. 71); and discharge conveyors 7226 (see FIG. 71).

Post conversion, it may be found that aspects of the product and pallet intake process of the existing fulfilment center remains unchanged. Transport trailers may be manually unloaded of their product loads. The products may be depalletized, if necessary, and the products may be processed at the product storage induction region 5202 for storage in the tower storage region 7604T.

Other aspects of the product and pallet intake process may be shown to differ from the intake process of the existing fulfilment center. For example, an inbound, single SKU pallet, arriving on a transport trailer, may be implemented as a plurality of standardized storage cases 7910 (see FIG. 79) upon a standardized pallet base 8002 (see FIG. 80). It is contemplated that full, standardized pallet bases 8002 may be received on trailers on a just-in-time basis, in lots of, say, 20 full, standardized pallet bases 8002 at a time. Such trailers-full may be unloaded by AGVs. The AGVs may deliver each full, standardized pallet base 8002 to an appropriate individual SKU pallet storage position in the product rack storage region 7604P.

As noted hereinbefore, a given inbound single SKU pallet (a plurality of standardized storage cases 7910 resting on a standardized pallet base 8002) may be subjected to robotic depalletization by a robotic picker arm 7106 (see FIG. 77) while the given inbound single SKU pallet is positioned on a storage level 7102 of a product storage rack 7100 (see FIG. 70). Indeed, the given inbound single SKU pallet may be specifically configured to facilitate robotic depalletization. For example, the given inbound single SKU pallet may be configured with strapping instead of stretch wrap. It may be shown that using strapping facilitates robotic depalletizing. The plurality of standardized storage cases 7910 resting on the standardized pallet base 8002 may be isolated from the strapping by a pallet top sheet, which may be formed of corrugated cardboard. As is known, the single SKU pallet may include other non-product material, such as slip sheets, which may also be formed of corrugated cardboard. Additionally, rather than a plurality of standardized storage cases 7910, the products may be found in shipping cases, which may also be formed of corrugated cardboard.

As the robotic picker arm 7106 loads products into the AMRs 5300/5800/5850, corrugated shipping cases may be emptied. Empty corrugated shipping cases may be picked by the robotic picker arm 7106 and dropped into a corrugated material recycling chute (not shown) as part of the product storage rack 7100. The shipping case, pallet top sheets and slip sheets, upon reaching a bottom of the corrugated material recycling chute, may drop onto a dunnage accumulation conveyor (not shown) located in the center of the product storage rack 7100. Material carried on the dunnage accumulation conveyor may be accumulated and loaded automatically into an automatic compactor and strapping machine for recycling. Thereafter, an AGV may pick strapped bundles and position the strapped bundles into a recycling trailer for delivery to a recycling station.

Conveniently, each standardized storage case 7910 among the plurality of standardized storage cases 7910 that rests on the standardized pallet base 8002 may be configured with an open top. The open top may be shown to allow for the robotic picker arm 7106 to pick products out of the standardized storage case 7910 and place the products into a shipping container carried on an AMR 5300/5800/5850. Many grocery products, like fruits and vegetables, are known to be shipped in cases with an open top configuration.

When a standardized pallet base 8002 has been emptied of all of the standardized storage cases 7910 that originally rested thereon, the robotic picker arm 7106 may load the empty standardized pallet base 8002 onto an AMR 5300/5800/5850. The AMR 5300/5800/5850 may then transfer the empty standardized pallet base 8002 to empty standardized pallet base staging area (not shown). In the empty standardized pallet base staging area, a pallet base stacking robot may stack the empty standardized pallet bases 8002 in stacks of a manageable height, say, ten empty standardized pallet bases high.

A customer order may be placed on a web site and processed by the order fulfillment processor 1300. The order fulfillment processor 1300 may determine various customer order-related parameters, such as: number of items in the customer order; shipping container size; shipping container style; shipping locations; number of shipping containers; and shipping destination address. It is contemplated that artificial intelligence innovations will enhance future order processing.

The fulfillment process may begin with the order fulfillment processor 1300 directing an AMR 5300/5800/5850 to a shipping container induction region 7606 (see FIG. 76). It may be shown that there is virtually no limit to the number of shipping containers to be used to complete the customer order.

A right-sized shipping container may be affixed to the AMR 5300/5800/5850 and used as a collating and accumulating device for the customer order. The shipping container induction region 7606 may be provisioned with over 150 shipping container forming machines, with each shipping container forming machine capable of forming a unique size and style of shipping container.

The AMR 5300/5800/5850 carrying the right-sized shipping container for the customer order may be directed to receive products at any combination of the 300-500 manual product induction stations in the product induction region 7608 and/or the 4,000 individual SKU pallet storage positions in the product rack storage region 7604P. The receipt of products may be expected to continue until all of the items in the customer order (or part of a customer order for a particular shipping container) have been placed into the right-sized shipping container.

Once the right-sized shipping container has received all the items in the customer order, the AMR 5300/5800/5850 may be directed to one of 200 order verification stations 7630 (see FIG. 56A) to confirm the contents of the right-sized shipping container matches the customer order using check weight systems. Using vision systems, the order verification stations 7630 may also check the item distribution in the shipping container. All data associated with the dimensional and weight information for each component in the customer order may be verified at the order verification stations 7630. With the customer order verified, the AMR 5300/5800/5850 may be instructed to pass through an appropriate case closing and order identification system (see the case top sealer 7620 and the case labeler 7624 of FIG. 56A). Dunnage may or may not be added at the case closing aspect of the system, in dependence upon the extent to which the shipping container has been selected to have a “right” size. Barcodes and shipping labels may be automatically applied to the erected case at the order identification aspects of the system.

Occasionally, shipping containers may be rejected at the order verification station 7630. A rejected shipping container may cause the AMR 5300/5800/5850 to be directed to an rework station, at which the rejected shipping container may be reworked manually. Subsequent to reworking, the AMR 5300/5800/5850 may be directed back to a designated order verification station 7630.

Responsive to successful verification at the order verification station 7630, the AMR 5300/5800/5850 may be directed to a combination dunnage insertion and case sealing station (see, for example, the case sealing stations 7620 in FIG. 56A and FIG. 73), at which, if necessary, dunnage may be added into the shipping container to stabilize the contents of the customer order and the top of the shipping container may be sealed.

It should be well understood that misplaced dunnage insertion or shipping container sealing faults may cause the AMR 5300/5800/5850 to be instructed to visit a rework station, at which the shipping container may be reworked manually. Subsequent to reworking, the AMR 5300/5800/5850 may be directed back to a designated combination dunnage insertion and case sealing station.

The AMR 5300/5800/5850, with a verified and sealed shipping container, may be directed to a labelling station (see the case labeler 7624 of FIG. 56A). The labelling station may be expected to label the shipping container to in accordance with routing and delivery instructions specific to the customer order. Order information data may be used to determine whether a “heavy” label and/or a “fragile” label are to be automatically applied at the labelling station.

The AMR 5300/5800/5850, with a verified, sealed and labelled shipping container, may be directed to a route distribution accumulation region 7612, at which the AMR 5300/5800/5850 may offload the shipping container onto a discharge routing conveyor 7626 (FIG. 56A) for loading into delivery vehicle. All of the shipping containers for a specific route may be accumulated and loaded into a delivery vehicle that has been assigned to the specific route.

The AMR 5300/5800/5850, while carrying the verified shipping container, may act on instructions to proceed to a particular one of, say, 150 stations in the route distribution accumulation regions 7612. The instructions may be based on a destination of the shipping container being on a delivery route assigned to a delivery vehicle associated with a particular station in the route distribution accumulation region 7612. As shipping containers accumulate for a given delivery route, a driver of the delivery vehicle assigned to the given delivery route may move shipping containers from the discharge routing conveyor 7626 into the delivery vehicle. The stations in the route distribution accumulation regions 7612 may be configured to be located directly adjacent to delivery vehicle loading positions. A delivery vehicle driver may commence a shift by packing a plurality of shipping containers for a delivery route into a delivery vehicle designated to that delivery route. On average, between 75 and 150 shipping containers, representing customer orders may be expected to be loaded into a delivery vehicle by a delivery vehicle driver carrying out a loading operation. Once the loading operation is completed, the delivery vehicle driver may be expected to distribute the shipping containers to respective customers using traditional delivery methods.

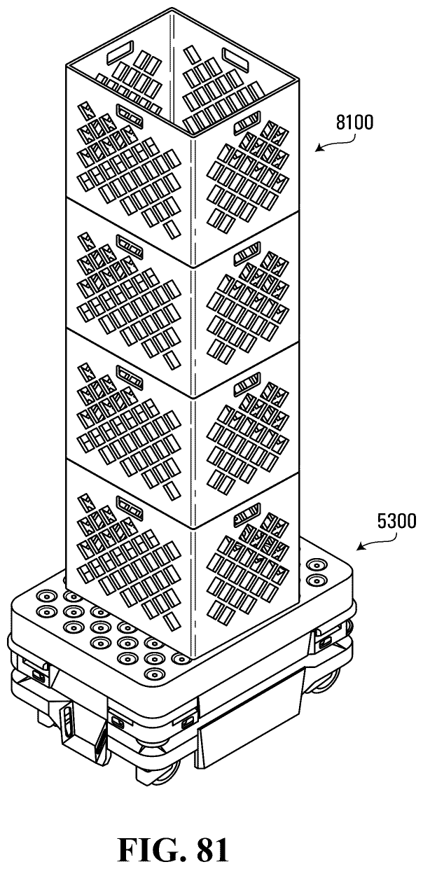

FIG. 81 illustrates a 1×4 stack 8100 of crates 7910 (FIG. 79) carried on top of an AMR 5300 (FIG. 53).

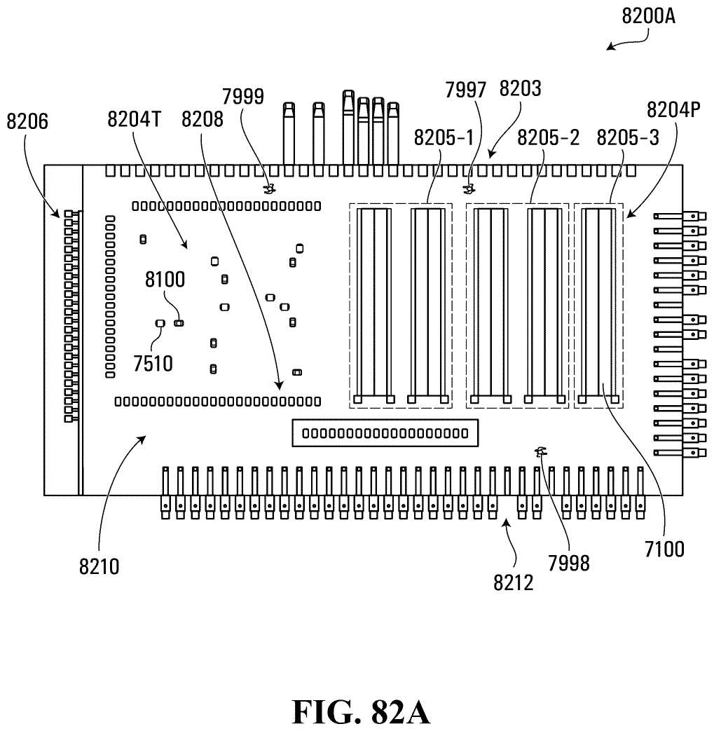

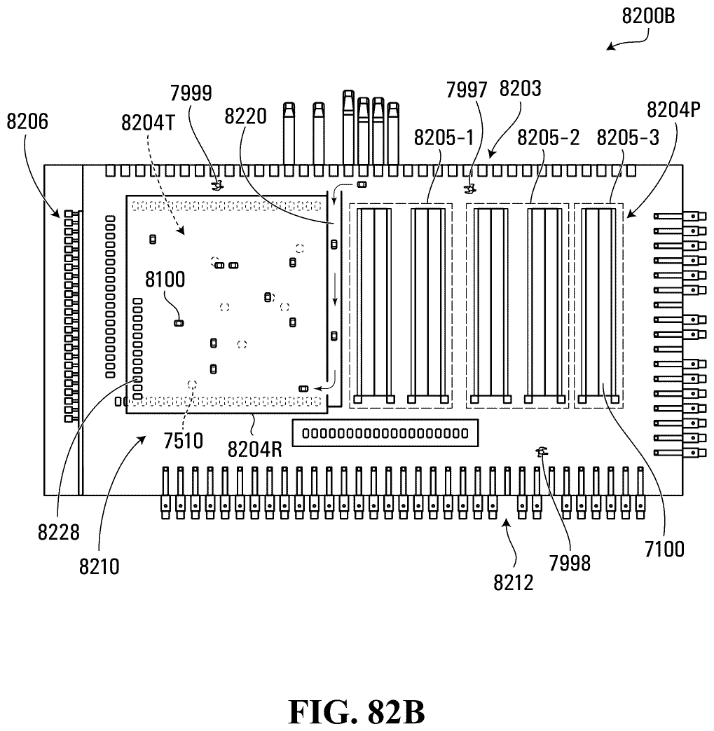

FIG. 82A illustrates, in a schematic plan view, an order fulfilment location 8200A that may be viewed as an alternative to the order fulfilment center 7600 of FIG. 76. The order fulfillment location 8200A may be considered to be physically organized, in a logical manner, into areas or regions associated with various functions. The order fulfillment location 8200A includes a product storage induction region 8203, a tower storage region 8204T, a product rack storage region 8204P, a shipping container induction region 8206, a product induction region 8208, an autonomous mobile robot movement region 8210, in which are located a plurality of AMRs (such as for example AMRs 5300 and/or AMRs 5800 and/or AMRs 5850), and a route distribution accumulation region 8212. In practice, depending upon the size of the order fulfillment location 8200A, the order fulfillment location 8200A may, in some cases, include multiples of the regions illustrated in FIG. 82 and may, in some other cases, omit one or more regions. The product induction region 8208 may be enclosed by a plurality of walls and a roof.

The tower storage region 8204T may be populated by a plurality of towers 7510 (see FIG. 75). In some embodiments, the plurality of towers 7510 in the tower storage region 7604T may store higher margin, lower volume products. Examples of such products may include consumer electronics, clothing, toys, and health and beauty items. In some embodiments, the number of different individual products (SKUs) stored by the plurality of towers 7510 may be on the order of several hundred thousand, or one or more millions, of different products (e.g., a vast range of different books or DVDs).

In contrast to the tower storage region 7604T of FIG. 76, in addition to the plurality of towers 7510, the tower storage region 8204T of FIG. 82A may also be populated by a plurality of stacks 8100 of crates 7910 (see FIG. 81). That is, the tower storage region 8204T of FIG. 82A may be populated by a plurality of towers 7510 mixed together with a plurality of stacks 8100.

The product rack storage region 8204P may be populated by a plurality of product storage racks 7100, as well as a plurality of AMR elevators 7110 (see FIG. 70). In some embodiments, the plurality of product storage racks 7100 in the product rack storage region 8204P may store lower margin, higher volume products. For example, the plurality of product storage racks 7100 may store grocery items.

The product rack storage region 8204P is illustrated as divided into three partitions 8205-1, 8205-2 and 8205-3. Each of the three partitions 8205-1, 8205-2 and 8205-3 may include one or more product storage racks 7100, which may be populated with pallets corresponding to various products.

The partitions 8205-1, 8205-2 and 8205-3 may be maintained at different conditions. For example, a first partition 8205-1 may maintain products at a moderate temperature, e.g., at room temperature or ambient temperature. A second partition 8205-2 may maintain products at a reduced temperature as compared to the temperature of the first partition 8205-1, e.g., at a refrigerated temperature. A third partition 8205-3 may maintain products at a temperature at or below freezing. In this way, the partitions 8205-1, 8205-2 and 8205-3 may provide three different storage conditions for storage of different products. For example, as previously mentioned the product rack storage region 8204P may house grocery items. Items that are safe to be stored at room temperature, such as non-perishable grocery goods, may be kept in the first partition 8205-1; perishable grocery items such as fresh produce and meats may be kept in the second partition 8205-2; and frozen grocery items may be kept in the third partition 8205-3.

In some embodiments, an air curtain or air door may be provided for the product storage racks 7100 located within the second partition 8205-2 and/or the third partition 8205-3. The air curtain may be understood to be a device configured to blow a consistent and controlled high-velocity stream of air to create an air seal and separate two environments from each other. Specifically, the air curtain may separate a portion of a product storage rack 7100 storing products at a refrigerated or freezing temperature, from an average warehouse temperature, which may be an ambient temperature.

For example, referring to FIG. 70, for a product storage rack 7100 located within the second partition 8205-2 or the third partition 8205-3, an air curtain (not shown) may be positioned above the product storage rack 7100 and configured to blow a high-velocity stream of air, in a substantially vertical direction, between the plurality of storage levels 7102 and the plurality of raised platforms 7104. The air curtain may therefore allow a first environment which includes the plurality of storage levels 7102 and the products stored on the plurality of storage levels 7102, to be maintained at different conditions from a second environment which includes the plurality of raised platforms 7104, the one or more robotic picker arms 7106, the AMR elevator 7110, the AMRs 5800/5850, and any forklifts or automated guided vehicles travelling along the ground level. For example, for a product storage rack 7100 located within the second partition 8205-2, the first environment may be maintained at a refrigerated temperature and the second environment may be maintained at an ambient temperature, while for a product storage rack 7100 located within the third partition 8205-3, the first environment may be maintained at a below freezing temperature and the second environment may be maintained at an ambient temperature. In this way, within the second partition 8205-2 and the third partition 8205-3, the AMR 5800/5850, the AMR elevator 7110, and any other equipment or material located within the second partition 8205-2 and the third partition 8205-3, may be protected from damage that may be caused by refrigerated or freezing temperatures. The one or more robotic picker arms 7106 may be configured to enter and exit the first environment to retrieve products stored on the plurality of storage levels 7102 and release them into one or more shipping containers carried by an AMR 5800/5850. In a rest position, the one or more robotic picker arms 7106 may be located in the second environment to minimize any damage from prolonged exposure to refrigerated or below freezing temperatures. In some embodiments, more than one air curtains may be provided for a product storage rack 7100, to ensure that air seals are created all around the products stored on the plurality of storage levels 7102. In other words, as opposed to creating an air seal at just a front side of the plurality of storage levels 7102, air curtains may be provided to create air seals at the left, right, and rear sides of the plurality of storage levels 7102. In some embodiments, air curtains or other means for maintaining various areas or environments of the second partition 8205-2 and/or the third partition 8205-3 at different temperatures may not be implemented. Instead, the second partition 8205-2, including the entirety of the product storage racks 7100 and AMR elevators 7110 may generally be maintained at a refrigerated temperature such that when any AMRs 5800/5850 and vehicles travelling along the ground level enter the second partition 8205-2, they are exposed to the refrigerated temperature at which the second partition 8205-2 is maintained. Similarly, the third partition 8205-3, including the product storage racks 7100 and AMR elevators 7110, may generally be maintained at a below freezing temperature such that when any AMRs 5800/5850 and vehicles travelling along the ground level enter the third partition 8205-3, they are exposed to the refrigerated temperature at which the third partition 8205-3 is maintained.

In operation, at the product storage induction region 8203, various products may be shown to arrive at the order fulfillment center 8200A in, for example, a plurality of transport trailers.

Some of the products that have arrived, often organized upon a pallet, may be stored into compartments of the plurality of towers, which towers are located at the tower storage region 8204T. Individual products organized upon a pallet may be retrieved through de-palletization and dismantlement processes and each individual product may subsequently be placed in one of the towers 7510, as described hereinbefore. Information regarding the location in which each individual product is stored (e.g., the specific tower 7510 and the compartment 7512 of the specific tower), may be stored in a suitable memory of the order fulfilment processor 1300.

Some of the products that have arrived, often organized in crates upon a pallet, may be removed from the pallet, by personnel and/or robots 7999, and remain in their respective crates. Crates (say, as few as one and as many as six) may be stacked upon an AMR 5300 (see FIG. 81) to form a stack 8100. In some embodiments, each respective crate may store a product of a distinct SKU. For example, each respective crate in a stack 8100 may store a different type of one product (e.g., different flavors of a candy item). Alternatively, each crate in a stack 8100 may store a different product to one or more the other crates in the stack 8100 (e.g., one crate in the stack 8100 may store a candy item, a separate crate in the same stack 8100 may store a gum product, etc.). Various stacks 8100 may be transported, upon the AMRs 5300, into the tower storage region 8204T.

Some of the products that have arrived, often organized upon a pallet, may be transported, upon their respective pallets, to specific corresponding locations in the product rack storage region 8204P, where a plurality of product storage racks 7100, at which the pallets may be stored, are located. Such transportation may be done using forklifts 7997. The forklifts 7997 may be operated manually by an operator or may operate autonomously. In a preferred embodiment, the forklifts 7997 may be AGVs.

In some embodiments, products to be stored at the product rack storage region 8204P, may arrive to the order fulfilment location 8200A in a standardized storage case, palletized on a standardized pallet base. In other words, suppliers may place products, which are to be stored at the product rack storage region 8204P and used in the fulfilment of orders, into a standardized storage case and may palletize a plurality of such cases on a standardized pallet base, as described hereinbefore.

The order fulfilment location 8200A of FIG. 82A includes the product induction region 8208. The product induction region 8208 may include both manual product induction stations and robotic product induction stations. A robotic product induction station may also be called a product transfer apparatus. Furthermore, due to the mix of towers 7510 and stacks 8100 in the tower storage region 8204T, there may also be a mix of robotic product induction stations. Indeed, some of the robotic product induction stations may be suited to obtaining a product from a tower 7510 and placing the product into an erected carton on an AMR 5300. Others of the robotic product induction stations may be suited to obtaining a product from a crate 7910 in a stack 8100 and placing the product into an erected carton on an AMR 5300. For those instances wherein the product to be obtained is in a crate 7910 that is not the top crate 7910 in the stack 8100, the robotic product induction station that is suited to obtaining a product from a crate 7910 may be expected to include robotic arms suited for a task of lifting one or more crates 7910 off the stack 8100 to, thereby, allow access to the crate 7910 storing the product to be obtained.

FIG. 82B illustrates, in a schematic plan view, an order fulfilment location 8200B that may be viewed as an alternative to the order fulfilment center 8200A of FIG. 82A.

Rather than mixing, in the tower storage region 8204T, a plurality of towers 7510 and a plurality of stacks 8100, as illustrated in the order fulfilment center 8200A of FIG. 82A, the order fulfilment center 8200B of FIG. 82B features a stack storage region 8204R that is separate from, and a level above, the tower storage region 8204T. Access to the stack storage region 8204R is illustrated, in FIG. 82B, as being provided by a ramp 8220. One alternative to the ramp 8220 is an elevator (not shown).

The order fulfilment location 8200B of FIG. 82B is illustrated as including a product induction region 8228 in the stack storage region 8204R. The product induction region 8228 may include robotic product induction stations suited to obtaining a product from a crate 7910 in a stack 8100 and placing the product into an erected carton on an AMR 5300. For those instances wherein the product to be obtained is in a crate 7910 that is not the top crate 7910 in the stack 8100, the robotic product induction station that is suited to obtaining a product from a crate 7910 may be expected to include robotic arms (not shown) suited for a task of lifting one or more crates 7910 off the stack 8100 to, thereby, allow access to the crate 7910 storing the product to be obtained.

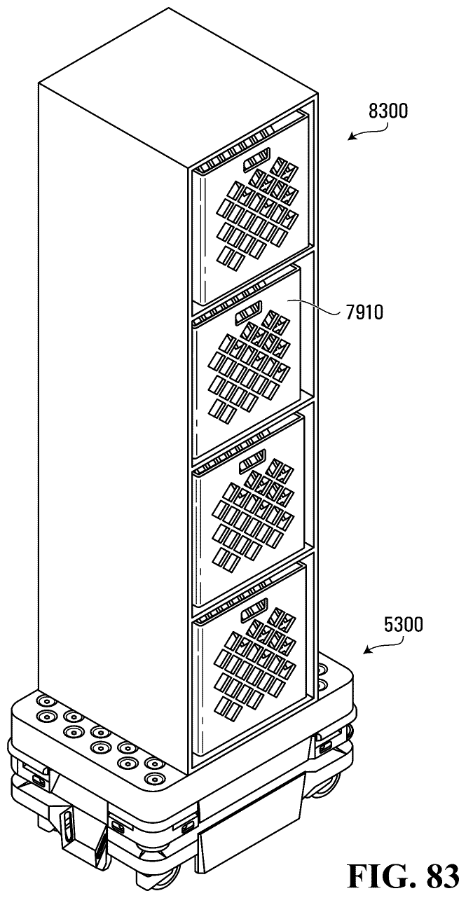

FIG. 83 illustrates an arrangement of crates 7910 (FIG. 79) within a crate retention structure 8300. The structure 8300 is illustrated as being carried on top of an AMR 5300 (FIG. 53). The structure 8300 provides an alternative to the stack 8100 of FIG. 81. Conveniently, for those instances wherein the product to be obtained is in a crate 7910 that is not the top crate 7910, the robotic product induction station that is suited to obtaining a product from a crate 7910 may be expected to withdraw the crate 7910 from the structure 8300 to, thereby, allow access to the crate 7910 storing the product to be obtained. On one hand, a robotic arm (not shown), at the robotic product induction station, may entirely withdraw the crate 7910 from the structure 8300, thereby separating the crate 7910 from the structure 8300. On the other hand, the robotic arm (not shown), at the robotic product induction station, may partially withdraw the crate 7910 from the structure 8300, thereby maintaining a spatial location of the crate 7910 within the structure 8300, as though the crate 7910 is a drawer.

In the context of FIG. 82B, a plurality of crate retention structures 8300 may populate the stack storage region 8204R. The product induction region 8228 may include robotic product induction stations suited to obtaining a product from a crate 7910 in a crate retention structure 8300 and placing the product into an erected carton on an AMR 5300.

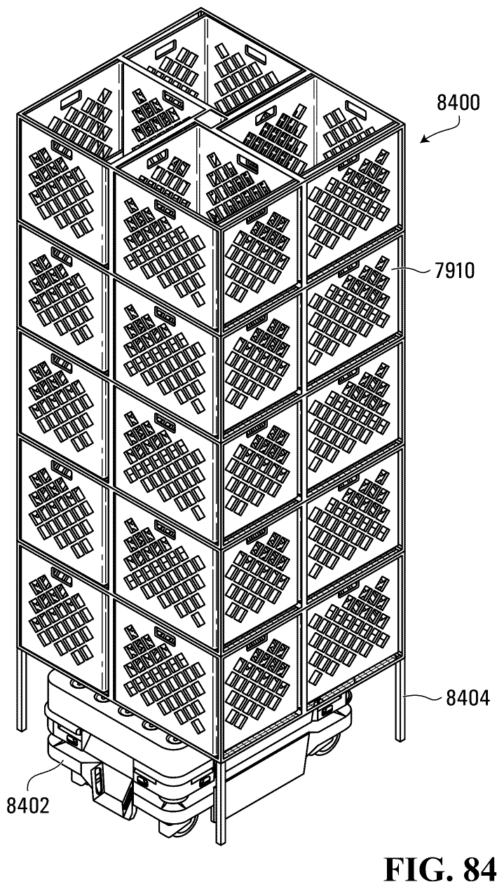

FIG. 84 illustrates a further crate retention structure 8400. Like the structure 8300 of FIG. 83, the further crate retention structure 8400 of FIG. 84 is illustrated as being carried on top of a crate retention AMR 8402. In contrast to the structure 8300 of FIG. 83, the further crate retention structure 8400 of FIG. 84 is illustrated as having legs 8404. Conveniently, the legs 8404 allow the further crate retention structure 8400 to be stored in a manner that is separate from the crate retention AMR 8402.

As discussed hereinbefore, in the context of the tower 7510 (see FIG. 75), the crate retention AMR 8402 may slide underneath the further crate retention structure 8400 and lift the further crate retention structure 8400 off the ground through, e.g., a corkscrew action. The crate retention AMR 8402 may then carry the further crate retention structure 8400 to an indicated location.

In the context of FIG. 82B, a plurality of further crate retention structures 8400 may populate the stack storage region 8204R. The product induction region 8228 may include robotic product induction stations suited to obtaining a product from a crate 7910 in a further crate retention structure 8400 and placing the product into a shipping container carried on an AMR 5300.

It is contemplated that either the crate retention structure 8300 (see FIG. 83) or the further crate retention structures 8400 (see FIG. 84) may be provisioned with a robot arm (not shown) on top of the structure. By provisioning a crate retention structure with a robot arm, an AMR with an erected shipping container may simply approach the location of the crate retention structure to receive a product from a crate 7910 carried by the crate retention structure. Accordingly, traffic at the product induction region 8228 may be reduced or eliminated.

The further crate retention structure 8400 has been discussed as an alternative to the crate retention structure 8300 of FIG. 83, which, in turn, is an alternative to the stack 8100 of FIG. 81. The crate retention structure 8300 of FIG. 83 and the stack 8100 of FIG. 81 have been presented, up to this point, as storage for multiple crates 7910, where each crate 7910 stores a product of a distinct SKU. Notably, however, it is contemplated that, for a scenario in which each crate 7910 stores a product of the same SKU, the further crate retention structure 8400 of FIG. 84 may be considered to be an alternative to the pallet 8010 of FIG. 80. Then, rather than moving, by forklifts 7997 or other AGVs, pallets 8010 of products onto the product storage racks 7100 in the product rack storage region 8204P (see FIG. 82), a plurality of crate retention AMRs 8402 may move a plurality of further crate retention structures 8400 onto the product storage racks 7100 in the product rack storage region 8204P. Conveniently, a product induction system based on the further crate retention structures 8400 may reduce any need for human operators for the forklifts 7997, which, as described hereinbefore, may be used to move pallets 8010 of products onto the product storage racks 7100 in the product rack storage region 8204P.

It is known that the forklifts 7997 may be the default vehicle for unloading pallets 8010 of products from transport trailers at the product storage induction region 8203 (see FIG. 82). It may be considered convenient to employ the further crate retention structures 8400 instead of the pallets 8010. It may be arranged, then, for a selected crate retention AMR 8402 to board a selected transport trailer, pick up a selected one of the further crate retention structures 8400 and carry the selected further crate retention structure 8400 to a particular destination. Accordingly, for a product induction system that is based on the further crate retention structures 8400, reliance upon human operators for the forklifts 7997 may be reduced.

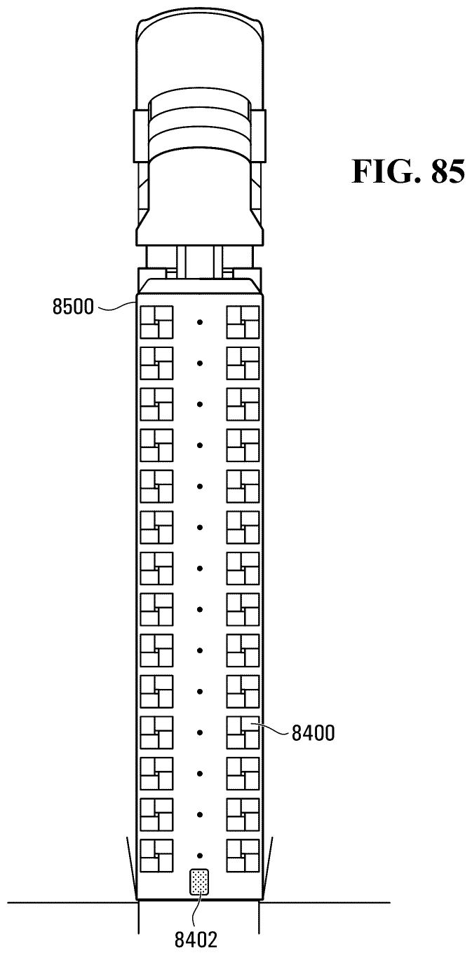

Of course, the further crate retention structures 8400 are not currently in common use. However, it is considered feasible to configure a typical transport trailer for use to carry a plurality of the further crate retention structures 8400. FIG. 85 illustrates, in a cut-away plan view, a transport trailer 8500 configured to carry a plurality of the further crate retention structures 8400. It has been discussed, hereinbefore, that AMRs may navigate, at least in part, on the basis of tracks defined by, for example, barcodes (or QR codes) on the floor of a generic order fulfilment location in which the AMRs are being used. It follows, then, that configuring the transport trailer 8500 for use with the further crate retention structures 8400 may further include implementing, in the transport trailer 8500, an adaptation allowing use with AMRs. Such adaptation may, for example, include installing tracks defined by barcodes on the floor of the transport trailer 8500 to, thereby, facilitate navigation by AMRs in the transport trailer 8500.

FIG. 86 illustrates a customer order processing matrix 8600. The customer order processing matrix 8600 may be understood to be a result of the order fulfillment processor 1300 (see FIG. 64) having processed a customer order.

According to the customer order processing matrix 8600, six AMRs 5300/5800/5850 are to be used in the fulfillment of the customer order. It may be understood that the order fulfillment processor 1300 has determined that six AMRs 5300/5800/5850 are to be used in the fulfillment of the customer order based on characteristics of individual items in the customer order. The order fulfillment processor 1300 may designate and schedule six specific AMRs 5300/5800/5850 according to the customer order processing matrix 8600.

In view of the customer order processing matrix 8600, it may be understood that four shipping containers, each associated with a distinct one of four shipping container codes (RC301, IR246, IF715, RC254) are to be used to package the order. The selection, by the order fulfillment processor 1300, of these four specific shipping containers may be based on individual item characteristics of the items in the customer order. Notably, item 4 and item 5 have been determined to not be packaged in a shipping container. However, this is simply an example, and, in some embodiments, each item to be used in the fulfilment of a customer order may be packaged in a shipping container to, e.g., prevent the items from being damaged.

Based on the characteristics of non-refrigerated items 1, 7, 8, 9, 10, 11 and 16, the order fulfillment processor 1300 may establish a shipping container size and style. For this portion of the customer order, the shipping container style is RSC and the size is 14″×10″×10″, which is implemented using shipping container code RC301. According to the customer order processing matrix 8600, the order fulfillment processor 1300 has designated AMR A1168 to carry the shipping container for this portion of the customer order.

Although not illustrated in the customer order processing matrix 8600, the order fulfillment processor 1300 may have determined that a picking and packing process, for this portion of the customer order, will consume between 70 and 80 minutes of AMR travel and wait time. The order fulfillment processor 1300 may also have determined that the processes related to verifying the contents of the shipping container, sealing the shipping container and labeling the shipping container are estimated to consume 10 minutes to complete.

Based on the characteristics of refrigerated items 2, 3 and 21, the order fulfillment processor 1300 has established a shipping container size and style. For this portion of the customer order, the shipping container style is “insulated refrigerated” and the size is 10″×8″×8″, which is implemented using shipping container code IR246. According to the customer order processing matrix 8600, the order fulfillment processor 1300 has designated AMR A4530 to carry the shipping container for this portion of the customer order.

Although not illustrated in the customer order processing matrix 8600, the order fulfillment processor 1300 may have determined that a picking and packing process, for this portion of the customer order, will consume between 40 and 50 minutes of AMR travel and wait time. The order fulfillment processor 1300 may also have determined that the processes related to verifying the contents of the shipping container, sealing the shipping container and labeling the shipping container are estimated to consume 10 minutes to complete.

Based on the characteristics of frozen items 6, 12, 19 and 20, the order fulfillment processor 1300 has established a shipping container size and style. For this portion of the customer order, the shipping container style is “insulated frozen” and the size is 12″×8″×10″, which is implemented using shipping container code IF715. According to the customer order processing matrix 8600, the order fulfillment processor 1300 has designated AMR A5546 to carry the shipping container for this portion of the customer order.

Although not illustrated in the customer order processing matrix 8600, the order fulfillment processor 1300 may have determined that a picking and packing process, for this portion of the customer order, will consume between 30 and 40 minutes of AMR travel and wait time. The order fulfillment processor 1300 may also have determined that the processes related to verifying the contents of the shipping container, sealing the shipping container and labeling the shipping container are estimated to consume 10 minutes to complete.

Based on the characteristics of items 4 and 5, the order fulfillment processor 1300 has established that a shipping container is not required. According to the customer order processing matrix 8600, the order fulfillment processor 1300 has designated AMR A9436 to carry item 4 and has designated AMR A13462 to carry item 5.

Although not illustrated in the customer order processing matrix 8600, the order fulfillment processor 1300 may have determined that a picking and packing process, for this portion of the customer order, will consume between 30 and 40 minutes of AMR travel and wait time. The order fulfillment processor 1300 may also have determined that the processes related to verifying the contents of item 4 and item 5, and labeling the shipping container are estimated to consume 10 minutes to complete.

Based on the characteristics of non-refrigerated items 13, 14, 15, 17 and 18, the order fulfillment processor 1300 may establish a shipping container size and style. For this portion of the customer order, the shipping container style is RSC and the size is 14″×14″×8″, which is implemented using shipping container code RC254. According to the customer order processing matrix 8600, the order fulfillment processor 1300 has designated AMR A10258 to carry the shipping container for this portion of the customer order.

For order items 1, 7, 8, 9, 10, 11 and 16, the order fulfillment processor 1300 may instruct AMR A1168 to proceed to a specific shipping container delivery system in the shipping container induction region 8206. In a manner described in more detail hereinbefore, the specific shipping container delivery system may pick, from the case magazine, a case blank for shipping container code RC301. The specific shipping container delivery system may then erect and bottom seal the shipping container and provide the shipping container to AMR A1168.

The order fulfillment processor 1300 may instruct AMR A1168 to proceed, with the shipping container, to a manual product induction station in the product induction region 8208 to receive item 1.

The order fulfillment processor 1300 may instruct AMR A1168 to proceed, with the shipping container, to a manual product induction station in the product induction region 8208 to receive item 7.

The order fulfillment processor 1300 may instruct AMR A1168 to proceed, with the shipping container, to a robotic product induction station in the stack storage region 8204R to receive item 8.

The order fulfillment processor 1300 may instruct AMR A1168 to proceed, with the shipping container, to a robotic product induction station in the stack storage region 8204R to receive item 9.

The order fulfillment processor 1300 may instruct AMR A1168 to proceed, with the shipping container, to a manual product induction station in the product induction region 8208 to receive item 16.

The order fulfillment processor 1300 may instruct AMR A1168 to proceed, with the shipping container, to a robotic product induction station in the stack storage region 8204R to receive item 11.

The order fulfillment processor 1300 may instruct AMR A1168 to proceed, with the shipping container, to a robotic product induction station in the stack storage region 8204R to receive item 10.

Responsive to the last item (item 10, in this case) having been loaded into the shipping container, the order fulfillment processor 1300 may instruct AMR A1168 to visit an order verification, case sealing and labelling station, such as the case sealing station 7620 of FIG. 73, to verify the contents of the shipping container, seal the shipping container and label the shipping container.

For order items 2, 3 and 21, the order fulfillment processor 1300 may instruct AMR A4530 to proceed to a specific shipping container delivery system in the shipping container induction region 8206. In a manner described in more detail hereinbefore, the specific shipping container delivery system may pick, from the case magazine, a case blank for shipping container code IR246. The shipping container code IR246 may, for example, be an insulated container designed for being loaded with refrigerated products. The specific shipping container delivery system may then erect and bottom seal the shipping container and provide the shipping container to AMR A4530.

The order fulfillment processor 1300 may instruct AMR A4530 to proceed, with the shipping container, to a robotic product induction station in the refrigerated temperature second partition 8205-2 within the product rack storage region 8204P. At the robotic product induction station, a robotic product induction robot will depalletize item 2 from a stored pallet and place item 2 into the shipping container on AMR A4530.

The order fulfillment processor 1300 may instruct AMR A4530 to proceed, with the shipping container, to a further robotic product induction station in the refrigerated temperature second partition 8205-2 within the product rack storage region 8204P. At the robotic product induction station, a robotic product induction robot will depalletize item 3 from a stored pallet and place item 3 into the shipping container on AMR A4530.

The order fulfillment processor 1300 may instruct AMR A4530 to proceed, with the shipping container, to a further robotic product induction station in the refrigerated temperature second partition 8205-2 within the product rack storage region 8204P. At the robotic product induction station, a robotic product induction robot will depalletize item 21 from a stored pallet and place item 21 into the shipping container on AMR A4530.

Responsive to the last item (item 21, in this case) having been loaded into the shipping container, the order fulfillment processor 1300 may instruct AMR A4530 to visit an order verification, case sealing and labelling station, such as the case sealing station 7620 of FIG. 73, to verify the contents of the shipping container, seal the shipping container and label the shipping container.

For frozen items 6, 12, 19 and 20, the order fulfillment processor 1300 may instruct AMR A5546 to proceed to a specific shipping container delivery system in the shipping container induction region 8206. In a manner described in more detail hereinbefore, the specific shipping container delivery system may pick, from the case magazine, a case blank for shipping container code IF715. The shipping container code IF715 may, for example, be an insulated container designed for being loaded with frozen products. The specific shipping container delivery system may then erect and bottom seal the shipping container and provide the shipping container to AMR A5546.

The order fulfillment processor 1300 may instruct AMR A5546 to proceed, with the shipping container, to a robotic product induction station in the frozen temperature third partition 8205-3 within the product rack storage region 8204P. At the robotic product induction station, a robotic product induction robot will depalletize item 6 from a stored pallet and place item 6 into the shipping container on AMR A5546.

The order fulfillment processor 1300 may instruct AMR A5546 to proceed, with the shipping container, to a robotic product induction station in the frozen temperature third partition 8205-3 within the product rack storage region 8204P. At the robotic product induction station, a robotic product induction robot will depalletize item 12 from a stored pallet and place item 12 into the shipping container on AMR A5546.

The order fulfillment processor 1300 may instruct AMR A5546 to proceed, with the shipping container, to a robotic product induction station in the frozen temperature third partition 8205-3 within the product rack storage region 8204P. At the robotic product induction station, a robotic product induction robot will depalletize item 19 from a stored pallet and place item 19 into the shipping container on AMR A5546.

The order fulfillment processor 1300 may instruct AMR A5546 to proceed, with the shipping container, to a robotic product induction station in the frozen temperature third partition 8205-3 within the product rack storage region 8204P. At the robotic product induction station, a robotic product induction robot will depalletize item 20 from a stored pallet and place item 20 into the shipping container on AMR A5546.

Responsive to the last item (item 20, in this case) having been loaded into the shipping container, the order fulfillment processor 1300 may instruct AMR A5546 to visit an order verification, case sealing and labelling station, such as the case sealing station 7620 of FIG. 73, to verify the contents of the shipping container, seal the shipping container and label the shipping container.

As discussed hereinbefore, for item 4 and item 5 there is to be no shipping container.

For item 4, the order fulfillment processor 1300 may instruct AMR A9436 to proceed to a robotic product induction station in the ambient temperature first partition 8205-1 within the product rack storage region 8204P. At the robotic product induction station, a robotic product induction robot will depalletize item 4 from a stored pallet and place item 4 onto AMR A9436.

For item 5, the order fulfillment processor 1300 may instruct AMR A13462 to proceed to a robotic product induction station in the ambient temperature first partition 8205-1 within the product rack storage region 8204P. At the robotic product induction station, a robotic product induction robot will depalletize item 5 from a stored pallet and place item 5 onto AMR A13462.

For order items 13, 14, 15, 17 and 18, the order fulfillment processor 1300 may instruct AMR A10258 to proceed to a specific shipping container delivery system in the shipping container induction region 8206. In a manner described in more detail hereinbefore, the specific shipping container delivery system may pick, from the case magazine, a case blank for shipping container code RC254. The specific shipping container delivery system may then erect and bottom seal the shipping container and provide the shipping container to AMR A10258.

The order fulfillment processor 1300 may instruct AMR A10258 to proceed, with the shipping container, to a robotic product induction station in the ambient temperature first partition 8205-1 within the product rack storage region 8204P. At the robotic product induction station, a robotic product induction robot will depalletize item 15 from a stored pallet and place item 15 onto AMR A10258.

The order fulfillment processor 1300 may instruct AMR A10258 to proceed, with the shipping container, to a robotic product induction station in the ambient temperature first partition 8205-1 within the product rack storage region 8204P. At the robotic product induction station, a robotic product induction robot will depalletize item 14 from a stored pallet and place item 14 onto AMR A10258.

The order fulfillment processor 1300 may instruct AMR A10258 to proceed, with the shipping container, to a robotic product induction station in the ambient temperature first partition 8205-1 within the product rack storage region 8204P. At the robotic product induction station, a robotic product induction robot will depalletize item 18 from a stored pallet and place item 18 onto AMR A10258.

The order fulfillment processor 1300 may instruct AMR A10258 to proceed, with the shipping container, to a robotic product induction station in the ambient temperature first partition 8205-1 within the product rack storage region 8204P. At the robotic product induction station, a robotic product induction robot will depalletize item 17 from a stored pallet and place item 17 onto AMR A10258.

The order fulfillment processor 1300 may instruct AMR A10258 to proceed, with the shipping container, to a robotic product induction station in the ambient temperature first partition 8205-1 within the product rack storage region 8204P. At the robotic product induction station, a robotic product induction robot will depalletize item 13 from a stored pallet and place item 13 onto AMR A10258.

Responsive to the last item (item 13, in this case) having been loaded into the shipping container, the order fulfillment processor 1300 may instruct AMR A10258 to visit an order verification, case sealing and labelling station, such as the case sealing station 7620 of FIG. 73, to verify the contents of the shipping container, seal the shipping container and label the shipping container.

At each customer order verification station, the AMR may allow for the contents of a shipping container to be subjected to an inspection. An inspection may include weighing the shipping container to verify the contents of the shipping container. According to the inspection, the shipping container may be accepted or rejected.

A shipping container that is rejected at the customer order verification station may be directed, by the order fulfillment processor 1300, to a manual rework station. At the manual rework station, an associate may attempt to rectify whatever issue caused the shipping container to be rejected. Subsequent to rectifying the issue, the associate may cause the order fulfillment processor 1300 to instruct the AMR carrying the shipping container to proceed to a designated dunnage loading station, a designated top sealing and a designated labeling station.

A shipping container that is accepted at the customer order verification station may be directed, by the order fulfillment processor 1300, to a designated dunnage loading station, a designated top sealing and a designated labeling station.

At the dunnage loading station, each individual AMR may move a respective shipping container through a dunnage placer. At the dunnage placer, it should be clear that dunnage may only be added if deemed helpful. The AMR may then continue to the top sealing station, at which the shipping container may be sealed. The sealed shipping container may be further inspected. An AMR, carrying a rejected sealed shipping container, may be directed, by the order fulfillment processor 1300, to a manual rework station. At the rework station, an associate may attempt to rectify whatever issue caused the sealed shipping container to be rejected. Subsequent to rectifying the issue, the associate may cause the order fulfillment processor 1300 to instruct the AMR carrying the shipping container to proceed to the designated labeling station. The AMR carrying the sealed shipping container that passes further inspection may be directed, by the order fulfillment processor 1300, to the designated labeling station.

Each individual AMR may move the respective sealed shipping container through the designated labeling station. At the designated labeling station, a shipping label may be printed and applied to the sealed shipping container, thereby forming a labeled shipping container. Other labels, designating the package as Fragile or Heavy, may also be applied to the labeled shipping container, if deemed necessary. The labeled shipping container may, again, be inspected and may pass inspection or be rejected. An AMR, carrying a labeled shipping container that has been rejected for an issue, may be directed, by the order fulfillment processor 1300, to a manual rework station. At the rework station, an associate may attempt to rectify whatever issue caused the labeled shipping container to be rejected. Subsequent to rectifying the issue, the associate may cause the order fulfillment processor 1300 to instruct the AMR carrying the labeled shipping container to proceed to a designated shipping container delivery route accumulation station. The AMR carrying the labeled shipping container that passes inspection may be directed, by the order fulfillment processor 1300, to the designated shipping container delivery route accumulation station.

In total, it may be recognized that there are six AMRs (A1168, A4530, A9436, A13462, A5546 and A10258) involved in fulfilling the customer order represented by the customer order processing matrix 8600 of FIG. 86. It is proposed herein that instructions to the six AMRs involve staggered AMR dispatch times. The staggered AMR dispatch times may, for example, take into account the estimated time for each AMR to fulfill part of the customer order.

As noted above, for example, the order fulfillment processor 1300 may have determined that a picking and packing process, for the items 1, 7, 8, 9, 10, 11 and 16 portion of the customer order, will consume between 70 and 80 minutes of AMR travel and wait time. As also noted above, for example, the order fulfillment processor 1300 may have determined that a picking and packing process, for the frozen items 6, 12, 19 and 20 portion of the customer order, will consume between 30 and 40 minutes of travel and wait time for AMR A5546. Accordingly, the order fulfillment processor 1300 may stagger the dispatch time for AMR A5546 to occur 40 minutes after the dispatch time for AMR A1168 so that AMR A5546 and AMR A1168 complete their respective travels around the order fulfillment location 8200 at roughly the same time.

Indeed, the order fulfillment processor 1300 may stagger the respective dispatch times for all six AMR so that all six AMRs complete their respective travels around the order fulfillment location 8200 at roughly the same time. It follows that all six portions of the customer order arrive at the delivery route accumulation station at approximately the same time.

To facilitate an effective in-delivery-vehicle sorting process, the order fulfillment processor 1300 may maintain a First-In-Last-Out (FILO) staging strategy for a designated last mile delivery vehicle. As such, the order fulfillment processor 1300 may generate instructions such that all six AMRs accumulate at the delivery route accumulation station at roughly the same time. Upon determining that all six AMRs, making up the customer order, have been accumulated, the order fulfillment processor 1300 may release the AMRs to travel to the discharge conveyor 7226 (see FIGS. 71, 72, 74).

At an unload position, the six AMRs carrying portions of the customer order may transfer their respective shipping container, or item without shipping container, onto the discharge conveyor 7226. The AMRs may be directed to the unload position in a particular sequence. The customer order may be understood to be conveyed, on the discharge conveyor 7226, to a delivery vehicle loading position. The customer order may be loaded into and stored on the delivery vehicle as a group. All customer orders on a preprogrammed delivery route to be followed by the delivery vehicle may be arranged, by the order fulfillment processor 1300, to arrive at the delivery vehicle loading position on a FILO basis that takes into account the preprogrammed delivery route. All shipping containers that have been designated to the preprogrammed delivery route may be loaded, by the delivery vehicle driver, into the delivery vehicle in a sequence. Preferably, the sequence is a prescribed FILO sequence configured to optimize the delivery process. That is, the unload position in the route distribution accumulation region corresponds to a delivery route representative of an ordered sequence of destinations. The generating, by the order fulfillment processor 1300, of instructions to the six AMRs may be understood to include determining a position, in the ordered sequence of destinations, for the destination for the customer order and arranging a timing of an arrival, of the six AMRs, at the unload position in the route distribution accumulation region, such that the timing of the arrival corresponds to the position in the ordered sequence of destinations.

Using the preprogrammed delivery route, the delivery vehicle driver proceeds to carry out deliveries. As the driver completes each delivery, the driver may mark the delivery as completed, thereby providing feedback to a delivery monitoring system. Beneficially, users may receive real time data on delivery status.

As a matter of course, the delivery driver may be expected to arrive at the address of the customer associated with the customer order processing matrix 8600. The driver may unload the shipping containers, and the items that are not in a shipping container, that make up the customer order and place the customer order at the door of the customer. The customer may then be notified of the delivery, thereby completing the order process.

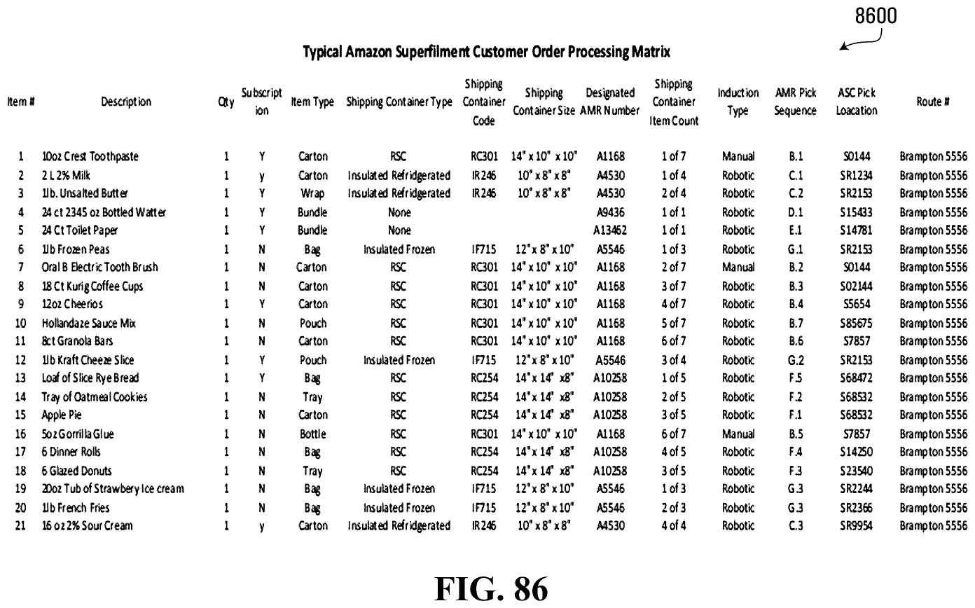

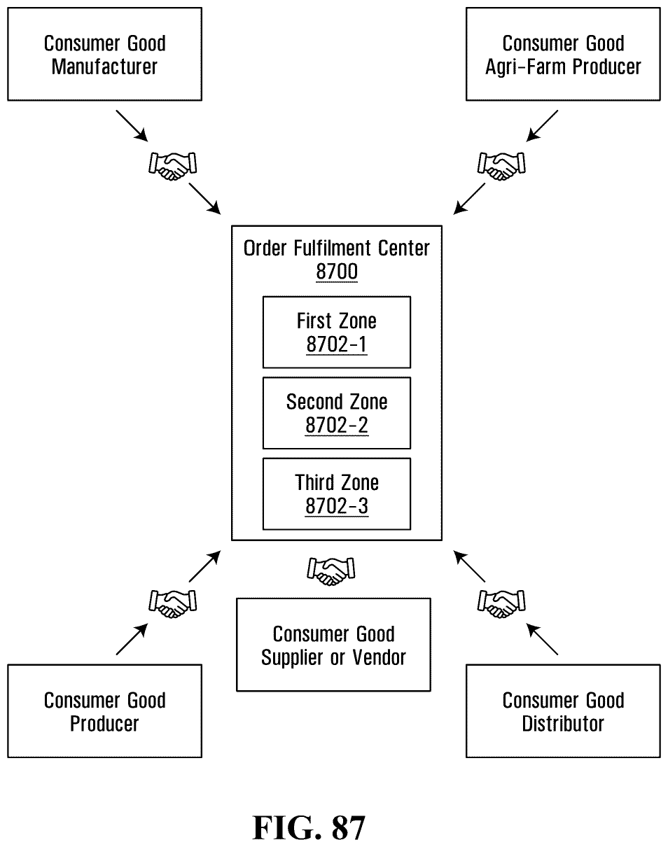

FIG. 87 schematically illustrates an order fulfilment center 8700 at the center of a network of suppliers of products to be stored at the order fulfilment center 8700. The order fulfilment center 8700 is illustrated as being split into three distinct product storage and customer order induction zones 8702 including: a first order induction zone 8702-1; a second order induction zone 8702-2; and a third order induction zone 8702-3. Each order induction zone may be associated with order-induction-zone-specific schemes for receiving products, storing products and inducting products into order shipping containers.

In view of the previously discussed order fulfilment center 8200B of FIG. 82B, the first order induction zone 8702-1 may be understood to map to the product rack storage region 8204P. It follows that the first order induction zone 8702-1 may be understood to be used in the context of relatively fast-moving consumer SKUs with a relatively small (say, 5,000) number of SKUs. The SKUs may be robotically inducted, by AMRs, and stored in the first order induction zone 8702-2 in product storage racks similar to the product storage racks 7100 discussed hereinbefore (see FIGS. 70, 76, 76A, 82A, 82B).

In view of the previously discussed order fulfilment center 8200B of FIG. 82B, the second order induction zone 8702-2 may be understood to map to the stack storage region 8204R. It follows that the second order induction zone 8702-2 may be understood to be used in the context of relatively medium-moving consumer SKUs with a relatively middling (say, 25,000) number of SKUs. The SKUs may be robotically inducted, by AMRs (like the AMR 8402 of FIG. 84), and stored in the second order induction zone 8702-2 in crate retention structures (like the further crate retention structure 8400 of FIG. 84).

In view of the previously discussed order fulfilment center 8200B of FIG. 82B, the third order induction zone 8702-3 may be understood to map to the tower storage region 8204T. It follows that the third order induction zone 8702-3 may be understood to be used in the context of relatively slow-moving consumer SKUs with a relatively large (say, 1,000,000) number of SKUs. The SKUs may be manually inducted, by personnel, and stored in the third order induction zone 8702-3 in towers (like the tower 7510 of FIG. 75).

With partnerships established with the suppliers illustrated in FIG. 87, an order fulfillment processor (e.g., the order fulfillment processor 1300 of FIG. 64) may determine an inventory process to be followed for each of the SKUs arriving at the order fulfilment center 8700. Inbound SKUs may be allocated to a designated receiving dock associated with an appropriate product storage and customer order induction order induction zone 8702. The receiving dock may be part of the product storage induction region 8203 (see FIG. 82). SKUs designated to the first order induction zone 8702-1 and the second order induction zone 8702-2 may be received on further crate retention structures 8400. SKUs designated to the third order induction zone 8702-3 may be received in traditional packaging.

A first stage of processing products may be related to inbound product receiving and trailer unloading.

SKUs that are inbound and destined for the first order induction zone 8702-1 of the order fulfilment center 8700 may be expected to arrive, in inbound transport trailers, on crate retention structures (e.g., the further crate retention structure 8400 of FIG. 84) with a single SKU per crate retention structure. The inbound transport trailers may be configured to transport crate retention structures (like, e.g., the transport trailer 8500 of FIG. 85). The inbound transport trailer may, for example, be configured to transport 28 crate retention structures. The inbound transport trailer may, for example, be configured with an AMR track defined by barcodes on the floor of the inbound transport trailer. Each crate retention structure may be removed from the inbound transport trailers by an AMR (e.g., AMR 8402 in FIG. 84).

A second stage of processing products may be related to removing empty crates (e.g., crates 7910) from the order fulfilment center 8700.

In one aspect of the present application, empty crates in the first order induction zone 8702-1 may be installed into designated crate retention structures (e.g., the further crate retention structure 8400 of FIG. 84). Upon determining that a particular designated crate retention structure qualifies as an empty designated crate retention structure, that is, the particular designated crate retention structure is full of empty crates, an order fulfillment processor may instruct an AMR (e.g., AMR 8402 in FIG. 84) to transport the particular designated crate retention structure into a transport trailer specifically designated to receive empty crate retention structures. The AMR may release the particular designated crate in a designated location in the transport trailer. The AMR may then depart the transport trailer and await further instructions.

A third stage of processing products may be related to storing inbound crate retention structures.

The AMR carrying an inbound crate retention structure associated with a single SKU may be directed from the transport trailer to a designated position in a designated product storage rack (see the product storage racks 7100 discussed in relation to FIGS. 70, 76, 76A, 82A, 82B) in the first order induction zone 8702-1. It is contemplated herein that movement of crate retention structures will be carried out by AMRs. Accordingly, it may be noted that use of roller conveyors, which are conventionally used for movement of conventional pallets of products, may be obviated.

The first order induction zone 8702-1, in a routine implementation, may be capable of storing approximately products representative of 5,000 SKUs on conventional pallets in combination with, say, 130,000 crate retention structures.

Responsive to determining that a crate on a particular crate retention structure at a particular order induction station in the first order induction zone 8702-1 has been emptied, a given AMR may be instructed to visit the particular order induction station. At the particular order induction station, an order induction robot (see the robotic picker arm 7106 of FIG. 70) may place the empty crate onto the given AMR.

Upon determining that the last crate has been removed from the particular crate retention structure, a further AMR may be instructed to visit the particular order induction station. The further AMR may engage the particular crate retention structure, for example, by slipping under the particular crate retention structure and lifting the particular crate retention structure and transport the particular crate retention structure to a re-palletizing station. At the re-palletizing station, the particular crate retention structure may await the arrival of empty crates. A robotic arm may be responsible for populating the particular crate retention structure with empty crates.

Once all of the available crate locations in the particular crate retention structure have been filled with empty crates, an available AMR may be instructed to transport the particular crate retention structure to a designated location in a transport trailer that has been specifically designated to receive empty crate retention structures. Upon determining that a transport trailer has a complete load of empty crate retention structures, a transport truck associated with the transport trailer may transport the load of crate retention structures full of empty crates to a location of one of the suppliers of products to the order fulfilment center 8700. This last act of returning a load of crate retention structures full of empty crates may be considered to close a loop of activity between the supplier of products and the order fulfilment center 8700.

There may be in the order of 200 carton forming systems in a shipping container induction region (see, for example, the shipping container induction region 8206 of FIG. 82A). Each carton forming system may be configured to produce a unique size and style of shipping container formed or erected from blank corrugated recyclable materials. Alternatively, in some embodiments, one or more of the carton forming system may be configured to produce more than one size and/or more than one style of shipping container formed or erected from blank corrugated recyclable materials. The variety of sizes and styles of shipping container may be shown to allow products to be packed in order-specific shipping containers. For example, refrigerated and frozen products may be packed into insulated shipping containers. As discussed briefly hereinbefore, the size and number of shipping containers employed for a given customer order may be determined on the basis of the sizes, types and quantities of items in the given customer order.

Upon initiation of a specific customer order, the order fulfillment processor (e.g., the order fulfillment processor 1300 of FIG. 64) may direct an available AMR to the appropriate carton forming system. The carton forming system may form a shipping container and place the formed shipping container on the AMR. The order fulfillment processor may then route the AMR to the first of a series of product induction stations. There may be in the order of 5,000 product induction stations in the first order induction zone 8702-1, in the order of 500 product induction stations in the second order induction zone 8702-2 and in the order of 500 product induction stations in the third order induction zone 8702-3.

As discussed hereinbefore, the AMR may be designed to hold and carry any shipping container among a wide variety of styles and sizes of shipping containers. The AMR may accept shipping containers from any one of the over 200 carton forming systems. As part of fulfilling an order, a given AMR may move a shipping container to one or more designated product induction stations, order verification stations, container sealing stations, labeling stations, rework stations, delivery route accumulation stations and discharge conveyors.

AMRs that have been routed to one of the roughly 5,000 product induction stations in the first order induction zone 8702-1 may be, more particularly, directed to a robotic product loading position. At the robotic product loading position, a robot may pick a product from a crate carried by a crate retention structure and place the product into the shipping container carried by the AMR. The robot may be expected to pick multiple products to fulfill a customer order. The AMR may then be directed to a next product induction station on an order induction route. AMRs that have been routed to the refrigerated and frozen food sections of the first order induction zone 8702-1 may be expected to carry insulated shipping containers.

The first order induction zone 8702-1 may be expected to be capable of handling products that do not require a shipping container, for example, bundled cases of beverages. These types of products may be picked directly from a crate retention structure and placed onto an available AMR. The AMR may be expected to then carry the product directly to a verification station.

SKUs that are inbound, into the second order induction zone 8702-2, on crate retention structures with one or more SKUs per crate retention structure, may arrive in transport trailers that are equipped to carry crate retention structures. As illustrated in FIG. 85, the transport trailer may be configured to hold 28 crate retention structures and feature AMR track embedded in the floor of the transport trailer. Each SKU on a crate retention structure destined for the second order induction zone 8702-2 may be carried in a single crate. As discussed hereinbefore, each crate retention structure may be removed from the transport trailer by an AMR.

As discussed hereinbefore in relation to the first order induction zone 8702-1, to close the loop with a consumer product provider of SKUs for the second order induction zone 8702-2, an outbound transport trailer may be reloaded with crate retention structures full of empty crates.

An AMR assigned to a multiple SKU crate retention structure may be directed to travel from the transport trailer to a designated storage position in the second order induction zone 8702-2.

A single-level implementation of the second order induction zone 8702-2 (see FIG. 82B) may be expected to be employed in a manner very similar to the manner in which the third order induction zone 8702-3 is employed.

It may be noted that use of AMRs for unloading crate retention structures from a transport trailer and moving the crate retention structures to respective designated storage positions in the second order induction zone 8702-2 may obviate use of roller conveyors, which are conventionally used for movement of conventional pallets of products.

The second order induction zone 8702-2, in a routine implementation, may be capable of storing products representative of approximately 25,000 SKUs in crates stored within approximately 5,000 crate retention structures.

Responsive to determining that the last crate on the crate retention structure at a product induction station in the second order induction zone 8702-2 has been emptied, an AMR may be directed to transport the crate retention structure full of empty crates to a re-palletizing station.

At the re-palletizing station, once it has been determined that all of the available crate locations in the particular crate retention structure are filled with empty crates, the crate retention structure full of empty crates may be wrapped at a pallet strapping stations. An available AMR may be instructed to transport the particular (wrapped) crate retention structure to a designated location in a transport trailer that has been specifically designated to receive empty crate retention structures. Upon determining that a transport trailer has a complete load of empty crate retention structures, a transport truck associated with the transport trailer may transport the load of crate retention structures full of empty crates to a location of one of the suppliers of products to the order fulfilment center 8700. This last act of returning a load of crate retention structures full of empty crates may be considered to close a loop of activity between the supplier of products and the order fulfilment center 8700.

There may be in the order of 200 carton forming systems in a shipping container induction region (see, for example, the shipping container induction region 8206 of FIG. 82A). Each carton forming system may be configured to produce a unique size and style of shipping container formed or erected from blank corrugated recyclable materials. Alternatively, in some embodiments, one or more of the carton forming systems may be configured to produce more than one size and/or more than one style of shipping container formed or erected from blank corrugated recyclable materials. The variety of sizes and styles of shipping container may be shown to allow product to be packed in order-specific shipping containers. As discussed briefly hereinbefore, the size and number of shipping containers employed for a given customer order may be determined on the basis of the sizes, types and quantities of items in the given customer order.

Upon initiation of a specific customer order, the order fulfillment processor (e.g., the order fulfillment processor 1300 of FIG. 64) may direct an available AMR to the appropriate carton forming system. The carton forming system may form a shipping container and place the formed shipping container on the AMR. The order fulfillment processor may then route the AMR to the first of a series of product induction stations.

As discussed hereinbefore, the AMR may be designed to hold and carry any shipping container among a wide variety of styles and sizes of shipping containers. The AMR may accept shipping containers from any one of the over 200 carton forming systems. As part of fulfilling an order, a given AMR may move a shipping container to one or more designated product induction stations, order verification stations, container sealing stations, labeling stations, rework stations, delivery route accumulation stations and discharge conveyors.

As described hereinbefore, products are stored in the second order induction zone 8702-2 in crates in crate retention structures. Each of the crate retention structures may be considered to be fully accessible by AMRs. When a customer order includes a product stored in the second order induction zone 8702-2, the order fulfillment processor (e.g., the order fulfillment processor 1300 of FIG. 64) may direct one AMR to retrieve the appropriate crate retention structure from a location within the second order induction zone 8702-2 and move the appropriate crate retention structure to a particular product induction station in a product induction region (see, for example, the product induction region 8228 in FIG. 82B) to meet another AMR carrying an appropriate shipping container.

AMRs that have been routed to one of the roughly 500 product induction stations in the second order induction zone 8702-2 may be, more particularly, directed to a robotic product loading position. At the robotic product loading position, a robot may pick a product from a crate carried by a crate retention structure and place the product into the shipping container carried by the AMR.

At the robotic product loading position the crate retention structure may be processed to make a particular product available, from an appropriate crate, for picking by an order induction robot. At the robotic product loading position, a robot may pick a product from a crate carried by a crate retention structure and place the product into the shipping container carried by the AMR. The robot may be expected to pick multiple products to fulfill a customer order. The AMR may then be directed to a next product induction station on an order induction route.

SKUs that are inbound, into the third order induction zone 8702-3, may, typically, arrive packed in corrugated boxboard cases. The corrugated boxboard cases may be unloaded manually from the transport trailer. The received cases may be inspected and scanned. The received cases may also be unpacked to allow individual products, unpacked from the cases, to be scanned and placed into totes. The totes may then be conveyed to a storage induction station.

In the context of the third order induction zone 8702-3, when transport trailers are returned to the consumer products supplier, it is expected that the transport trailer will be returned in an empty state.

Upon arriving at a storage induction station, a given tote may be directed to one storage induction station among, say, hundreds of storage induction stations. An associate may be expected to manually pick the product from the tote, scan the product and place the product into an available space in a tower (like the tower 7510 of FIG. 75) carried by an AMR. Responsive to the remaining products contained in the tote having been picked and placed in other spaces in the tower (or in other towers) the AMR may move the tower out of the storage induction stations and into a tower storage region (like the tower storage region 8204T of FIG. 82B). Empty totes may be stacked and returned to the product receiving area to be recycled.

The third order induction zone 8702-3, in a routine implementation, may be capable of storing products representative of approximately 1,000,000 SKUs in over 10,000 towers.

As discussed, it is expected that products in the third order induction zone 8702-3 are received packed in corrugated inbound shipping containers. After the inbound shipping containers have been unpacked, the inbound shipping containers may be subjected to a process that involves collecting and compacting the inbound shipping containers. The collected and compacted shipping containers may then be shipped out of the order fulfilment center 8700 to be recycled. This is process may be considered to be consistent with known order fulfilment center processes.

There may be in the order of 200 carton forming systems in a shipping container induction region (see, for example, the shipping container induction region 8206 of FIG. 82A). Each carton forming system may be configured to produce a unique size and style of shipping container formed or erected from blank corrugated recyclable materials. Alternatively, in some embodiments, one or more of the carton forming systems may be configured to produce more than one size and/or more than one style of shipping container formed or erected from blank corrugated recyclable materials. The variety of sizes and styles of shipping container may be shown to allow product to be packed in order-specific shipping containers. As discussed briefly hereinbefore, the size and number of shipping containers employed for a given customer order may be determined on the basis of the sizes, types and quantities of items in the given customer order.

Upon initiation of a specific customer order, the order fulfillment processor (e.g., the order fulfillment processor 1300 of FIG. 64) may direct an available AMR to the appropriate carton forming system. The carton forming system may form a shipping container and place the formed shipping container on the AMR. The order fulfillment processor may then route the AMR to the first of a series of product induction stations.

As discussed hereinbefore, the AMR may be designed to hold and carry any shipping container among a wide variety of styles and sizes of shipping containers. The AMR may accept shipping containers from any one of the over 200 carton forming systems. As part of fulfilling an order, a given AMR may move a shipping container to one or more designated product induction stations, order verification stations, container sealing stations, labeling stations, rework stations, delivery route accumulation stations and discharge conveyors.

Products in the third order induction zone 8702-3 may be understood to be stored in towers in a tower storage region, with each of the towers being fully accessible by AMRs. When a given customer order specifies a product that may be found in the third order induction zone 8702-3, the order fulfillment processor (e.g., the order fulfillment processor 1300 of FIG. 64) may direct an available AMR to the appropriate carton forming system. The carton forming system may form a shipping container and place the formed shipping container on the AMR. The order fulfillment processor may then route the AMR to the first of a series of product induction stations.

When a customer order includes a product stored in the third order induction zone 8702-3, the order fulfillment processor (e.g., the order fulfillment processor 1300 of FIG. 64) may direct one AMR to retrieve the appropriate tower from a location within the third order induction zone 8702-3 and move the appropriate tower to a particular product induction station in a product induction region (see, for example, the product induction region 8208 in FIG. 82A) to meet another AMR carrying an appropriate shipping container.

AMRs that have been routed to one of the roughly 500 product induction stations in the third order induction zone 8702-3 may be, more particularly, directed to a manual product loading position. At the manual product loading position, an associate may pick a product from a location in a tower and place the product into the shipping container carried by an AMR. The associate may be expected to pick multiple products to fulfill a customer order. The AMR may then be directed to a next product induction station on an order induction route.

While various stages of order fulfilment are described hereinbefore as being distinct for the three distinct order induction zones 8702-1, 8702-3 and 8702-3, the remaining stages are common for all three distinct order induction zones 8702-1, 8702-3 and 8702-3.

Shipping containers or unpackaged products, on respective AMRs, that have completed respective product induction routes are directed to a shipping container verification station among, say, 100 shipping container verification stations. Using tests that involve, for example, vision and check weighing technology, the shipping container verification station may be expected to perform a variety of checks on the shipping container while the shipping container is on the AMR. Shipping containers that fail the tests may be directed, on the AMR, to a manual rework station, at which an associate may act to correct an issue with the order and reroute AMR carrying the shipping container back through the verification station. Shipping containers that pass all of the tests may be directed to a dunnage inserting station (if necessary) or to a shipping container top closing system.

Due to a mismatch between dimensions of a given product and dimensions of a shipping container, the shipping container may benefit from the addition of dunnage. Dunnage may be seen to protect the given product during so-called last mile deliveries. Unpackaged products, for example, bundles of water bottles may be understood to not require dunnage. Verified shipping containers identified as potentially benefitting from dunnage may be directed to a shipping container dunnage insertion station among, say, 20 shipping container dunnage insertion stations. The shipping container dunnage insertion stations may insert an amount of dunnage directly into the shipping container while the shipping container is carried upon the AMR. The dunnage in the shipping container may be verified in a manner that allows any shipping container with dunnage that cannot be verified to be directed, on the AMR, to a manual rework station. At the manual rework station, an associate may correct the issue and reroute the shipping container to a shipping container top closing and sealing station among, say, 200 shipping container top closing and sealing stations.

At the top closing and sealing station, it may be expected that the open top of the shipping container is subjected to a process involving closing and sealing, while the shipping container is on the AMR. The shipping container is, generally, not disengaged from the AMR through the entire closing and sealing process. A closure on the shipping container may be inspected with a vision system. Successfully verified shipping containers may then be directed to a shipping container labeling station. A shipping container associated with a failed inspection may be directed, on the AMR, to a manual rework station, at which an associate may attempt to correct the issue that caused the failure and direct an AMR with verified shipping container to a labeling station.

It may be expected that a majority, for example, 95%, of customer orders will involve more than one shipping container and, accordingly, more than one shipping label and/or radio frequency identification (RFID) tag. It may further be expected that use of a so-called “print and apply” type of label will provide a given shipping container with all information involved in routing, accumulating, expediting, tracking and tracing the given shipping container throughout the last mile delivery process. The labels may be verified for accuracy. An AMR carrying a shipping container with a label that has failed verification may be directed to a manual rework station. At the manual rework station, an associate may take steps to correct the failed verification.

To ensure that the delivery vehicles are loaded in a “First-in-Last-out” (“FILO”), the order fulfillment processor may cause shipping containers on AMRs, associated with a single customer order, to accumulate in an accumulation area. Ideally, all of the shipping containers associated with the single customer order may be grouped prior to the entire grouped customer order being sent, in an ordered sequence, to a discharge conveyor.

At the discharge conveyor, 100-300 shipping containers may accumulate with a designated route in common. The AMRs may be directed to the discharge conveyors in a FILO sequence. As a delivery vehicle is being loaded, shipping containers may accumulate in a FILO sequence that matches delivery vehicle route sequence.

Discharge conveyors may be expected to move shipping containers to a vehicle loading position in the FILO Sequence. The last mile delivery associate (see robots and/or personnel 7998 in FIG. 82B) may be expected to load the shipping containers into the delivery vehicle in the FILO sequence that is closely related to a pre-planned route sequence. This may be seen to reduce sorting of the shipping containers during the product deliveries. The shipping containers may be scanned as the shipping containers are loaded onto the delivery vehicle to establish accurate and sequential delivery. Upon completion of the loading, the delivery vehicle driver may commence delivering the products that have been loaded onto the delivery vehicle.

The driver of the delivery vehicle may guide the delivery vehicle to follow directions to various customer drop-off locations along a delivery route. The driver of the delivery vehicle may unload the shipping containers at each customer drop-off location. Conveniently, due to well-planned loading of shipping containers onto the delivery vehicle, sorting of the shipping containers during unloading is obviated.

In view of FIG. 87 and FIG. 82B, it has been suggested hereinbefore that one configuration for the first order induction zone 8702-1 involves use of the product storage racks 7100 that have been discussed in relation to, inter alia, FIG. 70. In such a configuration, the AMR elevators 7110 lift AMRs 5800/5850 to appropriate locations in the product storage racks 7100 to receive products into shipping containers. It has also been discussed that the product rack storage region 8204P, which may be equated to the first order induction zone 8702-1, may be divided into three partitions 8205-1, 8205-2 and 8205-3, which may be maintained at three different conditions, such as: ambient; refrigerated; and sub-freezing.

It is further contemplated that the first order induction zone 8702-1 may, in contrast to the multiple levels of storage represented by the product storage racks 7100 of FIG. 70, employ a configuration that does not involve elevation of AMRs.

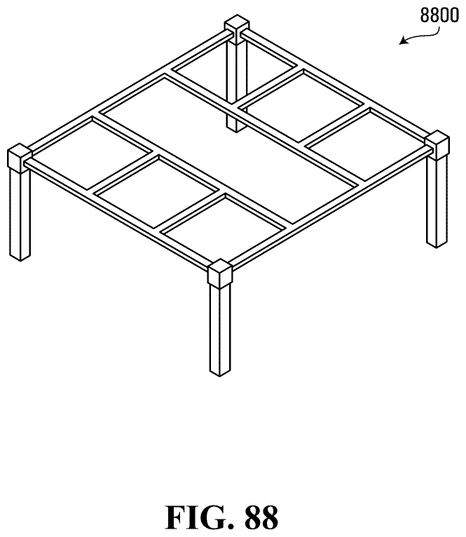

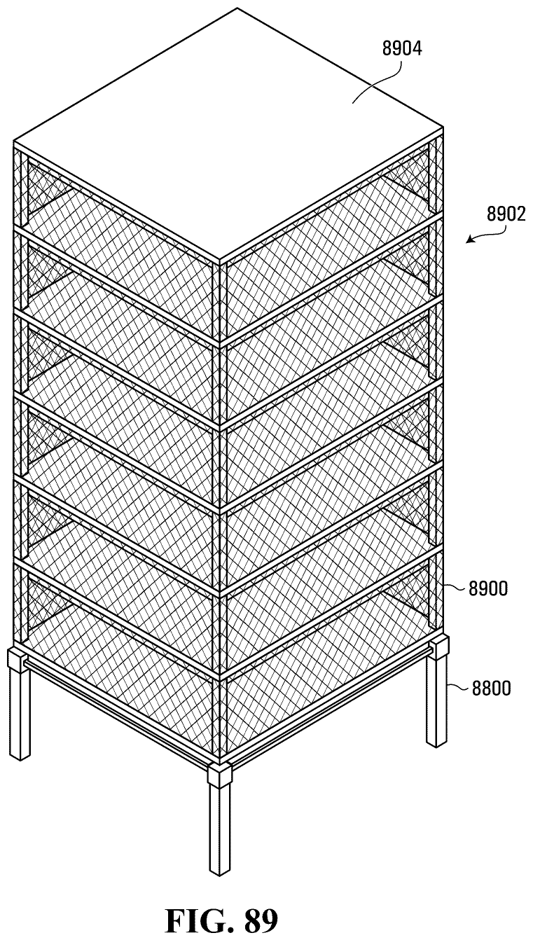

Accordingly, it is further contemplated that a structure that is an alternative to the further crate retention structure 8400, illustrated in FIG. 84, be designed to accommodate a universal crate. FIG. 88 illustrates a universal pallet 8800. Rather than receiving the crates 7910 as drawers, universal crates (see FIG. 89) may be stacked upon the universal pallet 8800 of FIG. 88. The universal pallet 8800 may be manufactured to exact standardized dimensions, which dimensions may be based on common transportation industry standards. In some embodiments, these dimensions include a length of 48 inches, a width of 48 inches, and a height of 10 inches. This standard size for the universal pallet 8800 may allow for compatibility and ease of use across various industries and supply chain networks. The universal pallet 8800 may be manufactured using materials that allow for the universal pallet 8800 to withstand frequent use and offer good load-bearing capacity, such as stainless steel angle iron or stainless steel plates. The universal pallet 8800 may be designed to have “four-way entry”, so that an AMR configured for moving the universal pallet 8800 may be able to engage the universal pallet 8800 from any side. Individual suppliers may be responsible for maintaining and refurbishing universal pallets 8800 to, thereby, ensure that the universal pallets 8800, which arrive at the order fulfilment location, are without defects.

FIG. 89 illustrates a stack 8902 of universal crates 8900 loaded upon the universal pallet 8800 of FIG. 88. Each universal crate 8900 may be designed as an open-topped bin configured to contain individual products of a particular SKU. The universal pallet 8800 may be sized and shaped to nest with (e.g., receive) the bottom of one of the universal crates 8900. Similarly, the top of each of the universal crates 8900 may be sized and shaped to nest with (e.g., receive) the bottom of another one of the universal crates 8900. The stack 8902 of universal crates 8900 is illustrated, in FIG. 89, as being topped with a lid 8904. The lid 8904 may be understood to be an attempt to maintain the top universal crate 8900 in the stack 8902 free from dust and debris during transport to the fulfilment center as well as during movement around the fulfilment center. The lid 8904 may be constructed to have a weight sufficient to stabilize the stack 8902.

Each universal crate 8900 may be manufactured to exact standardized dimensions. In some embodiments, outer dimensions of each universal crate 8900 includes a length of 48 inches, a width of 48 inches, and a height of 16 inches. The depicted nested stack includes six crates 8900. The height of the nested stack 8902 of universal crates 8900 may be approximately 98 inches. When the stack 8902 is loaded upon the universal pallet 8800 as shown in FIG. 89, the total height may measure approximately 108 inches.

The universal crate 8900 may include identically sized compartments ranging between 1 compartment and 256 compartments, to hold units of the SKU. The dimensions of the identically sized compartment depends on the number and pattern of compartments. For example, a 1-compartment universal crate 8900 may have one compartment having dimensions of approximately 47.5 inches×47.5 inches (length×width); a 2-compartment universal crate 8900 may have two identical compartments, each compartment having dimensions of approximately 47.5 inches×23.65 inches; and a 4-compartment universal crate 8900 may have four identical compartments, each compartment having dimensions of approximately 47.5 inches×11.75 inches, or approximately 23.65 inches×23.65 inches. In this way, each universal crate 8900 may be defined in terms of the number and the pattern of the compartments therein, so that a 4-compartment universal crate 8900 with compartments measuring approximately 47.5 inches×11.75 inches may be called a 1×4 universal crate 8900 (1 compartment lengthwise and 4 compartments widthwise) while a 4-compartment universal crate 8900 with compartments measuring approximately 23.65 inches×23.65 inches may be called a 2×2 universal crate (2 compartments lengthwise and 2 compartments widthwise). The numbers and patterns of compartments that are contemplated for the universal crate 8900 include 1×1; 1×2; 1×3; 1×4; 1×6; 1×8; 1×12; 1×16; 2×2; 2×3; 2×4; 2×6; 2×8; 2×12; 2×16; 3×3; 3×4; 3×6; 3×8; 3×12; 3×16; 4×4; 4×6; 4×8; 4×12; 4×16; 6×6; 6×8; 6×12; 6×16; 8×8; 8×16; 12×12; 12×16; and 16×16. Such a range of numbers and patterns of compartments may facilitate in the efficient or safe containment of SKU units in the universal crate 8900. For example, a 16×16 universal crate 8900 with 256 identically sized compartments, may efficiently and safely store 256 bottles each having a corresponding appropriately sized diameter, without concern for damage or breakage caused by bottles bumping into each other during transportation. The number and pattern of compartments of each universal crate 8900 may thus be specifically designed for the attributes of the specific product the universal crate 8900 is meant to contain. In some embodiments, the material making up the compartments may additionally be chosen with the attributes of the specific product the universal crate 8900 is meant to contain in mind.

In some cases, each universal crate 8900 of a stack 8902 may be configured to contain the same SKU as each of the other universal crates 8900 of the same stack 8902. Such a stack 8902 may be referred to as a same SKU stack. In some other cases, a universal crate 8900 of a particular stack 8902 may be configured to contain a different SKU to one or more of the other universal crates 8900 of the particular stack 8902. Such a stack 8902 may be referred to as a multiple SKU stack.

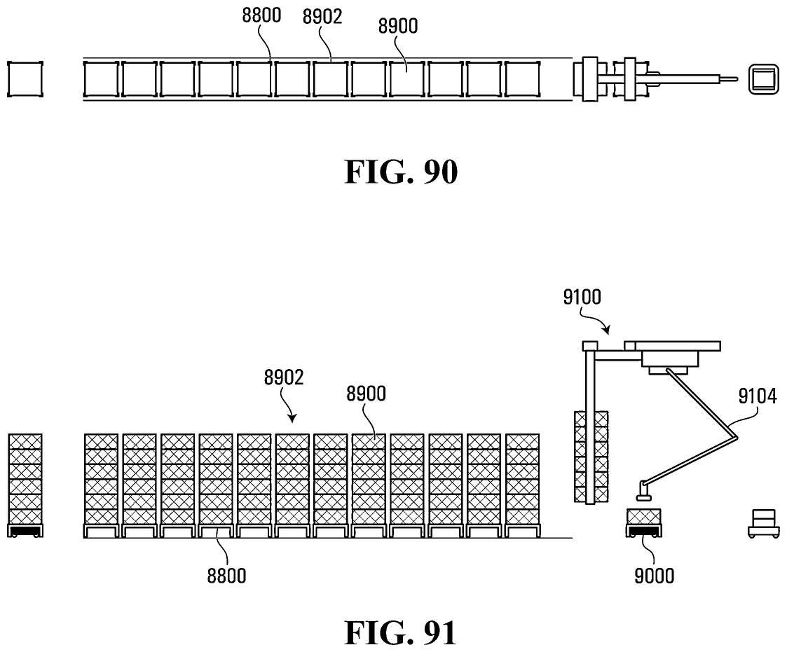

FIG. 90 illustrates, in a plan view, a configuration of a plurality of universal pallets 8800 loaded with stacks 8902 of universal crates 8900. As illustrated in FIG. 90, the universal pallets 8800 loaded with stacks 8902 of universal crates 8900 are arranged in rows, which may also be called “cells.” Each cell may be understood to be configured to accommodate a queue with a back and a front. Cells may be defined on the floor of the first order induction zone 8702-1, which may be labelled, e.g., using a plurality of barcodes (or QR codes). Each barcode may represent a pallet storage position in the cell.

AMRs that are configured for moving the universal pallets 8800 loaded with stacks 8902 of universal crates 8900 may be called “pallet AMRs” 9000. In operation, a given pallet AMR 9000 may be controlled to slip under a given universal pallet 8800 loaded with stacks 8902 of universal crates 8900 and be further controlled to engage and move the given universal pallet 8800 into a pallet storage position at the back of a queue in a cell. The pallet AMR 9000 may have a height of approximately 9 inches, allowing for it to slip under a universal pallet 8800 and engage the universal pallet 8800 to lift the universal pallet 8800 slightly off the ground, e.g., using a corkscrew motion.

FIG. 91 illustrates, in a side elevation view, the cell of FIG. 90 including the plurality of universal pallets 8800 loaded with stacks 8902 of universal crates 8900. Positioned at the front of the queue in FIG. 91 is a robotic product induction station 9100. The robotic product induction station 9100 may also be referenced as a product transfer apparatus. The robotic product induction station 9100 may be suited to obtaining a product from a universal crate 8900, in a stack 8902 carried by a universal pallet 8800, and placing the product into an erected carton on an AMR 5300. The robotic product induction station 9100 is illustrated as including a pair of robotic lifting arms 9102. The pair of robotic lifting arms 9102 are operable to lift one or more universal crates 8900 off the stack 8902. For example, as depicted, a stack 8902-1 includes crates 8900-1 through 8900-6. Lifting arms 9102 lift a section of the stack, namely, crates 8900-2 through 8900-6, to allow access to the crate positioned underneath, namely, crate 8900-1, and its contents. Similarly, access to any particular crate may be provided by lifting the crates above the particular crate.

The pair of robotic lifting arms 9102 may also be suited for a task of lifting the lid 8904 from the top of the top universal crate 8900 in the stack 8902. The pair of robotic lifting arms 9102 may hold the lid 8904 while the pallet AMR 9000 moves the combination of the stack 8902 and the universal pallet 8800 forward and into an operational range of picking by a robotic picker arm 9104.

For those instances wherein the product to be obtained is in a universal crate 8900 that is not the top universal crate 8900 in the stack 8902, the pair of robotic lifting arms 9102 may hold a combination of the lid 8904 and the universal crates 8900 located above the universal crate 8900 containing the product to be obtained. The pallet AMR 9000 may then move the combination of the remaining stack 8902 and the universal pallet 8800 forward and into the operational range of picking by the robotic picker arm 9104.

Indeed, the product may be obtained by the robotic picker arm 9104 for placement into a shipping container. The robotic picker arm 9104 may be configured to retrieve an individual product from within the universal crate 8900 of interest and load the product into an appropriate shipping container carried by the AMR 5800/5850.

Specifically, the robotic picker arm 9104 may be equipped with an end effector suitable for selectively retrieving an individual article from the universal crate 8900 and releasing the article into the appropriate shipping container carried by the AMR 5800/5850. The configuration of the end effector of a robotic picker arm 9104 may depend on characteristics of articles to be moved. For example, articles with planar surfaces and relatively low weight may be effectively engaged using an end effector with one or more vacuum cups. Other articles, for example, articles having curved or irregular surfaces or relatively high weight, may be grasped with claws or with clamping devices of corresponding size and shape.

In some embodiments, a camera may be associated with the robotic picker arm 9104, and the robotic picker arm may be configured to use computer vision to detect and manipulate the product to be retrieved. The robotic picker arm may be configured with one or more grippers, such as suction cups or any other suitable grippers, for retrieving products.

In some embodiments, a control system associated with robotic picker arm 9104 may be programmed with standardized configurations crates containing one or more of a particular SKU. That is, the control system may be programmed with the dimensions of each crate, as well as dimensions and locations of articles within the crate. In such embodiments, instead of, or in addition to, using computer vision, the robotic picker arm may be numerically guided to appropriate (e.g., pre-defined) locations to retrieve articles from such crates.

In some embodiments, multiple, interchangeable end effectors may be available. For example, one or more of the robotic picker arms 9104 may be equipped with a releasable linkage, the linkage configured to engage with or disengage with a selected one of a plurality of end effectors. Recall that FIG. 77 shows an example robotic picker arm 7106 having connectors 7710, which may be used to engage with a plurality of end effectors. The connectors 7710 may include physical linkages, such as quick connects for electrical connections and pneumatic connections. Available end effectors (not shown) may be placed in one or more rest locations accessible by the robotic picker arm 9104. When needed, the robotic picker arm 9104 may move to engage, via the connectors 7710, with a suitable end effector and employ the end effector to perform a specific task. After the task has been performed, or when a different end effector is needed, the robotic picker arm 9104 may return to a rest location and release the connectors 7710 to return the end effector.

Notably, components (the pair of robotic lifting arms 9102 and the robotic picker arms 9104) of the robotic product induction station 9100 may be suspended from a ceiling-based mount to, thereby, minimize a footprint on the floor of the first order induction zone 8702-1. Alternatively, the components of the robotic product induction station 9100 may be suspended from a gantry-based mount.

FIG. 91A, illustrates, in a side elevation view, a cell configured similar to that shown in FIG. 91, except that the cell is located within a reduced temperature zone 9120. The reduced temperature zone 9120 may be equipped with refrigerated systems to maintain the temperature of the cell including the plurality of universal pallets 8800 loaded with stacks 8902 of universal crates 8900 at a refrigerated or a frozen temperature. In some embodiments, the perimeter of the reduced temperature zone 9120 may be provided by way of one or more air curtains or air doors, which may be configured to blow a consistent and controlled high-velocity stream of air to create air seals and maintain the temperature in the reduced temperature zone 9120 at the refrigerated or frozen temperature. In some embodiments, the perimeter of the reduced temperature zone 9120 may be provided by way of one or more physical seals (e.g., automated doors, ceilings), or a combination of physical and air seals. As shown, a portion of the robotic product induction station 9100 may also be located within the reduced temperature zone 9120. However, components that are important to the functioning of the robotic product induction station 9100, such as a controller or actuators, may be positioned outside of the reduced temperature zone 9120 to prevent such components from being adversely affected by consistently low temperatures.

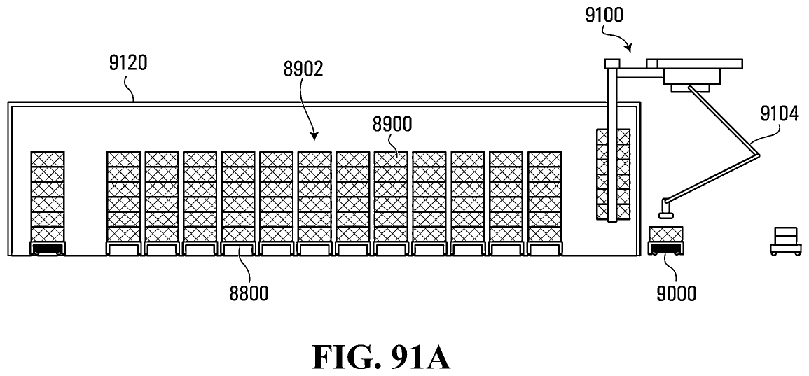

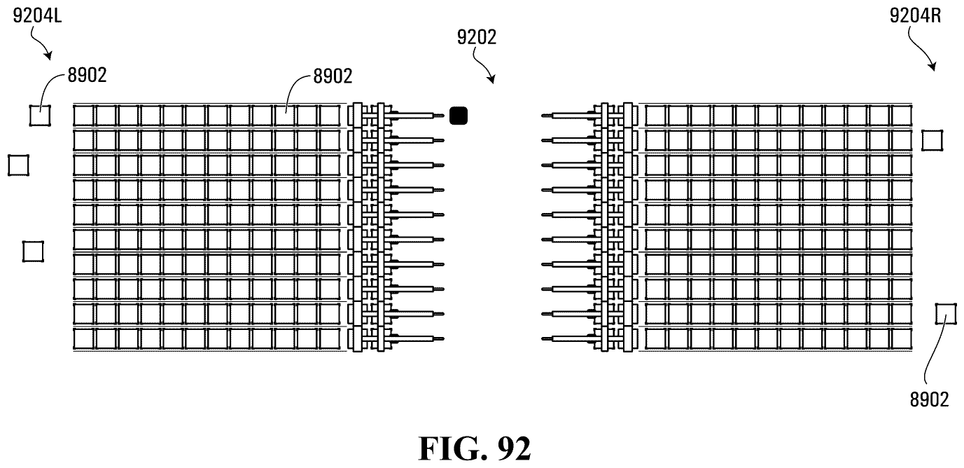

FIG. 92 illustrates, in a plan view, a configuration of 20 cells. The configuration includes a product induction aisle 9202, a left stack induction aisle 9204L to the left of the production induction aisle 9202 and a right stack induction aisle 9204R to the right of the production induction aisle 9202. Ten of the cells are positioned to the left of the product induction aisle 9202. Ten of the cells are positioned to the right of the product induction aisle 9202. The front of each queue is proximate to the product induction aisle 9202. The back of each queue is proximate to one of the two stack induction aisles 9204L, 9204R.

The production induction aisle 9202 may be configured for travel by AMRs such as the AMR 5800/5850 illustrated in FIG. 70, which may have a shipping container secured thereon, or by pallet AMRs 9000. The two stack induction aisles 9204L, 9204R may be configured for travel by pallet AMRs 9000 having thereon universal pallets 8800 loaded with stacks 8902 of universal crates 8900.

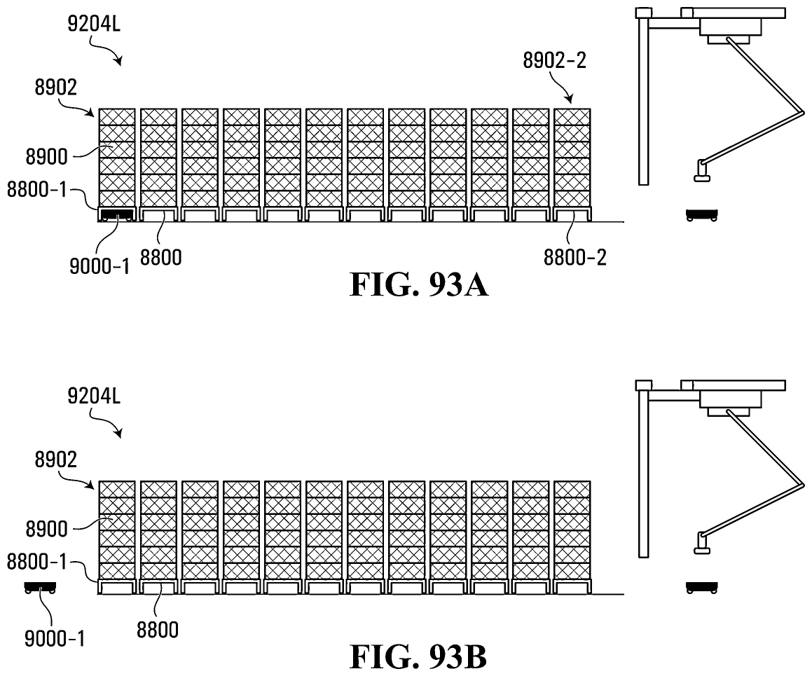

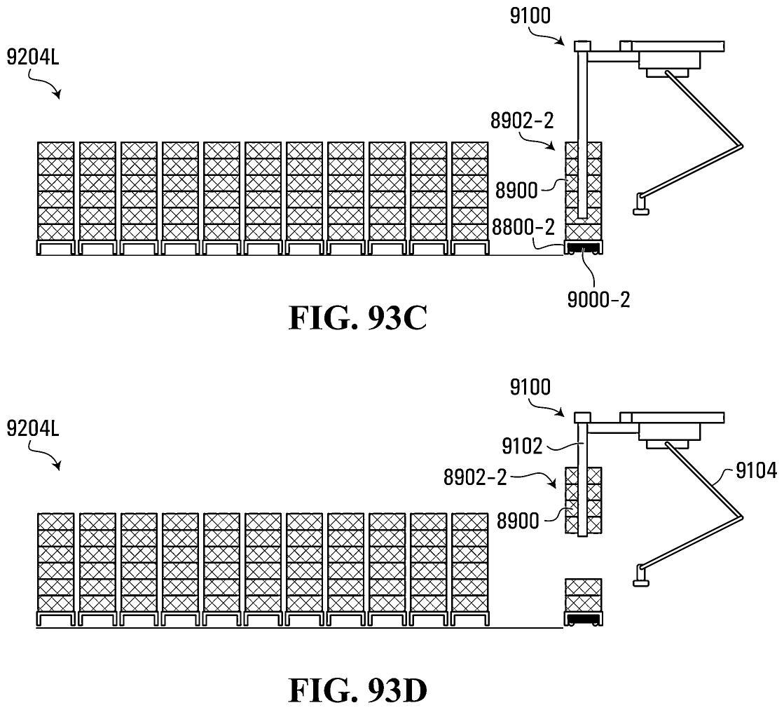

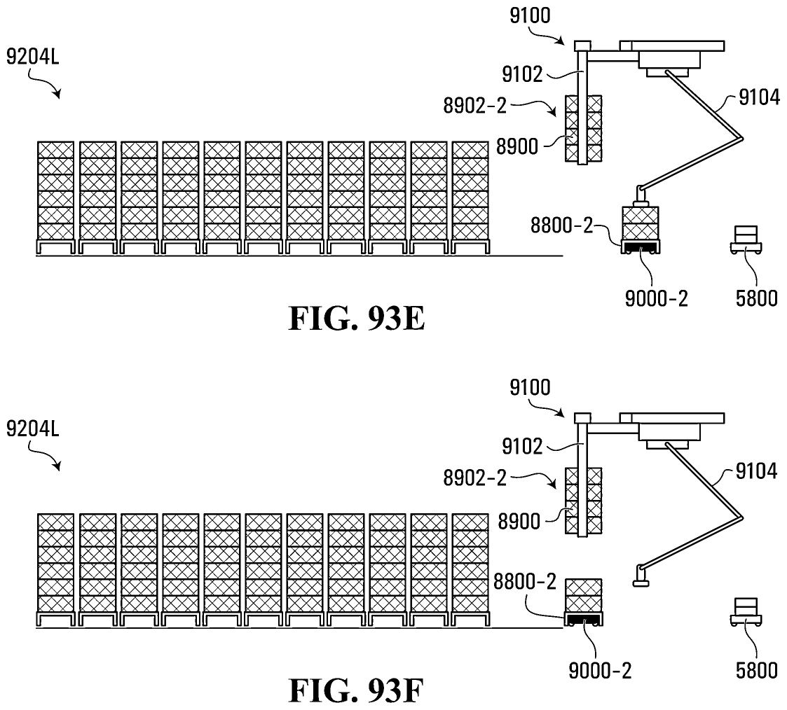

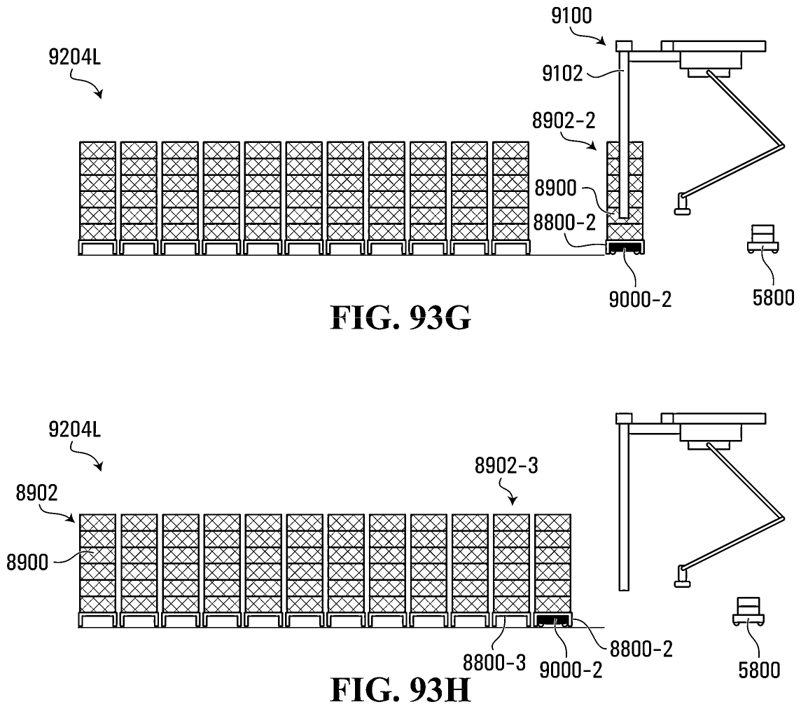

FIGS. 93A-93H illustrate a sequence of steps, in an elevation view, of a product being extracted from a universal crate in a cell and loaded into a shipping container or receptacle. Although not shown, the sequence and components as described below are largely applicable to a cell located within a reduced temperature zone 9120.

In operation, in view of FIG. 93A, a first universal pallet 8800-1 loaded with a first stack 8902-1 of universal crates 8900 may be carried by a first pallet AMR 9000-1, through the left stack induction aisle 9204L, into a designated pallet storage position at the back of a queue of universal pallets 8800 loaded with stacks 8902 of universal crates 8900 in a cell. For a cell located in a reduced temperature zone 9120, the first pallet AMR 9000-1 may enter the reduced temperature zone 9120 from the left stack induction aisle 9204L and into the designated pallet storage position at the back of the queue.

The first pallet AMR 9000-1 may then unburden itself of the first universal pallet 8800-1 and carry out instructions to proceed, as illustrated in FIG. 93B, away from the back of the queue to proceed to fetch a further universal pallet 8800 loaded with a further stack 8902 of universal crates 8900.

As illustrated in FIG. 93C, a second pallet AMR 9000-2 may carry out first repositioning instructions on a second universal pallet 8800-2 loaded with a second stack 8902-2 of universal crates 8900. The first repositioning instructions may cause the second pallet AMR 9000-2 to move the second universal pallet 8800-2 from the front of the queue in the cell to a position under a robotic product induction station 9100. For cells located in a reduced temperature zone 9120, the second pallet AMR 9000-2 and the second universal pallet 8800-2 remain in the reduced temperature zone 9120 at this position.

As illustrated in FIG. 93D, at the robotic product induction station 9100, the pair of robotic lifting arms 9102 may lift a determined number of universal crates 8900 in the second stack 8902-2 to expose a specific universal crate 8900 to the robotic picker arm 9104.

As illustrated in FIG. 93E, the second pallet AMR 9000-2 may carry out second repositioning instructions. The second repositioning instructions may cause the second pallet AMR 9000-2 to move the second universal pallet 8800-2 from under the determined number of universal crates 8900 lifted by the pair of robotic lifting arms 9102 to a position at which the robotic picker arm 9104 may extract, from the specific universal crate 8900, a product and place the product in a shipping container carried upon an AMR 5800/5850. As illustrated by FIG. 91A, for cells located in a reduced temperature zone 9120, the second repositioning instructions cause the second pallet AMR 9000-2 to move the second universal pallet 8800-2 and remaining crates 8900 out of the reduced temperature zone 9120.

As illustrated in FIG. 93F, the second pallet AMR 9000-2 may carry out third repositioning instructions. The third repositioning instructions may cause the second pallet AMR 9000-2 to move the second universal pallet 8800-2 from the position at which the robotic picker arm 9104 may extract the product, back to the position under the determined number of universal crates 8900 lifted by the pair of robotic lifting arms 9102. For cells located in a reduced temperature zone 9120, the third repositioning instructions cause the second pallet AMR 9000-2 to move the second universal pallet 8800-2 and remaining crates 8900 back into the reduced temperature zone 9120.

As illustrated in FIG. 93G, at the robotic product induction station 9100, the pair of robotic lifting arms 9102 may return the previously lifted universal crates 8900 in the second stack 8902-2 down onto the specific universal crate 8900.

As illustrated in FIG. 93H, the second pallet AMR 9000-2 may carry out fourth repositioning instructions. The fourth repositioning instructions may cause the second pallet AMR 9000-2 to move the second universal pallet 8800-2 from the position proximate the pair of robotic lifting arms 9102 back to the pallet storage position at the front of the queue.

In some embodiments, each stack of crates at a cell may contain crates of like SKUs. For example, each stack of six crates may contain one crate each of the same six SKUs. In such embodiments, stacks and crates may be handled sequentially. The sequence of steps illustrated in FIGS. 93C-93H may be repeated to place products contained in the universal crates 8900 of the stack 8902-2 into shipping containers carried by AMRs as needed to fulfil orders, until there are no more products left in the universal crates 8900 of the stack 8902-2. Once there are no more products left in the universal crates 8900 of the stack 8902-2, a pallet AMR 9000 may be controlled to move the combination of the second universal pallet 8800-2 and the second stack 8902-2 of now empty universal crates 8900 to the back of the queue, resulting in a third universal pallet 8800-3 loaded with a third stack 8902-3 of universal crates 8900 now being positioned at the front of the queue. In some embodiments, once there are no more products left in the universal crates 8900 of the stack 8902-2, a pallet AMR 9000 may instead be controlled to move the combination of the second universal pallet 8800-2 and the second stack 8902-2 of now empty universal crates 8900 to a designated location (not shown) dedicated to storage of stacks 8902 of empty universal crates 8900. The process illustrated in FIGS. 93C-93H may then be carried out with the third universal pallet 8800-3 loaded with the third stack 8902-3 of universal crates 8900, to place products contained in the universal crates of the stack 8902-3 into shipping containers carried by AMRS as needed to fulfil orders, and so on. This process may continue until a majority of the stacks 8902 of universal crates 8900 in a cell are empty of products, at which time the universal pallets 8800 loaded with stacks 8902 of empty universal crates 8900 may be replaced with new stacks 8902 of universal crates 8900 containing products, as discussed hereinafter.

In some embodiments, stacks of crates in a given cell may be heterogeneous. That is, the set of crates or SKUs in respective stacks may differ from one another. In such cases, stacks and crates in the queue need not be handled sequentially. For example, when an article is required and is not available in a current stack positioned at the robotic pallet induction station 9100, pallet AMRs may receive and carry out repositioning instructions to move the current stack into the queue, and to position another stack containing the required product at the pallet induction station 9100.

In FIG. 82A and FIG. 82B, three order induction zones are illustrated: a first order induction zone, the product rack storage region 8204P; a second order induction zone, the stack storage region 8204R; and a third order induction zone, the tower storage region 8204T.

More particularly, in FIG. 82B, the second order induction zone, the stack storage region 8204R, is illustrated as occupying a second level, located above the third order induction zone, which is referenced as the tower storage region 8204T.

It is contemplated that the first order induction zone 8702-1 may be implemented on a second level of the order fulfilment center 8700, with the second order induction zone 8702-2 and the third order induction zone 8702-3 implemented on a first level of the order fulfilment center 8700.

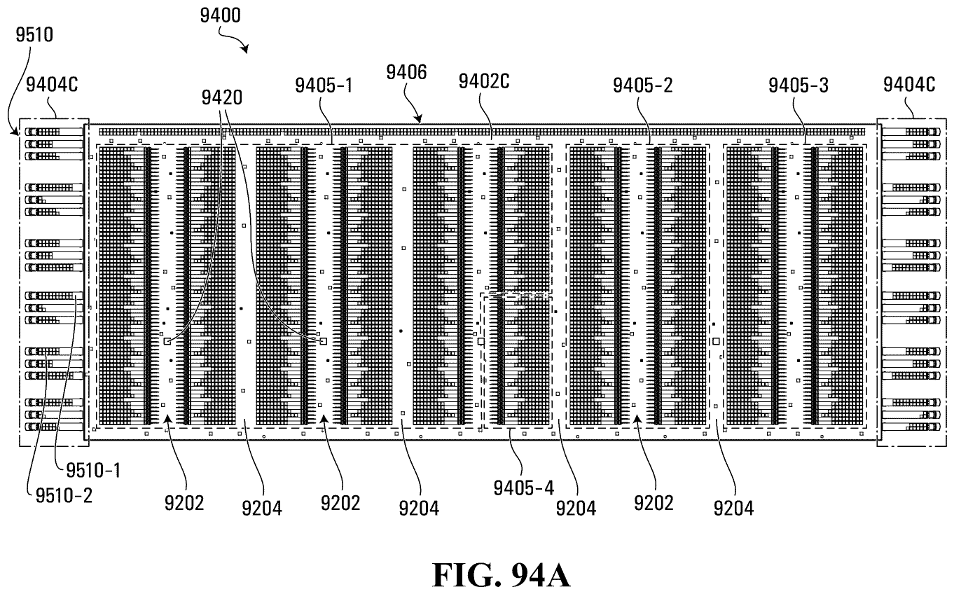

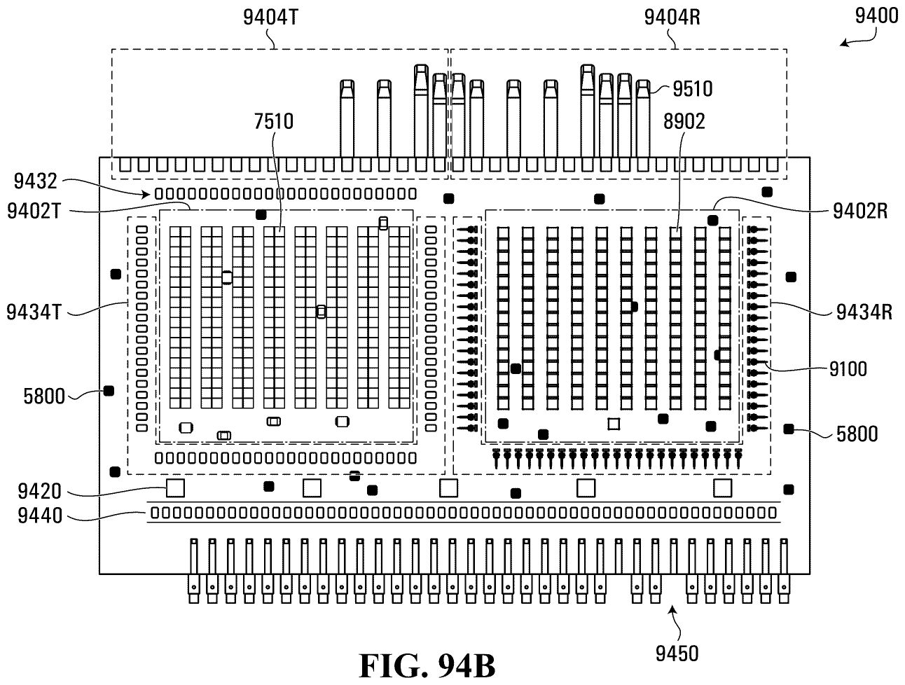

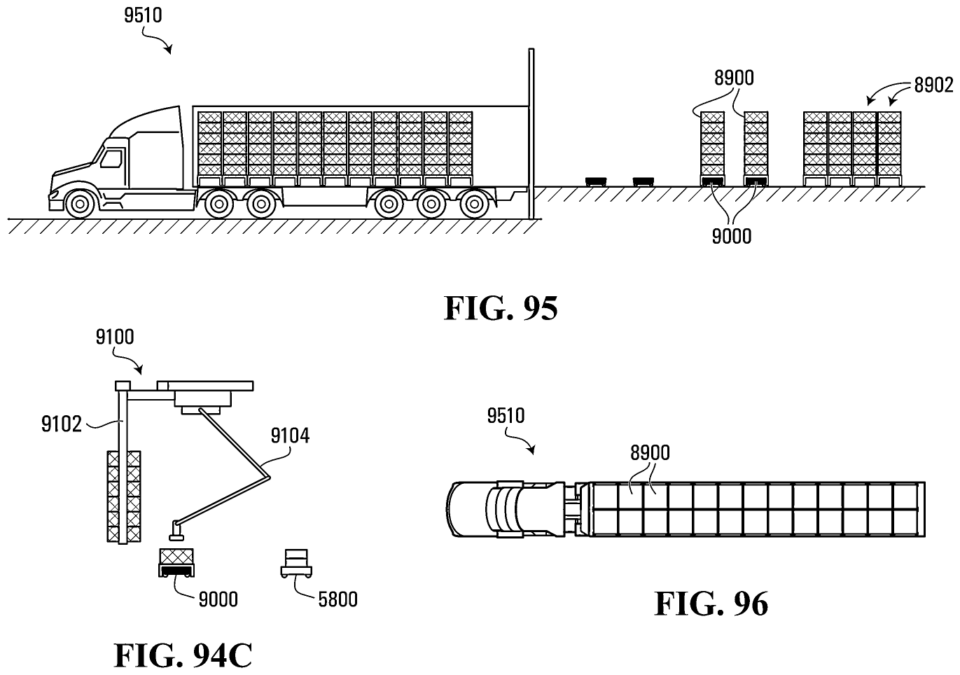

FIG. 94A illustrates, in a plan view, a second level of an order fulfilment center 9400. FIG. 94B illustrates, in a plan view, a first level of the order fulfilment center 9400. The order fulfilment center 9400 may be enclosed within walls of a physical building. The order fulfilment center 9400 is partitioned as described herein, e.g., to define various zones, regions and cells. The partitions may be logical or physical partitions, or a combination thereof. For example, partitions may be defined by logical boundaries, physical walls, doors such as overhead doors, physical curtains or air curtains. As depicted, the order fulfilment center 9400 has a first order induction zone, a cell product storage region 9402C. The cell product storage region 9402C may be understood to include in the range of thousands of cells. In some embodiments, the cells may store higher volume products, which may also be referred to as high turnover consumer products. For example, the cells may store those grocery items that are typically consumed daily, such as perishable foods, frozen foods, dairy products, meats, beverages and bakery products, in addition to personal care products, snack products, packaged food products, cleaning products and pharmaceutical products, all of which having, in common, that they are typically used daily. The cell product storage region 9402C is illustrated as including a plurality of product induction aisles 9202 and stack induction aisles 9204. Although five product induction aisles 9202 and 10 stack induction aisles 9204 are illustrated, more or fewer aisles may be present.

The cell product storage region 9402C is illustrated as divided into four partitions 9405-1, 9405-2, 9405-3, and 9405-4. The four partitions 9405-1, 9405-2, 9405-3, and 9405-4 may be maintained at various different conditions. For example, the first partition 9405-1 and the fourth partition 9405-4 may maintain products stored therein at a moderate temperature, e.g., at room temperature or ambient temperature. The second partition 9405-2 may maintain products at a reduced temperature as compared to the temperature of the first partition 9405-1 and fourth partition 9405-4, e.g., at a refrigerated temperature. The third partition 9405-3 may maintain products at a temperature at or below freezing. In this way, the four partitions 9405-1, 9405-2, 9405-3, and 9405-4 may provide three different storage conditions for storage of different products. For example, as previously mentioned, the cell product storage region 9402C may house grocery items. Items that are safe to be stored at room temperature, such as non-perishable grocery goods, may be kept in the first partition 9405-1 or the fourth partition 9405-4; perishable grocery items such as fresh produce and meats may be kept in the second partition 9405-2; and frozen grocery items may be kept in the third partition 9405-3.

Each of the first partition 9405-1, the second partition 9405-2, and the third partition 9405-3 are illustrated as including cells that may be populated with universal pallets 8800 loaded with stacks 8902 of universal crates 8900. A first reduced temperature zone 9120 may encompass the cells located in the second partition 9405-2 to maintain universal pallets 8800 loaded with stacks 8902 of universal crates 8900 in the second partition 9405-2 at a reduced temperature as compared to the temperature of the first partition 9405-1 and fourth partition 9405-4, e.g., at a refrigerated temperature. A second reduced temperature zone 9102 may encompass the cells located in the third partition 9405-3 to maintain universal pallets 8800 loaded with stacks 8902 of universal crates 8900 in the third partition 9405-3 at a temperature at or below freezing.

In operation, fulfilling an order may require retrieval of products from one or more of the cells located in the first partition 9405-1, the second partition 9405-2, or the third partition 9405-3, and placement of the products in a shipping container held by an AMR, such as AMR 5800/5850. This product retrieval and placement into a shipping container may generally occur according to the sequence of steps described above with reference to FIGS. 93C-93H. Once the shipping container receives the product(s) needed to fulfil the order, the AMR 5800/5850 may travel, while holding the shipping container with the product inside, to a location for further processing.

The fourth partition 9405-4 may include cells that may, instead of being populated with universal pallets 8800 loaded with stacks 8902 of universal crates 8900, be populated with universal pallets 8800 loaded with stacks of products that do not require containment within universal crates 8900. Such products may simply be strapped onto universal pallets 8800 (without a lid) for transport to the order fulfilment center 9400 without first being placed into universal crates 8900, and may include products such as bundled packages of water bottles, tissue paper, toilet paper, or diapers, or beverage cases. Products stored within the fourth partition 9405-5 may generally be referred as standalone products. All of the standalone products loaded on universal pallets 8800 in one particular cell may be product units of one SKU.

In operation, fulfilling an order may require retrieval of one or more standalone products from one or more of the cells located in the fourth partition 9405-4. The process of product retrieval as described with reference to FIGS. 93C-93H may, generally, be applicable to product retrieval within the fourth partition 9405-4, with a few changes.

For example, since the standalone products may be strapped directly onto universal pallets 8800, the robotic production induction station 9100 may be equipped with means to perform destrapping operations. A robotic production induction station 9100 in the fourth partition 9405-4 may include a destrapper-debander 7800, as illustrated in FIG. 78A and FIG. 78B, to remove the strapping that fixes the standalone products to a universal pallet 8800. In addition, there may be no need for robotic lifting arms 9102. Since each stack of standalone products do not require a lid, and no overlying crates need be removed to access a product in a stack that is required for order fulfilment (given that all products in a particular cell are units of a same SKU), the robotic picker arm 9104 may simply obtain the topmost standalone product without needing to lift anything to have access to the topmost standalone product.

Further, the robotic picker arm 9104 may directly transfer the standalone product to an AMR, such as AMR 5800 or AMR 5850, to be secured thereon. That is, a standalone product may be placed directly on the AMR rather than in a shipping container. The AMR 5800/5850 may then travel, while holding the standalone product, to a location for further processing to fulfil the order requiring the standalone product.

The second level of the order fulfillment center 9400 may additionally include universal pallet inbound and outbound regions 9404C for receiving universal pallets 8800 and sending (i.e., returning) empty universal pallets 8800 to product suppliers. The fulfilment center may further include a shipping container induction region 9406 for receiving shipping containers or blanks, and a plurality of AMR escalators 9420. Each AMR escalator 9420 may be located in a product induction aisle 9202. In practice, depending upon the size of the order fulfillment center 9400, the order fulfillment center 9400 may, in some cases, include multiples of the regions illustrated in FIG. 94A and may, in some other cases, omit one or more regions.

In contrast to the scenario presented in FIG. 82B, wherein AMRs carry crate retention structures 8300 to positions in the stack storage region 8204R on the second level via the ramp 8220, FIG. 94A presents a scenario wherein pallet AMRs 9000 carry universal pallets 8800 directly from transport trailers 9510, on the same level, to pallet storage positions in the cell product storage region 9402C on the second level.

At the universal pallet inbound and outbound regions 9404C, unloading and loading operations are performed at a plurality of transport trailers 9510. The transport trailers 9510 may include a plurality of inbound trailers 9510-1 and a plurality of outbound trailers 9510-2. Each inbound trailer 9510-1 may carry a plurality of universal pallets 8800 loaded with products (e.g., in stacks 8902 of universal crates 8900 or as standalone products) sent by a supplier, producer, or manufacturer, to be unloaded and stored at a determined pallet storage position in the cell product storage region 9402C. Each outbound trailer 9510-2 may be configured to be loaded by a plurality of universal pallets 8800 which may be loaded with stacks 8902 of empty universal crates 8900, for return transport to a supplier, producer, or manufacturer, who may then reuse the plurality of empty universal crates 8900 and the universal pallets 8800 for storing products and, then once again, send the palletized products to the order fulfilment center 9400 to be stored and used for the fulfilment of orders. The use of universal pallets 8800 and universal crates 8900 may, therefore, allow a closed loop system to be formed between the supplier, producer, or manufacturer of the products and the order fulfilment center 9400, as regards to the universal pallets 8800 and the universal crates 8900.

The shipping container induction region 9406 may, like the shipping container induction region 8206, be populated with a plurality of carton forming systems, perhaps following the design of the carton forming system 100 disclosed hereinbefore. Each carton forming system may be configured to produce a unique size and style of shipping container formed or erected from blank corrugated recyclable materials. Alternatively, in some embodiments, one or more of the carton forming systems may be configured to produce more than one size and/or more than one style of shipping container formed or erected from blank corrugated recyclable materials. The variety of sizes and styles of shipping container may be shown to allow product to be packed in order-specific shipping containers. As discussed briefly hereinbefore, the size and number of shipping containers employed for a given customer order may be determined on the basis of the sizes, types and quantities of items in the given customer order.

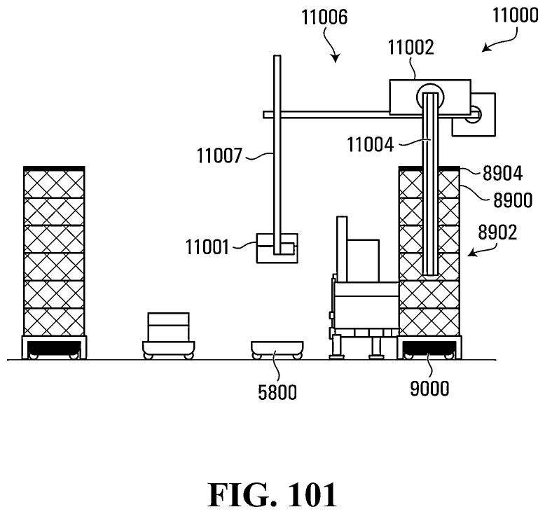

Briefly referring to FIG. 101, in some embodiments, the shipping container induction region 9406 may include a plurality of robotic shipping container induction systems 11000. The robotic shipping container induction systems 11000 may include a robotic carton forming system 11006 and a crate lifting system 11002 having a pair of robotic lifting arms 11004. In operation, a universal pallet 8800 loaded with a stack 8902 of universal crates 8900 may be transported by a pallet AMR 9000 to a position proximate the robotic lifting arms 11004. The universal crates 8900 may contain shipping container blanks of a same SKU, transported to the universal pallet inbound and outbound region 9404C via an inbound trailer 9510-1. The pair of robotic lifting arms 11004 may lift a lid 8904 from the top of the top universal crate 8900 in the stack 8902 to expose the shipping container blanks contained in the top universal crate 8900. The carton forming system 11006 may retrieve, e.g., by using a robotic picker arm 11007, a specific shipping container blank from the top universal crate 8900 and form an open top shipping container 11001 from the shipping container blank, perhaps using methods as described hereinbefore. The robotic carton forming system 11006 may then, using the robotic picker arm 11007, place the erected shipping container 11001 onto an AMR, such as AMR 5800 or AMR 5850. The AMR 5800/5850 may then travel, holding the shipping container 11001, to a location for further processing to fulfil an order. This sequence of retrieving a shipping container blank and forming a shipping container may be repeated until the top universal crate 8900 is empty. The pair of robotic lifting arms 11004 may then lift the lid 8904 as well as the top universal crate 8900 to expose the shipping container blanks contained in the second-from-the-top universal crate 8900 in the stack 8902, and the sequence may repeat again. This process may be repeated until all of the universal crates 8900 in the stack 8902 are empty, at which point, the pallet AMR 9000 may transport the universal pallet 8800 loaded with the stack 8902 of the now empty universal crates 8900 to a location to await being loaded into an outbound trailer 9510-2 for return to the shipping container blank manufacturer or supplier. The use of universal pallets 8800 and universal crates 8900 may, therefore, allow a closed loop system to be formed between the shipping container blank manufacturer or supplier and the order fulfilment center 9400, as regards to the universal pallets 8800 and the universal crates 8900.

The plurality of AMR escalators 9420 may allow for AMRs, such as AMR 5800 or AMR 5850, to travel between the second level of the order fulfilment center 9400 and the first level of the order fulfillment center 9400, as discussed hereinafter.

FIG. 94B illustrates, in a plan view, the first level of the order fulfilment center 9400. The first level of the order fulfilment center 9400 may include a second order induction zone, referenced as a stack storage region 9402R, and a third order induction zone, referenced as a tower storage region 9402T. The stack storage region 9402R may include in the range of thousands of universal pallets 8800 loaded with stacks 8902 of universal crates 8900 storing products therein, and the tower storage region 9402T may include in the range of thousands of towers 7510 (see FIG. 75) storing products therein. The stack storage region 9402R may also include universal pallets 8800 loaded with standalone products without universal crates 8900.

The layout of the stack storage region 9402R and the tower storage region 9402T may be similar, except that the stack storage region 9402R is populated with universal pallets 8800 loaded with stacks 8902 of universal crates 8900 and the tower storage region 9402T is populated with towers 7510. Specifically, each universal pallet 8800 in the stack storage region 9402R may be located at a respective designated pallet storage position within the stack storage region 9402R. In some embodiments, the universal pallets 8800 in the stack storage region 9402R may be organized by way of columns, as shown. These columns may be separated with enough space to allow a pallet AMR 9000 travelling with a universal pallet 8800 loaded with a stack 8902 of universal crates 8900 to pass through. Similarly, each tower 7510 in the tower storage region 9402T may be located at a respective designated tower storage position within the tower product storage region 9420T.

Information regarding the location at which each individual product is stored may be stored in a suitable memory of an order fulfilment processor, such as the order fulfilment processor 1300 of FIG. 64, responsible for processing an order. For example, the order fulfilment processor 1300 may store the location of a specific tower 7510 and the compartment 7512 of the specific tower a particular product is stored in the tower storage region 9402T, or the location of a specific stack 8902 and the universal crate 8900 of the specific stack 8902 another product is stored in the stack storage region 9402R.

In some embodiments, the stacks 8902 of universal crates 8900 in the stack storage region 9402R may store relatively medium-moving consumer products, which may also be referred to as medium-turnover consumer products. For example, the stacks 8902 of universal crates 8900 may store food items such as beverages, bakery products, snack products and packaged food products, in addition to personal care products, snack products, packaged food products, cleaning products, and pharmaceutical products that are typically consumed/used on a weekly to monthly basis. In some embodiments, the towers 7510 in the 9402T may store lower volume products, which may also be referred to as low-turnover consumer products. For example, the towers 7510 may store products typically consumed on a monthly to yearly basis, such as clothing, hardware, small appliances, jewelry, books, giftware and other incidental products that are consumed within similar time frames.

The first level of the order fulfilment center 9400 may also include a universal pallet inbound and outbound region 9404R, a stack product induction region 9434R, a tower inbound region 9404T, a tower product storage induction region 9432, a tower product induction region 9434T, the AMR escalators 9420, an order verification and sealing region 9440, and a route distribution accumulation region 9450. In practice, depending upon the size of the order fulfillment center 9400, the order fulfillment center 9400 may, in some cases, include multiples of the regions illustrated in FIG. 94B and may, in some other cases, omit one or more regions.

At the universal pallet inbound and outbound region 9404R, unloading and loading operations are performed with respect to a plurality of transport trailers 9510. Similar to what has been described with regard to universal pallet inbound and outbound regions 9404C located on the second level of the order fulfilment center 9400, the transport trailers 9510 at the universal pallet inbound and outbound region 9404R may include a plurality of inbound trailers and a plurality of outbound trailers. Each inbound trailer may carry a plurality of universal pallets 8800 loaded with products (e.g., in stacks 8902 of universal crates 8900 or as standalone products) sent by a supplier, producer, or manufacturer, to be unloaded and stored at their respective designated pallet storage position within the stack storage region 9402R. Each outbound trailer may be configured to be loaded by a plurality of universal pallets 8800 that are loaded with stacks 8902 of empty universal crates 8900, for return transport to a supplier, producer, or manufacturer, who may then reuse the plurality of empty universal crates 8900 and the universal pallets 8800 for storing products and then, once again, send the palletized products to the order fulfilment center 9400 to be stored and used for fulfilment of orders. The use of universal pallets 8800 and universal crates 8900 may, therefore, allow a closed loop system to be formed between the supplier, producer, or manufacturer of the products and the order fulfilment center 9400, as regards to the universal pallets 8800 and the universal crates 8900.

The stack product induction region 9434R may be populated with robotic product induction stations, such as the robotic product induction station 9100 illustrated in FIG. 91 (see, also, FIG. 94C). Each of the robotic product induction stations 9100 in the stack product induction region 9434R may be considered to be a place at which a pallet AMR 9000 meets up with a shipping container AMR 5800/5850.

In operation in view of FIG. 94C, a given robotic product induction station 9100 may be operated to retrieve a product, held in a universal crate 8900 in a stack 8902 on a universal pallet 8800 carried by a pallet AMR 9000, and place the retrieved product into a shipping container carried on a shipping container AMR 5800/5850. In the case of standalone products, a given robotic product induction station 9100 may be operated to retrieve a standalone product on a universal pallet 8800 carried by a pallet AMR 9000 and place the standalone product on a shipping container AMR 5800/5850. Specifically, a universal pallet 8800, which has been loaded with a stack 8902 of universal crates 8900, may be engaged by a pallet AMR 9000 and moved from a first pallet storage position within the stack storage region 9402R to a position proximate a particular robotic product induction station 9100. As described hereinbefore, the robotic product induction station 9100 may include the pair of robotic lifting arms 9102 suited for the task of lifting the lid 8904 from the top of the top universal crate 8900 in the stack 8902 in the cases in which a product to be obtained is in the top universal crate 8900. The pair of robotic lifting arms 9102 may also be suited for the task of lifting one or more universal crates 8900 off the stack 8902 to, thereby, allow access to the universal crate 8900 that is storing a product to be obtained. Once the product has been obtained and placed into the shipping container held by the shipping container AMR 5800/5850, the lid 8904 and any lifted universal crates 8900 may be placed back onto the stack 8902 on the universal pallet 8800. The pallet AMR 9000 may then move the universal pallet 8800 and the stack 8902 of universal crates 8900 to a second pallet storage position within the stack storage region 9402R.

At the tower inbound region 9404T, various products may be shown to arrive, often organized upon a pallet or in corrugated boxboard cases, at the first level of the order fulfillment center 9400 in a plurality of transport trailers, such as transport trailers 9510. Personnel and/or robots may unload the delivered products from the transport trailers. At the tower product storage induction region 9432, the products that have arrived may be stored by personnel and/or robots into a plurality of towers 7510, using methods described previously, e.g., de-palletizing or unpacking individual products, scanning and placing of products into totes, manually retrieving products from totes and placing them into an available space in a tower, etc. Upon being filled with products, a given tower 7510 may then be moved, by a tower-transportation AMR 7518, to a designated tower storage position within the tower product storage region 9420T.

The tower product induction region 9434T may be populated with manual product induction stations and/or robotic product induction stations, similar to what has been previously described for the production induction region 7608 in the order fulfilment location 7600. In operation, at the manual product induction stations and/or robotic product induction stations an operator and/or a robot retrieves a product required to fulfil an order from a tower 7510 and places the products into a shipping container held by an AMR, such as AMR 5800 or AMR 5850. Specifically, as described hereinbefore with respect to tower storage region 7604T of FIG. 76, a tower 7510 may be engaged by a tower-transportation AMR 7518 and moved from its designated tower storage position within the tower storage region 9402T to a position proximate a particular manual or robotic product induction station in the tower product induction region 9434T. An operator and/or robot may operate to retrieve a product from a compartment of the tower 7510 and place them in a shipping container held by AMR 5800/5850. Once the product is obtained and placed onto an AMR 5800/5850, the tower-transportation AMR 7518 may move the tower 7510 back to the designated pallet storage position within tower storage region 7604T.

The order verification and sealing region 9440 and route distribution accumulation region 9450 may be similar to the order verification and sealing region 6910 described with respect to FIG. 74 and the route distribution accumulation region 7612, 8212 described with respect to FIGS. 76-76A, and 82A-82B.

It has been discussed, hereinbefore, that a transport trailer 9510 may be configured to transport a plurality of the universal pallets 8800 loaded with stacks 8902 of universal crates 8900. In the context of FIGS. 94A and 94B, the transport trailer 9510 may be configured to carry the plurality of the universal pallets 8800 in a manner that allows one of the pallet AMRs 9000 to board the transport trailer, pick up one of the universal pallets 8800 and carry the universal pallet 8800 to a pallet storage position in the cell product storage region 9402C or the stack storage region 9402R.

FIG. 95 illustrates a transport trailer 9510, which may have travelled from a producer, supplier, or manufacturer to the universal pallet inbound and outbound regions 9404C or the universal pallet inbound and outbound region 9404R. The transport trailer 9510 is shown to be partially full of universal pallets 8800 and in the middle of a process of being unloaded into the cell product storage region 9402C or the stack storage region 9402R. The pallet AMRs 9000 may carry universal pallets 8800 with stacks 8902 of universal crates 8900 from the, and travel to a specified cell in the cell product storage region 9402C or a designated pallet storage position in the stack storage region 9402R. In the illustration of FIG. 95, each of the two AMRs 9000 may be shown to carry a universal pallet 8800 with stack 8902 of universal crates 8900 unloaded from the transport trailer 9510.

FIG. 96 illustrates, in a cut-away plan view, the transport trailer 9510 configured to carry a plurality of the universal pallets 8800. In contrast to the transport trailer 8500, illustrated in FIG. 85, the transport trailer 9510 illustrated in FIGS. 95 and 96 may be configured to be much more tightly packed with the universal pallets 8800. The transport trailer 9510 may have dimensions of 53 feet (length)×98 inches (width)×110 inches (height). These standard trailer dimensions allow 2 rows of 13 universal pallets 8800 to be loaded into the transport trailer 9510. Indeed, the dimensions of the universal pallets 8800 may offer the greatest load utility inside of the transport trailer 9510. It has been discussed previously that a transport trailer 8500 may be configured for use with the further crate retention structures 8400 in conjunction with an implementation of an adaptation allowing use with AMRs. Such adaptation may, for example, include installing tracks defined by barcodes on the floor of the transport trailer 8500 to, thereby, facilitate navigation by AMRs in the transport trailer 8500. An AMR may enter the transport trailer 8500, select any of the further crate retention structures 8400 and exit the transport trailer 8500 with the selected further crate retention structure 8400. In contrast, the universal pallets 8800 may be tightly packed on the transport trailer 9500 that a given one of the pallet AMRs 9000 may only board the transport trailer 9500 to extract one of the two universal pallets 8800 readily available to the given pallet AMR 9000. The floor of the transport trailer 9500 may be embedded with barcodes to facilitate navigation by the pallet AMRs 9000.

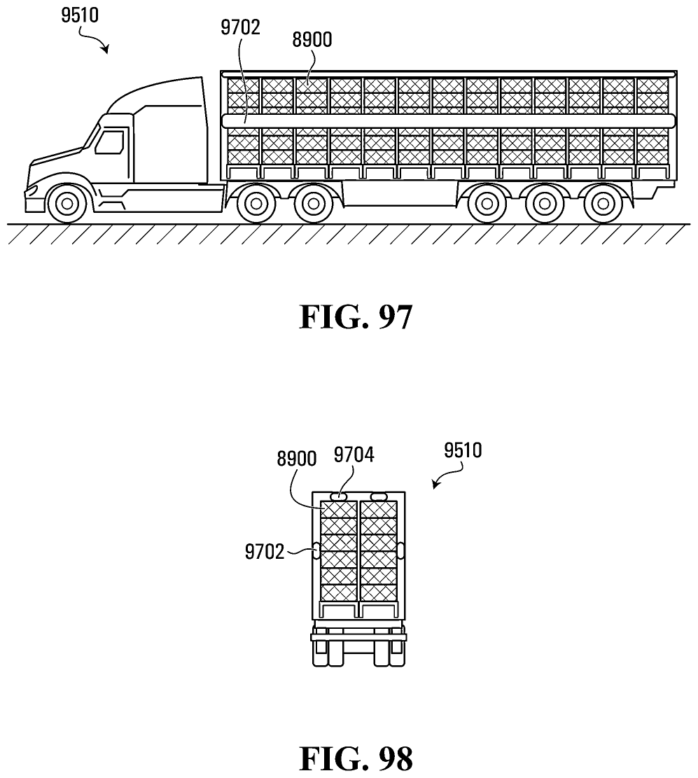

In some embodiments, the transport trailer 9510 may be fitted with inflatable air bags. Referring to FIGS. 97 and 98, a cut-away elevation view (FIG. 97) and a cut-away rear view (FIG. 98) of the transport trailer is shown, with inflatable air bags 9702, 9704. The inflatable air bags 9702, 9704 may be used to secure the universal crates 8900 and the universal pallets 8800 during transport, thereby minimizing damage to the universal pallets 8800, universal crates 8900, and more importantly, to the products while the transport trailer 9510 travels from the producer, supplier, or manufacturer to the order fulfilment center 9400. The inflatable air bags 9702 may be mounted to the inner side walls of a transport trailer 9510, and may traverse the length of each inner side wall. The inflatable air bags 9704 may be mounted to the ceiling of the transport trailer 9510 at locations approximately 2 feet from each side wall, and may traverse the length of the ceiling.

Many conventional transport trucks may include an air brake system that can apply pressure to the brake pads or brake shoes to slow or stop the truck. The inflatable air bags 9702, 9704 may be pneumatically plumbed into such an air brake system, and a control valve may be operated for inflating and deflating the inflatable air bags 9702, 9704. In operation, the inflatable air bags 9702, 9704 may be inflated at the producer, supplier, or manufacturer side after the transport trailer 9510 is loaded with the universal pallets 8800, remain inflated during transport to the order fulfilment center 9400, and then deflated once the trailer 9510 arrives at the order fulfilment center 9400.

It has been discussed hereinbefore that the use of universal pallets 8800 and universal crates 8900 may allow for a closed loop system to be formed between the supplier, producer, or manufacturer of products to be stored at the order fulfilment center 9400, and the order fulfilment center 9400. In some embodiments, it is contemplated that packaging operations at a production facility may be modified to be fully automated. The term production facility may encompass any supplier, producer, or manufacturer facility configured to package products (e.g., re-palletize products onto universal pallets 8800) and load the packaged products onto the transport trailers 9510 for transport to the order fulfilment center 9400.

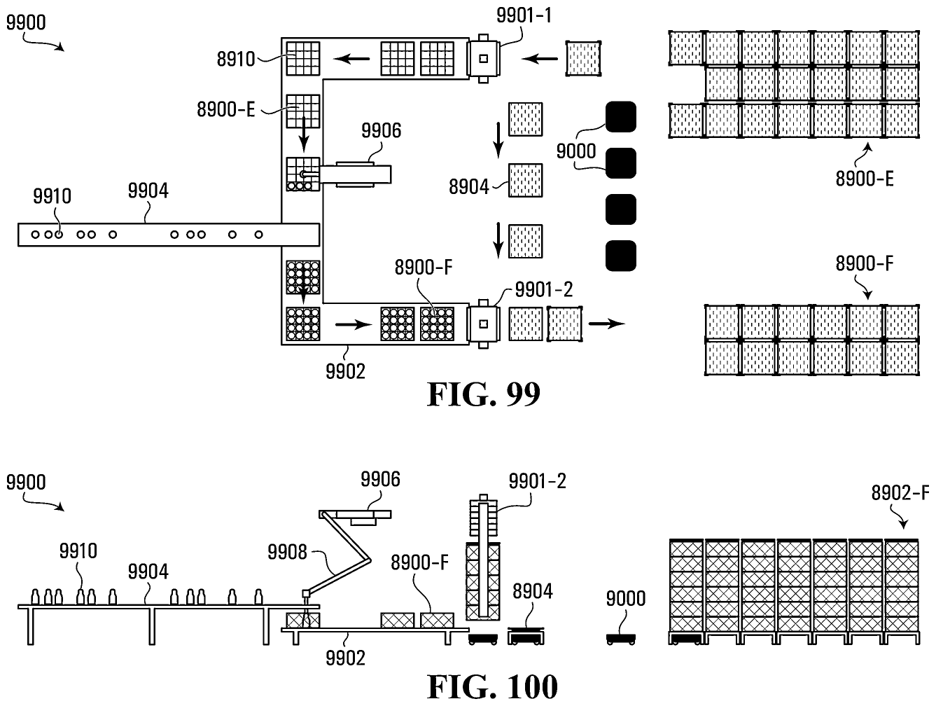

FIGS. 99 and 100 illustrate a process 9900 of automated product loading and re-palletization at a production facility. Stacks 8902 of empty universal crates 8900-E loaded on universal pallets 8800 may arrive via transport trailers 9510 to a production facility. Pallet AMRs 9000 may operate at the production facility to unload the universal pallets 8800 and store them at a first location of the production facility. The objective of process 9900 may be to load the empty universal crates 8900-E with products, such as product 9910, and re-palletize them as stacks 8902 on universal pallets 8800 so that they may be loaded on transport trailers 9510 and make their way again to the order fulfilment center 9400. The process 9900 may generally be carried out as follows.

A pallet AMR 9000 may engage a universal pallet 8800 loaded with a stack 8902 of empty universal crates 8900-E and move the combination of the universal pallet 8800 and stack 8902 of empty universal crates 8900-E proximate a first robotic station 9901-1. The first robotic station 9901-1 may be suited to obtaining empty universal crates 8900-E from the universal pallet 8800 and placing them on a first conveyor belt 9902 of a first conveyor belt system. The first conveyor belt 9902 may transport items placed thereon along a conveyor path in the direction indicated by the arrows along the first conveyor belt 9902 (see FIG. 99).

For example, the first robotic station 9901-1 may include a pair of robotic lifting arms (not shown) for lifting the empty universal crates 8900-E. The pair of robotic lifting arms of the first robotic station 9901-1 may lift all of the empty universal crates 8900-E, along with the lid 8904 closing the topmost universal crate 8900-E, so that the stack 8902 of empty universal crates 8900-E is suspended above the universal pallet 8800. A first end of the first conveyor belt 9902 proximate the first robotic station 9901-1 may be configured to telescope out towards the robotic station 9901-1 and be positioned directly underneath the suspended stack 8902 of empty universal crates 8900-E. The pair of robotic lifting arms of the first robotic station 9901-1 may be automatically operated to set the empty universal crates 8900-E down onto the first end of the first conveyor belt 9902, starting with the bottommost universal crate 8900-E. As the empty universal crates 8900-E are placed, the first conveyor belt 9902 may operate to move the empty universal crates 8900-E along the first conveyor belt path. Once all of the empty universal crates 8900-E of the suspended stack 8902 are placed onto the first conveyor belt 9902, the first end of the first conveyor belt 9902 may be telescoped back in to allow the robotic lifting arms of the first robotic station 9901-1 to have access to the universal pallet 8800. At this point, the lid 8904 may still be suspended by the pair of robotic lifting arms of the first robotic station 9901-1. The pair of robotic lifting arms may set the lid 8904 down onto the universal pallet 8800, and the pallet AMR 9000 may move the combination of the universal pallet 8800 and the lid 8904 towards a second robotic station 9901-2.

Meanwhile, the empty universal crates 8900-E may make their way along the first conveyor belt path towards a crate loading robotic station 9906. The crate loading robotic station 9906 may be positioned proximate a second conveyor belt 9904, as illustrated in FIGS. 99 and 100. The second conveyor belt 9904 may be configured to transport products 9910 to be loaded into the empty universal crates 8900-E. The crate loading robotic station 9906 may be configured, e.g., using a robotic picker arm 9908, to obtain products 9910 from atop the second conveyor belt 9904 and into the empty universal crates 8900-E to fill the empty universal crates 8900-E as they pass through an operational range of the robotic picker arm 9908 along the first conveyor belt path. The crate loading robotic station 9906 may fill each empty universal crate 8900-E to become a filled universal crate 8900-F. As noted previously, the universal crate 8900 may include identically sized compartments ranging between 1 compartment and 256 compartments, to hold units of a product. The embodiment illustrated in FIG. 99 shows each of the universal crates 8900 having a 4×4 pattern, creating 16 identical compartments that are appropriately sized to efficiently and safely contain products 9910.

Once full, the filled universal crates 8900-F continues along the first conveyor belt path towards a second end of the first conveyor belt 9902, proximate the second robotic station 9901-2. A pallet AMR 8900 carrying a universal pallet 8800 and a lid 8904 may already be positioned underneath a pair of robotic lifting arms of the second robotic station 9901-2, awaiting palletization.

The pair of robotic lifting arms of the second robotic station 9901-2 may lift the lid 8904 from the universal pallet 8800 to start the palletization process. The second end of the first conveyor belt 9902 may then be configured to telescope out towards the second robotic station 9901-2 and be positioned directly underneath the pair of robotic lifting arms of the second robotic station 9901-2. The pair of robotic lifting arms of the second robotic station 9901-2 may, while holding the lid 8904, cumulatively lift individual universal crates 8900-F that reach the second end of the first conveyor belt 9902, until the robotic lifting arms are holding the lid 8904 (at the top) and six filled universal crates-F as required to form a stack 8902. At this point, the second end of the first conveyor belt 9902 may be telescoped back in to allow the robotic lifting arms of the second robotic station 9901-2 to have access to the universal pallet 8800. The robotic lifting arms of the second robotic station 9901-2 may release the newly formed stack 8902 of filled universal crates 8900 onto the universal pallet 8800. The AMR 9000 may move the universal pallet 8800 with the stack 8902 of filled universal crates 8900 to a second location of the production facility to be stored. The second location may store only universal pallets 8800 loaded with stacks 8902 of filled universal crates 8900. The universal pallets 8800 in the second location may be engaged by pallet AMRs 9000 to be loaded onto a transport trailer 9510 for delivery to the universal pallet inbound and outbound regions 9404C or the universal pallet inbound and outbound region 9404R of the order fulfilment center 9400.

The process 9900 as outlined above may be implemented for any production facility participating in the closed loop system by use of the universal pallets 8800 and universal crates 8900, to achieve full automation of end-of-line product packing at the production facility. Conventional end-of-line product packaging at such production facilities may be modified to the systems and components shown in FIGS. 99 and 100. Each of the first robotic station 9901-1, the second robotic station 9901-2, and the crate loading robotic station 9906 may be suspending from a ceiling-based mount to, thereby, minimize a footprint on the floor of the production facility. Alternatively, the components of the robotic stations may be suspended from one or more gantry-based mounts.

The process 9900 may be automated by use of a production facility processor. The production facility processor may be a mainframe computer, a server, or other computing device that may include a database that includes information and instructions that may be stored in a suitable memory therein to implement the process 9900, as will be apparent to a person skilled in the art. The production facility processor may additionally be configured to instruct pallet AMRs 9000 to unload universal pallets 8800 with stacks 8902 of empty universal crates 8900-E from transport trailers 9510, and to load universal pallets 8800 with stacks 8902 of filled universal crates 8900-F onto transport trailers 9510 for delivery to the order fulfilment center 9400.

Of course, the use of universal pallets 8800 and universal crates 8900 to allow for a closed loop system to be formed between the supplier, producer, or manufacturer of products (e.g., products 9910), and the order fulfilment center 9400, need not apply only to products to be used in fulfilling customer orders at the order fulfilment center 9400. As mentioned hereinbefore, in some embodiments, universal pallets 8800 loaded with stacks 8902 of universal crates 8900 containing shipping container blanks may be transported to the universal pallet inbound and outbound region 9404C via an inbound trailer 9510-1. Therefore, in some embodiments, shipping container blanks or shipping containers may themselves be part of a closed loop system that is formed between the supplier or manufacturer of the shipping container blanks or shipping containers to be used at the order fulfilment center 9400, and the order fulfillment center 9400.

In some embodiments, it is contemplated that packaging operations at a shipping container production facility may be modified to be fully automated. The term production facility may encompass any supplier, producer, or manufacturer facility configured to package shipping container blanks or at least partially formed shipping containers (e.g., re-palletize shipping container blanks or shipping containers onto universal pallets 8800) and load the packaged shipping container blanks or shipping containers onto the transport trailers 9510 for transport to the order fulfilment center 9400.

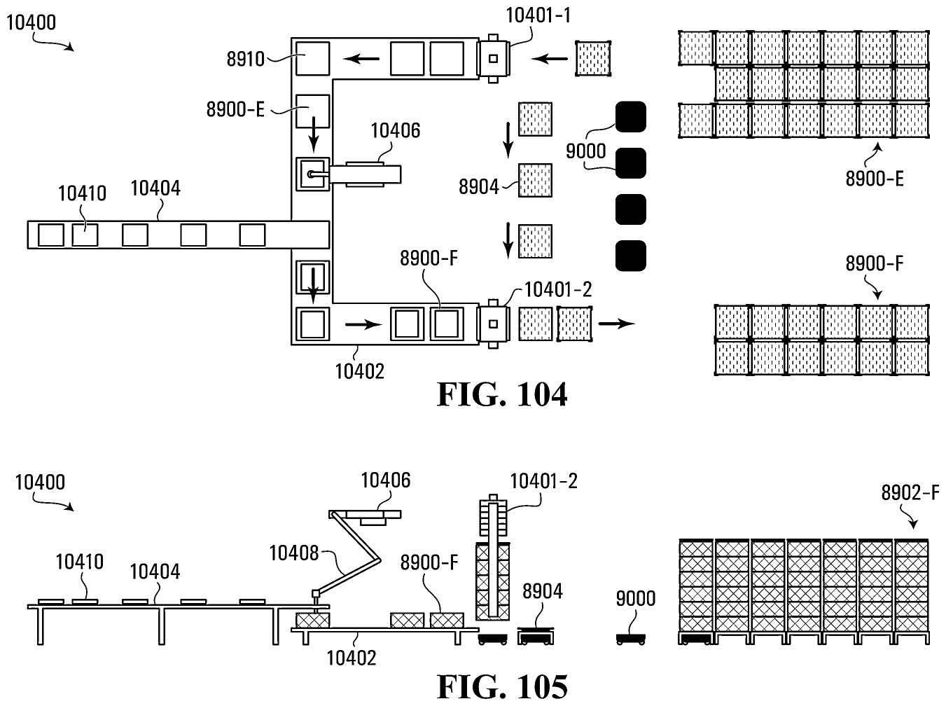

FIGS. 104 and 105 illustrate a process 10400 of automated product loading and re-palletization at a shipping container blank production facility. Stacks 8902 of empty universal crates 8900-E loaded on universal pallets 8800 may arrive via transport trailers 9510 to a shipping container blank production facility. Pallet AMRs 9000 may operate at the shipping container blank production facility to unload the universal pallets 8800 and store them at a first location of the production facility. The objective of process 10400 may be to load the empty universal crates 8900-E with shipping container blanks, such as blanks 10410, and re-palletize them as stacks 8902 on universal pallets 8800 so that they may be loaded on transport trailers 9510 and make their way again to the order fulfilment center 9400. The process 10400 may generally be carried out as follows.

A pallet AMR 9000 may engage a universal pallet 8800 loaded with a stack 8902 of empty universal crates 8900-E and move the combination of the universal pallet 8800 and stack 8902 of empty universal crates 8900-E proximate a first robotic station 10401-1. The first robotic station 10401-1 may be suited to obtaining empty universal crates 8900-E from the universal pallet 8800 and placing them on a first conveyor belt 10402 of a first conveyor belt system. The first conveyor belt 9902 may transport items placed thereon along a conveyor path in the direction indicated by the arrows along the first conveyor belt 10402 (see FIG. 104).

For example, the first robotic station 10401-1 may include a pair of robotic lifting arms (not shown) for lifting the empty universal crates 8900-E. The pair of robotic lifting arms of the first robotic station 10401-1 may lift all of the empty universal crates 8900-E, along with the lid 8904 closing the topmost universal crate 8900-E, so that the stack 8902 of empty universal crates 8900-E is suspended above the universal pallet 8800. A first end of the first conveyor belt 10402 proximate the first robotic station 10401-1 may be configured to telescope out towards the robotic station 10401-1 and be positioned directly underneath the suspended stack 8902 of empty universal crates 8900-E. The pair of robotic lifting arms of the first robotic station 10401-1 may be automatically operated to set the empty universal crates 8900-E down onto the first end of the first conveyor belt 10402, starting with the bottommost universal crate 8900-E. As the empty universal crates 8900-E are placed, the first conveyor belt 10402 may operate to sequentially move each of the empty universal crates 8900-E along the first conveyor belt path. Once all of the empty universal crates 8900-E of the suspended stack 8902 are placed onto the first conveyor belt 10402, the first end of the first conveyor belt 10402 may be telescoped back in to allow the robotic lifting arms of the first robotic station 10401-1 to have access to the universal pallet 8800. At this point, the lid 8904 may still be suspended by the pair of robotic lifting arms of the first robotic station 10401-1. The pair of robotic lifting arms may set the lid 8904 down onto the universal pallet 8800, and the pallet AMR 9000 may move the combination of the universal pallet 8800 and the lid 8904 towards a second robotic station 10401-2.

Meanwhile, the empty universal crates 8900-E may make their way along the first conveyor belt path towards a crate loading robotic station 10496. The crate loading robotic station 10406 may be positioned proximate a second conveyor belt 10404, as illustrated in FIGS. 104 and 105. The second conveyor belt 10404 may be configured to transport shipping container blanks 10410 to be loaded into the empty universal crates 8900-E. The crate loading robotic station 10406 may be configured, e.g., using a robotic picker arm 10408, to obtain shipping container blanks 10410 from atop the second conveyor belt 10404 and into the empty universal crates 8900-E to fill the empty universal crates 8900-E as they pass through an operational range of the robotic picker arm 9908 along the first conveyor belt path. The crate loading robotic station 9906 may fill each empty universal crate 8900-E to become a filled universal crate 8900-F. The embodiment illustrated in FIG. 104 shows each of the universal crates 8900 being a 1-compartment universal crate 8900, sized to efficiently and safely contain the shipping container blanks 10410. Depending on the size or configuration of the shipping container blank 10410, the universal crates 8900 may have a different internal configuration (e.g., 1×2, 1×3, 2×2, etc.).

Once full, the filled universal crates 8900-F continue along the first conveyor belt path towards a second end of the first conveyor belt 10402, proximate the second robotic station 10401-2. A pallet AMR 8900 carrying a universal pallet 8800 and a lid 8904 may be positioned underneath a pair of robotic lifting arms of the second robotic station 10401-2, awaiting palletization.

The pair of robotic lifting arms of the second robotic station 10401-2 may lift the lid 8904 from the universal pallet 8800 to start the palletization process. The second end of the first conveyor belt 10402 may then be configured to telescope out towards the second robotic station 10401-2 and be positioned directly underneath the pair of robotic lifting arms of the second robotic station 10401-2. The pair of robotic lifting arms of the second robotic station 10401-2 may, while holding the lid 8904, cumulatively lift individual universal crates 8900-F that reach the second end of the first conveyor belt 10402, until the robotic lifting arms are holding the lid 8904 (at the top) and six filled universal crates 8900-F as required to form a stack 8902. At this point, the second end of the first conveyor belt 10402 may be telescoped back in to allow the robotic lifting arms of the second robotic station 10401-2 to have access to the universal pallet 8800. The robotic lifting arms of the second robotic station 10401-2 may release the newly formed stack 8902 of filled universal crates 8900 onto the universal pallet 8800. The AMR 9000 may move the universal pallet 8800 with the stack 8902 of filled universal crates 8900 to a second location of the production facility to be stored. The second location may store only universal pallets 8800 loaded with stacks 8902 of filled universal crates 8900. The universal pallets 8800 in the second location may be engaged by pallet AMRs 9000 to be loaded onto a transport trailer 9510 for delivery to the universal pallet inbound and outbound regions 9404C or the universal pallet inbound and outbound region 9404R of the order fulfilment center 9400.

The process 10400 as outlined above may be implemented for any shipping container or shipping container blank production facility participating in the closed loop system by use of the universal pallets 8800 and universal crates 8900, to achieve full automation of end-of-line shipping container or shipping container blank packing at the production facility. Conventional end-of-line product packaging at such production facilities may be modified to the systems and components shown in FIGS. 104 and 105. Each of the first robotic station 10401-1, the second robotic station 10401-2, and the crate loading robotic station 10406 may be suspending from a ceiling-based mount to, thereby, minimize a footprint on the floor of the production facility. Alternatively, the components of the robotic stations may be suspended from one or more gantry-based mounts.

The process 10400 may be automated by use of a production facility processor. The production facility processor may be a mainframe computer, a server, or other computing device that may include a database that includes information and instructions that may be stored in a suitable memory therein to implement the process 10400, as will be apparent to a person skilled in the art. The production facility processor may additionally be configured to instruct pallet AMRs 9000 to unload universal pallets 8800 with stacks 8902 of empty universal crates 8900-E from transport trailers 9510, and to load universal pallets 8800 with stacks 8902 of filled universal crates 8900-F onto transport trailers 9510 for delivery to the order fulfilment center 9400.

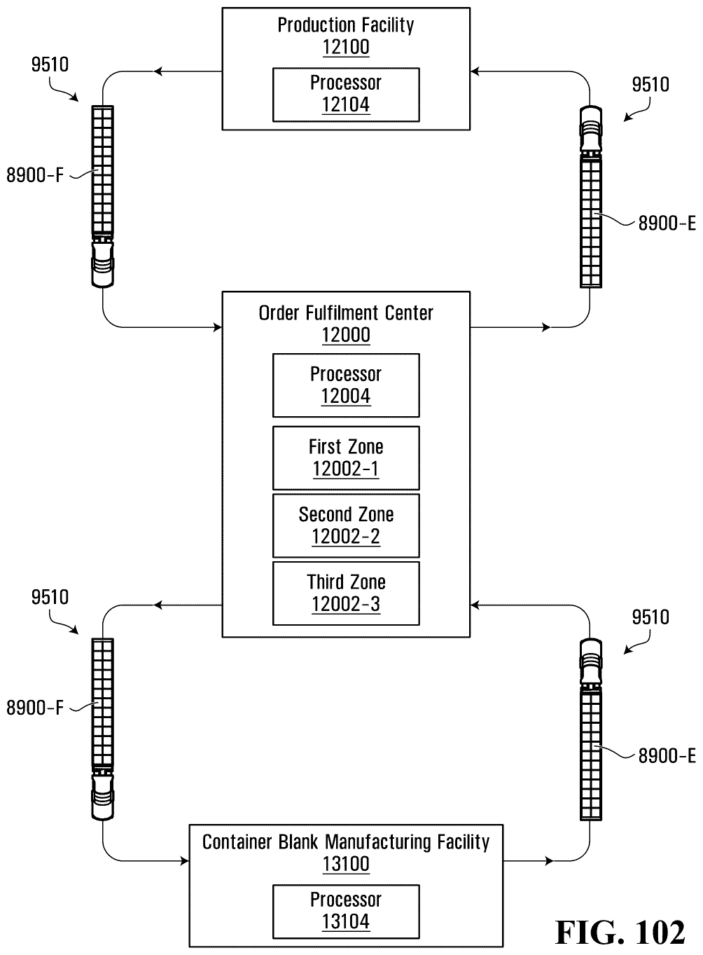

FIG. 102 schematically illustrates a first closed loop system as between an order fulfilment center 12000 and a production facility 12100, and a second closed loop system as between the order fulfillment center 12000 and a container blank manufacturing facility 13100. A plurality of universal pallets 8800 loaded with filled universal crates 8900-F are continually delivered from the production facility 12100 and the container blank manufacturing facility 13100 to the order fulfilment center 12000, and a plurality of plurality of universal pallets 8800 loaded with empty universal crates 8900-E are continually delivered from the order fulfilment center 12000 to the production facility 12100 and the container blank manufacturing facility 13100. The plurality of universal crates 8900-E and 8900-F delivered between the order fulfillment center 12000 and the production facility 12100 may have one or more designated internal configurations. For example, if the production facility 12100 produced only products 9910, as shown in FIGS. 99 and 100, each of the plurality of universal crates 8900-E and 8900-F delivered between the order fulfillment center 12000 and the production facility 12100 may have a 4×4 configuration to hold 16 units of the product 9910. If the production facility 12100 additionally produced other products requiring different patterns and number of compartments for the universal crates 8900 for safe and efficient transport, universal crates 8900 with the different patterns and number of compartments may also be included in the plurality of universal crates 8900-E and 8900-F delivered between the order fulfillment center 12000 and the production facility 12100. In such an embodiment, the first closed loop system may be organized in such a way that the empty universal crates 8900-E having the 4×4 configuration are correctly delivered to an area of the production facility 12100 where they can receive products 9910 via the process 9900, and the empty universal crates 8900-E having a different configuration are correctly delivered to an area of the production facility 12100 where they can receive a different product requiring that different configuration. Similarly, the plurality of universal crates 8900-E and 8900-F delivered between the order fulfillment center 12000 and the container blank manufacturing facility 13100 may have one or more designated internal configurations, to safely and efficiently contain and transport the shipping container or shipping container blanks produced at the container blank manufacturing facility 13100. Although only one production facility 12100 is illustrated, a plurality of closed loop systems may exist between other production facilities and the order fulfilment center 12000. Similarly, although only one container blank manufacturing facility 13100 is illustrated, a plurality of closed loop systems may exist between other shipping container or shipping container blank production facilities and the order fulfilment center 12000.

The production facility 12100 may have fully automated end-of-line product packaging as described above with respect to FIGS. 99 and 100, and the container blank manufacturing facility 13100 may have fully automated end-of-line shipping container or shipping container blank packaging as described above with respect to FIGS. 104 and 105. The production facility 12100 is illustrated as including a production facility processor 12104, which may include all of the hardware and software components and capabilities of the production facility processor discussed in view of FIGS. 99 and 100. The production facility processor 12104 may be configured to execute instructions that may be stored in a suitable memory therein, to operate the fully automated end-of-line product packaging. In addition, the production facility processor 12104 may be configured to execute instructions stored in a suitable memory therein, to allow for automated unloading of empty universal pallets and automated loading of filled universal pallets from and to transport trailers, as discussed above in relation to FIGS. 99 and 100. The container blank manufacturing facility 13100 is illustrated as including a container blank manufacturing facility processor 13104, which may include all of the hardware and software components and capabilities of the production facility processor discussed in view of FIGS. 104 and 105. The blank manufacturing facility processor 13104 may be configured to execute instructions that may be stored in a suitable memory therein, to operate the fully automated end-of-line shipping container or shipping container blank packaging. In addition, the blank manufacturing facility processor 13104 may be configured to execute instructions stored in a suitable memory therein, to allow for automated unloading of empty universal pallets and automated loading of filled universal pallets from and to transport trailers, as discussed above in relation to FIGS. 104 and 105.

The order fulfilment center 12000 is illustrated as being split into three distinct product storage and customer order induction zones 12002 including: a first order induction zone 12002-1; a second order induction zone 12002-2; and a third order induction zone 12002-3. Each order induction zone may be associated with order-induction-zone-specific schemes for receiving products, storing products and inducting products into order shipping containers held by AMRs (or directly onto AMRs for standalone products). The order fulfillment center 12000 may also include a shipping container induction zone (not shown) to receive and store shipping containers to be used as order shipping containers, or to receive and store shipping container blanks, such as shipping container blanks 10410 of FIGS. 104 and 105, to be erected into order shipping containers. Shipping container blanks that are received and stored in the shipping container induction zone may be erected into order shipping containers by carton forming systems in the shipping container zone, for example, by robotic shipping container induction systems 11000 as described with reference to FIG. 101. The order fulfilment center 12000 also includes an order fulfilment processor 12004. The order fulfilment processor 12004 may include at least all of the hardware and software components and functionalities of the order fulfilment processor 1300 of FIG. 64, and in a suitable memory therein contain at least all of the information known by the order fulfilment processor 1300. The order fulfilment processor 12004 may be configured to execute instructions stored in the suitable memory, to implement all of the processes required to operate the order fulfilment center 9400 and process customer orders received directly or indirectly from customer order devices.

In view of the previously discussed order fulfilment center 9400 of FIGS. 94A-94B, the first order induction zone 12002-1 may be understood to map to the cell product storage region 9402C on the second level of the order fulfilment center 9400. Accordingly, the first order induction zone 12002-1 may be understood to be used in the context of relatively fast-moving consumer SKUs with a relatively small (say, 5,000) number of SKUs. As mentioned in view of FIG. 94A, the SKUs may arrive to the universal pallet inbound and outbound regions 9404C on the second level of the order fulfilment center 9400 in inbound transport trailers 9510-1, stored upon universal pallets 8800. The universal pallets 8800 may be unloaded from the inbound transport trailers 9510-1 by pallet AMRs 9000, and stored in the first order induction zone 12002-1 in designated cells similar to the cells discussed hereinbefore (see FIGS. 90, 91, 94A). In some embodiments, the first order induction zone 12002-1 may be capable of storing approximately 70,000 universal pallets within three temperature zones that map respectively to first and fourth partitions 9405-1 and 9405-4, second partition 9405-2, and third partition 9405-3.

In view of the previously discussed order fulfilment center 9400 of FIGS. 94A-94B, the second order induction zone 12002-2 may be understood to map to the combination of stack storage region 9402R and stack product induction region 9434R. It follows that the second order induction zone 8702-2 may be understood to be used in the context of relatively medium-moving consumer SKUs with a relatively middling (say, 25,000) number of SKUs. As mentioned in view of FIG. 94B, the SKUs may arrive to the universal pallet inbound and outbound region 9404R of the first level of the order fulfilment center 9400 in inbound transport trailers 9510-1, stored upon universal pallets 8800. The universal pallets 8800 may be unloaded from the inbound transport trailers 9510-1 by pallet AMRs 9000, and stored in the first order induction zone 12002-2 in designated pallet storage positions within the stack storage region 9402R discussed hereinbefore (see FIG. 94B). In some embodiments, the second order induction zone 12002-2 may be capable of storing over 23,000 universal pallets 8800 and over 142,000 universal crates 8900 organized in stacks 8902 on the universal pallets 8800. The universal pallets 8800 stored (or headed for storage) in the second order induction zone 12002-2 may be served by thousands of pallet AMRs 9000.

In view of the previously discussed order fulfilment center 9400 of FIGS. 94A-94B, the third order induction zone 12002-3 may be understood to map to the combination of the tower storage region 8204T and tower product induction region 9434T. It follows that the third order induction zone 12002-3 may be understood to be used in the context of relatively slow-moving consumer SKUs with a relatively large (say, over 500,000) number of SKUs. As discussed hereinbefore, the SKUs may arrive to the tower inbound region 9404T of the first level of the order fulfilment center 9400 in transport trailers 9510, be manually and/or robotically inducted by personnel and/or robots, and stored in towers, such as tower 7510. The third order induction zone 12002-3 may be capable of storing over 25,000 towers 7510 containing millions of products.

With partnerships established with production facilities such as production facility 12100 and the container blank manufacturing facility 13100, the order fulfilment processor 12004 may determine an inventory process to be followed for each of the SKUs arriving at the order fulfilment center 9400. Inbound SKUs may be allocated to a designated receiving dock associated with an appropriate product storage induction region (e.g., regions 9404C, 9404R, or 9404T in FIGS. 94A-94B) and order induction zone 12002-1, 12002-2, or 12002-3 (or, in the case of shipping containers or shipping container blanks, the shipping container induction zone). SKUs designated to the first order induction zone 12002-1, the second order induction zone 12002-2, and the shipping container induction zone may be received on universal pallets 8800 which may be loaded with stacks 8902 of universal crates 8900. SKUs designated to the third order induction zone 12002-3 may be received in traditional packaging.

A first stage of processing products may be related to receiving inbound products from the production facility 12100 or the container blank manufacturing facility 13100 and trailer unloading.

With respect to the first order induction zone 12002-1, SKUs that are inbound and destined for the first order induction zone 12002-1 may be expected to arrive, in inbound transport trailers, on universal pallets (e.g., the universal pallet 8800 of FIG. 88) loaded with stacks of universal crates (e.g., the stacks 8902 of universal crates 8900) with a single SKU per stack of universal crates. In other words, each stack of universal crates destined for the first order induction zone 12002-1 may be same SKU stacks. The inbound transport trailers may be configured to transport the universal pallets loaded with products (like, e.g., the transport trailer 9510 of FIGS. 94A, 95-98). The inbound transport trailer may, for example, be configured to transport 26 universal pallets. The inbound transport trailer may, for example, be configured with an AMR track defined by barcodes on the floor of the inbound transport trailer. Each universal pallet may be removed from the inbound transport trailers by an AMR configured to move universal pallets (e.g., AMR 9000).

With respect to the second order induction zone 12002-2, SKUs that are inbound and destined for the second order induction zone 12002-2 may arrive, in inbound transport trailers, on universal pallets (e.g., the universal pallet 8800 of FIG. 88) loaded with stacks of universal crates (e.g., the stacks 8902 of universal crates 8900). Each stack of universal crates may be a same SKU stack or a multiple SKU stack. The inbound transport trailers (like, e.g., the transport trailer 9510 of FIGS. 94A, 95-98) may be configured to transport the universal pallets. The inbound transport trailer may, for example, be configured with an AMR track defined by barcodes on the floor of the inbound transport trailer. Each universal pallet may be removed from the inbound transport trailers by an AMR configured to move universal pallets (e.g., AMR 9000).

With respect to the shipping container induction zone, SKUs that are inbound and destined for the container induction zone may arrive, in inbound transport trailers, on universal pallets (e.g., the universal pallet 8800 of FIG. 88) loaded with stacks of universal crates (e.g., the stacks 8902 of universal crates 8900). Each stack of universal crates may be a same SKU stack or a multiple SKU stack. The inbound transport trailers (like, e.g., the transport trailer 9510 of FIGS. 94A, 95-98) may be configured to transport the universal pallets. The inbound transport trailer may, for example, be configured with an AMR track defined by barcodes on the floor of the inbound transport trailer. Each universal pallet may be removed from the inbound transport trailers by an AMR configured to move universal pallets (e.g., AMR 9000).

With respect to the third order induction zone 12002-3, SKUs that are inbound and destined for the third order induction zone 12002-3, may, typically, arrive packed in corrugated boxboard cases. The corrugated boxboard cases may be unloaded manually from the transport trailer. The received cases may be inspected and scanned. The received cases may also be unpacked to allow individual products, unpacked from the cases, to be scanned and placed into totes. The totes may then be conveyed to a storage induction station (e.g., tower product storage induction region 9432 in FIG. 94B).

A second stage of processing products may be related to storing received inbound products.

With respect to the first induction zone 12002-1, the pallet AMR carrying an inbound universal pallet associated with a single SKU may be directed from the transport trailer to a designated pallet storage position in a cell (e.g., see the cells discussed in relation to FIGS. 90-94A) in the first order induction zone 12002-1. It is contemplated herein that movement of universal pallets 8800 within the first induction zone 12002-1 are carried out by pallet AMRs. Accordingly, it may be noted that use of roller conveyors, which are conventionally used for movement of conventional pallets of products, may be obviated.

With respect to the second induction zone 12002-2, the pallet AMR carrying an inbound universal pallet carrying a same SKU stack of universal crates or a multiple SKU stack of universal crates may be directed from the transport trailer to a designated pallet storage position within a stack storage region (e.g., see stack storage region 9402R discussed in relation to FIG. 94B). It is contemplated herein that movement of universal pallets 8800 within the second induction zone 12002-2 are carried out by pallet AMRs. Accordingly, it may be noted that use of roller conveyors, which are conventionally used for movement of conventional pallets of products, may be obviated.

With respect to the shipping container induction zone, the pallet AMR carrying an inbound universal pallet carrying a same SKU stack of universal crates or a multiple SKU stack of universal crates may be directed from the transport trailer to a designated pallet storage position within a container storage region. It is contemplated herein that movement of universal pallets 8800 within the container induction zone are carried out by pallet AMRs. Accordingly, it may be noted that use of roller conveyors, which are conventionally used for movement of conventional pallets of products, may be obviated.

With respect to the third order induction zone 12002-3, SKUs that are inbound and destined for the third order induction zone 12002-3, may, typically, arrive packed in corrugated boxboard cases. The corrugated boxboard cases may be unloaded manually from the transport trailer. The received cases may be inspected and scanned. The received cases may also be unpacked to allow individual products, unpacked from the cases, to be scanned and placed into totes. The totes may then be conveyed to a storage induction station (e.g., tower product storage induction region 9432 in FIG. 94B).

With respect to the third induction zone 12002-3, as discussed products may be manually unloaded, scanned, and placed into totes. A given tote may be directed to one storage induction station among, say, hundreds of storage induction stations. An associate may be expected to manually pick the product from the tote, scan the product and place the product into an available space in a tower (like the tower 7510 of FIG. 75) carried by an AMR. Responsive to the remaining products contained in the tote having been picked and placed in other spaces in the tower (or in other towers) an AMR configured to transport towers (like tower-transportation AMR 7518 of FIG. 75) may move the tower to a designated pallet storage position within the tower product storage region (like the tower storage region 9402T of FIG. 94B). Empty totes may be stacked and returned to the product receiving area to be recycled.

After items contained within universal crates are used up to fulfill orders, a third stage of processing products may be related to returning empty universal pallets (e.g., universal pallets 8800) from the order fulfilment center 12000 to the production facility 12100, and replacing empty universal pallets with filled universal pallets.

In some embodiments, in the first order induction zone 12002-1, empty universal pallets (e.g., universal pallets 8800 loaded with stacks 8902 of empty universal crates 8900) in a particular cell may be kept in the same particular cell, as discussed hereinbefore in relation to FIGS. 90-93H. Upon determining that the majority of the universal pallets within a cell are empty, the order fulfilment processor 12004 may instruct one or more pallet AMRs to transport the empty universal pallets into an outbound transport trailer specifically designated to receive empty universal pallets (e.g., transport trailers 9510-2 in FIG. 94A). The pallet AMRs may release the empty universal pallets in a designated location in the transport trailer. The pallet AMRs may then depart the transport trailer and await further instructions. In some embodiments, instead of empty universal pallets being kept in the same cell, once a universal pallet is empty a pallet AMR may be instructed to transport the empty universal pallet to a storage location within the first order induction zone 12002-1 designated to receive empty universal pallets.

Upon determining that a transport trailer has a complete load of empty universal pallets, a transport truck associated with the transport trailer may transport the load of empty universal pallets with empty crates to the production facility 12100. This act of returning a load of universal pallets with empty crates may be considered to close a loop of activity between the production facility 12100 and the order fulfilment center 12000. The outbound shipment of empty universal pallets may match exactly the inbound shipment from the production facility 12100, ensuring that a same number of universal pallets with universal crates are delivered between a specific production facility 12100 and the order fulfilment center 12000 and ensuring a constant supply of SKUs and products in the supply chain.

While the empty universal pallets are transported to and loaded into a transport trailer specifically designated to receive empty universal pallets, filled universal pallets containing the appropriate SKU may arrive (or may have already arrived) at the order fulfilment center 9400. The filled universal pallets may have been filled and palletized at the production facility 12100 as described above with respect to FIGS. 99 and 100. The order fulfilment processor 12004 may instruct one or more pallet AMRs to unload the filled empty universal pallets from an appropriate inbound transport trailer, and transport them to the particular cell, so that the cell may be replenished with products.

In some embodiments, in the second order induction zone 12002-2, empty universal pallets may be kept in its designated pallet storage position within the stack storage region, as discussed. At an appropriate time as determined by the order fulfilment processor 12004, the order fulfilment processor 12004 may instruct a pallet AMR to transport the empty universal pallet into a transport trailer specifically designated to receive empty universal pallet. The pallet AMR may release the empty universal pallet in a designated location in the transport trailer. The pallet AMRs may then depart the transport trailer and await further instructions. In some embodiments, instead of empty universal pallets being kept in in its designated pallet storage position within the stack storage region, once a universal pallet is empty a pallet AMR may be instructed to transport the empty universal pallet to a storage location within the second order induction zone 12002-2 designated to receive empty universal pallets.

Upon determining that a transport trailer has a complete load of empty universal pallets, a transport truck associated with the transport trailer may transport the load of empty universal pallets with empty crates to the production facility 12100. This act of returning a load of universal pallets with empty crates may be considered to close a loop of activity between the production facility 12100 and the order fulfilment center 12000. The outbound shipment of empty universal pallets may match exactly the inbound shipment from the production facility 12100, ensuring that a same number of universal pallets with universal crates are delivered between a specific production facility 12100 and the order fulfilment center 12000 and ensuring a constant supply of SKUs and products in the supply chain.

While an empty universal pallet are transported to and loaded into a transport trailer specifically designated to receive empty universal pallets, a filled universal pallet containing the appropriate one or more SKUs for replacing the empty universal pallet may arrive (or may have already arrived) at the order fulfilment center 9400. The filled universal pallet may have been filled and palletized at the production facility 12100 as described above with respect to FIGS. 99 and 100. The order fulfilment processor 12004 may instruct one or more pallet AMRs to unload the filled empty universal pallet from an appropriate inbound transport trailer, and transport them to the designated pallet storage position within the stack storage region, so that the one or more appropriate SKUs may be replenished.

In the context of the third order induction zone 12002-3, when transport trailers are returned to the consumer products supplier that supplies products to be stored in the third order induction zone 8702-3, it is expected that the transport trailer will be returned in an empty state. The corrugated inbound cases in which products destined for the third order induction zone typically arrive, may, after being unpacked, be subjected to a process that involves collecting and compacting the cases. The collected and compacted cases may then be shipped out of the order fulfilment center 12000 to be recycled. This is process may be considered to be consistent with known order fulfilment center processes.

In some embodiments, in the shipping container induction zone, empty universal pallets may be kept in its designated pallet storage position within a storage region. At an appropriate time as determined by the order fulfilment processor 12004, the order fulfilment processor 12004 may instruct a pallet AMR to transport the empty universal pallet into a transport trailer specifically designated to receive empty universal pallet. The pallet AMR may release the empty universal pallet in a designated location in the transport trailer. The pallet AMRs may then depart the transport trailer and await further instructions.

Upon determining that a transport trailer has a complete load of empty universal pallets, a transport truck associated with the transport trailer may transport the load of empty universal pallets with empty crates to the container blank manufacturing facility 13100. This act of returning a load of universal pallets with empty crates may be considered to close a loop of activity between the container blank manufacturing facility 13100 and the order fulfilment center 12000. The outbound shipment of empty universal pallets may match exactly the inbound shipment from the container blank manufacturing facility 13100, ensuring that a same number of universal pallets with universal crates are delivered between a specific container blank manufacturing facility 13100 and the order fulfilment center 12000 and ensuring a constant supply of SKUs and products in the supply chain.

While an empty universal pallet are transported to and loaded into a transport trailer specifically designated to receive empty universal pallets, a filled universal pallet containing the appropriate one or more SKUs for replacing the empty universal pallet may arrive (or may have already arrived) at the order fulfilment center 9400. The filled universal pallet may have been filled and palletized at the production facility 12100 as described above with respect to FIGS. 104 and 105. The order fulfilment processor 12004 may instruct one or more pallet AMRs to unload the filled empty universal pallet from an appropriate inbound transport trailer, and transport them to the designated pallet storage position, so that the one or more appropriate SKUs may be replenished and used as shipping containers to fulfil customer orders.

The shipping container induction region of the order fulfilment center 12000 may include in the order of 200 carton forming systems (see, e.g., shipping container induction region 9406 of FIG. 94A). Each carton forming system may be configured to produce a unique size and style of shipping container formed or erected from blank corrugated recyclable materials, resulting in over 200 available shipping container sizes and styles. Alternatively, in some embodiments, one or more of the carton forming systems may be configured to produce more than one size and/or more than one style of shipping container formed or erected from blank corrugated recyclable materials. The variety of sizes and styles of shipping container may be shown to allow products to be packed in order-specific shipping containers. For example, refrigerated and frozen products may be packed into insulated shipping containers. As discussed briefly hereinbefore, the size and number of shipping containers employed for a given customer order may be determined by the order fulfilment processor 12004 on the basis of the sizes, types and quantities of items in the given customer order.

Upon initiation of a specific customer order, the order fulfillment processor 12004 may direct an AMR (e.g., AMR 5300 or 5800 or 5850) to the appropriate carton forming system. As the shipping container induction region of the order fulfilment center 12000 may be located on the second level of the order fulfillment center 12000 (like, e.g., shipping container induction region 9406 of FIG. 94A), if the current location of the AMR is on the first level of the order fulfilment center 12000, the AMR may travel to the second level using one of a plurality of AMR escalators (e.g., AMR escalator 9420).

The carton forming system may form a shipping container and place the formed shipping container on the AMR. As discussed hereinbefore, the AMR may be designed to hold and carry any shipping container among a wide variety of styles and sizes of shipping containers. The AMR may accept shipping containers from any one of the over 200 carton forming systems. As part of fulfilling an order, a given AMR may move a shipping container to one or more designated product induction stations, order verification stations, container sealing stations, labeling stations, rework stations, delivery route accumulation stations and discharge conveyors.

Once the AMR has received the formed shipping container, the order fulfillment processor 12004 may route the AMR to the first of a series of product induction stations as required to fulfil the specific customer order, at least partially. There may be in the order of 5,000 product induction stations in the first order induction zone 12002-1, in the order of 500 product induction stations in the second order induction zone 12002-2 and in the order of 500 product induction stations in the third order induction zone 12002-3.

In a majority (for example, 85% or more) of customer orders processed by the order fulfillment processor 12004, one or more products stored in the first order induction zone 12000-1 may be required in order to fulfil a given order. Therefore, positioning the shipping container induction region near the first order induction zone 12000-1, i.e., on the second level of the order fulfilment center 12000, may promote efficiency in terms of the distance the AMR may be required to cover to fulfil any given customer order.

AMRs that have been routed to one of the roughly 5,000 product induction stations in the first order induction zone 12002-1 may be, more particularly, directed to a specific robotic product induction station (like robotic product induction station 9100) corresponding to a specific cell storing a product required to fulfil a customer order. At the specific robotic product induction station, the AMR may receive the product from a universal crate into the shipping container carried by the AMR, using processes described in relation to FIGS. 93A-93H. The AMR may then be directed to a next product induction station on an order induction route. AMRs that have been routed to the refrigerated and frozen food sections of the first order induction zone 12002-1 may receive and carry insulated shipping containers.

The first order induction zone 12002-1 may be expected to be capable of handling standalone products that do not require a shipping container, for example, bundled cases of beverages (e.g., see fourth partition 9205-4 of FIG. 94A and the related description). These types of products may be picked directly from a crate retention structure and placed onto an available AMR, for example, using methods as described with respect to the fourth partition 9405-4. The AMR may be expected to then carry the product directly to a verification station.

AMRs that have been routed to one of the 500 product induction stations in the second order induction zone 12002-2 may be, more particularly, directed to travel to the first level of the order fulfilment center 12000 using an AMR escalator and to a particular robotic product induction station in a stack product induction region (like stack product induction region 9434R in FIG. 94B). As described hereinbefore, products are stored in the second order induction zone 12002-2 in universal crates on universal pallets. Each of the universal pallets may be considered to be fully accessible by AMRs. When a customer order includes a product stored in the second order induction zone 12002-2, the order fulfillment processor 12002 may direct a pallet AMR to retrieve the appropriate universal pallet from a designated location within the second order induction zone 12002-2 and move the appropriate universal pallet to the particular product induction station to meet another AMR carrying an appropriate shipping container. At the specific robotic product induction station, the AMR may receive the product from a universal crate into the shipping container carried by the AMR, e.g., in the manner described above with respect to stack product induction region 9434R. The AMR may be directed to one or more product induction stations in the second order induction zone 12002-2, and each of the one or more product induction stations may be expected to transfer one or more products to the AMR. The AMR may then be directed to a next product induction station on an order induction route.

Recall that each robotic product induction station in the first order induction zone 12002-1 corresponds to just one cell and therefore each robotic product induction station is permanently designated for an individual SKU. By contrast, the robotic production induction stations in the second order induction zone 12002-2 are not each assigned to a specific SKU. As such, in some embodiments, the robotic production induction stations in the second order induction zone 12002-2 induction stations may be divided by general product type. The product type may determine a preferred end effector style to be used by the robotic production induction stations. For example, certain product types may be more suited for handling by an end effector with claws, while other product types may be more suited for handling by an end effector with clamping devices. In some embodiments, there may be six product types, which may include: bagged product; bottled product; canned product; carton product; and wrapped product.

AMRs that have been routed to one of the roughly 500 product induction stations in the third order induction zone 12002-3 may be, more particularly, directed to a manual product induction station in a tower product induction region (e.g., tower product induction region 9434T of FIG. 94B). At the manual product induction station, an associate may pick a product from a location in a tower and place the product into the shipping container carried by an AMR. The associate may be expected to pick multiple products to fulfill a customer order. The AMR may then be directed to a next product induction station on an order induction route.

While various stages of order fulfilment are described hereinbefore as being distinct for the three distinct order induction zones 12002-1, 12002-3 and 12002-3, the remaining stages are common for all three distinct order induction zones 12002-1, 12002-3 and 12002-3. The remaining stages may take place at an order verification and sealing region and a route distribution accumulation region 9450 (e.g., see order verification and sealing region 9440 and route distribution accumulation region 9450 in FIG. 94B).

Shipping containers or unpackaged (standalone) products, on respective AMRs, that have completed respective product induction routes are directed to a shipping container verification station among, say, 200 shipping container verification stations. Using tests that involve, for example, vision and check weighing technology, the shipping container verification station may be expected to perform a variety of checks on the shipping container while the shipping container is on the AMR. Shipping containers that fail the tests may be directed, on the AMR, to a manual rework station, at which an associate may act to correct an issue with the order and reroute AMR carrying the shipping container back through the verification station. Shipping containers that pass all of the tests may be directed to a dunnage inserting station (if necessary) or to a shipping container top closing system.

Due to a mismatch between dimensions of a given product and dimensions of a shipping container, the shipping container may benefit from the addition of dunnage. Dunnage may be seen to protect the given product during so-called last mile deliveries. Unpackaged products, for example, bundles of water bottles may be understood to not require dunnage. Verified shipping containers identified as potentially benefitting from dunnage may be directed to a shipping container dunnage insertion station among, say, 20 shipping container dunnage insertion stations. The shipping container dunnage insertion stations may insert an amount of dunnage directly into the shipping container while the shipping container is carried upon the AMR. The dunnage in the shipping container may be verified in a manner that allows any shipping container with dunnage that cannot be verified to be directed, on the AMR, to a manual rework station. At the manual rework station, an associate may correct the issue and reroute the shipping container to a shipping container top closing and sealing station among, say, 200 shipping container top closing and sealing stations.

At the top closing and sealing station, it may be expected that the open top of the shipping container is subjected to a process involving closing and sealing, while the shipping container is on the AMR. The shipping container is, generally, not disengaged from the AMR through the entire closing and sealing process. A closure on the shipping container may be inspected with a vision system. Successfully verified shipping containers may then be directed to a shipping container labeling station. A shipping container associated with a failed inspection may be directed, on the AMR, to a manual rework station, at which an associate may attempt to correct the issue that caused the failure and direct an AMR with verified shipping container to a labeling station.

It may be expected that a majority, for example, 95%, of customer orders will involve more than one shipping container and, accordingly, more than one shipping label and/or radio frequency identification (RFID) tag. It may further be expected that use of a so-called “print and apply” type of label will provide a given shipping container with all information involved in routing, accumulating, expediting, tracking and tracing the given shipping container throughout the last mile delivery process. The labels may be verified for accuracy. An AMR carrying a shipping container with a label that has failed verification may be directed to a manual rework station. At the manual rework station, an associate may take steps to correct the failed verification.

To ensure that the delivery vehicles are loaded in a “First-in-Last-out” (“FILO”), the order fulfillment processor may cause shipping containers on AMRs, associated with a single customer order, to accumulate in an accumulation area. Ideally, all of the shipping containers associated with the single customer order may be grouped prior to the entire grouped customer order being sent, in an ordered sequence, to a discharge conveyor.

At the discharge conveyor, 100-300 shipping containers may accumulate with a designated route in common. The AMRs may be directed to the discharge conveyors in a FILO sequence. As a delivery vehicle is being loaded, shipping containers may accumulate in a FILO sequence that matches delivery vehicle route sequence.

Discharge conveyors may be expected to move shipping containers to a vehicle loading position in the FILO Sequence. The last mile delivery associate (see robots and/or personnel 7998 in FIG. 82B) may be expected to load the shipping containers into the delivery vehicle in the FILO sequence that is closely related to a pre-planned route sequence. This may be seen to reduce sorting of the shipping containers during the product deliveries. The shipping containers may be scanned as the shipping containers are loaded onto the delivery vehicle to establish accurate and sequential delivery. Upon completion of the loading, the delivery vehicle driver may commence delivering the products that have been loaded onto the delivery vehicle.

The driver of the delivery vehicle may guide the delivery vehicle to follow directions to various customer drop-off locations along a delivery route. The driver of the delivery vehicle may unload the shipping containers at each customer drop-off location. Conveniently, due to well-planned loading of shipping containers onto the delivery vehicle, sorting of the shipping containers during unloading is obviated.

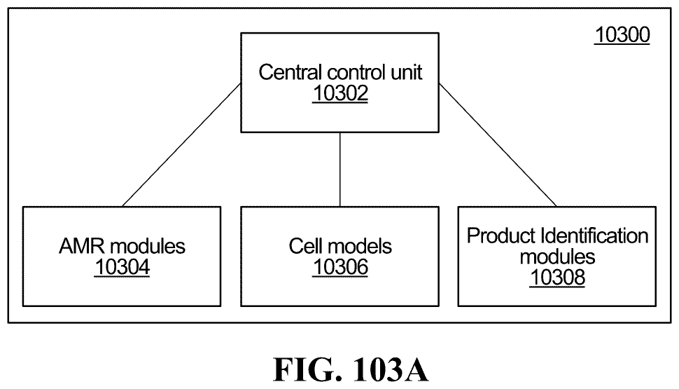

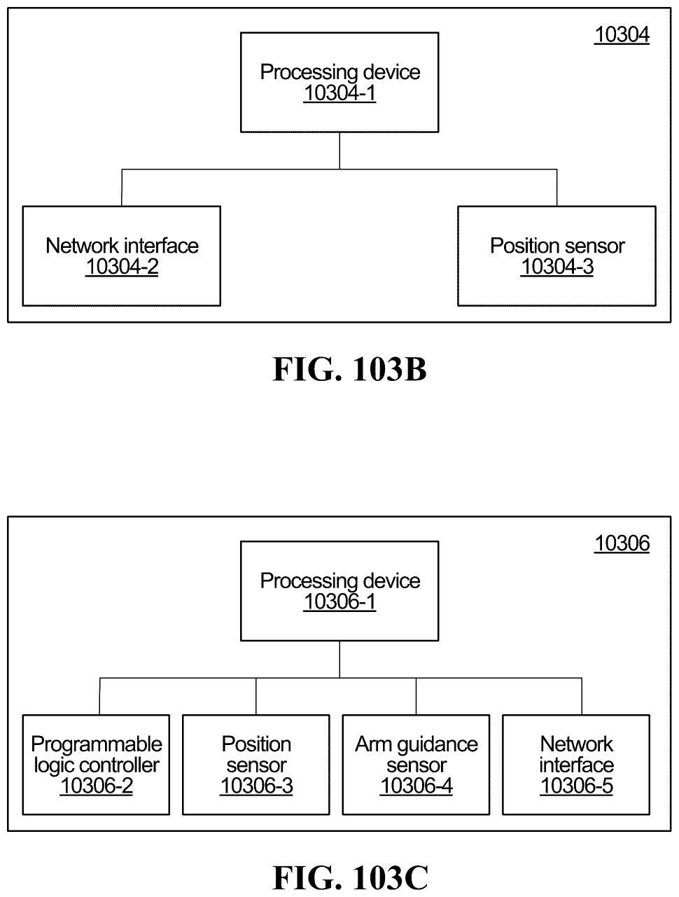

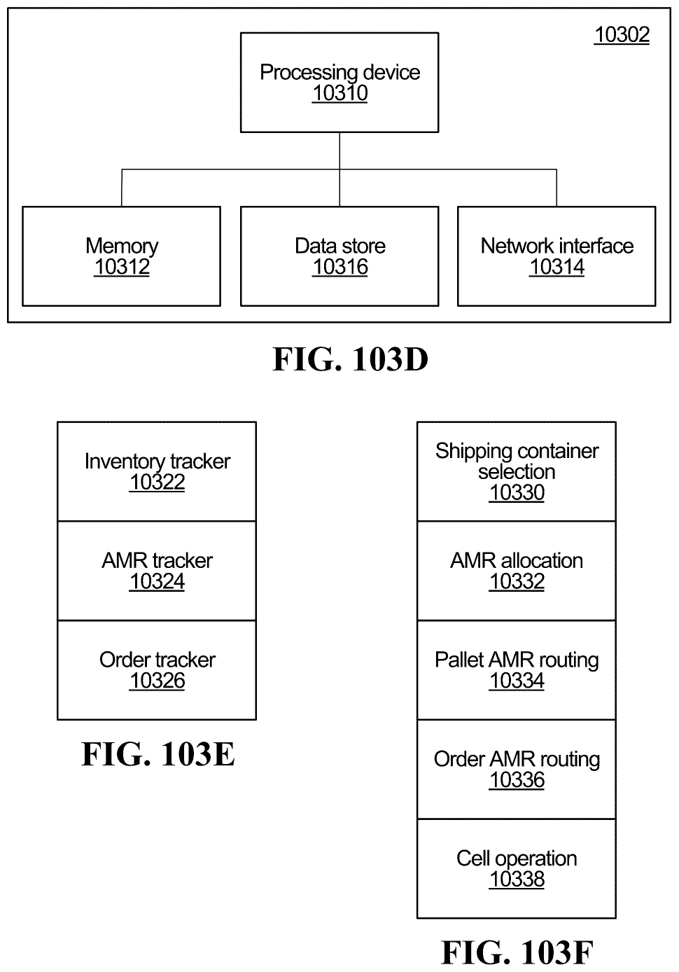

FIG. 103A depicts components of an example control system 10300 at the fulfilment center 9400. The control system 10300 is responsible for directing and coordinating operation of equipment in the fulfilment center 9400, including the shipping container AMRs 5800/5850, the pallet AMRs 9000, the tower transportation AMRs 7518, the lifting arms 9102 and 11004 and the picker arms 9104 and 11007.

As depicted in FIG. 103A, the control components may include a central control unit 10302. The control components may further include a plurality of AMR modules 10304, a plurality of cell modules 10306 and a plurality of product identification modules 10308.

The AMR modules 10304, the cell modules 10306 and the product identification modules 10308 may be implemented as peripheral devices connected to the central control unit 10302, or as separate systems interconnected with the central control unit 10302 over one or more networks. Such networks may, for example, be IPv4, IPv6, X.25, IPX-compliant or similar networks (e.g., the public Internet).

FIG. 103B depicts example components of an AMR module 10304. Each AMR 5800/5850, 9000, 7518 may be associated with an AMR module, which may be physically located at the AMR or which may be wirelessly connected to the AMR. The AMR module 10304 includes a processing device 10304-1, a network interface 10304-2 and a position sensor 10304-3. The processing device 10304-1 communicates with the central control unit 10302 to receive operational instructions from a processing device 10310 (see FIG. 103D) and to send status information to the processing device 10310. For example, the central control unit 10302 may send instructions to an AMR module 10304, causing the associated AMR to perform operations. The operations may include moving to a specified location, picking up or unloading a pallet or tower, picking up or unloading a shipping container, or receiving picked products in a shipping container. The instructions may cause the AMR to perform multiple ones of these operations in a specified sequence. An AMR module 10304 may send, to the central control unit 10302, messages, such as messages identifying the current position of the associated AMR or messages notifying the central control unit 10302 of completion of operations. For example, a pallet AMR module 10304 may send, to the central control unit 10302, a message confirming that a pallet has been unloaded and the position of the corresponding pallet AMR and, thus, the position of the pallet. Communications with the central control unit 10302 may occur over the network interface 10304-2. The processing device 10304-1 may determine the position of the associated AMR using one or more position sensors. The position sensors may include, for example, optical sensors for measurement of positions relative to markers or landmarks such as barcodes, QR codes, light beacons or the like, distributed throughout relevant portions of the fulfilment center 9400. Additionally or alternatively, the position sensors may include one or more wireless positioning system receivers, such as GPS receivers. Additionally or alternatively, the position sensors may allow for computation of position based on network infrastructure. For example, distance from a network access point may be inferred based on signal strength and distances from multiple network access points may be used to triangulate a location. Locations may be expressed, for example, in terms of a 2-dimensional or 3-dimensional coordinate system.

FIG. 103C depicts example components of an example one of the cell modules 10306. Each cell at the cell product storage region 9402C (FIG. 94A) and each induction station 9100 at the stack storage region 9402R may be associated with a corresponding one of the cell modules 10306. The cell module 10306 may direct operation of the lifter arms and picker arms at the respective cell or induction station.

Each cell module 10306 may include a processing device 10306-1 and one or more programmable logic controllers (PLCs) 10306-2. The PLCs 10306-2 may be configured to operate the lifting arms 9102/11004 and the picker arms 9104/11007. The PLCs 10306-2 may be discrete physical devices or may be virtualized in a suitable computing environment executed by the processing device 10306-1. The arms 9102/11004 and 9104/11007 may further be equipped with one or more position sensors 10306-3 for measuring and reporting their respective positions. The position sensors 10306-3 may be optical sensors, drive sensors operable to record movement of the arms in one or more axes, magnetic sensors, RF sensors, or any other suitable type of sensors. The position sensors 10306-3 may be used to measure proximity and position of an arm relative to an article to be manipulated. For example, a particular one of the position sensors 10306-3 may be used to precisely position a lifting arm to lift the desired universal crates 8900 in a stack 8902. Each cell module 10306 may also include one or more arm guidance sensors 10306-4 for coordinating pick up of articles from within a stack 8902. In some examples, the guidance sensors 10306-4 may include stereoscopic optical sensors such as cameras. As will be apparent to skilled persons, images acquired using such stereoscopic sensors may be used to determine the location and contours of an object to be picked up. The picker arm 9104 may, therefore, be directed to grasp and retain an article for transfer to a shipping container. Each cell module 10306 may further include a network interface 10306-5 for facilitating communication between the cell module 10306 and the central control unit 10302, for example, to send and receive instructions and status messages. The cell module 10306 may receive instructions from the central control unit 10302 for lifting universal crates 8900 above an identified desired crate 8900 in a stack 8902 to, thereby, provide access to the desired crate 8900. The cell module 10306 may further receive instructions from the central control unit 10302 for picking an identified quantity of an identified product from the desired crate 8900. The cell module 10306 may send status messages to the central control unit 10302 indicating that the identified product has been picked from the desired crate 8900. The processing device 10310 may, for example, adjust inventory levels or update order tracking accordingly.

Each product identification module 10308 may comprise one or more sensors for reading identification information of products received at fulfillment center 9400. The sensors may comprise, for example, optical scanners such as barcode or QR code scanners, RF tag readers, manual input terminals, or any other suitable devices for identification of products. Products may be identified based on one or more SKUs and associated quantities in a crate 8900 or stack 8902 of crates 8900. Product identification modules 10308 may be interconnected with the central control unit 10302, e.g., via a network connection. The product identification modules 10308 may be operable to acquire identification information from products received at the fulfilment center 9400 and to send messages reflecting such identification information to the central control unit 10302 to be used, e.g., for inventory tracking and order fulfilment.

FIG. 103D depicts details of an example of components for the central control unit 10302. As depicted, the central control unit 10302 includes the processing device 10310, a memory 10312, a network interface 10314 and a data store 10316. The central control unit 10302 may be implemented using a dedicated specialized or generalized computer, such as an industrial computer based on intel or AMD processors using the x86 instruction set. Other suitable platforms may be used, such as platforms using ARM-based processors, as will be apparent to skilled persons. The network interface 10314 may be any suitable wired or wireless interface for communicating over networks as discussed above. The data store 10316 may be any suitable computer-readable storage and may be local to the central control unit 10302 or network (e.g., cloud) connected.

The data store 10316 may include one or more applications (see FIG. 103F) and one or more data structures (see FIG. 103E) for tracking inventory and orders and for directing and tracking operation of equipment within the fulfilment center 9400.

As depicted in FIG. 103E, the data structures may include an inventory tracker 10322, an AMR tracker 10324 and an order tracker 10326. The data structures may, for example, be implemented as tables of a relational database. Other suitable structures may be used, as will be apparent to skilled persons.

The inventory tracker 10322 may be used to maintain records of all products (e.g., items to be used in fulfilling customer orders or shipping container blanks to be erected and used to contain and transport such items) available within the fulfilment center 9400. For example, the inventory tracker 10322 may include records of: all cells within the cell product storage region 9402C; records of all stack locations within the stack storage region 9402R; records of all towers within the tower storage region 9402T; and SKUs available at each cell, stack location and tower. It will be appreciated that the inventory tracker 10322 may one or both of: correlate SKUs to cells, stack locations and towers, i.e., record SKUs corresponding to each cell, stack location or tower; and correlate cells, stack locations and towers to SKUs, i.e., record each cell, stack location and tower at which a SKU is available.

The inventory tracker 10322 may also store physical locations corresponding to each cell, stack location and tower, e.g., locations measured on a coordinate system within the fulfilment center 9400, such that AMRs can be directed to pick up a crate 8900, stack 8902 of crates or a product, as desired.

Records of SKU characteristics may also be incorporated into or associated with the inventory tracker 10322. The records may define, for example, physical characteristics of units of each SKU available within the fulfillment center 9400. The physical characteristics may include, for example, the physical height, width, depth and weight of an article of that SKU. The physical characteristics may further include the number of articles in a crate 8900 of that SKU and the height, width, depth and weight of such crate 8900.

The AMR tracker 10324 may, for example, maintain records of each AMR within the fulfilment center 9400, location information for each AMR (e.g., location in a fulfilment center coordinate system) and task information for each AMR. The task information may define, for example, whether each AMR is idle or occupied and a destination to which the AMR is headed. The task information may further define an operation to which an AMR is assigned. For example, a shipping container AMRs 5800/5850 may be assigned to an order number for accumulating articles in that order and the task information may include an identifier of the assigned order for a shipping container AMR. Similarly, a tower transportation AMR 7518 may be assigned, e.g., to an order number or to a product induction station to which the tower transportation AMR is directed. The task information for tower transportation AMRs 7518 may include identifiers of one or both of order numbers and product induction stations. The pallet AMRs 9000 may be assigned to a particular SKU, or to a particular cell, and task information may include identifiers of such SKUs or cells.

The order tracker 10326 may include records for orders being fulfilled or to be fulfilled in the fulfillment center 9400. Each order record may include an order identifier, a list of products (SKUs and associated quantities) in the order, a shipping container identifier listing a particular type of shipping container to be used with the order, and one or more of shipping container AMR identifiers and product induction station identifiers for accumulation of products for the order.

As shown in FIG. 103F, applications at the central control unit 10302 may include: a shipping container selection application 10330; an AMR allocation application 10332; a pallet AMR routing application 10334; an order AMR routing application 10336; and a cell operation application 10338.

The shipping container selection application 10330 may be operable to acquire order details (e.g., a list of articles to be included in an order and associated sizes) and to select one or more appropriate shipping containers to hold the order. The shipping container may be selected from a plurality of available shipping containers of varying sizes and construction based on the sizes of the included articles, as described above. The shipping container selection application returns an identification of a selected shipping container type. Based on that identification, the central control unit 10302 selects a shipping container delivery system for supplying the selected shipping container.

The AMR allocation application 10332 may be operable to track positions of AMRs within the fulfillment center 9400 and to assign AMRs for completion of order and inventory processing tasks. For example, The AMR allocation application 10332 may acquire details of an order to be fulfilled. The details may include, for example, a list of articles and corresponding locations, as well as an identifier of one or more shipping containers with corresponding locations, expressed as coordinates, or as an identification of a shipping container delivery system at which a shipping container is available. The AMR allocation application 10332 may search AMR tracking records to identify one or more shipping container AMRs 5800/5850 to be used.

The AMR allocation application 10332 may also acquire details of products arriving at fulfilment center 9400. The details may, for example, include product identification and quantity for one or more SKUs, acquired using the product identification module 10308. For example, one or more product SKUs and associated quantities in a crate or stack of crates may be read by scanning a barcode or QR code associated with the crate or stack of crates. The product details may also include a location, e.g., based on the location of the product identification module or the location of a transport trailer from which the products are to be unloaded. The AMR allocation application 10332 may search AMR tracking records to identify one or more pallet AMRs 9000 to be used.

The AMR allocation application 10332 may employ a suitable AMR allocation and tracking algorithm for choosing AMRs. In an example, the AMR allocation and tracking algorithm may search AMR records to identify an idle AMR. The AMR allocation application 10332 may, for example, scan all records of idle AMRs and associated locations and select the idle AMR that is closest to the article to be handled (e.g., shipping container or stack of crates). Other strategies may additionally or alternatively be used. For example, the AMR allocation application 10332 may select the first idle AMR that is within a maximum threshold distance from the article to be handled.

The AMR allocation application 10332 may output an identification of one or more AMRs selected to handle a shipping container or stack of crates. The central control unit 10302 may then send instructions to selected AMRs, as described herein.

The pallet AMR routing application 10334 may provide instructions for directing pallet AMRs 9000 to locations for performing inventory or order operations. For example, when a product is received at the fulfillment center 9400, the pallet AMR routing application 10334 may determine a location at which a received product is to be stored, e.g., a cell within the cell storage region 9402C or a position within the stack storage region 9402R and output an identification of that location. In an example, the pallet AMR routing application 10334 may receive an identification of a crate 8900 or a stack 8902 on a pallet to be stored (e.g., by SKU) and output instructions for a pallet AMR 9000 to take the crate 8900 or the stack 8902 on the pallet to a selected storage location (e.g., a location in the rack storage region 9402 or a cell in the cell storage region 9402C). In an example, the pallet AMR routing application 10334 may search the inventory tracker 10322 for an existing location at which the SKU is stored and at which additional capacity exists, and if such a location is found, may output an identification of that location. If the SKU is not yet stored at any location with available capacity, a vacant location may be selected and output.

The pallet AMR routing application 10334 may also receive an identifier of a product to be picked for an order in the rack storage region 9402R and based on the inventory tracker 10322, output instructions for a pallet AMR to pick up a pallet containing that product and bring it to a product induction station.

The order AMR routing application 10336 may receive order details including a list of products to be included in an order, along with an identification of a shipping container AMR 5800/5850 selected to handle the order. The order AMR routing application 10336 may then determine a location associated with each product in the order and generate a series of instructions for causing that shipping container AMR 5800/5850 to proceed to each of the locations in turn.

The cell operation application 10338 may be operable to coordinate unloading of products at robotic product induction stations 9100. For example, the cell operation application 10338 may determine which crate 8900 in a stack 8902 contains the desired SKU, and may direct the product induction stations 9100 to allow access to that crate by lifting the crates above. Such determination may be based on inventory information recorded in the inventory tracker 10322, or by tracking progress of unloading a crate 8900, i.e., tracking removal of products to determine when the crate 8900 has been emptied, and lifting empty crates to provide access to additional products.

While the above applications have been depicted as discrete components, it will be appreciated that some or all of the above functions may be combined in a single component.

The control system 10300, including the above-described applications and data structures, may send instructions to equipment of the fulfillment center to perform the method of FIG. 57, with movement of AMRs and transfer of products into shipping containers on shipping container AMRs being directed by instructions produced by the above applications.

The control system 10300 may include other components in addition to those described above. The above-described arrangement of components is an example only.

For example, while the above example depicts a single central control unit 10302 and a single processing device 10310, the functionality of such components may be distributed across multiple discrete control units and multiple processing devices. Components may be implemented in hardware (e.g., physical PLCs) or in software (e.g., virtualized PLCs), or any combination thereof. The central control unit 10302, the AMR modules 10304, the cell modules 10306 and the product identification modules 10308 may be implemented in separate physical devices, or any of the modules or their functionality may be integrated into the central control unit 10302. For example, the sensors of the AMR modules 10304, the cell modules 10306 and the product identification modules 10308 may be physically installed at the respective equipment and may communicate, e.g., over a network connection, with centralized control modules. Alternatively, functions of the central control unit 10302, such as the applications or portions of the applications described above may additionally or alternatively be incorporated in the AMR modules 10304, the cell modules 10306 and the product identification modules 10308.

Of course, the above described embodiments are intended to be illustrative only and in no way limiting. The described embodiments of carrying out the aspects of the present application are susceptible to many modifications of form, arrangement of parts, details and order of operation. The present application, rather, is intended to encompass all such modifications within its scope, as defined by the claims.

When introducing elements of aspects of the present application or the embodiments thereof, the articles “a,” “an,” “the” and “said” are intended to mean that there are one or more of the elements. The terms “comprising,” “including” and “having” are intended to be inclusive and mean that there may be additional elements other than the listed elements.

1. A fulfillment system comprising:
a first product induction region including:
a plurality of product storage apparatuses, each product storage apparatus, among the plurality of product storage apparatuses, holding a plurality of products; and
a first product transfer apparatus operable to transfer a first product, among a first plurality of products held by a first product storage apparatus among the plurality of storage apparatuses, into a shipping container;
a shipping container autonomous mobile robot (AMR);
a shipping container delivery system operable to deliver the shipping container to the shipping container AMR;
the shipping container AMR operable to:
travel, according to shipping container AMR instructions, to the shipping container delivery system;
wait, at the shipping container delivery system, to receive the shipping container;
travel, while holding the shipping container and according to the shipping container AMR instructions, to the first product transfer apparatus;
wait, at the first product transfer apparatus and according to shipping container AMR instructions, for the first product to be transferred, by the first product transfer apparatus, from the product storage apparatus into the shipping container; and
travel, while holding the shipping container with the first product inside and according to the shipping container AMR instructions, to at least one location for further processing of the shipping container.

2. The fulfillment system claimed in claim 1, further comprising:
a control system including a processor, the processor operable to:
generate shipping container delivery system instructions; and
generate the shipping container AMR instructions;
wherein the shipping container delivery system is configured to:
receive, from the processor, the shipping container delivery instructions; and
according to the shipping container delivery instructions, deliver the shipping container to the shipping container AMR;
the shipping container AMR configured to receive, from the processor, the shipping container AMR instructions.

3. The fulfillment system as claimed in claim 2, wherein the plurality of product storage apparatuses comprises a plurality of pallets within the first product induction region, each pallet, among the plurality of pallets, holding the plurality of products, and wherein the first product storage apparatus comprises a selected pallet selected, by the processor, from among the plurality of pallets.

4. The fulfillment system as claimed in claim 3, wherein the selected pallet is located at a first pallet storage position in the first product induction region.

5. The fulfillment system as claimed in claim 1, wherein selected pallet holds a plurality of products corresponding to a single stock keeping unit.

6. The fulfillment system as claimed in claim 4 or claim 5, wherein the first product induction region includes the plurality of pallets located at a respective plurality of pallet storage positions.

7. The fulfillment system as claimed in claim 6, wherein the plurality of pallet storage positions are positioned in a row.

8. The fulfillment system as claimed in claim 7, wherein the first pallet storage position is positioned at a first end position of the row of the pallet storage positions.

9. The fulfillment system as claimed in any one of claims 3 to 8, wherein the first product transfer apparatus comprises a robotic picking apparatus controlled by the processor.

10. The fulfillment system as claimed in claim 9, wherein the first product is held directly upon the selected pallet.

11. The fulfillment system as claimed in claim 9, wherein the first product is held in a crate and the crate is supported on the selected pallet.

12. The fulfillment system as claimed in claim 11, wherein the crate comprises a first crate of a plurality of crates and wherein the plurality of crates are stacked vertically in series on top of each other in a crate stack supported on the selected pallet.

13. The fulfillment system as claimed in claim 12, wherein at least some crates among the plurality of crates contain at least one product among the plurality of products.

14. The fulfillment system as claimed in claim 13, wherein each crate among the plurality of crates contains at least one product among the plurality of products.

15. The fulfillment system as claimed in claim 12, 13 or 14, wherein the plurality of crates are stacked vertically in a nested arrangement.

16. The fulfillment system as claimed in any one of claims 12 to 15, further comprising a crate lifting apparatus controlled by the processor and operable to lift all crates in the crate above the first crate, to expose a top opening of the first crate, thereby allowing the robotic picking apparatus to pick up the first product and transfer the first product to the shipping container.

17. The fulfillment system as claimed in claim 16, further comprising a lid covering an open top of a top crate in the crate stack.

18. The fulfillment system as claimed in claim 17, wherein the lid is constructed of a weight sufficient to stabilize the crate stack.

19. The fulfillment system as claimed in claim 17 or 18, wherein the crate lifting apparatus is further operable to lift just the lid from the top crate in the crate stack, to expose the open top of the top crate.

20. The fulfillment system as claimed in any one of claims 3 to 19, further comprising:
a second product induction region, wherein the second product induction region includes a product tower, the product tower including a plurality of compartments for storing products, and wherein at least one compartment among the plurality of compartments includes one or more products, the one or more products corresponding with at least one stock keeping unit; and
a second product transfer apparatus operable to transfer a second product from the product tower to the shipping container;
wherein the shipping container AMR is further operable to:
travel, while holding the shipping container with the first product inside and according to the shipping container AMR instructions, to the second product transfer apparatus;
wait, at the second product transfer apparatus, for a second product to be transferred, by the second product transfer apparatus, from the product tower into the shipping container; and
travel, while holding the shipping container with the first product and the second product inside and according to the shipping container AMR instructions, to at least one further location for further processing of the shipping container.

21. The fulfillment system as claimed in claim 20, further comprising a tower-transportation AMR, and wherein the processor is further operable to generate instructions for the tower-transportation AMR to move the product tower to the second product transfer apparatus in the second product induction region.

22. The fulfillment system as claimed in claim 20 or 21, wherein each compartment among the plurality of compartments includes one or more products, the one or more products corresponding with a plurality of stock keeping units.

23. The fulfillment system as claimed in claim 20, 21 or 22, wherein the product tower comprises a selected product tower and wherein the second product induction region comprises a plurality of product towers.

24. The fulfillment system as claimed in claim 23, wherein the processor is further operable to generate instructions for a plurality of tower-transportation AMRs to independently move the plurality of product towers to a plurality of product transfer apparatuses in the second product induction region.

25. The fulfillment system as claimed in claim 24, wherein the plurality of product towers stores products representative of more than 500,000 stock keeping units.

26. The fulfillment system as claimed in any one of claims 20 to 25, wherein the second product transfer apparatus comprises an individual.

27. The fulfillment system as claimed in claim any one of claims 20 to 26, further comprising:
a third product induction region, wherein the third product induction region includes a third region pallet, the third region pallet holding a plurality of products, the plurality of products corresponding with a plurality of stock keeping units;
a third product transfer apparatus operable to transfer a third product from the third region pallet into the shipping container;
wherein the shipping container AMR is further configured to:
travel, while holding the shipping container and according to shipping container AMR instructions, to the third product transfer apparatus at which is located the third region pallet;
wait, at the third product transfer apparatus and according to shipping container AMR instructions, for the third product to be transferred, from the third region pallet into the shipping container; and
travel, while holding the shipping container with the first product, the second product and the third product inside and according to shipping container AMR instructions, to a location for further processing of the shipping container.

28. The fulfillment system as claimed in claim 27, wherein the third region pallet is located at a second pallet storage position in the third product induction region.

29. The fulfillment system as claimed in claim 27 or 28, wherein the third product induction region comprises a plurality of pallets that store a plurality of products on each pallet among the plurality of pallets at a plurality of third region pallet storage positions.

30. The fulfillment system as claimed in claim 29, wherein the selected pallet comprises a first selected pallet and wherein a second selected pallet is selected by the processor from the plurality of third region pallets.

31. The fulfillment system as claimed in claim 30, further comprising a pallet AMR, and wherein the processor is further operable to generate pallet AMR instructions, wherein the pallet AMR is operable to:
receive, from the processor, the pallet AMR instructions;
according to the pallet AMR instructions, travel to the selected pallet in the first product induction region and move the selected pallet into proximity with the shipping container AMR holding the shipping container.

32. The fulfillment system as claimed in claim 31, wherein the pallet AMR is operable, according to the pallet AMR instructions, after the first product has been transferred from the first selected pallet to the shipping container, to move the selected pallet away from the shipping container AMR holding the shipping container.

33. The fulfillment system as claimed in claim 32, wherein the pallet AMR is operable, according to the pallet AMR instructions, after the first product has been transferred from the first selected pallet into the shipping container, to move the selected pallet to a second pallet storage position in the first induction region.

34. The fulfillment system as claimed in claim 33, further comprising a second pallet AMR and wherein the processor is further operable to generate second pallet AMR instructions wherein the second pallet AMR is configured to:
receive, from the processor, the second pallet AMR instructions;
according to the second pallet AMR instructions, travel to the second selected pallet in the third product induction region and move the second selected pallet into proximity with the shipping container AMR holding the shipping container;
according to the second pallet AMR instructions, after the second product has been transferred from the second selected pallet to the shipping container, move the second selected pallet to the first pallet storage position or a second pallet storage position in the third product induction region.

35. The fulfillment system as claimed in claim 1, wherein selected pallet holds a plurality of products corresponding to a plurality of stock keeping units.

36. The fulfillment system as claimed in claim 3, wherein the selected pallet comprises a first region pallet, the fulfillment system further comprising:
a second product induction region, wherein second product induction region includes a second region pallet, the second region pallet holding a plurality of products, the plurality of products corresponding with a plurality of stock keeping units;
a second product transfer apparatus operable to transfer a second product from the second region pallet into the shipping container;
wherein the shipping container AMR is further configured to:
travel, while holding the selected shipping container and according to the shipping container AMR instructions, to the second product transfer apparatus at which is located the third region pallet;
wait, at the second product transfer apparatus and according to the shipping container AMR instructions, for a second product to be transferred from the second region pallet into the shipping container; and
travel, while holding the shipping container with the first product and the second inside and according to the shipping container AMR instructions, to at least one further location for further processing of the selected shipping container.

37. The fulfillment system as claimed in claim 4, wherein the selected pallet includes a first selected pallet and the processor is further operable to generate first pallet AMR instructions and wherein the fulfillment system further comprises:
a first pallet AMR configured to:
receive, from the processor, the first pallet AMR instructions;
according to the first pallet AMR instructions, travel to a pallet receiving location and, at the pallet receiving location, engage a second selected pallet;
according to the first pallet AMR instructions:
travel, while engaging the second selected pallet, to a second pallet storage position in the first product induction region; and
release the second selected pallet at the second pallet storage position, wherein the second selected pallet holds at least one product, the at least one product corresponding with at least one stock keeping unit.

38. The fulfillment system as claimed in claim 37, wherein the pallet receiving location comprises a location within the storage area of a selected transport trailer.

39. The fulfillment system as claimed in claim 38, wherein the at least one product is held in a crate and the crate is supported on the second selected pallet.

40. The fulfillment system as claimed in claim 37, 38 or 39, further comprising a second pallet AMR and wherein the processor is further operable to generate second pallet AMR instructions wherein the second pallet AMR is configured to:
receive, from the processor, the second pallet AMR instructions;
according to the second pallet AMR instructions, travel to the first selected pallet in the first product induction region and move the first selected pallet into proximity with the shipping container AMR holding the shipping container;
according to the second pallet AMR instructions, after the first product has been transferred from the first selected pallet to the shipping container, move the first selected pallet to the first pallet storage position or a second pallet storage position in the first product induction region.

41. The fulfillment system as claimed in claim 4, further comprising a pallet AMR, and wherein the processor is further operable to generate pallet AMR instructions, wherein the pallet AMR is operable to:
receive, from the processor, the pallet AMR instructions;
according to the pallet AMR instructions, travel to the selected pallet in the first product induction region and move the selected pallet into proximity with the shipping container AMR holding the shipping container.

42. The fulfillment system as claimed in claim 41, wherein the selected pallet comprises a first region pallet, the fulfillment system further comprising:
a second product induction region, wherein second product induction region includes a second region pallet, the second region pallet holding a plurality of products, the plurality of products corresponding with a plurality of stock keeping units;
a second product transfer apparatus operable to transfer a second product from the second region pallet into the shipping container;
a second pallet AMR;
wherein the processor is further operable to generate second pallet AMR instructions;
wherein the second pallet AMR is configured to:
receive, from the processor, the second pallet AMR instructions;
according to the second pallet AMR instructions:
travel to the second region pallet in the second product induction region; and
move the second region pallet into proximity with the shipping container AMR holding the shipping container; and
according to the second pallet AMR instructions, after the second product has been transferred from the second region pallet to the shipping container, move the second selected pallet to the first pallet storage position or a second pallet storage position in the second product induction region.

43. The fulfillment system as claimed in claim 41, wherein the pallet AMR is operable, according to the pallet AMR instructions, after the first product has been transferred from the first selected pallet to the shipping container, to move the selected pallet away from the shipping container AMR holding the shipping container.

44. The fulfillment system as claimed in claim 43, wherein the pallet AMR is operable, according to the pallet AMR instructions, after the first product has been transferred from the first selected pallet into the shipping container, to move the selected pallet to a second pallet storage position.

45. The fulfillment system as claimed in any one of claims 41-44, wherein the first product transfer apparatus comprises a robotic picking apparatus controlled by the processor and operable to transfer the first product from the first selected pallet to the shipping container.

46. The fulfillment system as claimed in claim 45, wherein the first product is held in a crate and the crate is supported on the selected pallet.

47. The fulfillment system as claimed in claim 46, wherein the crate comprises a first crate of a plurality of crates and wherein the plurality of crates are stacked vertically in series on top of each other in a crate stack.

48. The fulfillment system as claimed in claim 47, wherein at least some of the plurality of crates contain at least one product.

49. The fulfillment system as claimed in claim 47, wherein each of the plurality of crates contain at least one product.

50. The fulfillment system as claimed in claim 47, 48 or 49, wherein the plurality of crates are stacked vertically in a nested arrangement.

51. The fulfillment system as claimed in any one of claims 47 to 50, further comprising a crate lifting apparatus controlled by the processor and operable to lift all crates in the crate stack above the crate holding the first product to expose a top opening of the crate holding the first product, such that the robotic apparatus is operable to pick up the first product and transfer the first product to the shipping container.

52. The fulfillment system as claimed in claim 51, further comprising a lid covering an open top of a top crate in the crate stack.

53. The fulfillment system as claimed in claim 52, wherein the lid is constructed of a weight sufficient to stabilize the crate stack.

54. The fulfillment system as claimed in claim 52 or 53, wherein the crate lifting apparatus is further operable to lift just the lid from the top crate in the crate stack, to expose the open top of the top crate.

55. The fulfillment system as claimed in claim 3, further comprising:
a plurality of first product transfer apparatuses operable to transfer a plurality of products from the plurality of pallets, into the shipping container;
a plurality of pallet AMRs and wherein the processor is further operable to generate pallet AMR instructions for controlling the plurality of pallet AMRs;
wherein the plurality of pallet AMRs are configured to:
receive, from the processor, the pallet AMR instructions;
according to the pallet AMR instructions, travel to a plurality of selected pallets in the first product induction region and move the plurality of selected pallets into proximity with a respective plurality of shipping container AMRs holding a respective plurality of shipping containers; and
according to the pallet AMR instructions, after a plurality of products have been transferred from the plurality of selected pallets to the plurality of shipping containers, move the plurality of selected pallets to a plurality of respective pallet storage positions.

56. The fulfillment system as claimed in claim 34, further comprising:
a plurality of first product transfer apparatuses operable to transfer a plurality of products from the plurality of pallets, into the shipping container;
a plurality of pallet AMRs and wherein the processor is further operable to generate pallet AMR instructions for controlling the plurality of pallet AMRs;
wherein some of the plurality of pallet AMRs are configured to:
receive, from the processor, the pallet AMR instructions;
according to the pallet AMR instructions, travel to a plurality of selected pallets in the first product induction region and move the plurality of selected pallets into proximity with a respective plurality of shipping container AMRs holding a respective plurality of shipping containers; and
according to the pallet AMR instructions, after a plurality of products have been transferred from the plurality of selected pallets to the plurality of shipping containers, move the plurality of selected pallets to a plurality of respective pallet storage positions in the first product induction region;
wherein others of the plurality of pallet AMRs are configured to:
receive, from the processor, the pallet AMR instructions;
according to the pallet AMR instructions, travel to a plurality of selected pallets in the third product induction region and move the plurality of selected pallets into proximity with a respective plurality of shipping container AMRs holding a respective plurality of shipping containers; and
according to the pallet AMR instructions, after a plurality of products have been transferred from the plurality of selected pallets to the plurality of shipping containers, move the plurality of selected pallets to a plurality of respective pallet storage positions in the third product induction region.

57. The fulfillment system as claimed in any one of claims 2 to 56, wherein the shipping container selection instructions are generated by the processor based on a customer order received by the processor and the shipping container AMR instructions are generated by the processor based on the customer order received by the processor.

58. The fulfillment system as claimed in claim 1, wherein the first product induction region includes a plurality of zones.

59. The fulfillment system as claimed in claim 58, wherein the plurality of zones comprises a zone wherein the products are maintained at a temperature of below freezing.

60. The fulfillment system as claimed in claim 58 or 59, wherein the plurality of zones comprises a zone wherein the products are maintained at an ambient temperature.

61. The fulfillment system as claimed in claim 58, 59 or 60, wherein the plurality of zones comprises a zone wherein the products are maintained at a temperature of above freezing and below an ambient temperature.

62. The fulfillment system as claimed in any one of claims 1 to 61, further comprising a plurality of walls and a roof that enclose the first product induction region.

63. The fulfillment system as claimed in any one of claims 20 to 36, further comprising a plurality of walls and a roof that enclose the first product induction region and the second product induction region.

64. The fulfillment system as claimed in any one of claims 27 to 30, further comprising a plurality of walls and a roof that enclose the first product induction region, the second product induction region and the third product induction region.

65. The fulfillment system as claimed in claim 64, further comprising an upper level and a lower level, and wherein the first product induction region is located on one of the upper level and the lower level, and the second product induction region and the third product induction region are located on the other of the upper level and the lower level.

66. The fulfillment system as claimed in claim 64, further comprising an upper level and a lower level, and wherein the first product induction region is located on the upper level and the second product induction region and the third product induction regions are located on the lower level.

67. The fulfillment system as claimed in claim 65 or 66, further comprising an AMR level changing apparatus, operable to move the shipping container AMR between the upper level and the lower level.

68. The fulfillment system as claimed in claim 67, wherein the AMR level changing apparatus comprises an escalator device.

69. The fulfillment system as claimed in claim 67 or 68, wherein the shipping container delivery system is located on the upper level.

70. The fulfillment system as claimed in any one of claims 1 to 69, wherein the at least one location for further processing comprises a flap sealing station at which is located a sealing apparatus operable to seal open flaps of the selected shipping container, and the further processing includes sealing open flaps of the selected shipping container.

71. The fulfillment system as claimed in claim 70, wherein, while as the shipping container AMR moves through the sealing apparatus, the sealing apparatus seals the open flaps of the shipping container.

72. The fulfillment system as claimed in claim 71, further comprising a shipping container verification apparatus and wherein the further processing includes verifying the shipping container using the shipping container verification apparatus.

73. The fulfillment system as claimed in claim 70, wherein the shipping container AMR further comprises a drive mechanism operable to drive the movement of the shipping container AMR and wherein the shipping container AMR is driven thorough the sealing apparatus by the drive mechanism.

74. The fulfillment system as claimed in claim 73, further comprising first and second transversely spaced, longitudinally extending guide belts, operable to guide the selected shipping container during longitudinal movement of the shipping container AMR, with the shipping container thereon, through the sealing apparatus.

75. The fulfillment system as claimed in any one of claims 70 to 74, further comprising a shipping container labeling apparatus and wherein the further processing includes labeling the shipping container using the shipping container labeling apparatus.

76. The fulfillment system as claimed in any one of claims 70 to 75, further comprising a shipping container radio frequency (RF) tagging apparatus and wherein the further processing includes tagging the shipping container with an RF tag using the shipping container RF tagging apparatus.

77. The fulfillment system as claimed in any one of claims 70 to 76, further comprising a dunnage insertion apparatus and wherein the further processing includes inserting dunnage into the shipping container using the dunnage insertion apparatus.

78. The fulfillment system as claimed in any one of claims 70 to 77, further comprising a route distribution accumulation regio, operable to receive and form a group of a plurality of filled shipping containers filled with one or more products, which together comprise a single customer order.

79. The fulfillment system as claimed in claim 78, further comprising a discharge conveyor, operable to receive the group of the plurality of the filled shipment containers and move the group to a vehicle loading position.

80. The fulfillment system as claimed in any one of claims 70 to 79, further comprising a route distribution accumulation region and wherein the further processing includes:
determining, at the processor, a destination for the shipping container and/or the first product; and
transferring, using a transfer apparatus, the shipping container to a station in the route distribution accumulation region, the station in the route distribution accumulation region corresponding to the destination.

81. The fulfillment system as claimed in claim 80, wherein an unload position in the route distribution accumulation region corresponds to a delivery route representative of an ordered sequence of destinations and wherein the generating the AMR instructions comprises:
determining a position, in the ordered sequence of destinations, for the destination for the first product; and
arranging a timing of an arrival, of the shipping container AMR, at the unload position in the route distribution accumulation region, such that the timing of the arrival corresponds to the position in the ordered sequence of destinations.

82. The fulfillment system as claimed in any one of claims 64 to 69, wherein the first product induction region includes a plurality of zones.

83. The fulfillment system as claimed in claim 82, wherein the plurality of zones comprises an ambient zone in which the products are maintained at an ambient temperature.

84. The fulfillment system as claimed in claim 83, wherein the plurality of zones comprises a frozen zone in which the products are maintained at a temperature of below freezing.

85. The fulfillment system as claimed in claim 84, wherein the frozen zone is defined by logical and/or physical partitions.

86. The fulfillment system as claimed in claim 82, 83 or 84, wherein the plurality of zones comprises a refrigerated zone in which the products are maintained at a temperature of above freezing and below an ambient temperature.

87. The fulfillment system as claimed in claim 86, wherein the refrigerated zone is defined by logical and/or physical partitions.

88. The fulfillment system as claimed in any one of claims 3 to 37, wherein the selected pallet comprises a universal pallet.

89. The fulfillment system as claimed in any one of claims 38 to 40, wherein the first selected pallet and the second selected pallet both comprise universal pallets.

90. The fulfillment system as claimed in claim 89, wherein the first universal pallet and the second universal pallet support thereon a vertical crate stack of universal crates.

91. The fulfillment system as claimed in any one of claims 1 to 90, wherein the shipping container comprises a selected shipping container, and the shipping container delivery system is operable to deliver the selected shipping container from among a plurality of different sizes of shipping containers, and wherein the shipping container AMR is configured to, according to the shipping container AMR instructions, wait, at the shipping container delivery system, to receive the selected shipping container.

92. The fulfillment system as claimed in any one of claims 1 to 13, or claims wherein the processor is further operable to generate shipping container induction AMR instructions and wherein the fulfillment system further comprises:
a shipping container induction AMR configured to:
receive, from the processor, the shipping container induction AMR instructions;
according to the shipping container induction AMR instructions:
travel to a shipping container pallet receiving location; and
at the shipping container pallet receiving location, engage a shipping container pallet, the shipping container pallet holding a plurality of shipping container blanks; and
travel to a blank transfer location proximate the shipping container delivery system; and
a blank transfer apparatus proximate the shipping container delivery system and the blank transfer location, the blank transfer apparatus operable to transfer shipping container blanks from the shipping container pallet to the shipping container delivery system.

93. The fulfillment system as claimed in claim 92, wherein the shipping container delivery system comprises the blank transfer apparatus.

94. The fulfillment system as claimed in claim 92 or 93, wherein the plurality of shipping container blanks are held in a plurality of crates supported on the shipping container pallet.

95. The fulfillment system as claimed in claim 94, wherein the plurality of crates are stacked vertically in series on top of each other in a crate stack.

96. The fulfillment system as claimed in claim 95, wherein the plurality of crates are stacked vertically in a nested arrangement.

97. The fulfillment system as claimed in any one of claims 1 to 15 or claims 36 to 50, wherein the blank transfer apparatus comprises a crate lifting apparatus and a robotic apparatus both controlled by the processor, the crate lifting apparatus operable to lift all crates in the crate stack above the crate holding at least one shipping container blank, to expose a top opening of the crate holding the at least one shipping container blank, the robotic apparatus is operable to pick up the shipping container blank from the crate holding the at least one shipping container blank, and transfer the at least one shipping container blank to the shipping container delivery system.

98. The fulfillment system as claimed in claim 97, wherein the shipping container delivery system is, according to shipping container delivery instructions received from the processor, erect the shipping container blank into the selected shipping container and deliver the selected shipping container to the shipping container AMR.

99. The fulfillment system as claimed in claim 97 or 98, further comprising a lid covering an open top of a top crate in the crate stack, and wherein the crate lifting apparatus is further operable to lift just the lid from the top crate, to expose the open top of the top crate.

100. A method of operating a fulfilment system, the system including:
a first product induction region comprising a plurality of product storage apparatuses, each product storage apparatuses among the plurality of product storage apparatuses, holding a plurality of products;
a first product transfer apparatus operable to transfer a first product among a first plurality of products held by a first product storage apparatus among the plurality storage apparatuses, into a shipping container;
a shipping container autonomous mobile robot (AMR); and
a shipping container delivery system operable to deliver the shipping container to the shipping container AMR;
the method comprising the shipping container AMR:
travelling to the shipping container delivery system;
waiting to receive, from the shipping container delivery system, the shipping container;
travelling, while holding the shipping container, to the first product transfer apparatus in the first product induction region;
waiting to receive, at the first product transfer apparatus, the first product from the product storage apparatus, into the shipping container; and
travelling, while holding the shipping container with the first product inside, to at least one location for further processing of the shipping container.

101. A fulfillment system comprising:
a first product induction region comprising a plurality of pallets, each of the plurality of pallets holding a plurality of products;
a product transfer apparatus operable to transfer a first product from a selected pallet of the plurality of pallets;
a shipping container autonomous mobile robot (AMR); and
a shipping container delivery system operable to deliver a selected shipping container to the shipping container AMR;
wherein the shipping container AMR is operable to:
travel to the shipping container delivery system;
wait, at the shipping container delivery system, to receive the selected shipping container;
travel, while holding the selected shipping container, to the product transfer apparatus in the product induction region;
wait, at the first product transfer location, to receive a first product from the selected pallet into the selected shipping container; and
travel, while holding the selected shipping container with the first product inside, to at least one location for further processing of the selected shipping container.

102. The system as claimed in claim 101, wherein the selected shipping container is selected by a processor from a plurality of available types of shipping containers.

103. The system as claimed in claim 102, wherein the plurality of available types of shipping containers comprises a plurality of different size shipping containers.

104. The system as claimed in claim 102 or 103, wherein the plurality of available types of shipping containers comprises both insulated and non-insulated shipping containers.

105. The system as claimed in any one of claims 102 to 104, wherein the selected container is selected by the processor based on a customer order received by the processor and wherein shipping container AMR instructions for the shipping container AMR are generated by the processor based on the customer order received by the processor.

106. The fulfillment system as claimed in any one of claims 102 to 105, wherein the selected pallet comprises a universal pallet.

107. A method of operating a fulfillment system, the fulfillment system including:
a first product induction region comprising a plurality of pallets, each pallet among the plurality of pallets holding a plurality of products;
a product transfer apparatus operable to transfer a first product from a selected pallet, the selected pallet selected from among the plurality of pallets;
a shipping container autonomous mobile robot (AMR); and
a shipping container delivery system operable to deliver a selected shipping container to the shipping container AMR;
the method comprising the shipping container AMR:
travelling to the shipping container delivery system;
waiting, at the shipping container delivery system, to receive the selected shipping container;
travelling, while holding the selected shipping container, to the product transfer apparatus in the product induction region;
waiting, at the first product transfer location, to receive a first product from the selected pallet into the selected shipping container; and
travelling, while holding the selected shipping container with the first product inside, to at least one location for further processing of the selected shipping container.

108. A fulfillment system comprising:
a processor operable to generate pallet autonomous mobile robot (AMR) instructions;
a pallet AMR configured to:
receive, from the processor, the pallet AMR instructions;
according to the pallet AMR instructions:
travel to a pallet receiving location;
receive, at the pallet receiving location, a selected pallet;
travel, while holding the selected pallet, to a product storage region; and
release the selected pallet;
wherein the pallet holds at least one product, the at least one product corresponding with at least one stock keeping unit.

109. The fulfillment system as claimed in claim 107, wherein the pallet AMR is configured to, according to the AMR instructions, travel, while holding the selected pallet, to a pallet storage position in the product storage region, and release the selected pallet at the pallet storage position.

110. The fulfillment system as claimed in claim 109, wherein the selected pallet is located at a first pallet storage position in the product induction region.

111. The fulfillment system as claimed in claim 110, wherein the product induction region includes a plurality of pallets located at a respective plurality of pallet storage positions.

112. The fulfillment system as claimed in claim 111, wherein the plurality of pallet storage positions are arranged in a row.

113. The fulfillment system as claimed in claim 112, wherein the first pallet storage position is positioned at a first end position of the row of the pallet storage positions.

114. The fulfillment system as claimed in any one of claims 108 to 113, wherein the pallet receiving location is a location within the storage area of a selected transport trailer.

115. The fulfillment system as claimed in claim 114, wherein the at least one product is held in a crate, and the crate is supported on the selected pallet.

116. The fulfillment system as claimed in claim 115, wherein the crate is a first crate of a plurality of universal crates, wherein the plurality of universal crates are stacked vertically in series on top of each other in a crate stack and wherein each of the universal crates holds at least one product.

117. The fulfillment system as claimed in claim 116 wherein each crate among the plurality of universal crates contains at least one product and wherein all the least one products in all of the plurality of universal crates correspond to the same stock keeping unit.

118. The fulfillment system as claimed in claim 117, wherein each universal crate of the plurality of universal crates contains at least one product.

119. The fulfillment system as claimed in claim 118, wherein each universal crate among the plurality of universal crates holds one or more products of the same stock keeping units.

120. The fulfillment system as claimed in claim 118, wherein at least some of the universal crates among the plurality of universal crates holds one or more products of different stock keeping units.

121. A method of operating a fulfillment system, the fulfillment system including:
a processor operable to generate pallet autonomous mobile robot (AMR) instructions;
a pallet AMR;
the method comprising the pallet AMR:
receiving, from the processor, the pallet AMR instructions;
according to the pallet AMR instructions:
travelling to a pallet receiving location;
receiving, at the pallet receiving location, a selected pallet;
travelling, while holding the selected pallet, to a product storage region; and
releasing the selected pallet, wherein the selected pallet holds at least one product, the at least one product corresponding with at least one stock keeping unit.

122. A system comprising:
a moving apparatus operable to move one or more of a plurality of crates of a plurality of stacked crates that are vertically stacked on a pallet in a crate stack positioned at a crate moving position, wherein at least some of the plurality of crates contain at least one product in a crate and the crate stack is supported on a pallet;
a processor operable to generate moving apparatus instructions;
wherein the moving apparatus is operable to:
receive the moving apparatus instructions from the processor;
engage a selected crate of the plurality of crates in the crate stack; and
move the selected crate and any crates stacked above the selected crate.

123. The system as claimed in claim 122, wherein:
the moving apparatus includes a lifting apparatus, the lifting apparatus being operable to vertically lift the one or more crate among the plurality of crates of the crate stack positioned at a crate moving position that is a first crate lift position;
the processor is operable to generate lifting apparatus instructions;
the lifting apparatus being further operable to:
receive the lifting apparatus instructions from the processor;
engage a selected crate of the plurality of crates in the crate stack; and
vertically lift the selected crate and any crates of the crate stack that are stacked above the selected crate.

124. The system as claimed in claim 123, wherein the lifting apparatus is further operable to receive the lifting apparatus instructions from the processor to vertically lift the selected crate and any crates of the crate stack that are stacked above the selected crate and thereby expose a top opening in an immediately below crate positioned immediately below the selected crate in the crate stack.

125. The system as claimed in claim 123 or 124, wherein the lifting apparatus comprises at least one vertically movable lift arm, the at least one vertically movable lift arm operable to releasably engage the selected crate of each of the plurality of crates in the crate stack, and lift and lower the selected crate, along with all crates of the plurality of crates in the crate stack that are stacked above the selected crate.

126. The system as claimed in claim 125, wherein the at least one lift arm comprises first and second robotic lift arms positioned on opposite vertical sides of the crate stack.

127. The system as claimed in claim 124, wherein the processor is operable to generate picking instructions and the further comprises:
a robotic picking apparatus operable such that, after the lifting apparatus has lifted the selected crate, along with all crates of the plurality of crates that are stacked above the selected crate, to expose the top opening of an immediately below crate, the robotic picking apparatus is operable to, according to the picking instructions:
pick up a product; and
transfer the product from the immediately below crate into a shipping container.

128. The system as claimed in any one of 123 to 127, wherein the plurality of crates are configured in the crate stack in a vertically nested arrangement.

129. The system as claimed in claim 123 or 124, wherein the crate stack is supported on a crate support structure.

130. The system as claimed in claim 129, wherein the crate support structure comprises a pallet.

131. The system as claimed in claim 130, wherein the pallet comprises a universal pallet.

132. The system as claimed in any one of claims 125 to 128, wherein the crate stack is supported on a crate support structure.

133. The system as claimed in claim 132, wherein the crate support structure comprises a pallet.

134. The system as claimed in claim 133, further comprising a pallet autonomous mobile robot (AMR), wherein the processor is configured to generate pallet AMR instructions and wherein the pallet AMR is configured to, according to the pallet AMR instructions, engage and move the pallet from the first crate lift position with the crate stack or a portion of the crate stack, on the pallet.

135. The system as claimed in claim 134, wherein, after the lifting apparatus lifts the selected crate, along with all crates of the plurality of crates that are stacked above the selected crate, to expose the top opening of the immediately below crate, the pallet AMR is operable to move the pallet with the immediately below crate, and any of the plurality of crates below the immediately below crate that are supported on the pallet AMR, from the first crate lift position to a picking position at which the robotic picking apparatus is operable to pick up a product and transfer the product from the immediately below crate into a shipping container.

136. The system as claimed in claim 135, wherein the shipping container is supported on a shipping container AMR.

137. The system as claimed in claim 135 or 136, wherein the system is operable such that:
after the robotic picking apparatus has picked up the product and transferred the product from the immediately below crate into the shipping container, according to the pallet AMR instructions:
the pallet AMR is operable to move the pallet with the immediately below crate, and any of the plurality of crates below the immediately below crate that are supported on the pallet AMR, from the picking position to a second crate lift position; and
the lifting apparatus is operable to, at the crate lift position and according to the lifting apparatus instruction, lower the selected crate, along with all crates of the plurality of crates that are stacked above the selected crate, such that the selected crate is supported on the immediately below crate, to re-constitute the crate stack.

138. The system as claimed in claim 137, wherein the first crate lift position at substantially at the same physical position as the second crate lift position.

139. The system as claimed in claim 137 or 138, wherein the pallet AMR is operable to, according to the pallet AMR instructions, engage with the pallet supporting the crate stack at a pallet storage position and move the pallet supporting the crate stack from the pallet storage position to the first crate lifting position.

140. The system as claimed in claim 139, wherein the pallet storage position is located in a refrigerated zone or in a frozen zone.

141. The system as claimed in claim 140, wherein the crate lift position is located in the refrigerated zone or the frozen zone.

142. The system as claimed in claim 141, wherein the picking position is located in an ambient zone.

143. The system as claimed in claim 141 or 142, wherein the picking apparatus is located in the ambient zone.

144. The system as claimed in claim 143, wherein the processor is operable to generate roll-up door instructions such that, when the pallet AMR moves with the immediately below crate, and any of the plurality of crates below the immediately below crate that are supported on the pallet AMR, from the lift position to the picking position passing through a roll-up door that moves up and down as controlled by the roll-up door instructions, so as to reduce an amount of air from the ambient zone that travels to heat air in the refrigerated zone or in the refrigerated zone.

145. The system as claimed in any one of claims 141 to 144, wherein the lift apparatus further comprises one or more of an actuator and a control device and wherein at least one of the actuator and the control device is located in the ambient zone and at least part of the at least one picking arm extends into the refrigerated zone or into the frozen zone.

146. The system as claimed in claim 145, wherein the frozen zone and the refrigerated zone are defined by physical partitions, wherein both the actuator and the control device are located on an ambient zone side of the physical partitions and wherein at least part of the at least one picking arm is positioned on a refrigerated zone side zone or a frozen zone side of the physical partitions.

147. The system as claimed in any one of claims 137 to 146, wherein the pallet supporting the crate stack comprises a pallet among a plurality of pallets, each pallet among the plurality of pallets supporting a respective crate stack, wherein at least some of the plurality of crates of each crate stack on the plurality of pallets, contains at least one product in each crate.

148. The system as claimed in claim 147, wherein the plurality of pallets are arranged in one or more rows of pluralities of pallets.

149. The system as claimed in claim 148, wherein a first group of a plurality of rows of the plurality of pallets are arranged in spaced transverse relationship to a second group of a plurality of rows of the plurality of pallets.

150. The system as claimed in claim 148, wherein the first group and the second group are located in a refrigerated zone or in a frozen zone.

151. The system as claimed in claim 150, wherein the first group of pallets and the second group of pallets are transversely spaced apart to provide a longitudinally oriented aisle therebetween, the aisle configured to provide physical access for the pallet AMR to enable the pallet AMR to engage with and move a leading pallet in each row of the plurality of rows of pallets to the first lifting position.

152. The system as claimed any one of claims 122 to 151, wherein each of the crates of the plurality of crates holds one or more products of the same stock keeping units.

153. The system as claimed any one of claims 122 to 151, wherein at least some of the crates of the plurality of crates holds one or more products of different stock keeping units.

154. A method comprising:
moving one or more of a plurality of crates of a plurality of stacked crates that are vertically stacked on a pallet in a crate stack positioned at a crate moving position, wherein at least some of the plurality of crates contain at least one product in a crate, and the crate stack is supported on a pallet; and
engaging a selected crate of the plurality of crates in the crate stack and moving, optionally by lifting, the selected crate and any crates stacked above the selected crate.

155. A system for delivering products comprising:
a transport trailer configured to receive and store at least one pallet;
a pallet autonomous mobile robot (AMR), operable to transport a pallet; and
a processor operable to transmit instructions to the pallet AMR, the instructions causing the pallet AMR to:
navigate to a pallet receiving position outside of the transport trailer and engage a pallet;
navigate to a storage position in the transport trailer and release the pallet in the storage position; and
navigate away from the transport trailer without the pallet;
wherein the transport trailer includes an interior storage space defined by a ceiling surface, a side wall surface and a floor surface; and
wherein the floor surface implements a configuration to facilitate navigation in the transport trailer by the pallet AMR.

156. The system as claimed in claim 155, wherein the configuration comprises bar codes on the floor surface, the bar codes being detectable by the pallet AMR.

157. A method for delivering products using a pallet autonomous mobile robot (AMR) to load a transport trailer with a pallet, the transport trailer configured to receive and store the pallet, the method comprising the pallet AMR:
navigating to a pallet receiving position outside of the transport trailer and engaging the pallet;
navigating to the storage position in the transport trailer and releasing the pallet in the storage position; and
navigating away from the transport trailer without the pallet.

158. The method as claimed in claim 157, wherein a floor surface of the transport trailer is configured to facilitate navigation in the transport trailer by an autonomous mobile robot (AMR).

159. A system for delivering products comprising:
a transport trailer configured to receive and store at least one pallet;
a pallet autonomous mobile robot (AMR) operable to transport a pallet; and
a processor operable to transmit instructions to the pallet AMR, the instructions causing the pallet AMR to:
navigate to a pallet receiving position inside the transport trailer and engage a given pallet;
navigate to a storage position outside of the transport trailer and release the given pallet in the storage position; and
navigate away from the given pallet.

160. The system as claimed in claim 159, wherein:
the transport trailer includes an interior storage space defined by a ceiling surface, a side wall surface and a floor surface; and
the floor surface is configured to facilitate navigation, in the transport trailer, by the given pallet AMR.

161. A method for delivering products using a pallet autonomous mobile robot (AMR) to unload a transport trailer, the transport trailer capable of receiving and storing the pallet, the method comprising the pallet AMR:
navigating to a pallet receiving position inside the transport trailer and engaging a given pallet;
navigating to a storage position outside of the transport trailer and releasing the given pallet in the storage position; and
navigating away from the given pallet.

162. The method as claimed in claim 161, wherein the transport trailer includes an interior storage space defined by a ceiling surface, a side wall surface and a floor surface and the floor surface of the transport trailer facilitates navigation in the transport trailer by the pallet AMR.

163. A system for loading and transporting products comprising:
a source of a plurality of products, wherein the system is operable to transfer the plurality of products onto a pallet located at a pallet loading position;
a transport trailer configured to receive and store at least one pallet;
a pallet autonomous mobile robot (AMR), operable to move a pallet; and
a processor operable to transmit instructions to the pallet AMR, the instructions causing the pallet AMR to:
navigate to a pallet receiving position and engage a given pallet holding a plurality of products;
navigate to a storage position in the transport trailer and release the given pallet in the storage position; and
navigate away from the transport trailer without the given pallet.

164. The system as claimed in claim 163, further comprising a source of crates, wherein the system is further operable to transfer the plurality of products onto a particular pallet and the system further comprises:
a product transfer apparatus operable to transfer at least one product into each crate among a plurality of crates provided by the source of crates;
a crate stack forming apparatus operable to form the plurality of crates into a crate stack; and
a crate stack loading apparatus operable to load the crate stack onto the particular pallet;
wherein the pallet AMR is operable to:
navigate to the pallet receiving position;
engage the particular pallet;
navigate to the storage position in the transport trailer; and
release the particular pallet in the storage position.

165. The system as claimed in claim 163 or 164, wherein the source of the plurality of products comprises a product delivery conveyor operable to deliver the plurality of products to a product transfer location, wherein, at the product transfer location, the product transfer apparatus is operable to transfer at least one product into each crate among a plurality of crates provided by the source of crates.

166. The system as claimed in claim 165, wherein the product transfer apparatus comprises a robotic picking apparatus controlled by the processor and the robotic picking apparatus is operable to pick the at least one product and transfer the at least one product into each crate among the plurality of crates.

167. The system as claimed in claim 166, wherein the robotic picking apparatus further comprises a vision sensing system.

168. A system for loading products onto pallets, the system comprising:
a source of products;
a product transfer apparatus operable to load at least one product provided by the source of products into each crate among a plurality of crates at a loading station to, thereby, form a plurality of loaded crates;
a loaded crate stack forming apparatus operable to form a loaded crate stack from the plurality of loaded crates;
an apparatus operable to load the loaded crate stack onto a pallet to form a loaded pallet;
a pallet autonomous mobile robot (AMR), the pallet AMR operable to engage with and move the loaded pallet while supporting the loaded crate stack; and
a processor operable to transmit instructions to the pallet AMR, the instructions causing the pallet AMR to:
navigate to a pallet receiving position;
engage, at the pallet receiving position, a non-loaded pallet;
navigate to a crate stack receiving position with the non-loaded pallet;
receive the crate stack to, thereby, form the loaded pallet;
navigate away from the crate stack receiving position with the loaded pallet; and
travel, while engaging the loaded pallet, to a location for further processing.

169. The system as claimed in claim 168, wherein the product transfer apparatus comprises a robotic picking apparatus controlled by the processor and the robotic picking apparatus is operable to pick the at least one product and transfer the at least one product into each of the plurality of crates.

170. The system as claimed in claim 169, wherein the robotic picking apparatus further comprises a vision sensing system.

171. The system as claimed in any one of claims 168 to 170, further comprising a crate conveyor apparatus operable to deliver the plurality of crates to the loading station.

172. The system as claimed in claim 171, wherein the crate conveyor apparatus is further operable to deliver the plurality of loaded crates to the loaded crate stack forming apparatus.

173. The system as claimed in any one of claims 168 to 172, wherein the system further comprises:
a plurality of non-loaded pallets, each non-loaded pallet among the plurality of non-loaded pallets containing the plurality of empty crates containing no products;
an apparatus operable to successively remove each empty crate among the plurality of empty crates from each the unloaded pallet at an empty crate transfer station, and transfer the plurality of empty crates to the crate conveyor apparatus, wherein the crate conveyor apparatus delivers the plurality of empty crates to the loading station.

174. The system as claimed in claim 171, further comprising:
an non-loaded pallet AMR, the non-loaded pallet AMR operable to engage with and move a given non-loaded pallet among the plurality of non-loaded pallets from a non-loaded pallet storage location, to the empty crate transfer station; and
a processor operable to transmit instructions to the non-loaded pallet AMR, the instructions causing the non-loaded pallet AMR to:
navigate to an non-loaded pallet storage location;
engage, at the non-loaded pallet storage location, the given non-loaded pallet;
navigate to the empty crate transfer station, with the given non-loaded pallet;
navigate away from the crate transfer station with the non-loaded pallet and without the crate stack; and
travel, while engaging the non-loaded pallet to a location for further processing.

175. A method for loading products onto pallets, the method comprising:
loading at least one product provided by a source of products into each crate among a plurality of empty crates to form a plurality of loaded crates;
forming a loaded crate stack from the plurality of loaded crates;
loading the loaded crate stack onto a pallet to form a loaded pallet;
engaging, with a pallet autonomous mobile robot (AMR), with the loaded pallet; and
moving the loaded pallet while supporting the loaded crate stack.

176. A system for delivering products to a fulfillment operation, the system comprising:
a production operation including a source of products;
a product transfer apparatus, at the production operation, operable to transfer a plurality of products, provided by the source of products, onto a pallet located at a pallet loading position;
a first transport trailer operable to receive and store at least one pallet, the first transport trailer enabling navigation of autonomous mobile robots (AMRs) therein;
a first production pallet AMR at the production operation, the first production pallet AMR operable to:
navigate to a pallet receiving position;
engage, at the pallet receiving position, a loaded pallet holding a plurality of products;
navigate to a storage position in the transport trailer;
release, at the storage position, the loaded pallet; and
navigate away from the transport trailer without the loaded pallet;
a fulfillment operation including a first fulfilment pallet AMR operable to:
navigate to the storage position on the first transport trailer;
engage, at the storage position, the loaded pallet;
navigate to a pallet storage position within the fulfillment operation;
release, at the pallet storage position, the loaded pallet;
navigate away from the pallet storage position without the loaded pallet;
wherein, when the first transport trailer is loaded with the loaded pallet, the first transport trailer is operable to transport the loaded pallet from the production operation to the fulfillment operation.

177. The system as claimed in claim 176, further comprising:
a second transport trailer operable to receive and store at least one pallet, the second transport trailer enabling navigation of AMRs therein;
a second fulfillment pallet AMR operable to:
navigate to a fulfillment operation returning pallet storage position in the fulfillment operation;
engage, at the fulfillment operation returning pallet storage position, a returning pallet, the returning pallet being a pallet no longer holding any products;
navigate from the fulfillment operation returning pallet storage position to a return trailer storage position in the second transport trailer;
release, at the return trailer storage position, the returning pallet; and
navigate away from the second transport trailer without the returning pallet;
a second production pallet AMR operable to:
navigate to the return trailer storage position;
engage, at the return trailer storage position, the returning pallet;
navigate out of the second transport trailer without the returning pallet to a production operation returning pallet storage position in the production operation;
release, at the production operation returning pallet storage position, the returning pallet; and
navigate away from the production operation returning pallet storage position;
wherein, when the second transport trailer is loaded with the returning pallet, the second transport trailer is operable to transport the returning pallet from the fulfillment operation to the production operation.

178. The system as claimed in claim 177, further comprising a processing system operable to control the operation of: the fulfillment pallet AMR, the first production pallet AMR, the second fulfillment pallet AMR and the second production pallet AMR.

179. A method for delivering products to a fulfillment operation, the method comprising:
at a production operation:
transferring a plurality of products provided by a source of products onto a pallet to, thereby, form a loaded pallet;
navigating, by a first production pallet autonomous mobile robot (AMR), to the loaded pallet;
engaging, by the first production pallet AMR, the loaded pallet;
navigating, by the first production pallet AMR, to a storage position in a transport trailer;
releasing, by the first production pallet AMR, the loaded pallet in the pallet storage position while the transport trailer located at the production operation; and
navigating, by the first production pallet AMR, away from the transport trailer without the loaded pallet.

180. The method as claimed in claim 179, further comprising moving the transport trailer from the production operation to the fulfillment operation.

181. The method as claimed in claim 179 or 180, wherein the fulfillment operation further includes a first fulfilment pallet AMR, the method further comprising:
navigating, by the first fulfilment pallet AMR, to the pallet storage position on the transport trailer;
engaging, by the first fulfilment pallet AMR, the loaded pallet;
navigating, by the first fulfilment pallet AMR, to a second pallet storage position in the fulfillment operation;
releasing, by the first fulfilment pallet AMR at the second pallet storage position, the loaded pallet; and
navigating, by the first fulfilment pallet AMR, away from the second pallet storage position without the loaded pallet.

182. A method of operating a fulfillment operation, the method comprising:
navigating, by a first autonomous mobile robot (AMR) at the fulfillment operation, to a pallet storage position on a first transport trailer located at the fulfillment operation;
engaging, by the first AMR, a loaded pallet, the loaded pallet holding a plurality of products;
moving, by the first AMR, the loaded pallet to a location with the fulfillment operation;
emptying, by components of the fulfillment operation, the loaded pallet of most or all of the plurality products to, thereby, form a returning pallet;
navigating, by a second AMR at the fulfillment operation, to the returning pallet; and
moving, by the second AMR, the returning pallet to a pallet storage position on a second transport trailer located at the fulfillment operation.

183. A method of operating a production operation, the method comprising:
loading a pallet with a plurality of products to, thereby, form a loaded pallet;
navigating, by a first autonomous mobile robot (AMR) at the production operation, to the loaded pallet;
moving, by the first AMR, the loaded pallet onto a first transport trailer;
navigating, by a second AMR at the production operation, to a returning pallet on a second transport trailer located at the production operation; and
removing, by the second AMR, the returning pallet from the second transport trailer.

184. A transport trailer comprising an interior storage space defined by a ceiling surface, a side wall surface and a floor surface, the floor surface including a first configuration to facilitate navigation in the transport trailer by an autonomous mobile robot (AMR).

185. The transport trailer as claimed in claim 184, wherein the first configuration is consistent with a second configuration of a fulfillment operation, wherein the second configuration facilitates navigation, in the fulfillment operation, by the AMR.

186. The transport trailer as claimed in claim 184 or 185, wherein the first configuration is consistent with a third configuration of a production operation, wherein the third configuration facilitates navigation, in the production operation, by the AMR.

187. The transport trailer as claimed in any one of claims 184 to 186, wherein the first configuration comprises bar codes on an interior floor surface of the transport trailer, the bar codes being detectable by the AMR.

188. A system comprising:
the transport trailer as claimed in claim 187;
an AMR; and
a processor operable to communicate with the AMR to receive bar code signals from the AMR and, in response thereto, guide movement of the AMR within the transport trailer.

189. A transport trailer comprising:
an interior storage space defined by a ceiling surface, a side wall surface and a floor surface;
a plurality of air bags positioned on the side wall surface, the plurality of air bags having:
a first state, in which the air bags are inflated with pressurized air to engage a side surface of a crate supported on a pallet stored in the interior space; and
a second state, in which the air bags are depressurized and disengage from the side surface of the crate.

190. The transport trailer as claimed in claim 189, wherein the pallet supports a vertical stack of a plurality of crates and wherein:
the plurality of air bags in the first state engage side surfaces of some of the plurality of crates supported on the pallet stored in the interior space; and
the plurality of air bags in the second state disengage from the some of the plurality of crates.

191. The transport trailer as claimed in claim 189 or 190, further comprising:
an air pressure system operable to inflate and deflate the plurality of air bags; and
a tractor operable to propel the transport trailer.

192. A shipping container blank delivery system for delivering shipping container blanks to an erected shipping container delivery system, the shipping container blank delivery system comprising:
a shipping container blank pallet holding a plurality of shipping container blanks;
a shipping container blank autonomous mobile robot (AMR) configured to:
travel to a shipping container blank pallet receiving location;
engage, at the shipping container blank pallet receiving location, the shipping container blank pallet; and
travel to a blank transfer location, wherein the blank transfer location is proximate the erected shipping container delivery system; and
a blank transfer apparatus proximate the blank transfer location and the erected shipping container delivery system, the blank transfer apparatus operable to transfer the plurality of shipping container blanks from the shipping container blank pallet to the erected shipping container delivery system.

193. The system as claimed in claim 192, further comprising a processor operable to generate shipping container blank AMR instructions and wherein the shipping container blank AMR is configured to:
receive, from the processor, the shipping container induction AMR instructions;
travel, according to the shipping container induction AMR instructions, to the shipping container pallet receiving location;
engage, at the shipping container pallet receiving location and according to the shipping container induction AMR instructions, a shipping container pallet; and
travel, according to the shipping container induction AMR instructions, to the blank transfer location.

194. The system as claimed in claim 193, wherein the blank transfer apparatus is part of the erected shipping container delivery system.

195. The system as claimed in claim 193 or 194, wherein the blank transfer apparatus comprises a robotic apparatus and a computer vision apparatus operable to, together, locate, engage with and move each of the plurality of shipping container blanks from the shipping container blank pallet to the erected shipping container delivery system.

196. The system as claimed in any one of claims 193 to 195, wherein the plurality of shipping container blanks are held in a plurality of crates supported on the shipping container pallet.

197. The system as claimed in claim 196, wherein the plurality of crates are stacked vertically in series on top of each other in a crate stack.

198. The system as claimed in claim 197, wherein the plurality of crates are stacked vertically in a nested arrangement.

199. The system as claimed in any one of claims 196 to 198, wherein the blank transfer apparatus comprises:
a crate lifting apparatus controlled by the processor; and
the robotic apparatus controlled by the processor;
wherein the crate lifting apparatus is operable to lift all crates in the crate stack above a crate holding a selected shipping container blank to, thereby, expose a top opening of the crate holding the selected shipping container blank;
wherein the robotic apparatus is operable to pick up the selected shipping container blank from the crate holding the selected shipping container blank and transfer the selected shipping container blank to the erected shipping container delivery system.

200. The system as claimed in claim 193, wherein the erected shipping container delivery system is operable to, according to shipping container delivery instructions received from the processor, erect the selected shipping container blank into a erected shipping container and deliver the erected shipping container to a shipping container AMR.

201. The system as claimed in claim 197 or 198, further comprising a lid covering an open top of a top crate in the crate stack and wherein the crate lifting apparatus is further operable to lift just the lid from the top crate to, thereby, expose the open top of the top crate in the crate stack.

202. A method of operating a fulfillment system that includes a shipping container blank autonomous mobile robot (AMR), the method comprising:
travelling, by the shipping container blank AMR, to a shipping container blank pallet receiving location;
engaging, by the shipping container blank AMR at the shipping container blank pallet receiving location, a shipping container blank pallet, the shipping container blank pallet holding a plurality of shipping container blanks; and
travelling, by the shipping container blank AMR, to a blank transfer location proximate a shipping container delivery system.

203. The method as claimed in claim 202, further comprising transferring the plurality of shipping container blanks from the shipping container blank pallet to the shipping container delivery system.

204. A system for delivering shipping container blanks to a fulfillment operation, the system comprising:
a production operation operable to provide a source of shipping container blanks;
a product transfer apparatus, at the production operation, operable to transfer a plurality of shipping container blanks, provided by the source of shipping container blanks, onto a shipping container blank pallet located at a pallet loading position;
a first transport trailer configured to receive and store the shipping container blank pallet;
a production pallet autonomous mobile robot (AMR), at the production operation, operable to move the shipping container blank pallet; and
a processing system operable to transmit production pallet AMR instructions to the production pallet AMR, the production pallet AMR instructions causing the production pallet AMR to:
navigate to a pallet receiving position;
engage the shipping container blank pallet holding the plurality of shipping container blanks;
navigate to a storage position in the transport trailer;
release, in the storage position, the shipping container blank pallet; and
navigate away from the transport trailer without the shipping container blank pallet;
wherein, when the first transport trailer is loaded with the shipping container blank pallet, the first transport trailer is operable to transport the shipping container blank pallet from the production operation to the fulfillment operation.

205. The system as claimed in claim 204, further comprising:
a fulfillment system including a shipping container delivery system; and
a fulfilment pallet AMR, at the fulfillment operation, operable to move the shipping container blank pallet;
the processing system further operable to transmit fulfillment pallet AMR instructions to the fulfillment pallet AMR, the fulfillment pallet AMR instructions causing the fulfillment pallet AMR to:
navigate to a pallet storage position on the first transport trailer;
engage the shipping container blank pallet;
navigate to a pallet storage position in the fulfillment operation;
release, in the pallet storage position, the shipping container blank pallet; and
navigate away from the pallet storage position without the shipping container blank pallet.

206. The system as claimed in claim 205, further comprising:
a first shipping container blank AMR configured to:
travel to a pallet storage position in the fulfillment operation;
engage, at the pallet storage position, the shipping container blank pallet; and
travel to a blank transfer location proximate the shipping container delivery system; and
a blank transfer apparatus proximate the shipping container delivery system and the blank transfer location, the blank transfer apparatus operable to transfer the plurality of shipping container blanks from the shipping container blank pallet to the shipping container delivery system.

207. The system as claimed in claim 206, wherein the processing system is further operable to:
transmit second fulfillment pallet AMR instructions to a second fulfillment pallet AMR, the second fulfillment pallet AMR instructions causing the second fulfillment pallet AMR to:
engage a returning pallet, the returning pallet including the shipping container blank pallet without any shipping container blanks;
navigate from the blank transfer location to:
a returning pallet storage position in the fulfillment operation; or
a return trailer storage position in a second transport trailer;
release the shipping container blank pallet;
transmit second production pallet AMR instructions to a second production pallet AMR, the second production pallet AMR instructions causing the second production pallet AMR to:
navigate to the return trailer storage position in the second transport trailer;
engage the returning pallet;
navigate, out of the second transport trailer with the returning pallet, to a returning pallet storage position in the production operation;
release the returning pallet; and
navigate away from the returning pallet storage position;
wherein, when the second transport trailer is loaded with the returning pallet, the second transport trailer is operable to transport the returning pallet from the fulfillment operation to the production operation.

208. The system as claimed in any one of claims 204 to 207, wherein the processing system comprises a first processor located at the production operation and a second processor at the fulfillment operation.

209. The system as claimed in claim 208, wherein the first processor and the second processor and in electronic communication with each other.

210. A method for delivering shipping container blanks to a fulfillment operation, the method comprising:
transferring a plurality of shipping container onto a shipping container blank pallet;
navigating, by a pallet autonomous mobile robot (AMR), to the shipping container blank pallet;
engaging, by the pallet AMR, the shipping container blank pallet holding the plurality of shipping container blanks;
navigating, by the pallet AMR, to a storage position on a transport trailer;
releasing, by the pallet AMR, the shipping container blank pallet in the storage position; and
navigating away from the transport trailer without the shipping container blank pallet.

211. A combined production and fulfillment system comprising:
the system as claimed in claim 177; and
the system as claimed in claim 205.

212. A fulfillment system comprising:
a processor operable to:
generate carton forming instructions; and
generate autonomous mobile robot (AMR) instructions;
a carton forming system configured to:
receive, from the processor, the carton forming instructions;
according to the carton forming instructions, select, from a plurality of available carton blanks, a carton blank; and
form the carton blank into an erected carton;
an AMR configured to:
receive, from the processor, the AMR instructions;
according to the AMR instructions, travel to the carton forming system and receive, from the carton forming system, the erected carton;
according to the AMR instructions, travel, while holding the erected carton, to a station in a product induction region;
receive, at the station, a product into the erected carton; and
according to the AMR instructions, travel, while holding the erected carton with the product inside, to a location for further processing of the erected carton.

213. The fulfillment system of claim 212, wherein the carton forming instructions are generated by the processor based on a customer order received by the processor, and the AMR instructions are generated by the processor based on the customer order received by the processor.

214. The fulfillment system of claim 212 or claim 213, wherein the product induction region comprises a product tower, the product tower comprising a plurality of compartments for storing products, and wherein at least one of the plurality of compartments contains one or more products, the one or more products corresponding with at least one stock keeping unit.

215. The fulfillment system of any one of claims 212 to 214, further comprising a scale and wherein the further processing comprises confirming that a weight, measured using the scale, of a combination of the erected carton and the product is near to an expected weight of the combination of the erected carton and the product.

216. The fulfillment system of any one of claims 212 to 215, further comprising a carton sealing apparatus wherein the further processing comprises sealing the erected carton at the carton sealing apparatus.

217. The fulfillment system of any one of claims 212 to 216, further comprising a carton labeling apparatus wherein the further processing comprises labeling the erected carton using the carton labeling apparatus.

218. The fulfillment system of any one of claims 212 to 217, further comprising a route distribution accumulation region and wherein the further processing comprises:
determining a destination for the product; and
transferring the erected carton to a station in the route distribution accumulation region, the station in the route distribution accumulation region corresponding to the destination.

219. The fulfillment system of claim 218, wherein an unload position in the route distribution accumulation region corresponds to a delivery route representative of an ordered sequence of destinations and wherein the generating the AMR instructions comprises:
determining a position, in the ordered sequence of destinations, for the destination for the product; and
arranging a timing of an arrival, of the AMR, at the unload position in the route distribution accumulation region, such that the timing of the arrival corresponds to the position in the ordered sequence of destinations.

220. The fulfillment system of any one of claims 212 to 219, wherein the further processing comprises holding the erected carton using suction cups.

221. The order fulfillment system of any one of claims 212 to 220, wherein the further processing comprises holding the erected carton using lugs attached to independently controlled belts.

222. The order fulfilment system of any one of claims 212 to 220, wherein the further processing comprises holding the erected carton using lugs, a first lug attached to an independently controlled belt and the first lug moveable, by controlling the independently controlled belt, relative to a second lug.

223. The order fulfillment system of any one of claims 212 to 221, wherein the product induction region is adjacent to a storage region.

224. The order fulfillment system of claim 223, wherein the storage region includes a plurality of towers that store products in compartments, wherein the towers are configured for being transported, by a tower-transportation autonomous mobile robot, to the product induction region.

225. The order fulfillment system of claim 223, wherein the storage region includes a plurality of product storage racks that store products in pallets.

226. The order fulfillment system of any one of claims 212 to 225, wherein the plurality of available carton blanks are stored in a plurality of magazines.

227. The order fulfillment system of any one of claims 212 to 226, wherein the station in the product induction region comprises a robotic product loading station and wherein the AMR is configured to receive the product, at the robotic product loading station, from a product retrieval robot into the erected carton.

228. The order fulfillment system of any one of claims 212 to 226, wherein the station in the product induction region comprises a manual product loading station and wherein the AMR is configured to receive, at the manual product loading station, the product from a manual product retrieval associate into the erected carton.

229. A fulfillment system comprising:
a processor operable to:
generate shipping container selection instructions; and
generate autonomous mobile robot (AMR) instructions;
a shipping container delivery system configured to:
receive, from the processor, the shipping container selection instructions; and
according to the shipping container selection instructions, select, from a plurality of shipping containers, a selected shipping container;
an AMR configured to:
receive, from the processor, the AMR instructions;
according to the AMR instructions, travel to the shipping container delivery system and receive, from the shipping container delivery system, the selected shipping container;
according to the AMR instructions, travel, while holding the selected shipping container, to a station in a product induction region;
receive, at the station, a product into the selected shipping container; and
according to the AMR instructions, travel, while holding the selected shipping container with the product inside, to a location for further processing of the selected shipping container.

230. The fulfillment system of claim 229, wherein the shipping container selection instructions are generated by the processor based on a customer order received by the processor, and the AMR instructions are generated by the processor based on the customer order received by the processor.

231. The fulfillment system of claim 229 or claim 230, wherein the product induction region comprises a product tower, the product tower comprising a plurality of compartments for storing products, and wherein at least one of the plurality of compartments includes one or more products, the one or more products corresponding with at least one stock keeping unit.

232. The fulfillment system of any one of claims 229 to 231, wherein the product is a first product, and wherein the AMR is further configured to:
according to the AMR instructions, travel, while holding the selected shipping container, to a given product storage rack in a storage region, wherein the storage region includes a plurality of product storage racks that store products in pallets;
receive, at the given product storage rack, a second product into the selected shipping container; and
according to the AMR instructions, travel, while holding the selected shipping container with the first product and the second product inside, to a distinct location for further processing of the selected shipping container.

233. The fulfillment system of any one of claims 229 to 232, wherein the AMR is further configured to, according to the AMR instructions, travel, while holding the selected shipping container, to a location in a second product induction region, wherein the second product induction region includes a crate retention structure, the crate retention structure retaining a plurality of crates for storing products, and wherein at least one of the plurality of crates includes one or more products, the one or more products corresponding with a single stock keeping unit.

234. The fulfillment system of claim 233, wherein the AMR is a shipping container AMR and the system further comprises a crate retention AMR, wherein the processor is further operable to generate crate retention AMR instructions, the crate retention AMR instructions instructing the crate retention AMR to transport the crate retention structure to the second product induction region to meet with the shipping container AMR.

235. The fulfillment system of any one of claims 229 to 234, further comprising a sealing apparatus operable to seal open flaps of the selected shipping container.

236. The fulfillment system of claim 235, wherein, while the AMR moves through the sealing apparatus, the sealing apparatus seals the open flaps of the selected shipping container.

237. The fulfillment system of claim 236, wherein the AMR further comprises a drive mechanism operable to drive the movement of the AMR, and wherein the AMR is driven thorough the sealing apparatus by the drive mechanism.

238. The fulfillment system of claim 237, further comprising first and second transversely spaced, longitudinally extending guide belts, operable to guide the selected shipping container during longitudinal movement of the AMR, with the selected shipping container thereon, through the sealing apparatus.

239. The fulfillment system of claim 238, wherein the order fulfillment system is operable such that the movement of the guide belts provides information to the processor indicative of the movement of the AMR and the shipping container through the sealing apparatus.

240. The fulfillment system of any one of claims 229 to 239, wherein the station in the product induction region comprises a robotic product loading station and wherein the AMR is configured to receive the product, at the robotic product loading station, from a product retrieval robot into the shipping container.

241. The fulfillment system of any one of claims 229 to 239, wherein the station in the product induction region comprises a manual product loading station and wherein the AMR is configured to receive, at the manual product loading station, the product from a manual product retrieval associate into the shipping container.

242. A carton closing and sealing system comprising:
an autonomous mobile robot (AMR);
a processor operable to generate AMR instructions;
a shipping container delivery system configured and operable to deliver, to the AMR, a shipping container;
a sealing apparatus operable such that when the AMR moves through the sealing apparatus with the shipping container thereon the shipping container is sealed;
the AMR being configured and operable to:
receive, from the processor, the AMR instructions; and
according to the AMR instructions, travel to the sealing apparatus and move through the sealing apparatus to seal the shipping container.

243. The system of claim 242, wherein the AMR further comprises a drive mechanism operable to drive the movement of the AMR and wherein the AMR with the shipping container thereon, is driven thorough the sealing apparatus by the drive mechanism.

244. The system of claim 242 or claim 243, further comprising first and second transversely spaced, longitudinally extending guide belts, operable to guide the shipping container during longitudinal movement of the AMR with the shipping container secured thereon through the sealing apparatus.

245. The system of claim 244, wherein the guide belts are in contact with respective opposed side surfaces of the shipping container during longitudinal movement of the AMR with the shipping container secured thereon, through the sealing apparatus.

246. The system of claim 244 or claim 245, wherein the transverse spacing of the guide belts is adjustable by the processor to correspond to a width of the shipping container.

247. The system of any one of claims 244 to 246, the system being operable such that the movement of the longitudinal guide belts provides information to the processor indicative of the movement of the AMR and shipping container through the through the sealing apparatus.

248. The system of any one of claims 242 to 247, wherein the sealing apparatus comprises a folding rail system operable for closing at least one of an upper leading flap and first and second opposed side flaps of the shipping container, during the movement of the AMR and shipping container through the through the sealing apparatus.

249. The system of claim 248, wherein the sealing apparatus further comprises a flap kicking mechanism operable for closing a trailing flap of the shipping container, during the movement of the AMR and the shipping container through the through the sealing apparatus.

250. The system of any one of claims 242 to 249, further comprising a labelling apparatus operable such that when the AMR moves through the labelling apparatus with the shipping container thereon the shipping container is labeled.

251. The system of claim 250, wherein the AMR moves, according to the AMR instructions, through the sealing apparatus and the labelling apparatus to seal and label the shipping container.

252. An autonomous mobile robot (AMR) for transporting a receptacle, the AMR comprising:
a mobile cart;
a control system for controlling operation of the AMR;
a first belt having an upper surface;
a first lug fastened to the upper surface of the first belt;
a second belt having an upper surface; and
a second lug fastened to the upper surface of the second belt;
the control system operable to control and adjust a position of the first lug relative to the second lug to move between:
a first position wherein a spacing between the first lug and the second lug is suitable to allow the receptacle to be positioned between, and removed from between, the first lug and the second lug; and
a second position wherein the spacing between the first lug and the second lug provides for the first lug and the second lug to engage side surfaces of the receptacle to secure the receptacle between the first lug and the second lug.

253. The AMR of claim 252, wherein the upper surface of the first belt and the upper surface of the second belt are configured to support the receptacle thereon and wherein, when the shipping container is secured between the first lug and the second lug, the receptacle is supported on the upper surface of the first belt and the upper surface of the second belt.

254. An autonomous mobile robot (AMR) for transporting a receptacle, the AMR comprising:
a mobile cart;
a control system for controlling operation of the autonomous mobile robot; and
a receptacle securement mechanism operable to releasably secure the receptacle to the mobile cart during movement in a warehouse, when the receptacle carries at least one product in a product order and when the receptacle is empty of any products;
the control system operable to control and adjust the operation of the receptacle securement mechanism between:
a first state in which the receptacle is secured to the mobile cart and can be moved within the warehouse when the receptacle is both carrying at least one product in a product order and when the receptacle is empty of any products; and
a second state wherein the receptacle can be removed from the mobile cart.

255. The AMR as claimed in claim 254, wherein, in the second state, the receptacle can be received onto the mobile cart.

256. The AMR as claimed in claim 254 or claim 255:
wherein the receptacle securement mechanism comprises first and second lugs, the first lug attached to a belt and the second lug mounted in place, wherein the first lug is moveable, by controlling the belt, relative to the second lug to, thereby, alter a spacing between the first and second lugs;
wherein the first state is characterized by a first spacing between the first lug and the second lug that provides for the first lug and the second lug to engage side surfaces of the receptacle to, thereby, secure the receptacle to the AMR; and
wherein the second state is characterized by a second spacing between the first lug and the second lug that is suitable to allow the receptacle to be positioned between, and removed from between, the first lug and the second lug.

257. A product unloading system comprising:
a product rack for storing products, the product rack comprising:
a plurality of storage levels for storing the products thereon, the plurality of storage levels spaced apart from each other and arranged vertically within the product rack; and
a plurality of raised platforms configured for travel of an autonomous mobile robot (AMR) thereon, each one of the plurality of raised platforms positioned proximate to a respective one of the plurality of storage levels;
an elevator system comprising an elevating platform for lifting the AMR between a ground level and the plurality of raised platforms; and
a product retrieval robot for retrieving a product from a storage level of the plurality of storage levels and unloading the product onto a receptacle held by the AMR at a corresponding one of the plurality of storage levels.

258. The system of claim 256, wherein the product retrieval robot comprises an end of arm tool (EOAT) for engaging the product during retrieval.

259. The system of claim 256 or claim 258, wherein the product retrieval robot comprises a sensor for detecting the product for retrieval.

260. The system of claim 259, wherein the sensor is a camera.

261. The system of any one of claims 258 to 260, further comprising a pallet positioned on one of the plurality of storage levels, the pallet including a plurality of containers, wherein each of the containers include an article having dimensions known to the product retrieval robot, and wherein engaging the product during retrieval comprises engaging the article.

262. The system of claim 261, wherein the plurality of containers are reusable containers.

263. A fulfilment system comprising:
a processor operable to:
generate carton forming instructions;
generate product retrieval instructions; and
generate autonomous mobile robot (AMR) instructions;
a carton forming system configured to:
receive, from the processor, the carton forming instructions;
according to the carton forming instructions, select, from a magazine, a carton blank; and
form the carton blank into an erected carton;
a product retrieval robot configured to:
receive, from the processor, the product retrieval instructions; and
retrieve, according to the product retrieval instructions, a product from a product rack in a product storage location;
an AMR configured to:
receive, from the processor, the AMR instructions;
according to the AMR instructions, travel to the carton forming system and receive, from the carton forming system, the erected carton;
according to the AMR instructions, travel, while holding the erected carton, to the product rack;
receive, at the product rack, the product from the product retrieval robot into the erected carton; and
according to the AMR instructions, travel, while holding the erected carton with the product inside, to a location for further processing of the erected carton.

264. The system of claim 263, wherein the carton forming instructions are generated by the processor based on a customer order received by the processor, the product retrieval instructions are generated by the processor based on the customer order received by the processor, and the AMR instructions are generated by the processor based on the customer order received by the processor.

265. The system of claim 263 or claim 264, wherein the product rack comprises:
a plurality of storage levels for storing products thereon, the plurality of storage levels spaced apart from each other and arranged vertically within the product rack; and
a plurality of raised platforms configured for travel of an AMR thereon, each one of the plurality of raised platforms positioned proximate to a respective one of the plurality of storage levels.

266. The system of claim 265 further comprising an elevator system configured to receive, from the processor, elevation instructions for lifting the AMR between a ground level and one of the plurality of raised platforms, and wherein the AMR is further to:
at the product rack, be transported by the elevator system to the one of the plurality of raised platforms;
travel, according to the AMR instructions, along the one of the plurality of raised platforms; and
receive the product from the product retrieval robot into the erected carton.

267. The system of claim 265 or 266, further comprising a pallet positioned on one of the plurality of storage levels, the pallet including a plurality of reusable containers, each of the plurality of reusable containers including a plurality of products, and wherein:
responsive to the AMR receiving a last of the plurality of products in any one of the reusable containers, an empty AMR is configured to:
receive, from the processor, empty AMR instructions generated by the processor;
according to the empty AMR instructions, travel to the product rack;
receive, at the product rack, the reusable container from the product retrieval robot; and
according to the empty AMR instructions, travel, while holding the container, to a location for further processing of the reusable container.

268. The system of claim 267, wherein the further processing of the reusable container comprises unloading the reusable container onto a further pallet.

269. A fulfillment system comprising:
a processor operable to:
generate receptacle delivery instructions; and
generate autonomous mobile robot (AMR) instructions;
a carton delivery system configured to:
receive, from the processor, the receptacle delivery instructions; and
according to the receptacle delivery instructions, select, from a selection of receptacles a chosen receptacle for delivery;
an AMR configured to:
receive, from the processor, the AMR instructions;
according to the AMR instructions, travel to a receptacle delivery system and receive, from the receptacle delivery system, the chosen receptacle;
according to the AMR instructions, travel, while holding the chosen receptacle, to a station in a product induction region;
receive, at the station, a product into the chosen receptacle; and
according to the AMR instructions, travel, while holding the chosen receptacle with the product inside, to a location for further processing of the chosen receptacle.

270. The fulfilment system of claim 269, wherein the receptacle delivery system comprises a carton forming system configured to:
receive, from the processor, receptacle delivery instructions that comprise carton forming instructions;
according to the carton forming instructions, select, from a plurality of magazines, a carton blank, thereby establishing a selected carton blank; and
form the selected carton blank into an erected carton.

271. The fulfilment system of claim 269 or claim 270, wherein the station in the product induction region comprises a robotic product loading station and wherein the AMR is configured to receive the product from a product retrieval robot into the chosen receptacle.

272. The fulfilment system of claim 269 or claim 270, wherein the station in the product induction region comprises a manual product loading station and wherein the AMR is configured to receive the product from a manual product retrieval associate into the chosen receptacle.

273. A fulfillment system comprising:
a processor operable to:
generate shipping container selection instructions; and
generate autonomous mobile robot (AMR) instructions;
a shipping container delivery system configured to:
receive, from the processor, the shipping container selection instructions; and
according to the shipping container selection instructions, select, from a plurality of shipping containers, a selected shipping container;
an AMR configured to:
receive, from the processor, the AMR instructions;
according to the AMR instructions, travel to the shipping container delivery system and receive, from the shipping container delivery system, the selected shipping container;
according to the AMR instructions, travel, while holding the selected shipping container, to a station in a product induction region, wherein the product induction region includes a product tower, the product tower including a plurality of compartments for storing products, and wherein at least one of the plurality of compartments includes one or more products, the one or more products corresponding with at least one stock keeping unit;
receive, at the station, a first product into the selected shipping container;
according to the AMR instructions, travel, while holding the selected shipping container, to a given product storage rack in a storage region, wherein the storage region includes a plurality of product storage racks that store products in pallets;
receive, at the given product storage rack, a second product into the selected shipping container; and
according to the AMR instructions, travel, while holding the selected shipping container with the first product and the second product inside, to a location for further processing of the selected shipping container.

274. The fulfillment system of claim 273, wherein the shipping container selection instructions are generated by the processor based on a customer order received by the processor and the AMR instructions are generated by the processor based on the customer order received by the processor.

275. The fulfillment system of claim 273 or claim 274, further comprising a sealing apparatus operable to seal open flaps of the selected shipping container.

276. The fulfillment system of claim 275, wherein, while the AMR moves through the sealing apparatus, the sealing apparatus seals the open flaps of the selected shipping container.

277. The fulfillment system of claim 276, wherein the AMR further comprises a drive mechanism operable to drive the movement of the AMR and wherein the AMR is driven thorough the sealing apparatus by the drive mechanism.

278. The fulfillment system of claim 277, further comprising first and second transversely spaced, longitudinally extending guide belts, operable to guide the selected shipping container during longitudinal movement of the AMR, with the selected shipping container thereon, through the sealing apparatus.

279. The fulfillment system of claim 273, wherein the processor is further operable to generate instructions for a tower-relocating AMR to relocate the product tower to the station in the product induction region.

280. The fulfillment system of claim 273, wherein the processor is further operable to generate instructions for a product picking robot, associated with the given product storage rack, to:
pick the second product; and
place the second product into the selected shipping container.

281. The fulfillment system of claim 273, wherein the AMR is further configured to, according to the AMR instructions, travel, while holding the selected shipping container, to a location in a second product induction region, wherein the second product induction region includes a crate retention structure, the crate retention structure retaining a plurality of crates for storing products, and wherein at least one of the plurality of crates includes one or more products, the one or more products corresponding with a single stock keeping unit.

282. The fulfillment system of claim 281, wherein the AMR is a shipping container AMR and the system further comprises a crate retention AMR, wherein the processor is further operable to generate crate retention AMR instructions, the crate retention AMR instructions instructing the crate retention AMR to transport the crate retention structure to the second product induction region to meet with the shipping container AMR.

283. The fulfillment system of claim 273, wherein the storage region includes a plurality of zones.

284. The fulfillment system of claim 283, wherein the plurality of zones comprises a zone wherein the products are maintained at a temperature of below freezing.

285. The fulfillment system of claim 283, wherein the plurality of zones comprises a zone wherein the products are maintained at an ambient temperature.

286. The fulfillment system of claim 283, wherein the plurality of zones comprises a zone wherein the products are maintained at a temperature of above freezing and below an ambient temperature.

287. The fulfillment system of claim 273, wherein the product tower stores products representative of around 50 stock keeping units.

288. The fulfillment system of claim 287, further comprising a tower storage region configured for storing a plurality of product towers.

289. The fulfillment system of claim 288, wherein the tower storage region stores products representative of more than 500,000 stock keeping units.

290. The fulfillment system of claim 273, wherein each pallet in the storage region stores a product representative of a single stock keeping unit.

291. The fulfillment system of claim 290, wherein the storage region stores products representative of fewer than 10,000 stock keeping units.

292. The fulfillment system of claim 291, wherein the products stored in the storage region comprise grocery items.

293. A fulfilment system comprising:
a processor operable to:
generate carton forming instructions;
generate product retrieval instructions; and
generate autonomous mobile robot (AMR) instructions;
a carton forming system configured to:
receive, from the processor, the carton forming instructions;
according to the carton forming instructions, select, from a plurality of available carton blanks, a carton blank; and
form the carton blank into an erected carton;
a product retrieval robot configured to:
receive, from the processor, the product retrieval instructions; and
retrieve, according to the product retrieval instructions, a product in a product storage location;
a reusable container, the reusable container including a plurality of products used to fulfil a plurality of orders, the reusable container becoming an empty reusable container upon the plurality of products being removed from the reusable container to fulfil the plurality of orders;
an AMR configured to:
receive, from the processor, the AMR instructions;
according to the AMR instructions, travel to the carton forming system and receive, from the carton forming system, the erected carton;
according to the AMR instructions, travel, while holding the erected carton, to a product loading station;
receive, at the product loading station, the product into the erected carton;
according to the AMR instructions, travel, while holding the erected carton with the product inside, to a location for further processing of the erected carton, wherein the further processing of the erected carton includes removal of the erected carton from the AMR;
thereafter, according to the AMR instructions, travel and receive, the empty reusable container; and
according to the AMR instructions, travel, while holding the empty reusable container, to a location for further processing of the empty reusable container.

294. The system of claim 293, wherein the plurality of available carton blanks are stored in a plurality of magazines.

295. The system of claim 293, wherein the carton forming instructions are generated by the processor based on a customer order received by the processor, the product retrieval instructions are generated by the processor based on the customer order received by the processor, and the AMR instructions are generated by the processor based in part on the customer order received by the processor.

296. The system of claim 293, wherein the product loading station comprises a robotic product loading station and wherein the AMR is configured to receive the product from the product retrieval robot into the erected carton.

297. The system of claim 293, wherein the product loading station comprises a manual product loading station and wherein the AMR is configured to receive the product from a manual product retrieval associate into the erected carton.

298. A fulfilment system comprising:
a processor operable to:
generate shipment container delivery instructions;
generate product retrieval instructions; and
generate autonomous mobile robot (AMR) instructions;
a shipment container delivery system configured to:
receive, from the processor, the shipment container delivery instructions; and
according to the shipment container delivery instructions, select, from a plurality of available shipment containers, a shipment container;
a product retrieval robot configured to:
receive, from the processor, the product retrieval instructions; and
retrieve, according to the product retrieval instructions, a product in a product storage location;
a reusable container, the reusable container including a plurality of products used to fulfil a plurality of orders, the reusable container becoming an empty reusable container upon the plurality of products being removed from the reusable container to fulfil the plurality of orders;
an AMR configured to:
receive, from the processor, the AMR instructions;
according to the AMR instructions, travel to the shipment container delivery system and receive the shipment container;
according to the AMR instructions, travel, while holding the shipment container, to a product loading station;
receive, at the product loading station, the product into the shipment container;
according to the AMR instructions, travel, while holding the shipment container with the product inside, to a location for further processing of the shipment container, wherein the further processing of the shipment container includes removal of the shipment container from the AMR;
thereafter, according to the AMR instructions, travel and receive, the empty reusable container on the AMR; and
according to the AMR instructions, travel, while holding the empty reusable container, to a location for further processing of the empty reusable container.

299. The system of claim 298, wherein the product loading station comprises a robotic product loading station and wherein the AMR is configured to receive the product from the product retrieval robot into the shipment container.

300. The system of claim 298, wherein the product loading station comprises a manual product loading station and wherein the AMR is configured to receive the product from a manual product retrieval associate into the shipment container.

301. The system of claim 298, wherein the shipment container delivery instructions are generated by the processor based on a customer order received by the processor, the product retrieval instructions are generated by the processor based on the customer order received by the processor, and the AMR instructions are generated by the processor based in part on the customer order received by the processor.

302. A method of receiving products into a fulfillment center, the method including:
transmitting instructions to a first autonomous mobile robot (AMR), the instructions causing the first AMR to:
navigate to a crate retention structure in a first transport trailer, the crate retention structure retaining a crate in which is stored a plurality of a product; and
transport the crate retention structure to a product induction region at which individual products among the plurality of products may be removed from the crate;
transmitting instructions to a second AMR, the instructions causing the second AMR to:
navigate to the crate retention structure in the product induction region, the crate no longer storing the product;
transport the crate retention structure to a second transport trailer; and
navigate away from the second transport trailer without the crate retention structure.

303. The method of claim 302, wherein an origin of the first transport trailer comprises a supplier of the product.

304. The method of claim 303, wherein a destination of the second transport trailer comprises the supplier of the product.

305. The method of claim 303, wherein a destination of the second transport trailer comprises a supplier of a distinct product.

306. The method of claim 302, further comprising configuring the first transport trailer to facilitate navigation, in the first transport trailer, by the first AMR.

307. The method of claim 306, wherein the configuring the first transport trailer comprises using a configuration consistent with a configuration of the fulfillment center that facilitates navigation, in the fulfillment center, by the first AMR.

308. An autonomous mobile robot for transporting a shipping container, the autonomous mobile robot comprising:
a mobile cart;
a control system for controlling operation of the autonomous mobile robot;
an outer case mounted to the cart, the outer case including:
a vacuum reservoir defining a plurality of apertures;
a vacuum pump in pneumatic communication with the vacuum reservoir, the vacuum pump configured to, responsive to an instruction received from the control system, create a negative pressure within the vacuum reservoir; and
a plurality of suction cups corresponding to the plurality of apertures, the plurality of suction cups mounted to the outer case.

309. The autonomous mobile robot of claim 308, wherein each suction cup among the plurality of suction cups is in fluid communication with a valve to provide a plurality of combinations of valves and suction cups, wherein each valve has a corresponding suction cup.

310. The autonomous mobile robot of claim 309, wherein the each valve is configured to open responsive to sensing that the corresponding suction cup is covered by at least a portion of the shipping container.

311. The autonomous mobile robot of claim 309, further comprising a slide plate interposing each combination among the plurality of combinations and the vacuum reservoir, the slide plate having a plurality of openings corresponding to the plurality of apertures in the vacuum reservoir and corresponding to the plurality of combinations.

312. The autonomous mobile robot of claim 308, further comprising a slide plate interposing each of the plurality of suction cups and the vacuum reservoir, the slide plate having a plurality of openings corresponding to the plurality of apertures in the vacuum reservoir and corresponding to the plurality of suction cups.

313. The autonomous mobile robot of claim 308, further comprising a slide plate interposing the outer case and the vacuum reservoir, the slide plate having a plurality of openings corresponding to the plurality of apertures in the vacuum reservoir.

314. The autonomous mobile robot of any one of claim 311, 312 or 313, further comprising an electrical actuator to, responsive to receiving activation from the control system, cause the slide plate to move between:
a first position, wherein the openings in the slide plate align with the apertures in the vacuum reservoir; and
a second position, wherein the openings in the slide plate do not align with the apertures in the vacuum reservoir.

315. The autonomous mobile robot of any one of claims 308 to 313, wherein the mobile cart comprises drive wheels.

316. The autonomous mobile robot of claim 315, wherein the control system is configured to control the drive wheels to maneuver the autonomous mobile robot to a station within a fulfilment center.

317. The autonomous mobile robot as claimed in any one of claims 308 to 316, wherein at least some of the plurality of suction cups are generally oriented in a vertically upwards direction.

318. An outer case for mounting to a mobile cart of an autonomous mobile robot (AMR) for transporting a shipping container, the AMR including a control system for controlling operation of the AMR, the outer case including:
a vacuum reservoir defining a plurality of apertures;
a vacuum pump in pneumatic communication with the vacuum reservoir, the vacuum pump configured to, responsive to an instruction received from the control system, create a negative pressure within the vacuum reservoir; and
a plurality of suction cups corresponding to the plurality of apertures, the plurality of suction cups mounted to the outer case.

319. The outer case of claim 318, wherein each suction cup among the plurality of suction cups is in fluid communication with a valve to provide a plurality of combinations of valves and suction cups, wherein each valve has a corresponding suction cup.

320. The outer case of claim 319, wherein the each valve is configured to open responsive to sensing that the corresponding suction cup is covered by at least a portion of the shipping container.

321. The outer case of claim 320, further comprising a slide plate interposing each combination of the plurality of combinations and the vacuum reservoir, the slide plate having a plurality of openings corresponding to the plurality of apertures in the vacuum reservoir and corresponding to the plurality of combinations.

322. The outer case of claim 319, further comprising a slide plate interposing each of the plurality of suction cups and the vacuum reservoir, the slide plate having a plurality of openings corresponding to the plurality of apertures in the vacuum reservoir and to the plurality of suction cups.

323. The outer case of claim 319, further comprising a slide plate interposing the outer case and the vacuum reservoir, the slide plate having a plurality of openings corresponding to the plurality of apertures in the vacuum reservoir.

324. The outer case of any one of claim 321, 322 or 323, further comprising an electrical actuator to, responsive to receiving activation from the control system, cause the slide plate to move between:
a first position, wherein the openings in the slide plate align with the apertures in the vacuum reservoir; and
a second position, wherein the openings in the slide plate do not align with the apertures in the vacuum reservoir.

325. The outer case of any one of claims 318 to 324, wherein at least some suction cups among the plurality of suction cups are generally oriented in a vertically upwards direction.

326. An autonomous mobile robot for transporting a shipping container, the autonomous mobile robot comprising:
a base;
at least three wheels configured for supporting the base, at least one of the wheels being a drive wheel, the drive wheel being operably connected to a drive motor;
a control system for controlling operation of the drive motor to control the movement of the drive wheel and corresponding movement of the base;
a vacuum reservoir inter-connected to the base and defining a plurality of openings;
a vacuum pump in pneumatic communication with the vacuum reservoir, the vacuum pump configured to, responsive to an instruction received from the control system, create a negative pressure within the vacuum reservoir; and
a plurality of suction cups corresponding to the plurality of openings, the plurality of suction cups inter-connected to the base.

327. A method of fulfilling an order, the method comprising:
moving the autonomous mobile robot as claimed in any one of claims 308 to 317 and claim 326, to a shipment container loading station;
receiving, onto the autonomous mobile robot, an empty shipment container;
generating a suction force at each suction cup of at least some of the suction cups of the plurality of suction cups to hold the empty shipment container on the autonomous mobile robot; and
while the suction force is being generated at each suction cup of at least some of the suction cups of the plurality of suction cups to hold the shipment container on the autonomous mobile robot, moving the autonomous mobile robot to a goods loading station.

328. The method of claim 327, further comprising, at the goods loading station, receiving, within the empty shipping container, one or more goods.

329. The method of claim 328, further comprising, while the suction force is being generated at each suction cup of at least some of the suction cups of the plurality of suction cups to hold the shipment container on the autonomous mobile robot, moving the autonomous mobile robot to a closing station.

330. The method of claim 329, further comprising, at the closing station, closing the shipment container with the one or more goods held in the shipping container.

331. An autonomous mobile robot (AMR) for transporting a receptacle, the AMR comprising:
a mobile cart;
a first belt on the mobile cart having an upper surface, and a first lug on the upper surface;
a second lug mounted to the mobile cart;
first lug movable relative to the second lug to selectively retain the receptacle between the first and second lugs by squeezing the receptacle.

332. The AMR of claim 331, wherein the first lug is movable between:
a first position wherein a spacing between the first lug and the second lug is suitable to allow a receptacle to be positioned between, and removed from between, the first lug and the second lug; and
a second position wherein the spacing between the first lug and the second lug provides for the first lug and the second lug to engage side surfaces of the receptacle to secure the receptacle between the first lug and the second lug.

333. The AMR of claim 332, wherein, in the first of position of said first lug, at least one of said first lug and said second lug does not engage the receptacle.

334. The AMR of any one of claims 331 to 333, wherein the first position is characterized by a first spacing between the first lug and the second lug; and wherein the second state is characterized by a second spacing between the first lug and the second.

335. The AMR of any one of claims 331 to 334, wherein the upper surface of the first belt is configured to support the receptacle thereon and wherein, when the shipping container is secured between the first lug and the second lug, the receptacle is supported on the upper surface of the first belt.

336. The AMR of any one of claims 331 to 335, wherein the second lug is fixed relative to the mobile cart.

337. The AMR of any one of claims 331 to 336, wherein the second lug is mounted to a top surface of the mobile cart.

338. The AMR of any one of claims 331 to 337, comprising a control system operable to adjust a position of the first lug between the first and second positions by movement of the first belt.

339. An order fulfilment system, comprising:
a plurality of reusable pallets;
a production operation;
a shipping container operation;
a fulfillment operation;
the production operation comprising:
a source of products;
a product transfer apparatus, operable to transfer a plurality of products, provided by the source of products, onto a pallet at a production pallet loading position; and
a plurality of production AMRs, each operable to move first loaded ones of the pallets from the product transfer apparatus to first transport trailers for transport to the fulfillment operation, and to receive unloaded ones of the pallets from second transport trailers and move the unloaded ones of the pallets to the production pallet loading position;
the shipping container operation comprising:
a source of shipping container blanks;
a shipping container blank transfer apparatus, at the shipping container operation, operable to transfer a plurality of shipping container blanks, provided by the source of shipping container blanks, onto a shipping container blank pallet located at a shipping container pallet loading position; and
a plurality of shipping container AMRs, each operable to move second loaded ones of the pallets from the product transfer apparatus to third transport trailers for transport to the fulfillment operation, and to receive unloaded ones of the pallets from fourth transport trailers and move the unloaded ones of the pallets to the shipping container pallet loading position; and
the fulfillment operation comprising:
a shipping container erector operable to form shipping containers from the shipping container blanks for shipping fulfilled product orders to customers; and
a plurality of fulfillment AMRs, each operable to:
receive said first loaded ones of the pallets and move the first loaded ones from the first transport trailers to storage locations in the fulfillment operation;
receive said second loaded ones of the pallets and move the second loaded ones of the pallets from the third transport trailers to the shipping container erector; and
move unloaded ones of the pallets to the second transport trailers for transportation to the production operation and to the fourth transport trailers for transportation to the shipping container operation.

340. The system of claim 339, wherein the production AMRs, shipping AMRs, and fulfillment AMRs are operable to navigate within the first transport trailers, second transport trailers, third transport trailers and fourth transport trailers;

341. The system of claim 340, wherein the production AMRs, shipping AMRs, and fulfillment AMRs are operable to navigate within the first transport trailers, second transport trailers, third transport trailers and fourth transport trailers using tracks defined on the floors of the transport trailers.

342. The system of claim 341, wherein the tracks are defined using barcodes.

343. The system of any one of claims 339 to 342, wherein the pallets are configured to permit access thereunder from any of four sides by the production AMRs, shipping AMRs, and fulfillment AMRs.

344. The system of any one of claims 339 to 343, wherein the production AMRs, shipping AMRs, and fulfillment AMRs are operable to lift the first loaded ones of the plurality of pallets and the second loaded ones of the plurality of pallets.

345. The system of any one of claims 339 to 344, wherein the storage locations are storage cells in the fulfillment operation.

346. The system of any one of claims 339 to 345, wherein each of the plurality of pallets has the same external dimensions.

347. The system of any one of claims 339 to 346, wherein each one of the plurality of pallets is configured for engagement by the production AMRs, shipping AMRs, and fulfillment AMRs.

348. The system of any one of claims 339 to 347, comprising a plurality of crates, wherein the product transfer apparatus is operable to transfer the products into ones of the crates on a pallet at the production pallet loading position, and wherein the shipping container blank transfer apparatus is operable to transfer the shipping container blanks into ones of the crates on the shipping container blank pallet located at a shipping container pallet loading position.

349. The system of claim 348, wherein the plurality of crates are sized and shaped to be stacked atop a pallet, wherein crates in the stack nest with one another.

350. The system of claim 348 or 349, wherein each of the plurality of pallets is sized and shaped to receive a crate of the plurality of crates such that the bottom of the crate nests with the pallet.

351. The system of any one of claims 339 to 350, wherein the pallets are transported in a closed loop among the production operation, the shipping container operation, and the fulfillment operation.
